(19) United States
(12) Patent Application Publication
(10) Pub. No.: US 2011/0307289 A1
(43) Pub. Date: Dec. 15, 2011

(54) MANAGING CONSISTENT INTERFACES FOR CUSTOMER PROJECT INVOICING AGREEMENT, ENGINEERING CHANGE CASE, PRODUCT DESIGN, PRODUCT DESIGN VERSION HIERARCHY, AND PROJECT EXPENSE VIEW BUSINESS OBJECTS ACROSS HETEROGENEOUS SYSTEMS

(76) Inventors: Lohit Hosur, Bangalore (IN); Volker Faisst, Heidelberg (DE); Otfried Von Geisau, Sinsheim (DE); Vytas Cirpus, Waldsee (DE); Joerg Goeppert, Karlsruhe (DE); Guang Yang, Bad Schoenborn (DE); Volker Schott, Nussloch (DE); Monica Reidl, Sandhausen (DE); Michael Seubert, Sinsheim (DE); Arno Mielke, Karlsruhe (DE); Klaus Herter, Leimen (DE); Andre Doerfler, Sofia (BG); Steffen Springborn, Edingen (DE); Alexander S. Adam, Montreal (CA); Christian Fuhlbruegge, Spechbach (DE); Michael Belenki, Karlsruhe (DE); Thomas Kretz, Muehlhausen (DE); Thomas Leichtweiss, Heilbronn (DE); Werner Sottong, Ubstadt-Weiher (DE); Rudolf Winkel, Walldorf (DE); Monika Kaiser, Bad Schoenborn (DE); Claus Gschiermeister, Eggenstein-Leopoldshafen (DE); Jens Griessmann, Walldorf (DE); Kristina Grunewald, Heidelberg (DE); Michael Wachter, Hockenheim (DE); Werner Gnan, Angelbachtal (DE); Thilo Kraehmer, Heidelberg (DE); Payal Patnaik, Bangalore (IN); Tanja Rueckel, Waghaeusel (DE)

(21) Appl. No.: 12/816,083

(22) Filed: Jun. 15, 2010

(51) Int. Cl. G06Q 10/00; G06Q 40/00; G06Q 30/00

(52) U.S. Cl. 705/7.23; 705/34; 705/342; 705/30

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a customer project invoicing agreement, an engineering change case, a product design, a product design version hierarchy, and/or a project expense view business object.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In one aspect, a tangible computer readable medium includes program code for providing a message-based interface for exchanging sales and invoice information between a sales order processing system and other systems. The medium includes program code for receiving via a message-based interface derived from a common business object model. The common business object model includes business objects having relationships that enable derivation of message-based interfaces and message packages, the message-based interface exposing at least one service as defined in a service registry and from a heterogeneous application executing in an environment of computer systems providing message-based services, a first message for requesting a confirmation to the sales order processing system that a customer project invoicing agreement related to a sales order has been created or updated that includes a first message package derived from the common business object model and hierarchically organized in memory as: a customer project invoicing agreement maintain confirmation request message entity. The system further includes a customer project invoicing agreement package that includes a customer project invoicing agreement entity and an item package includes an item entity. The customer project invoicing agreement entity includes an item list complete transmission indicator, an action code, a base customer transaction document identifier (ID), a base customer transaction document universally unique ID and a customer project invoicing agreement reference, and where the item entity includes a base customer transaction document item ID, a fulfillment processing status code, an invoice processing status code and a customer project invoicing agreement item reference. The system further includes program code for processing the first message according to the hierarchical organization of the first message package. Processing the first message includes unpacking the first message package based on the common business object model. The system further includes program code for sending a second message to the heterogeneous application responsive to the first message. The second message includes a second message package derived from the common business object model to provide consistent semantics with the first message package.

Implementations can include any, all, or none of the following features. The customer project invoicing agreement entity further includes at least one of the following: a reconciliation period counter value.

In another aspect, a distributed system operating in a landscape of computer systems providing message-based services defined in a service registry, the system includes a graphical user interface includes computer readable instructions, embedded on tangible media, for requesting a confirmation to a sales order processing system that a customer project invoicing agreement related to a sales order has been created or updated using a request. The system further includes a first memory storing a user interface controller for processing the request and involving a message includes a message package derived from a common business object model. The common business object model includes business objects having relationships that enable derivation of message-based service interfaces and message packages, the message package hierarchically organized as: a customer project invoicing agreement maintain confirmation request message entity. The system further includes a customer project invoicing agreement package includes a customer project invoicing agreement entity and an item package includes an item entity. The customer project invoicing agreement entity includes an item list complete transmission indicator, an action code, a base customer transaction document identifier (ID), a base customer transaction document universally unique ID and a customer project invoicing agreement reference, and where the item entity includes a base customer transaction document item ID, a fulfillment processing status code, an invoice processing status code and a customer project invoicing agreement item reference. The system further includes a second memory, remote from the graphical user interface, storing a plurality of message-based service interfaces derived from the common business object model to provide consistent semantics with messages derived from the common business object model. One of the message-based service interfaces processes the message according to the hierarchical organization of the message package. Processing the message includes unpacking the first message package based on the common business object model.

Implementations can include any, all, or none of the following features. The first memory is remote from the graphical user interface. The first memory is remote from the second memory.

In another aspect, a tangible computer readable medium includes program code for providing a message-based interface for exchanging information about an engineering change case includes a collection of documents, references, and decisions for the purpose of i) identifying a potential solution to problems that initiate an engineering change, ii) researching, designing, and validating engineering change alternatives, iii) reviewing and deciding on an implementation of the change, and iv) instructing the participants in the change and defining their responsibilities, the medium includes program code for receiving via a message-based interface derived from a common business object model. The common business object model includes business objects having relationships that enable derivation of message-based interfaces and message packages, the message-based interface exposing at least one service as defined in a service registry and from a heterogeneous application executing in an environment of computer systems providing message-based services, a first message for retrieving information about an engineering change case that includes a first message package derived from the common business object model and hierarchically organized in memory as: an engineering change case request message entity. The system further includes an engineering change case package includes an engineering change case entity, a business folder entity, and a business process variant type entity. The engineering change case entity includes a universally unique identifier (UUID), an identifier (ID), an engineering change type code, a responsible employee UUID, a responsible employee ID, a due date time, a partial system administrative data, and a status. The system further includes program code for processing the first message according to the hierarchical organization of the first message package. Processing the first message includes unpacking the first message package based on the common business object model. The system further includes program code for sending a second message to the heterogeneous application responsive to the first message. The second message includes a second message package derived from the common business object model to provide consistent semantics with the first message package.

Implementations can include any, all, or none of the following features. The engineering change case entity further includes at least one of the following: a name, an engineering change reason code, an engineering change risk level code, a project UUID, and a project ID. The engineering change case package includes at least one of the following: a text collection entity, a stage entity, an engineering change order reference entity, a product requirement specification reference entity, a product design reference entity, a material reference entity, a production bill of material reference entity, a production model reference entity, a master data change folder entity, and a master data change record entity.

In another aspect, a distributed system operating in a landscape of computer systems providing message-based services defined in a service registry, the system includes a graphical user interface includes computer readable instructions, embedded on tangible media, for retrieving information about an engineering change case using a request. The system further includes a first memory storing a user interface controller for processing the request and involving a message includes a message package derived from a common business object model. The common business object model includes business objects having relationships that enable derivation of message-based service interfaces and message packages, the message package hierarchically organized as: an engineering change case request message entity. The system further includes an engineering change case package includes an engineering change case entity, a business folder entity, and a business process variant type entity. The engineering change case entity includes a universally unique identifier (UUID), an identifier (ID), an engineering change type code, a responsible employee UUID, a responsible employee ID, a due date time, a partial system administrative data, and a status. The system further includes a second memory, remote from the graphical user interface, storing a plurality of message-based service interfaces derived from the common business object model to provide consistent semantics with messages derived from the common business object model. One of the message-based service interfaces processes the message according to the hierarchical organization of the message package. Processing the message includes unpacking the first message package based on the common business object model.

Implementations can include any, all, or none of the following features. The first memory is remote from the graphical user interface. The first memory is remote from the second memory.

In another aspect, a tangible computer readable medium includes program code for providing a message-based interface for exchanging design-related information that describes a product as designed by engineering includes design-related documents and a list of components, the medium includes program code for receiving via a message-based interface derived from a common business object model. The common business object model includes business objects having relationships that enable derivation of message-based interfaces and message packages, the message-based interface exposing at least one service as defined in a service registry and from a heterogeneous application executing in an environment of computer systems providing message-based services, a first message for confirming the replication of the design-related information that includes a first message package derived from the common business object model and hierarchically organized in memory as: a product design replication confirmation request message entity. The system further includes a product design package includes a product design entity. The product design entity includes an action code, an identifier (ID), an engineering design business system name, an engineering design business system ID, an engineering design ID, and an engineering design internal ID. The system further includes program code for processing the first message according to the hierarchical organization of the first message package. Processing the first message includes unpacking the first message package based on the common business object model. The system further includes program code for sending a second message to the heterogeneous application responsive to the first message. The second message includes a second message package derived from the common business object model to provide consistent semantics with the first message package.

Implementations can include any, all, or none of the following features. The product design package further includes at least one of the following: a version package and a log package.

In another aspect, a distributed system operating in a landscape of computer systems providing message-based services defined in a service registry, the system includes a graphical user interface includes computer readable instructions, embedded on tangible media, for confirming the replication of design-related information that describes a product as designed by engineering includes design-related documents and a list of components, using a request. The system further includes a first memory storing a user interface controller for processing the request and involving a message includes a message package derived from a common business object model. The common business object model includes business objects having relationships that enable derivation of message-based service interfaces and message packages, the message package hierarchically organized as: a product design replication confirmation request message entity. The system further includes a product design package includes a product design entity. The product design entity includes an action code, an identifier (ID), an engineering design business system name, an engineering design business system ID, an engineering design ID, and an engineering design internal ID. The system further includes a second memory, remote from the graphical user interface, storing a plurality of message-based service interfaces derived from the common business object model to provide consistent semantics with messages derived from the common business object model. One of the message-based service interfaces processes the message according to the hierarchical organization of the message package. Processing the message includes unpacking the first message package based on the common business object model.

Implementations can include any, all, or none of the following features. The first memory is remote from the graphical user interface. The first memory is remote from the second memory.

In another aspect, a tangible computer readable medium includes program code for providing a message-based interface for exchanging information about a hierarchy of product design versions that describe, in detail, a product as designed by engineering, the medium includes program code for receiving via a message-based interface derived from a common business object model. The common business object model includes business objects having relationships that enable derivation of message-based interfaces and message packages, the message-based interface exposing at least one service as defined in a service registry and from a heterogeneous application executing in an environment of computer systems providing message-based services, a first message for requesting information about a hierarchy of product design versions that describe, in detail, a product as designed by engineering that includes a first message package derived from the common business object model and hierarchically organized in memory as: a product design version hierarchy request message entity and a product design version hierarchy package includes a product design version hierarchy entity and a component entity. The product design version hierarchy entity includes a universally unique identifier (UUID), a product design version UUID, a product design version key, a product design ID, a product design version ID, and an inactive version included indicator. The medium further includes program code for processing the first message according to the hierarchical organization of the first message package. Processing the first message includes unpacking the first message package based on the common business object model. The medium further includes program code for sending a second message to the heterogeneous application responsive to the first message. The second message includes a second message package derived from the common business object model to provide consistent semantics with the first message package.

Implementations can include any, all, or none of the following features. The product design version hierarchy entity further includes at least one of the following: a product design version base, a quantity, a product design version base quantity type code, a quantity, an explosion date, and a maximum hierarchy level ordinal number value.

In another aspect, a distributed system operating in a landscape of computer systems providing message-based services defined in a service registry, the system includes a graphical user interface includes computer readable instructions, embedded on tangible media, for requesting information about a hierarchy of product design versions that describe, in detail, a product as designed by engineering, using a request. The system further includes a first memory storing a user interface controller for processing the request and involving a message includes a message package derived from a common business object model. The common business object model includes business objects having relationships that enable derivation of message-based service interfaces and message packages, the message package hierarchically organized as: a product design version hierarchy request message entity. The system further includes a product design version hierarchy package includes a product design version hierarchy entity and a component entity. The product design version hierarchy entity includes a universally unique identifier (UUID), a product design version UUID, a product design version key, a product design ID, a product design version ID, and an inactive version included indicator. The system further includes a second memory, remote from the graphical user interface, storing a plurality of message-based service interfaces derived from the common business object model to provide consistent semantics with messages derived from the common business object model. One of the message-based service interfaces processes the message according to the hierarchical organization of the message package. Processing the message includes unpacking the first message package based on the common business object model.

Implementations can include any, all, or none of the following features. The first memory is remote from the graphical user interface. The first memory is remote from the second memory.

In another aspect, a tangible computer readable medium includes program code for providing a message-based interface for exchanging grouping-related information that is used for grouping business information related to sending a business document in a message, the medium includes program code for receiving via a message-based interface derived from a common business object model. The common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification of a grouping of business information that is relevant for sending the business document in the message that includes a first message package derived from the common business object model and hierarchically organized in memory as: a project expense view notification request message entity and a project expense view package that includes a project expense view entity. The project expense view entity includes a reconciliation period counter value, an action code, a complete transmission indicator, an item list complete transmission indicator, an expense document reference, and a canceled indicator. The medium further includes program code for processing the first message according to the hierarchical organization of the first message package. Processing the first message includes unpacking the first message package based on the common business object model. The medium further includes program code for sending a second message to the heterogeneous application responsive to the first message. The second message includes a second message package derived from the common business object model to provide consistent semantics with the first message package.

Implementations can include any, all, or none of the following features. The project expense view entity further includes at least one of the following: an expense document containing business object reference and an expense document transaction UUID. The project expense view package includes at least one of the following: an attachment folder package, a text collection package, and an item package.

In another aspect, a distributed system operating in a landscape of computer systems providing message-based services defined in a service registry, the system includes a graphical user interface includes computer readable instructions, embedded on tangible media, for providing a notification of a grouping of business information that is relevant for sending a business document in a message using a request. The system further includes a first memory storing a user interface controller for processing the request and involving a message includes a message package derived from a common business object model. The common business object model includes business objects having relationships that enable derivation of message-based service interfaces and message packages, the message package hierarchically organized as: a project expense view notification request message entity. The system further includes a project expense view package includes a project expense view entity. The project expense view entity includes a reconciliation period counter value, an action code, a complete transmission indicator, an item list complete transmission indicator, an expense document reference, and a canceled indicator. The system further includes a second memory, remote from the graphical user interface, storing a plurality of message-based service interfaces derived from the common business object model to provide consistent semantics with messages derived from the common business object model. One of the message-based service interfaces processes the message according to the hierarchical organization of the message package. Processing the message includes unpacking the first message package based on the common business object model.

Implementations can include any, all, or none of the following features. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-12 depict an example object model for a business object Customer Project Invoicing Agreement.

FIG. 33 depicts an example Customer Project Invoicing Agreement Maintain Confirmation Message Data Type.

FIGS. 34-1 through 34-5 depict an example Customer Project Invoicing Agreement Maintain Request Message Data Type.

FIGS. 35-1 through 35-3 show an example configuration of an Element Structure that includes a CustomerProjectInvoicingAgreementMaintainConfirmation package.

FIGS. 36-1 through 36-24 show an example configuration of an Element Structure that includes a CustomerProjectInvoicingAgreementMaintainRequest package.

FIGS. 37-1 through 37-8 depict an example object model for a business object Engineering Change Case.

FIGS. 38-1 through 38-8 depict an example object model for a business object Product Design.

FIG. 39 depicts an example Product Design Replication Confirmation Message Data Type.

FIGS. 40-1 through 40-2 depict an example Product Design Replication Request Message Data Type.

FIGS. 41-1 through 41-9 show an example configuration of an Element Structure that includes a ProductDesignReplicationConfirmation package.

FIGS. 42-1 through 42-37 show an example configuration of an Element Structure that includes a ProductDesignReplicationRequest package.

FIG. 43 depicts an example object model for a business object Product Design Version Hierarchy.

FIGS. 44-1 through 44-8 depict an example object model for a business object Project Expense View.

FIGS. 45-1 through 45-3 depict an example Project Expense View Notification Message Data Type.

FIGS. 46-1 through 46-9 show an example configuration of an Element Structure that includes a ProjectExpenseViewMessage package.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

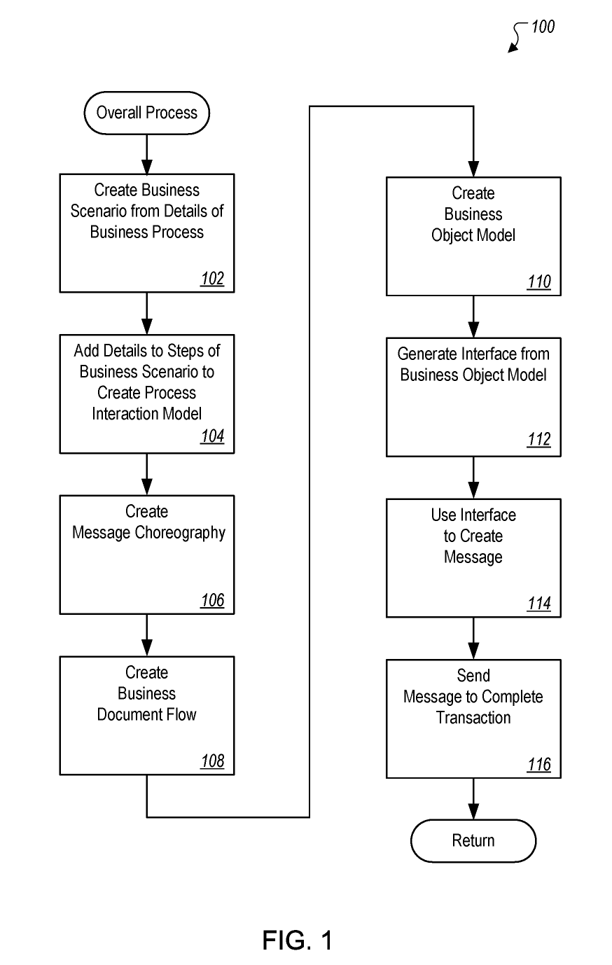

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

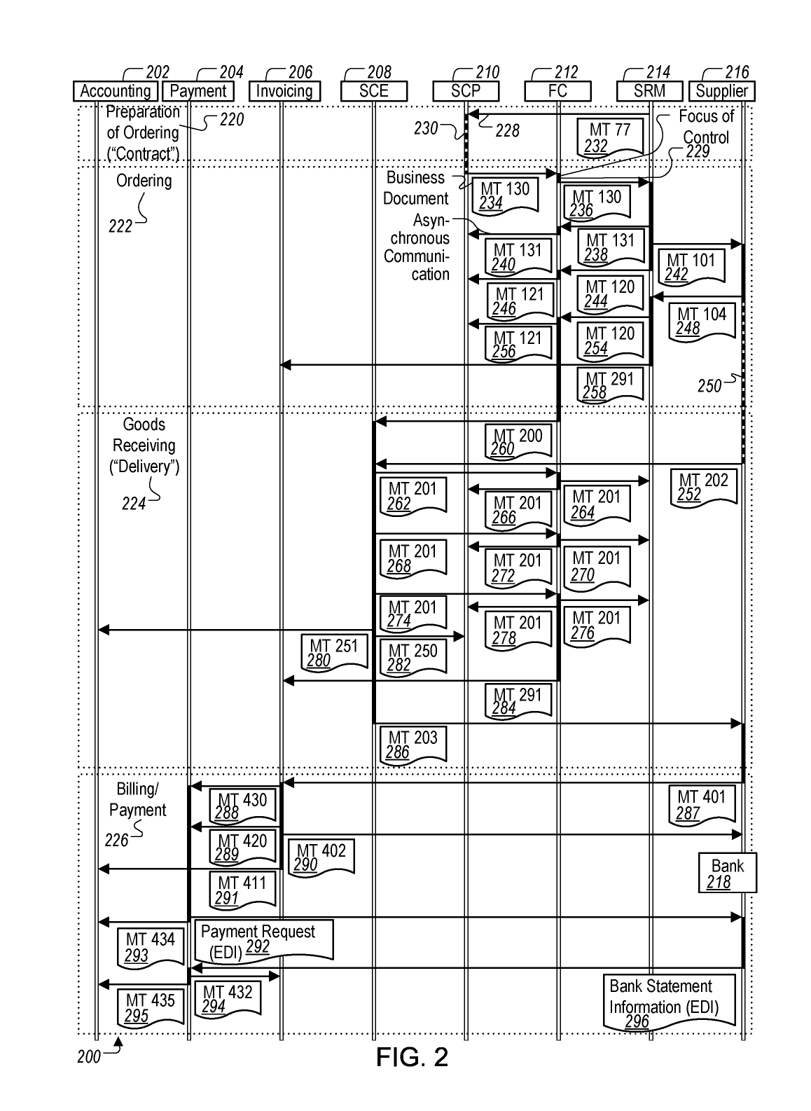

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

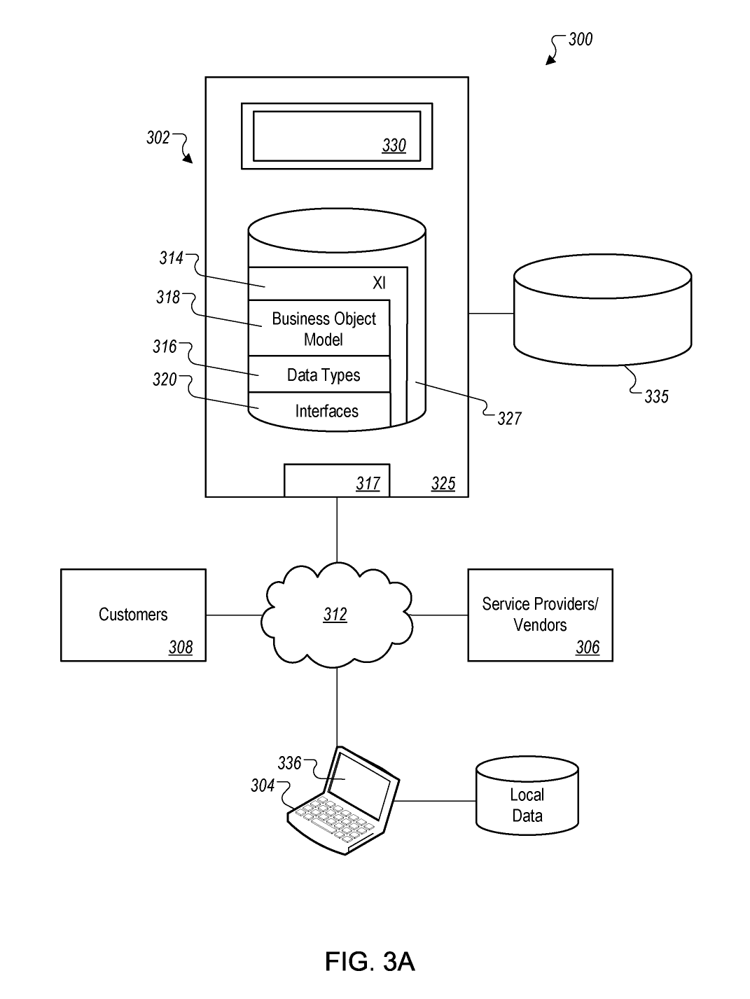

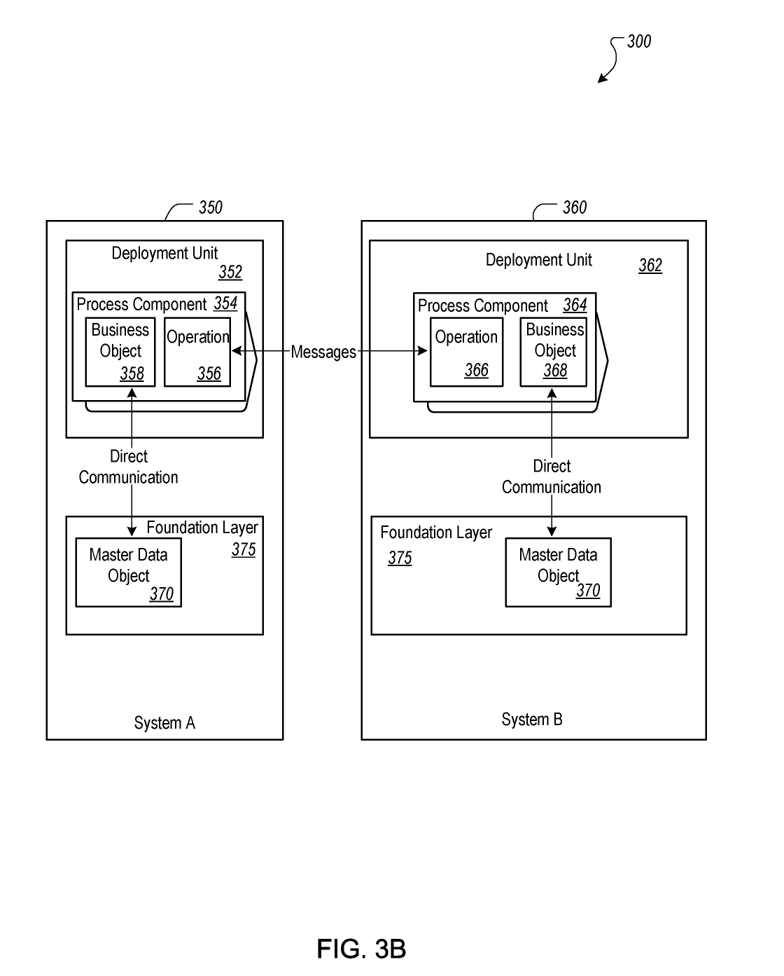

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

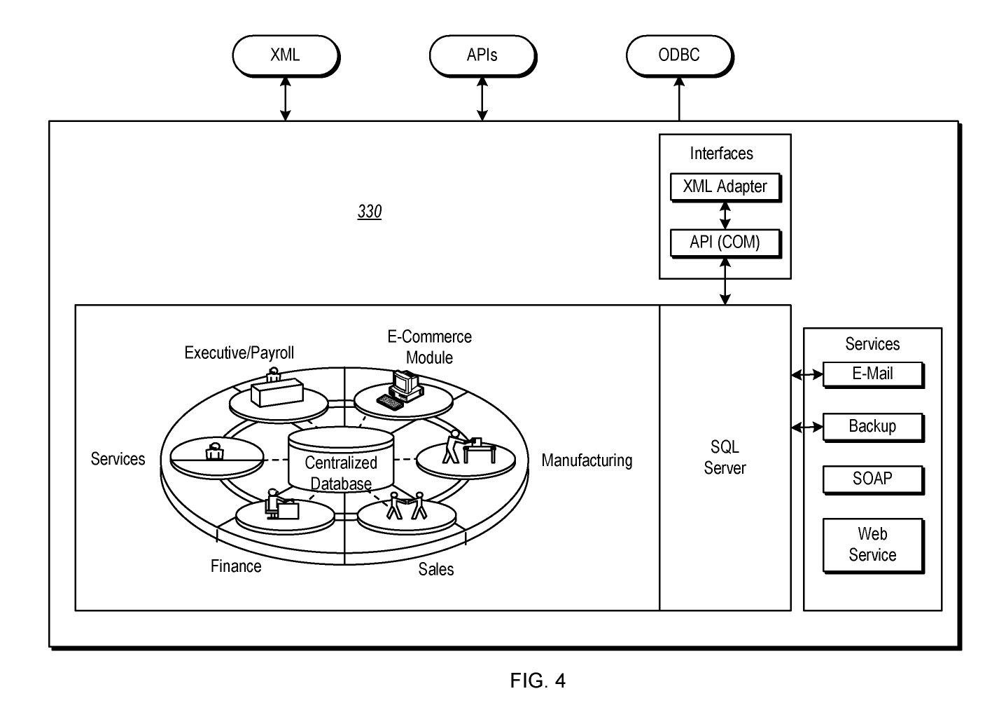

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

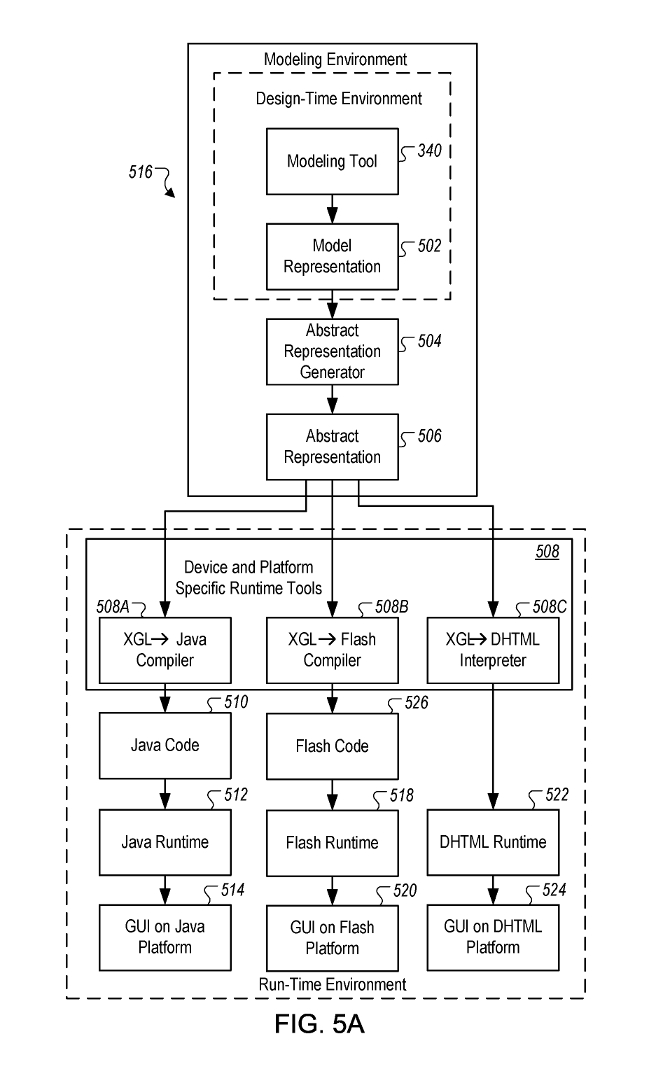

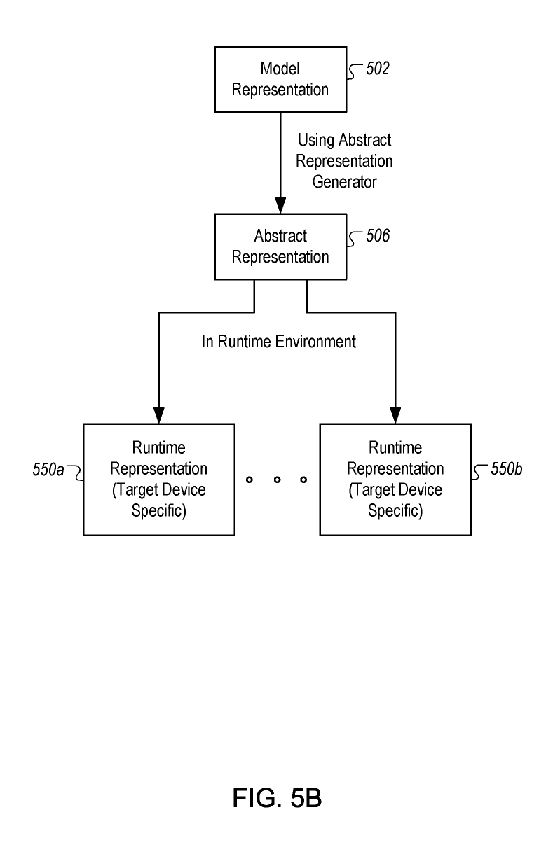

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

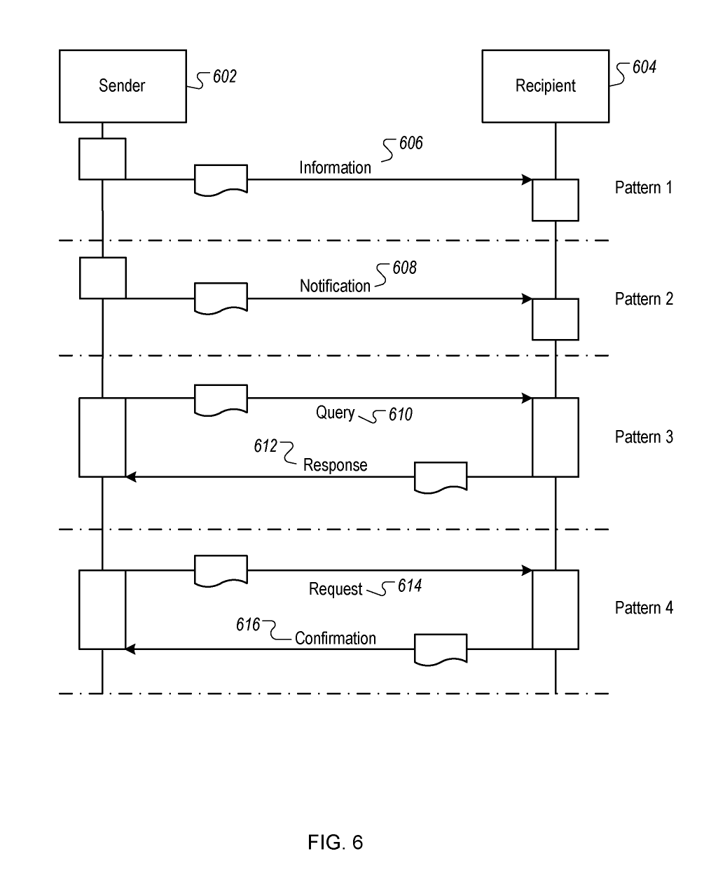

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model.” For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

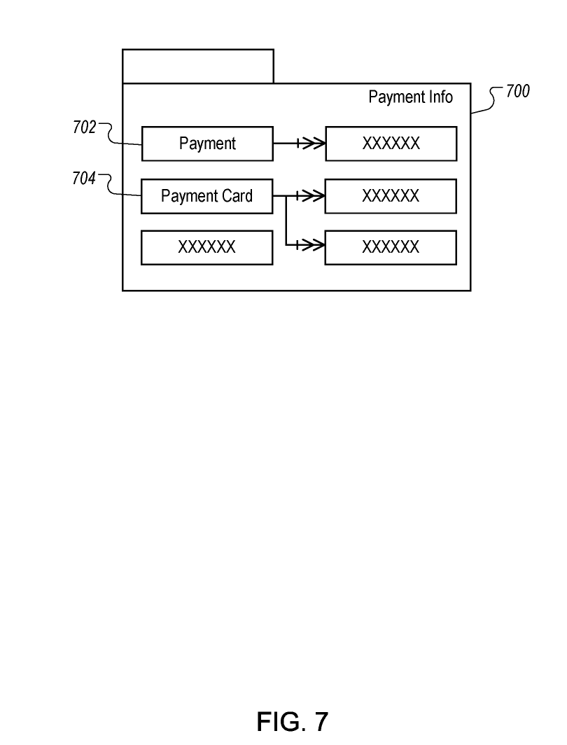

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

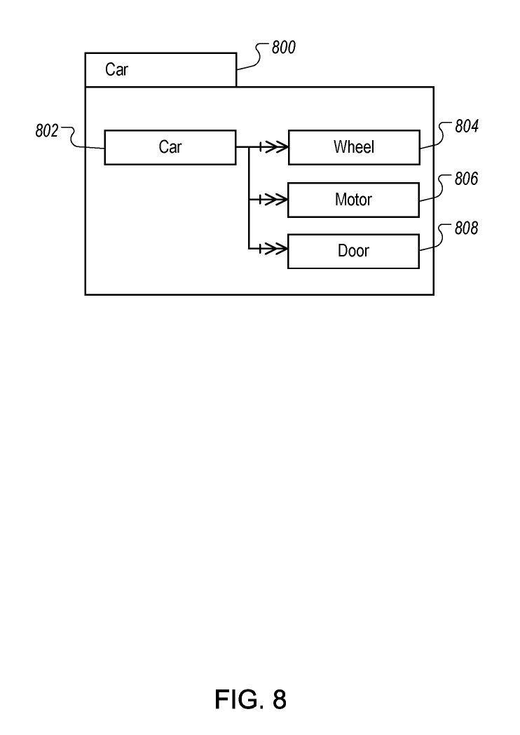

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

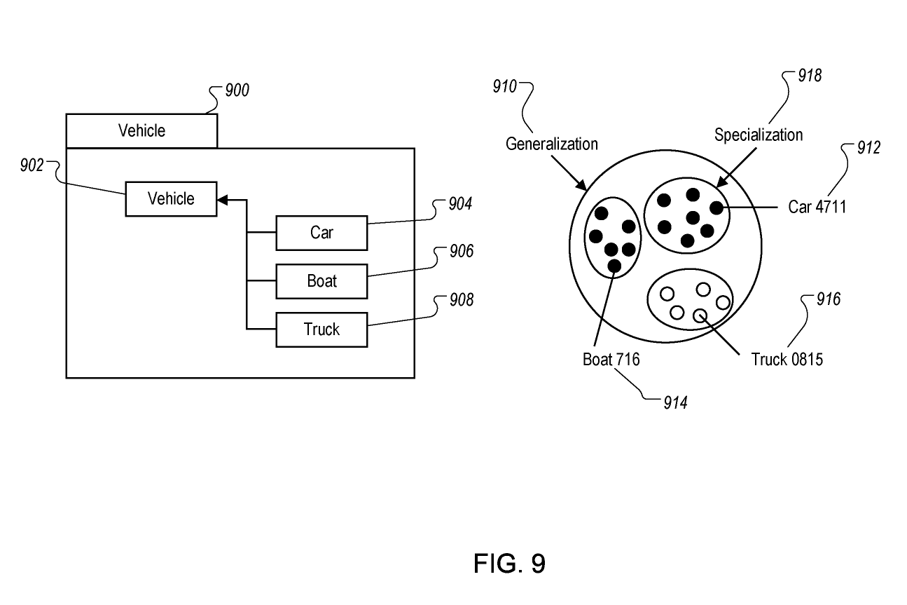

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

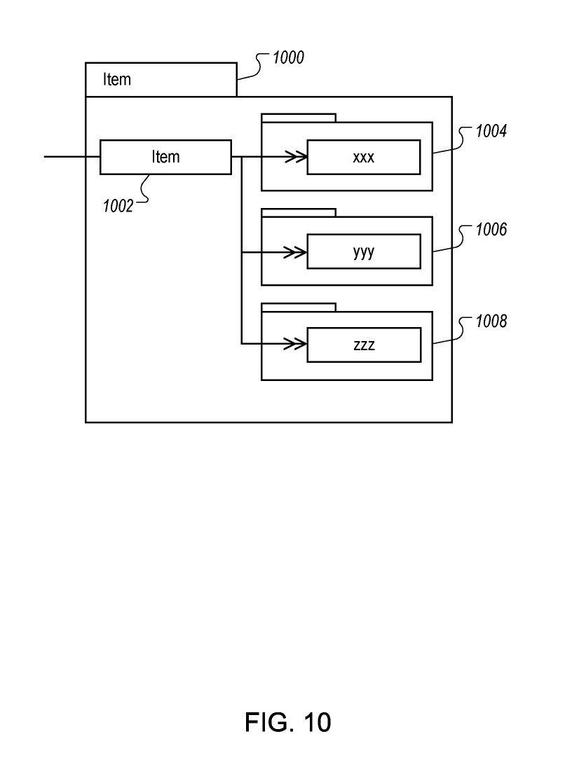

Packages also may be used to represent hierarchy levels. For example, as depicted in FIG. 10, the Item Package 1000 includes Item 1002 with subitem xxx 1004, subitem yyy 1006, and subitem zzz 1008.

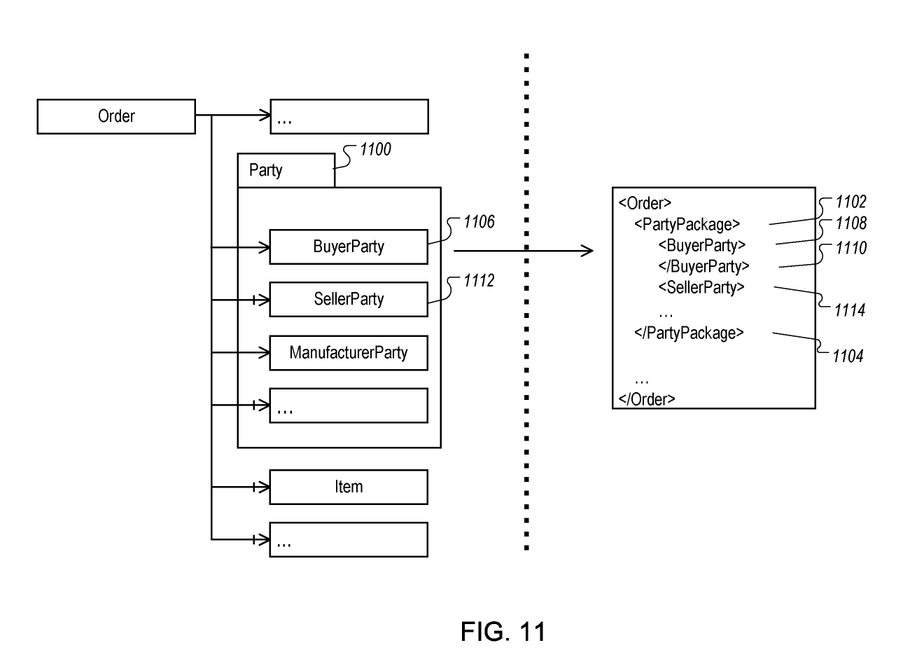

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

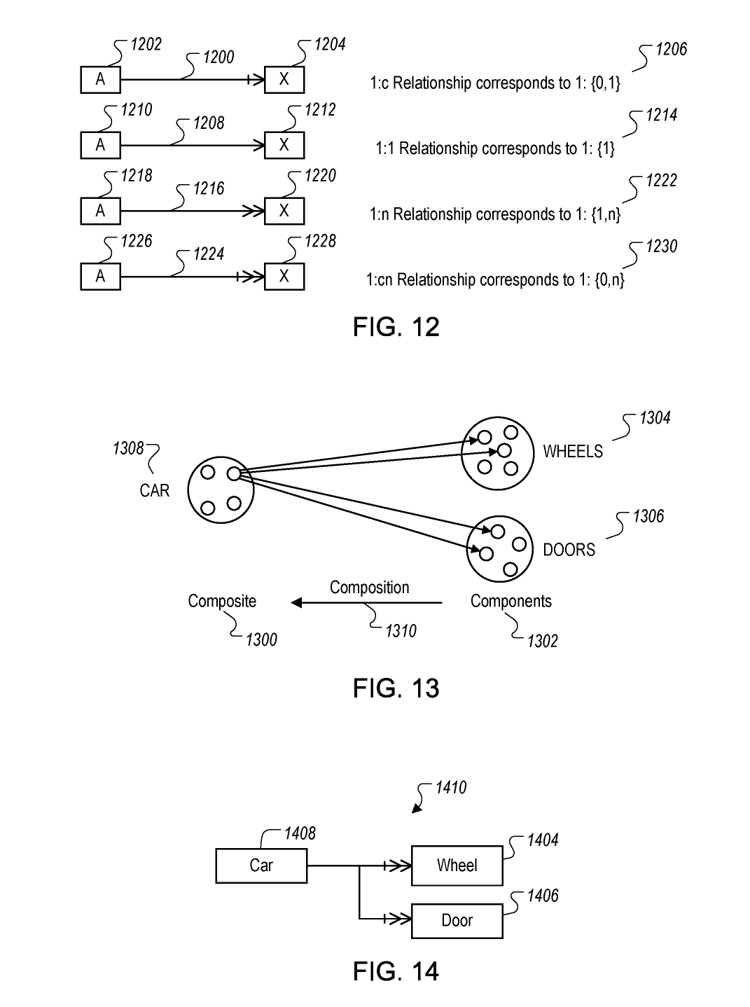

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

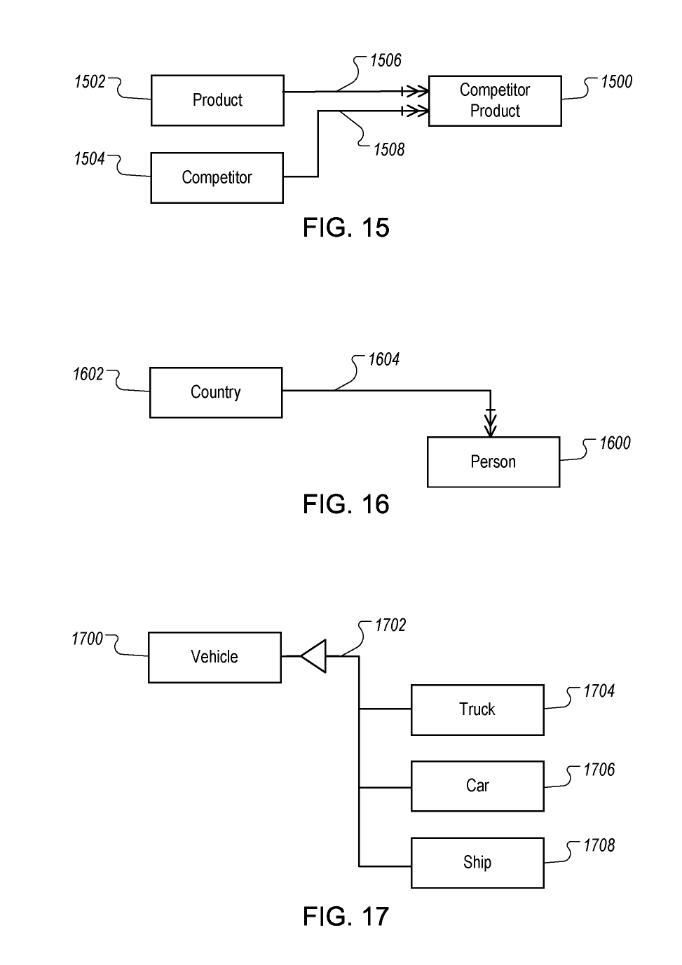

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

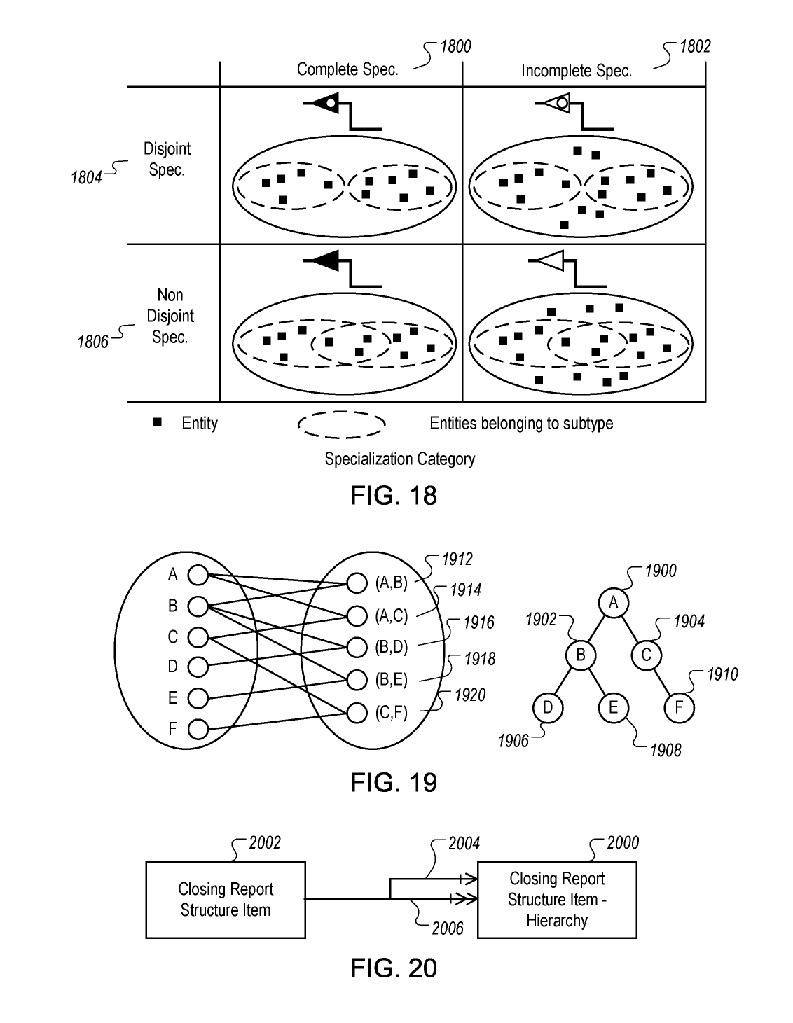

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

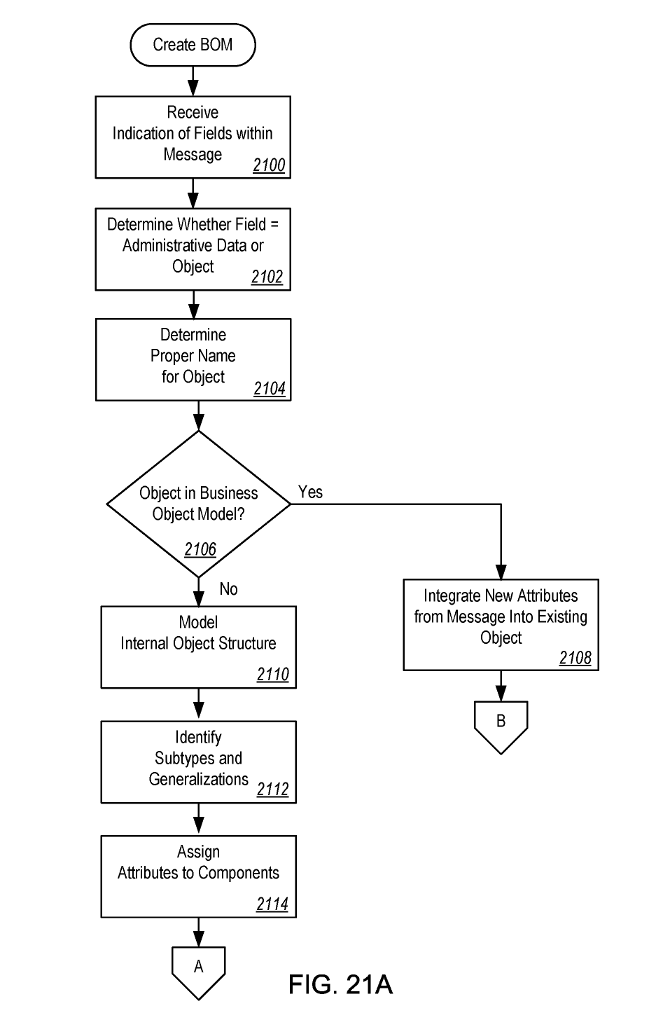

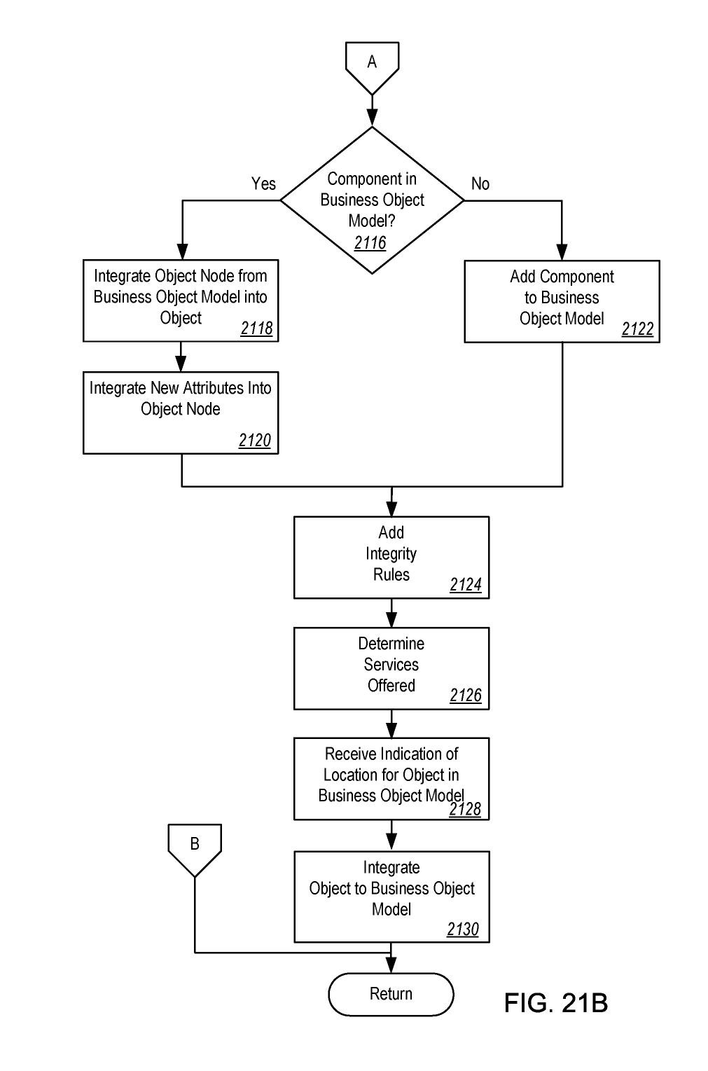

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order | |
| HierarchyType | | Item | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

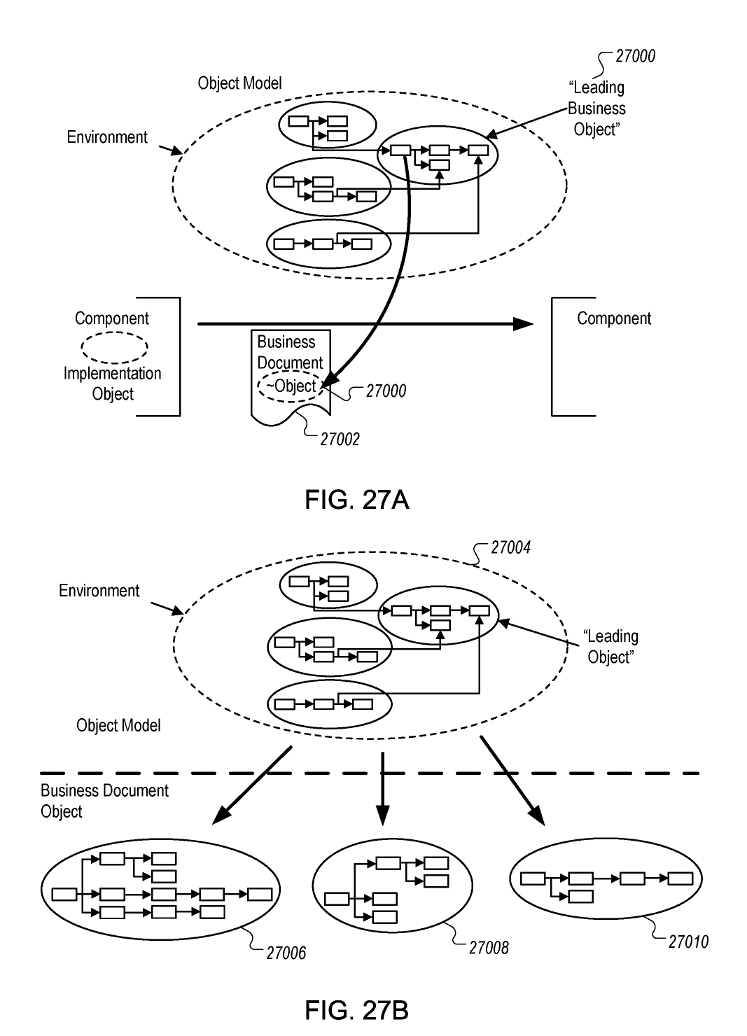

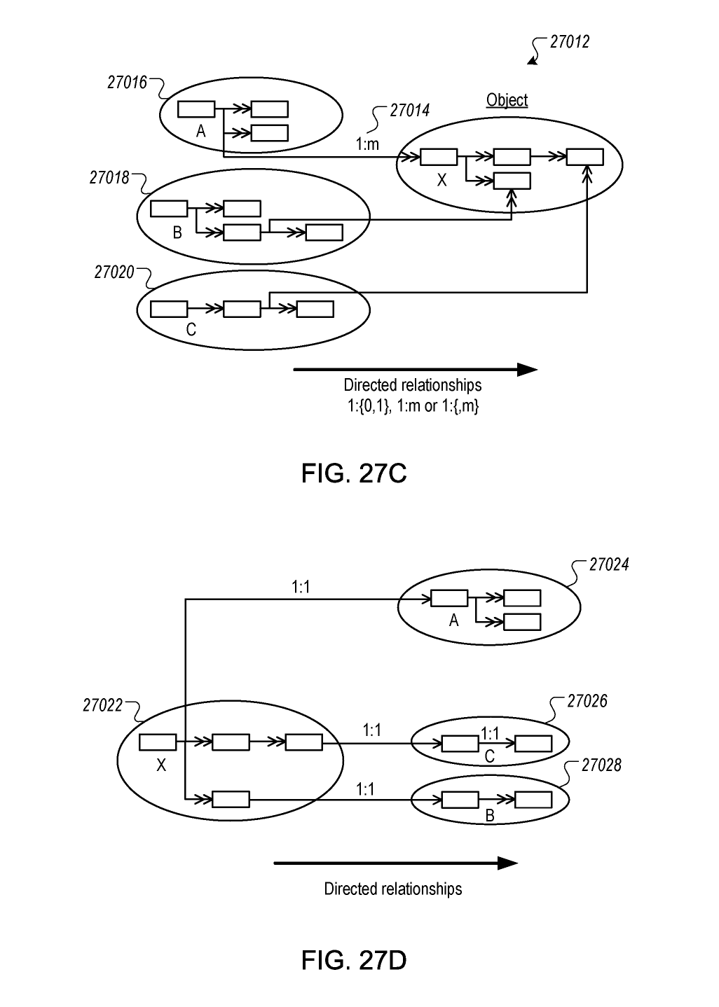

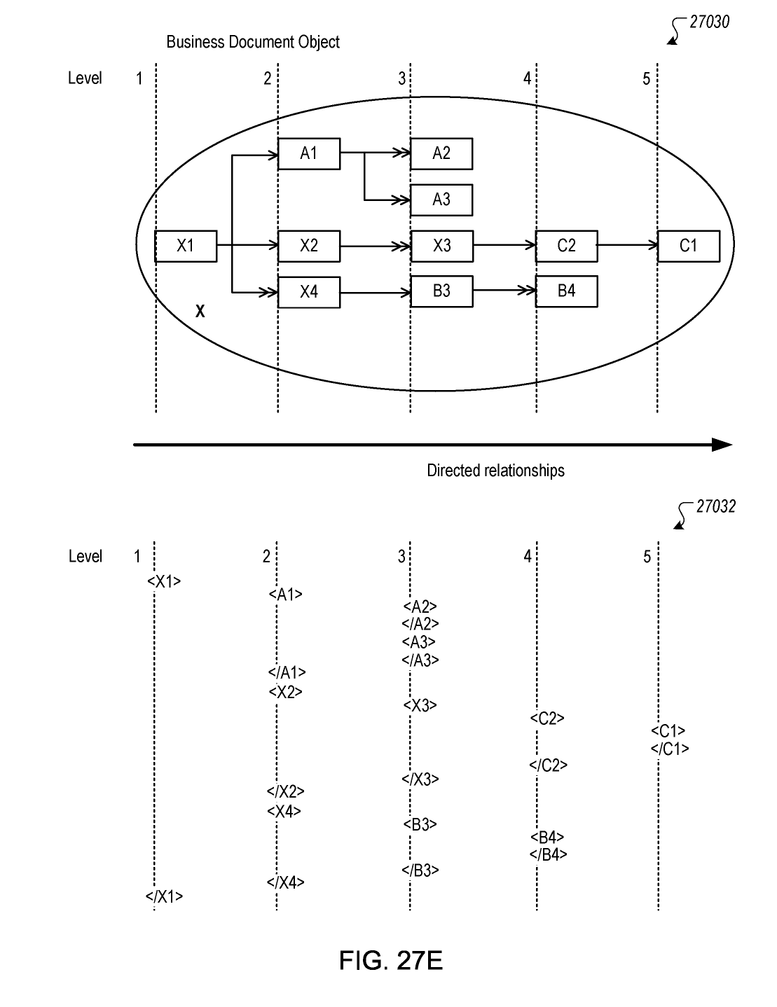

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message.” For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

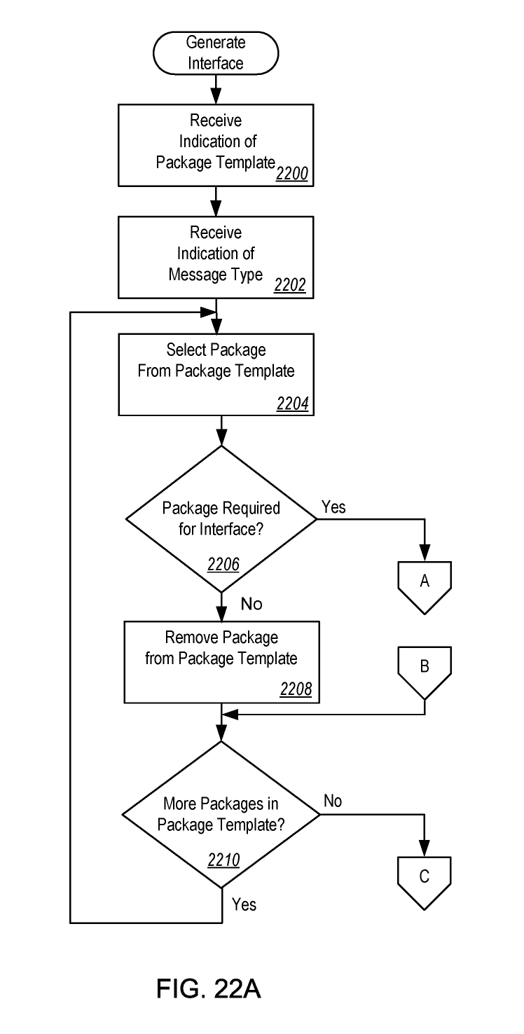

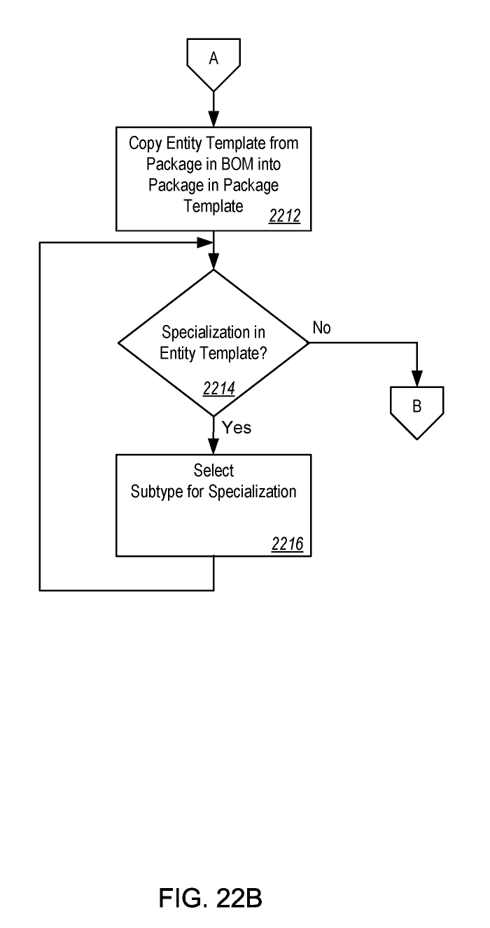

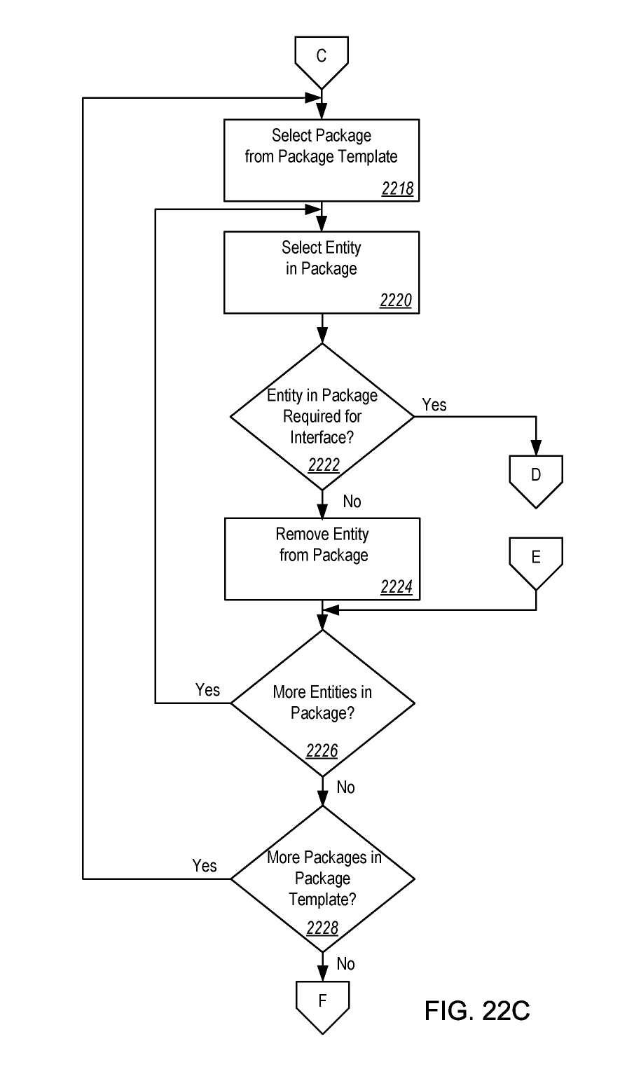

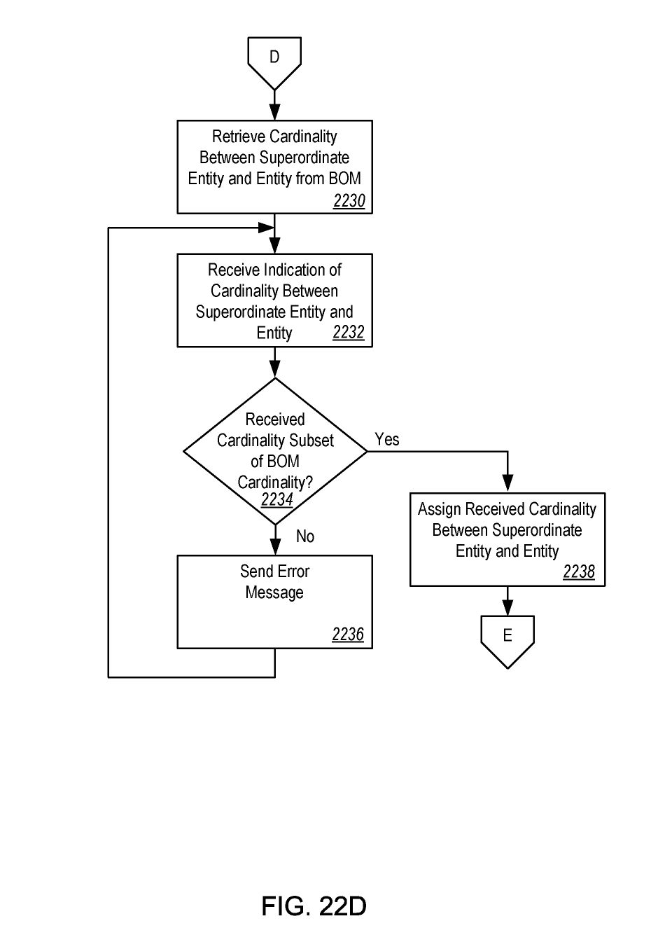

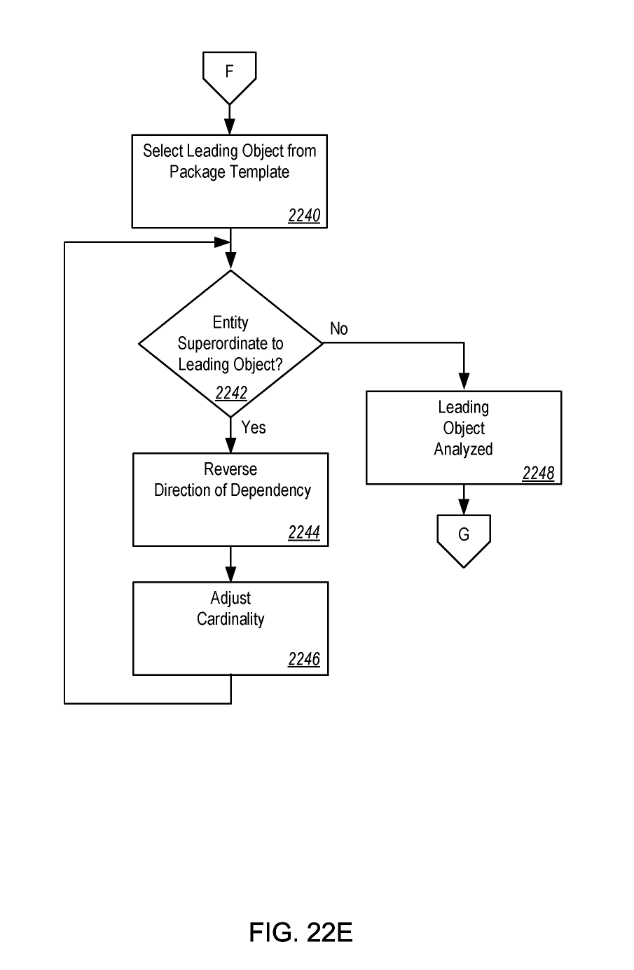

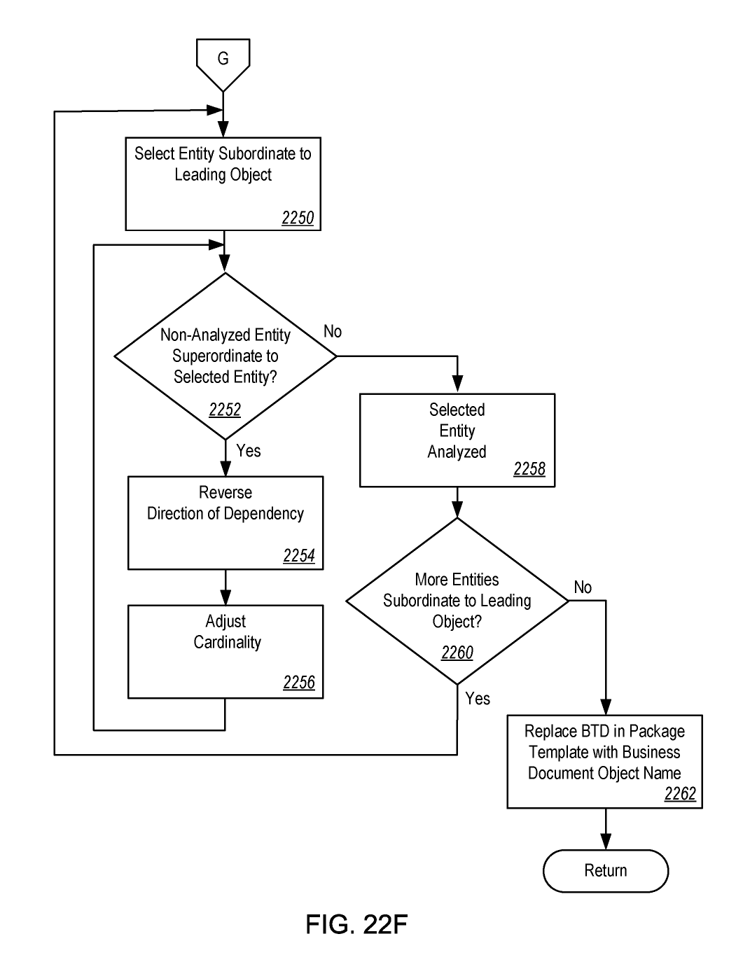

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

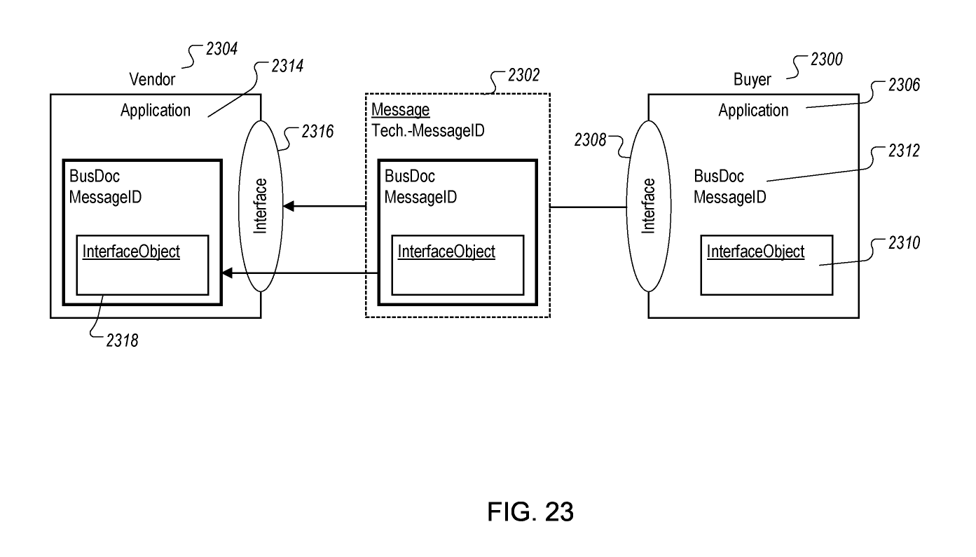

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

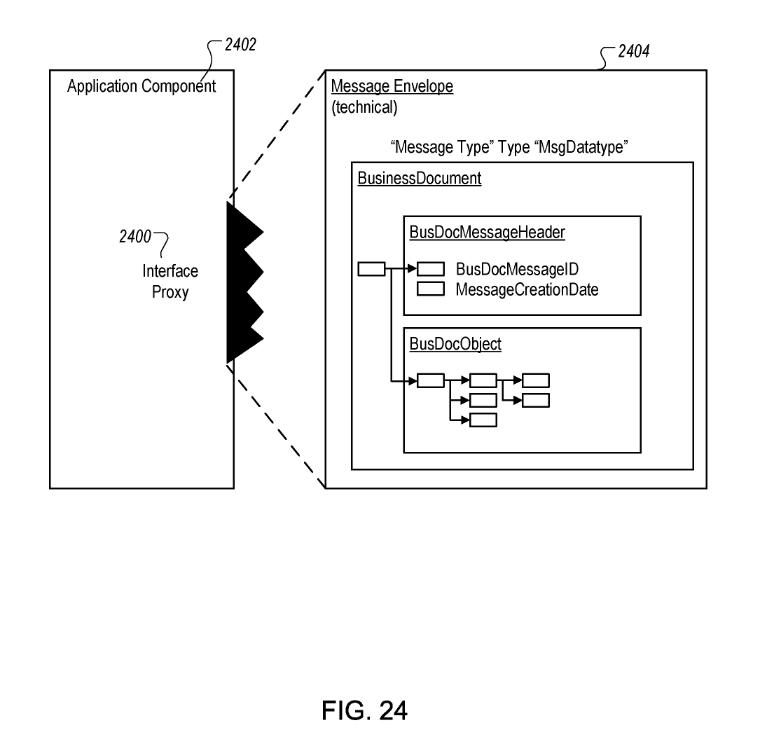

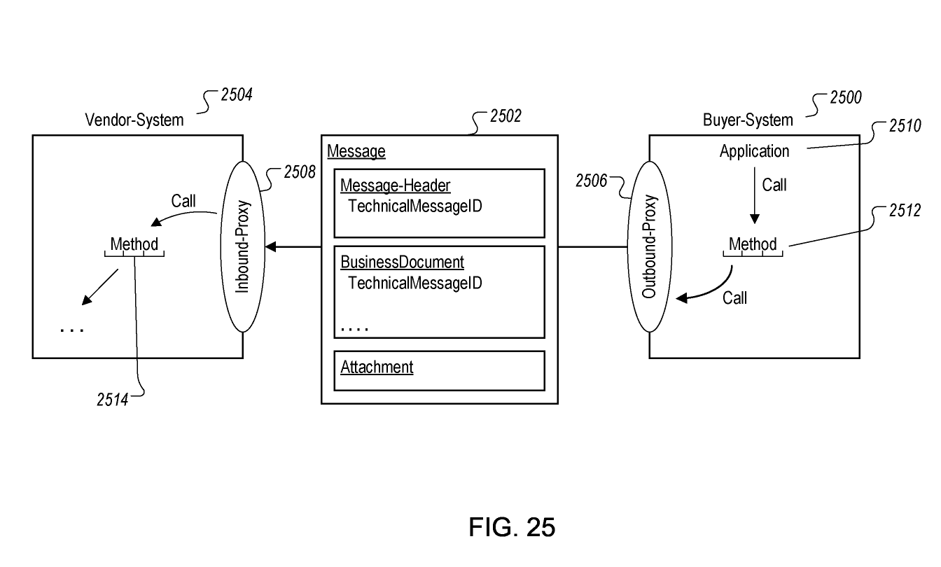

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

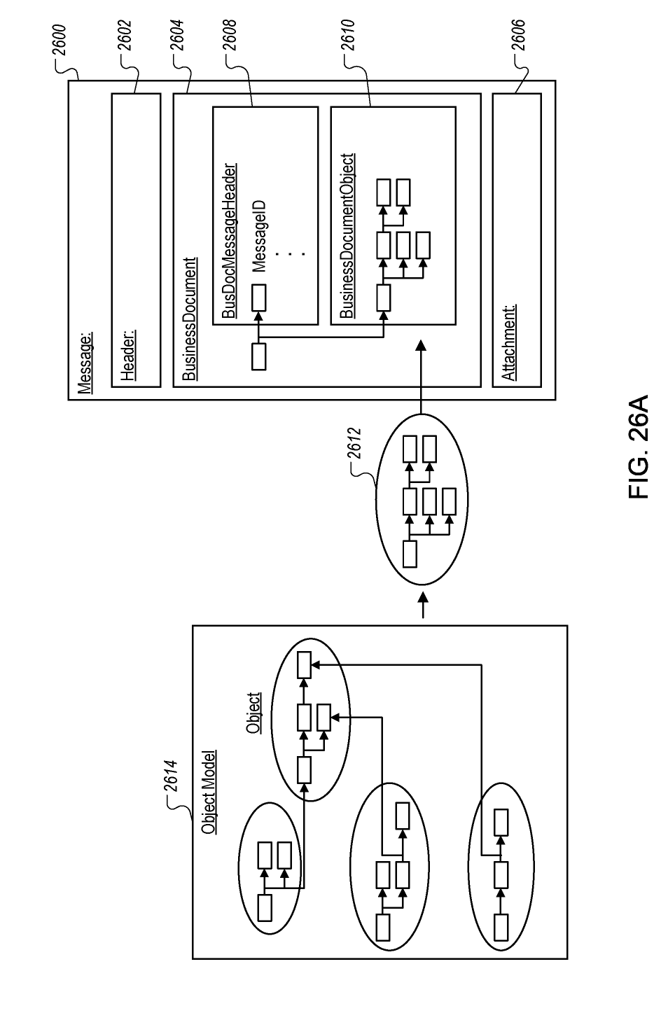

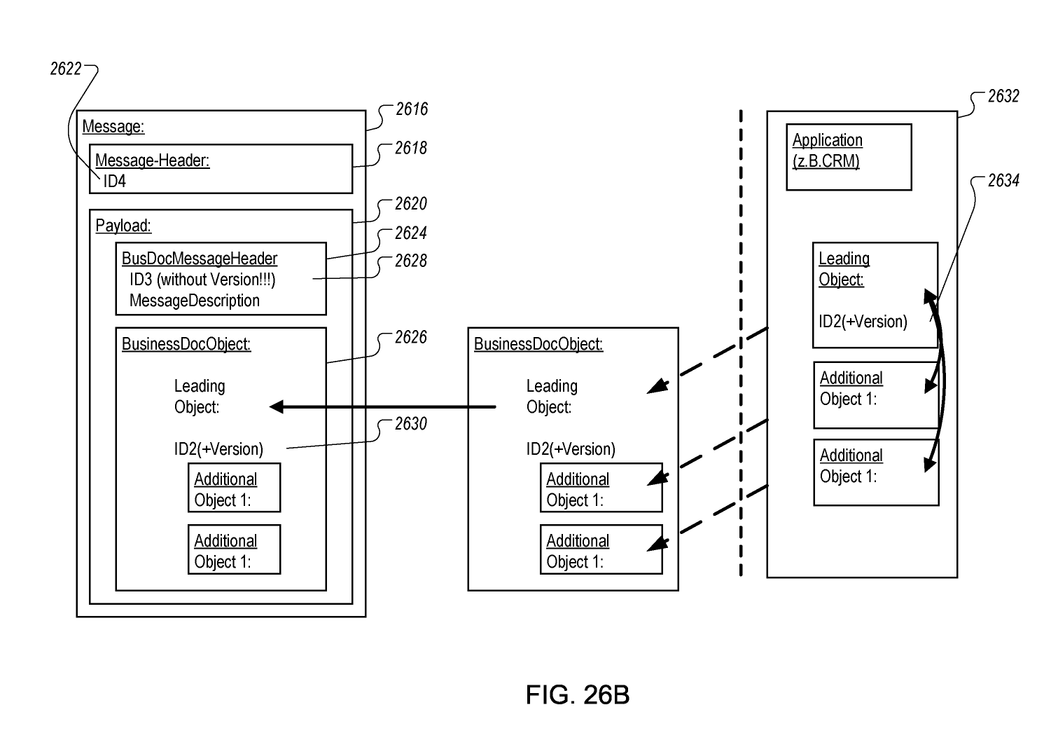

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

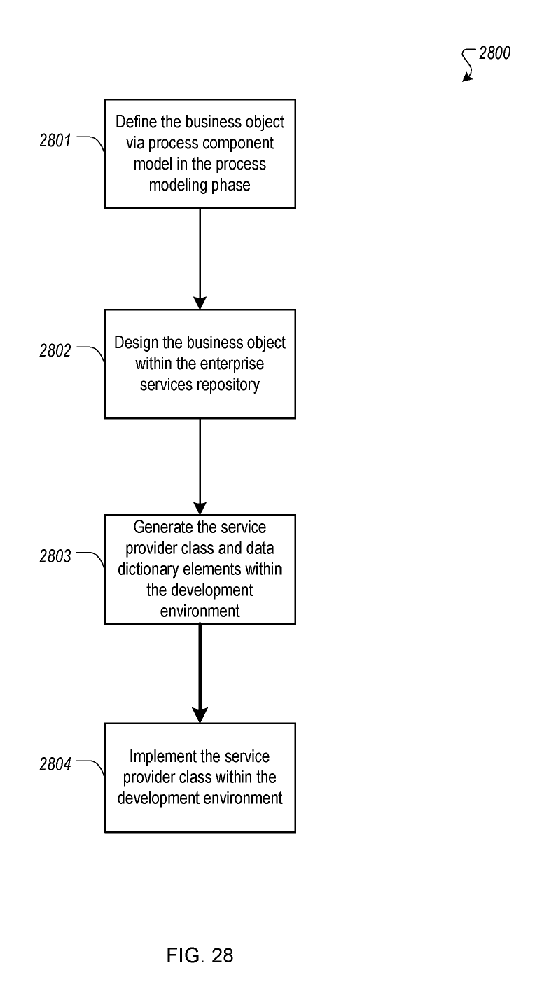

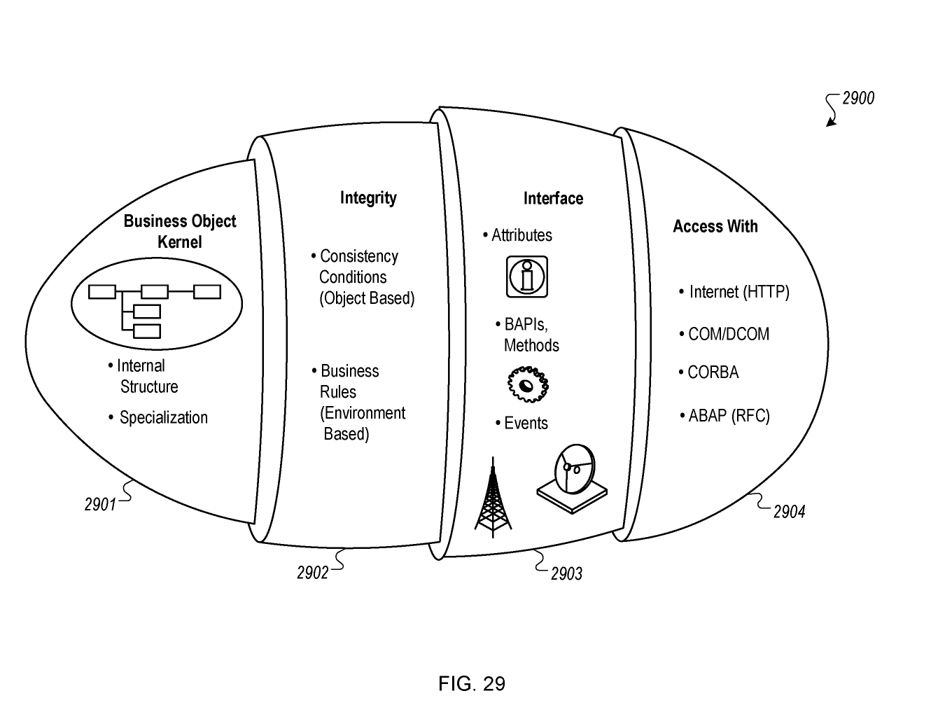

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

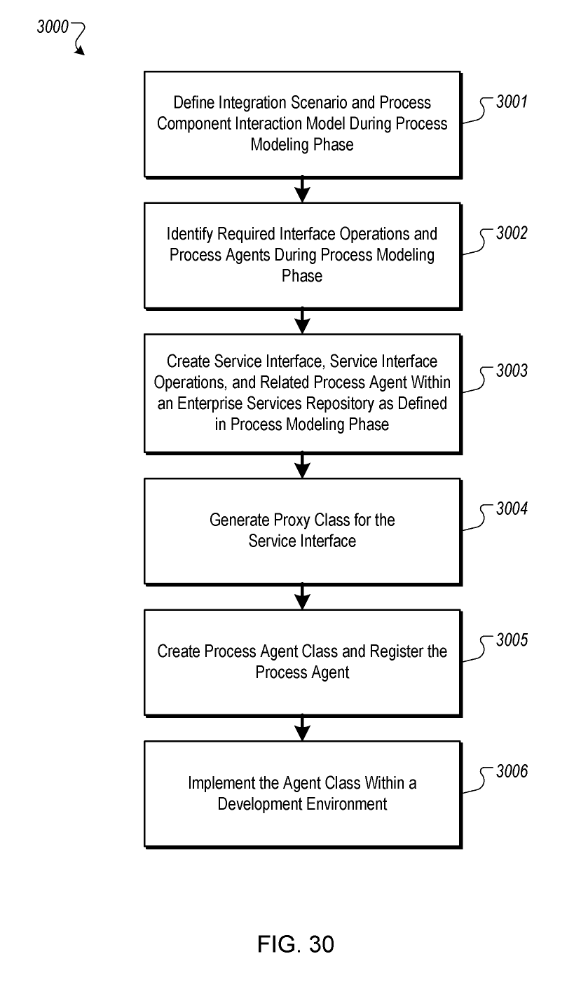

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

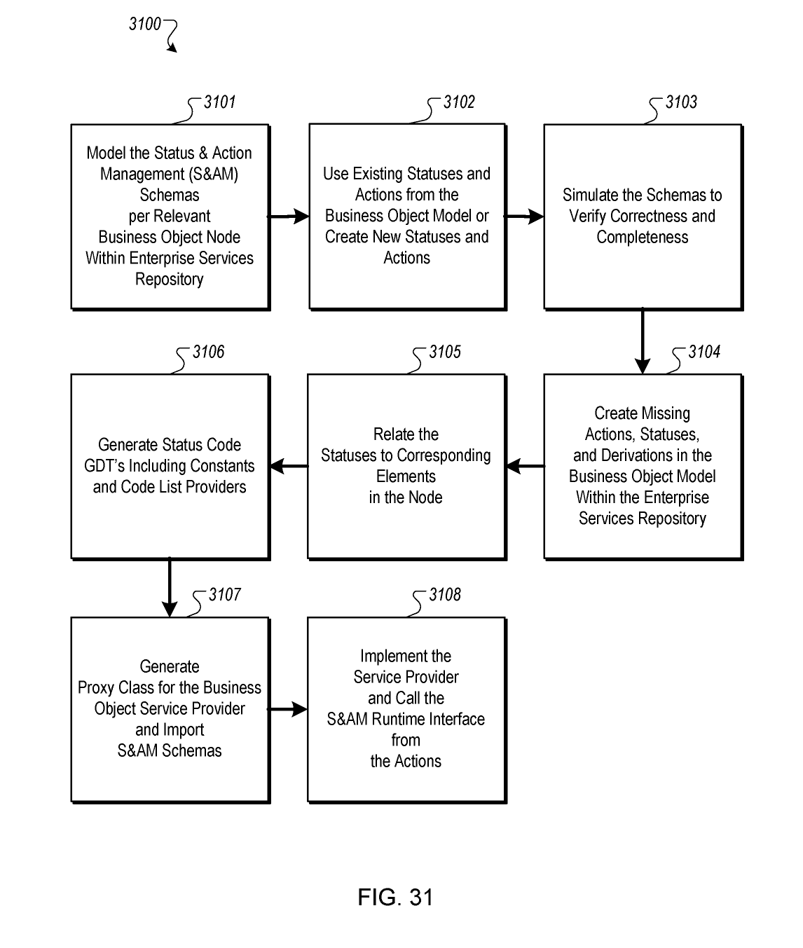

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

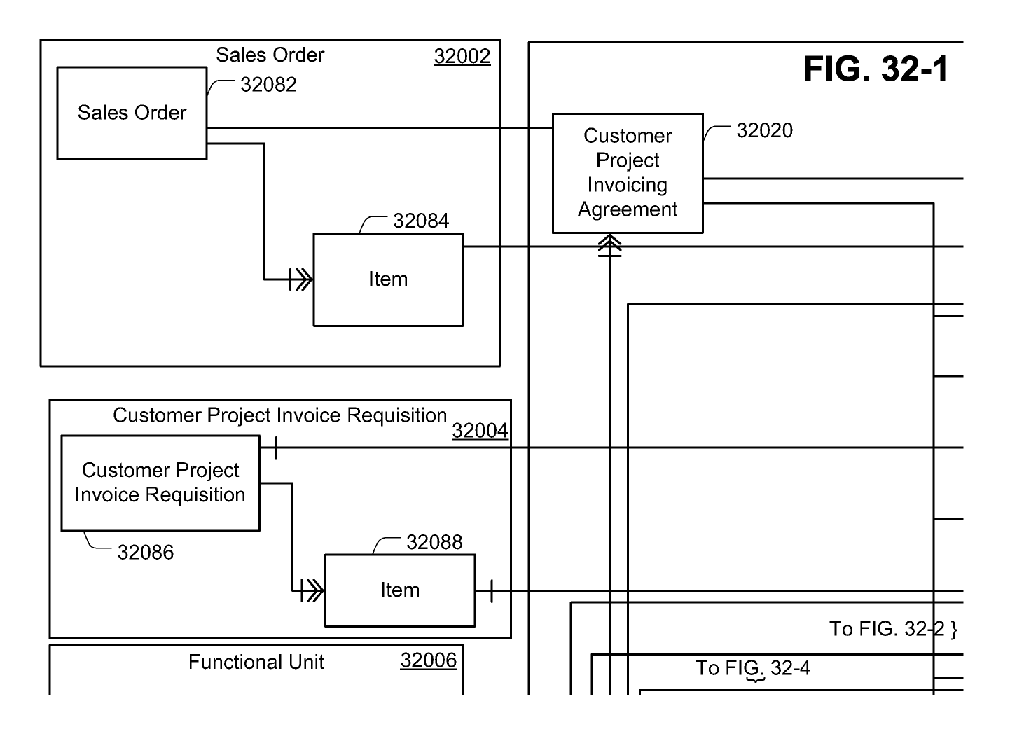

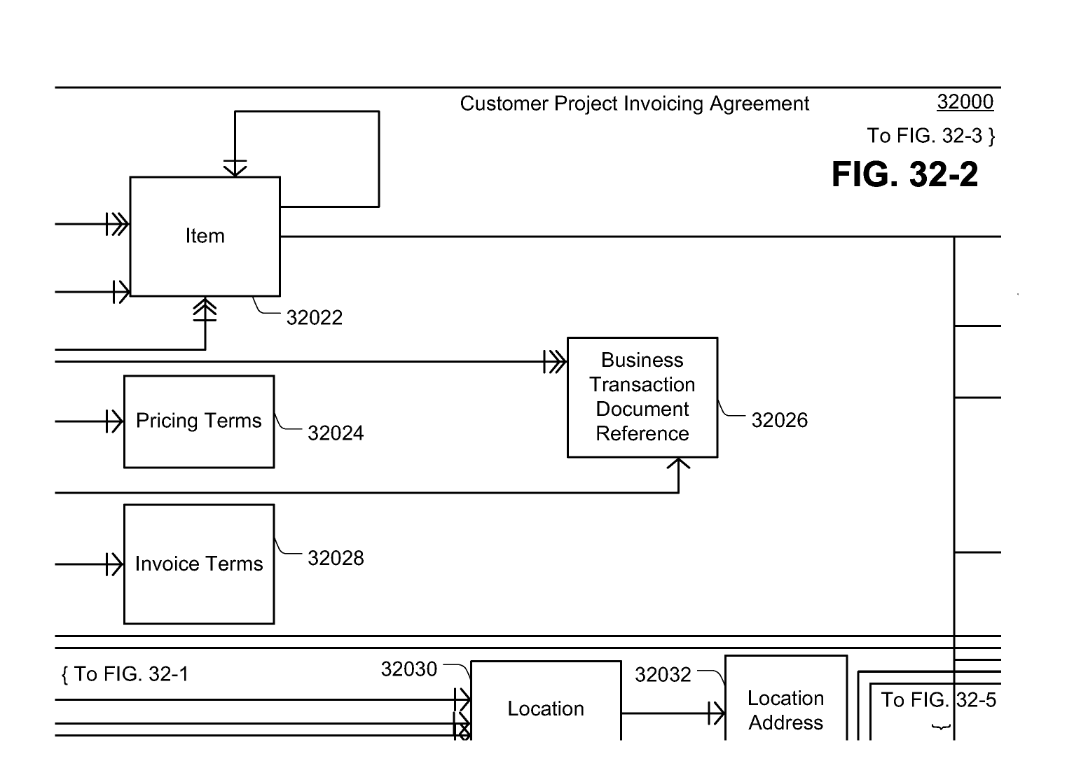

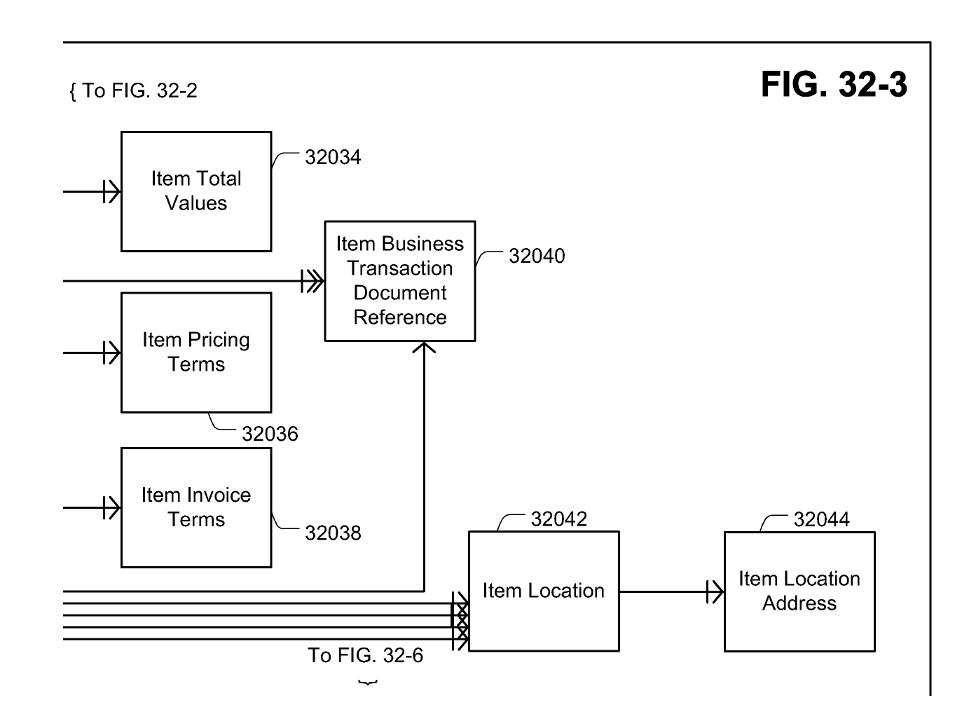

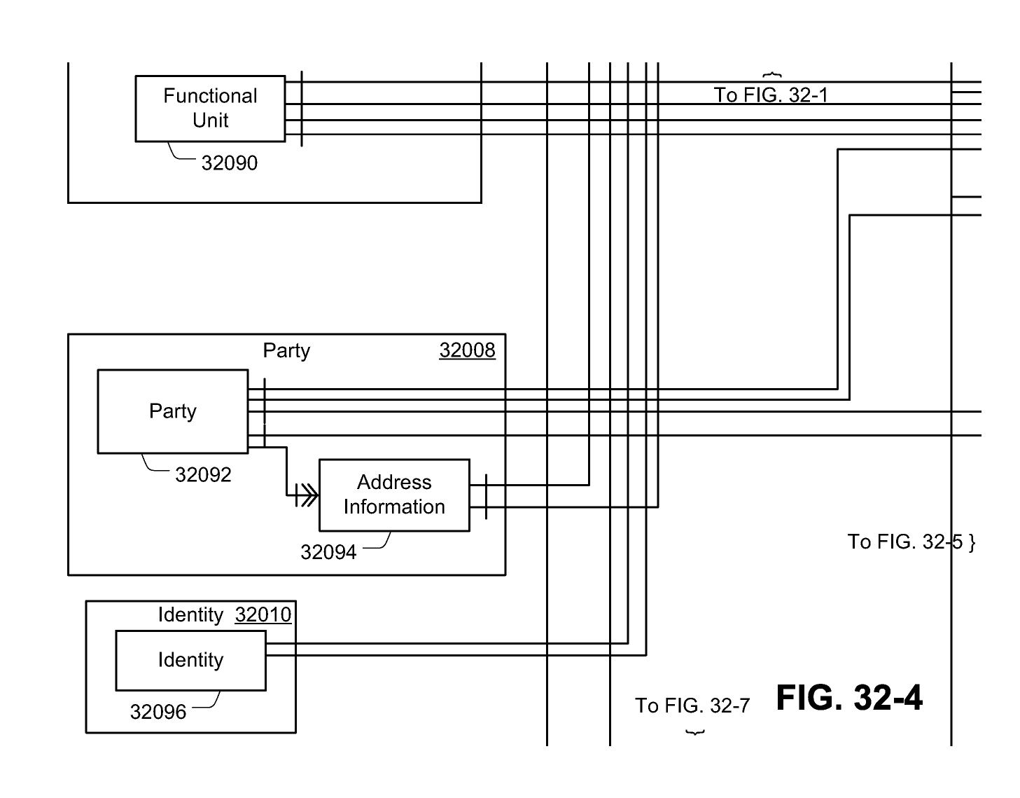

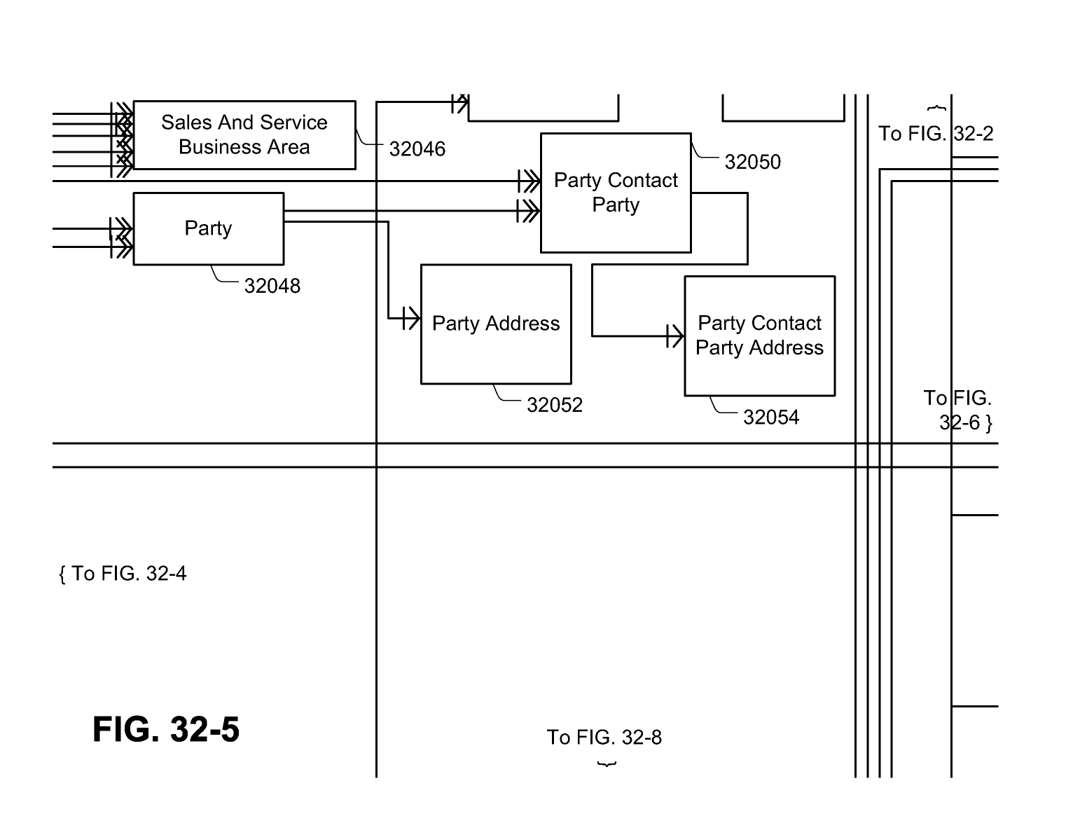

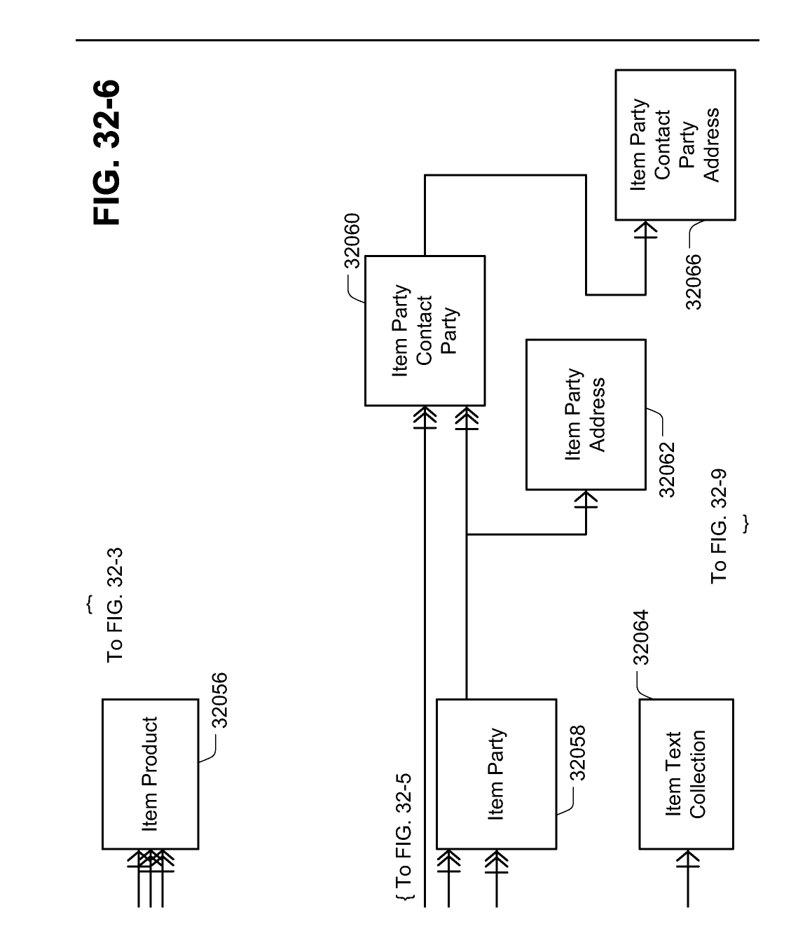

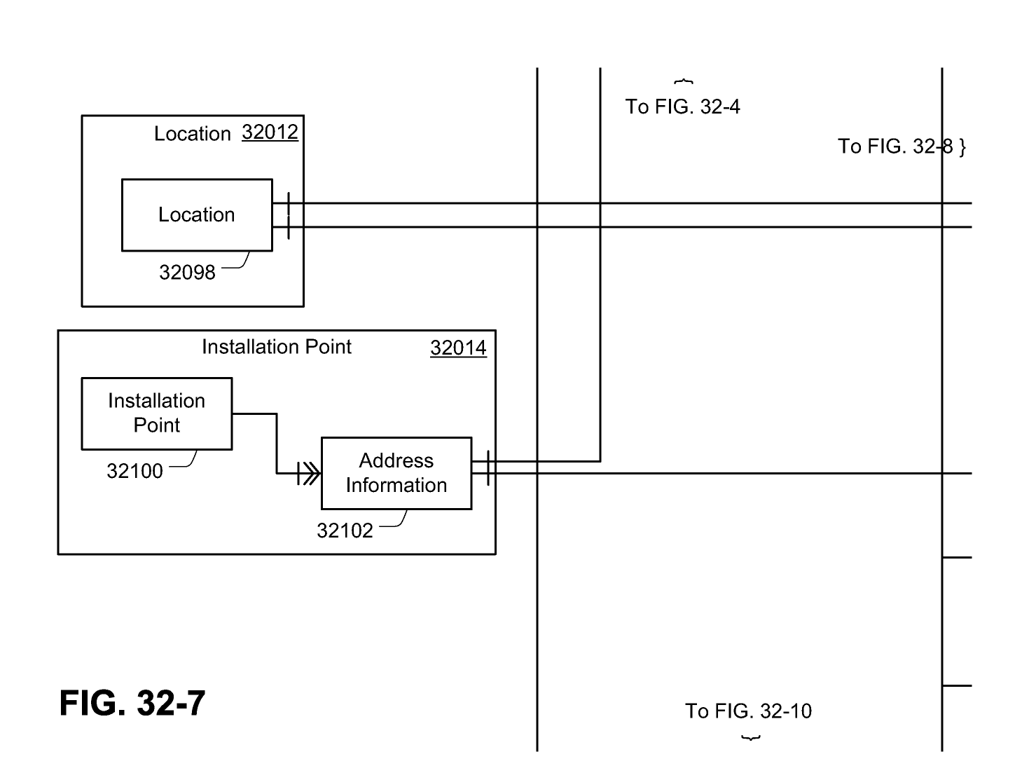

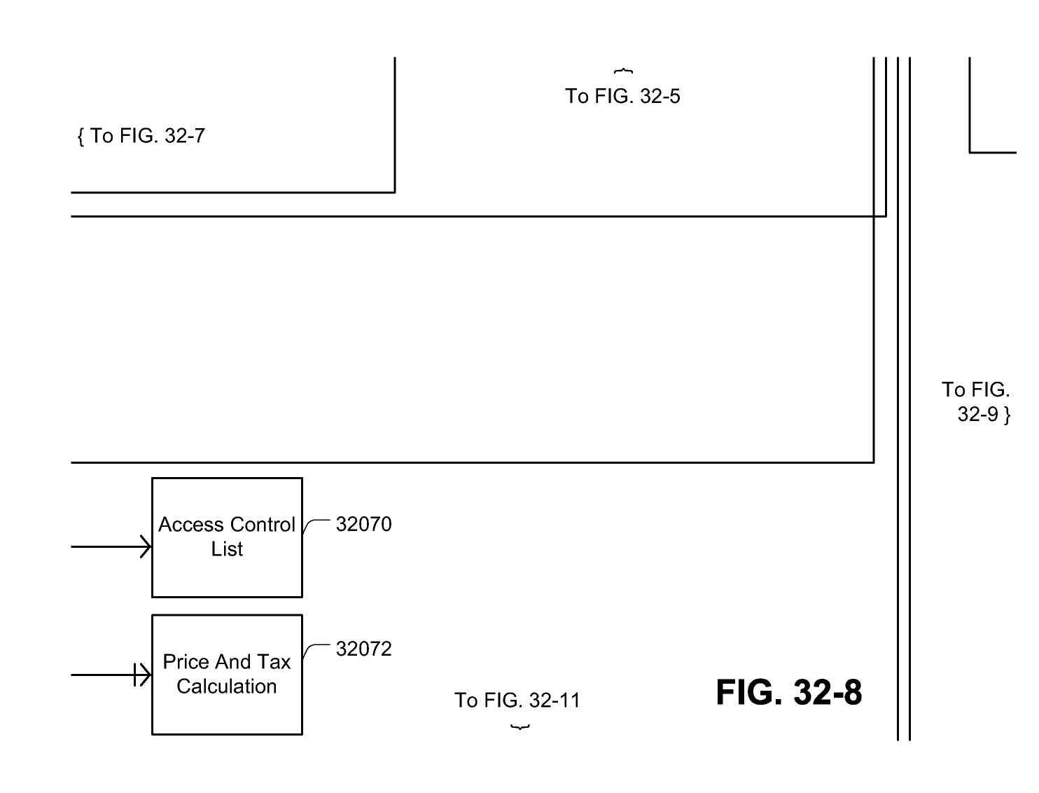

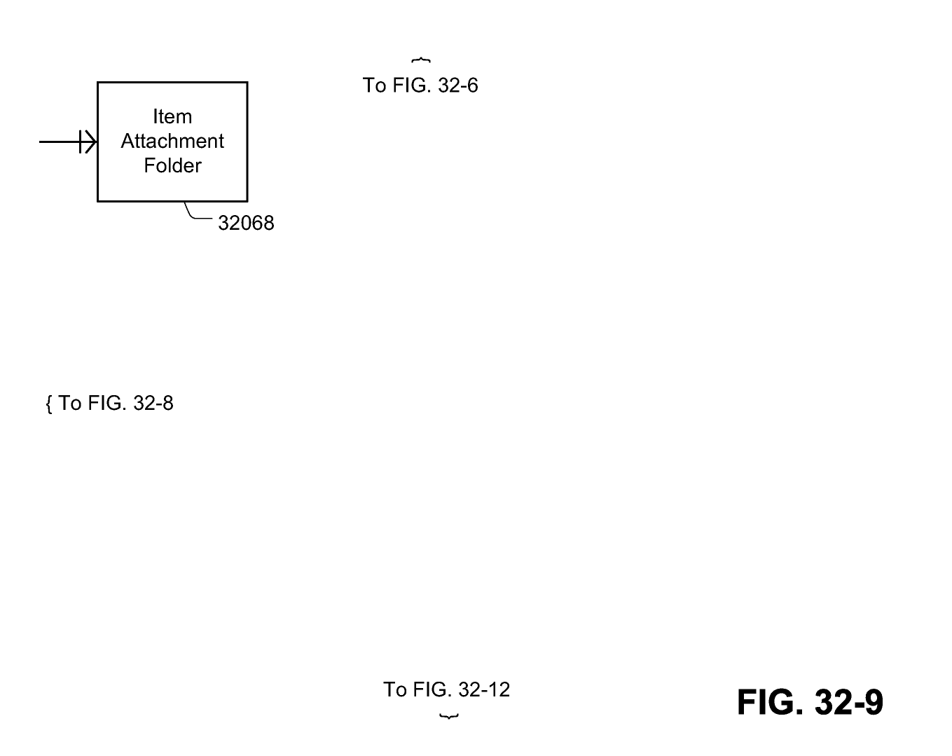

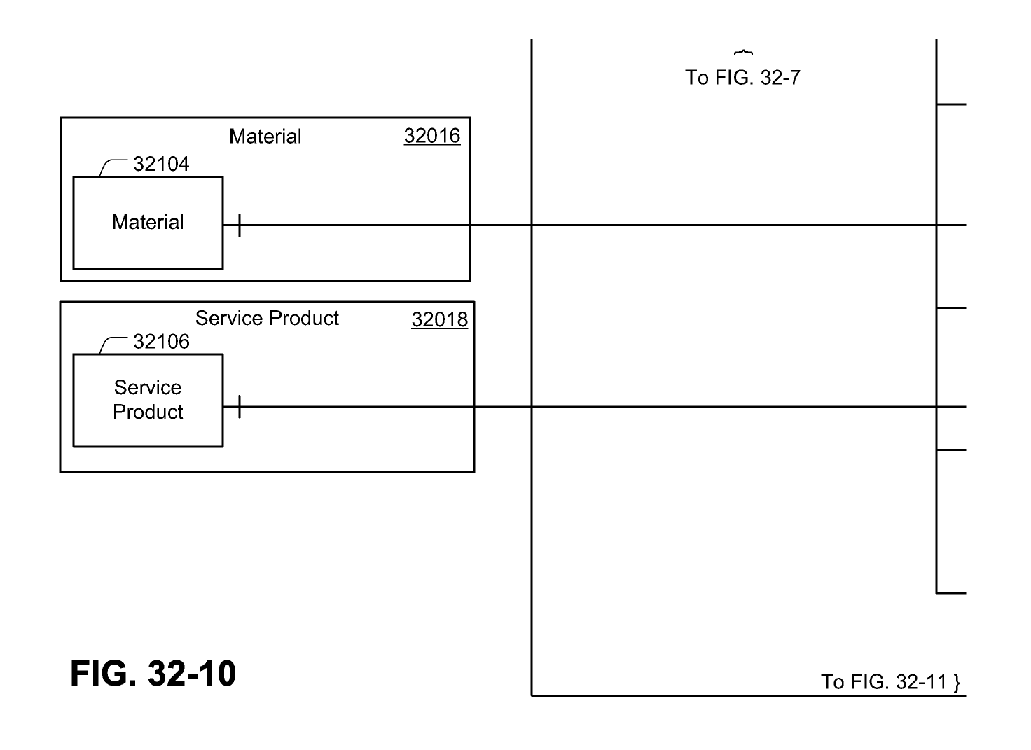

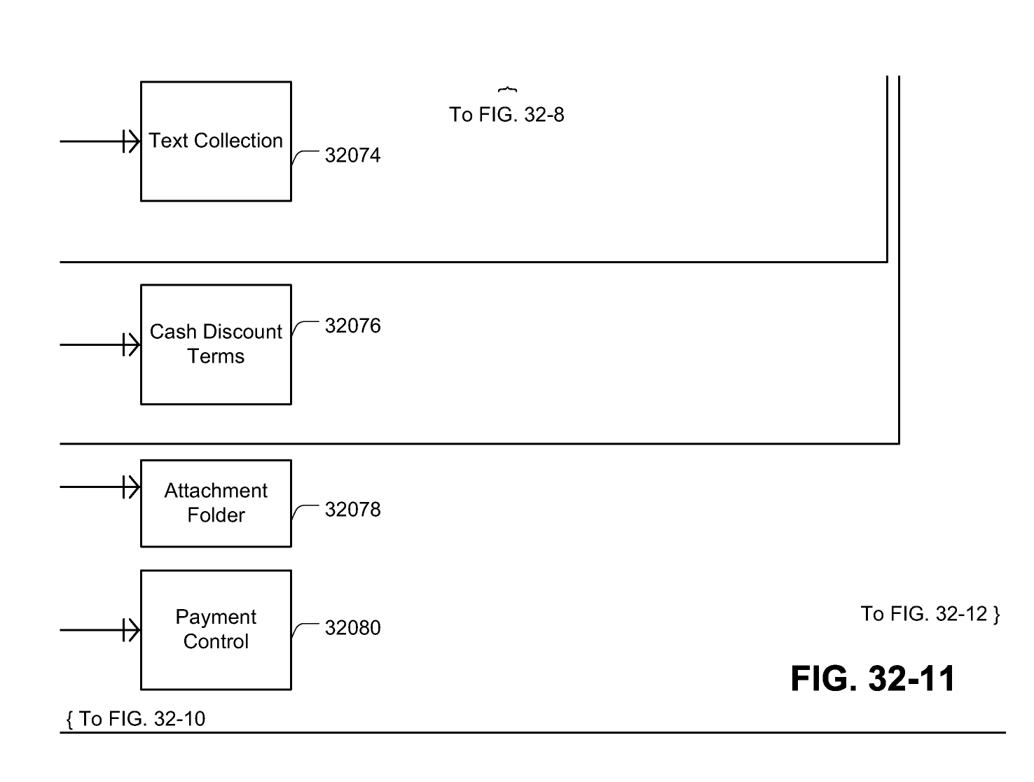

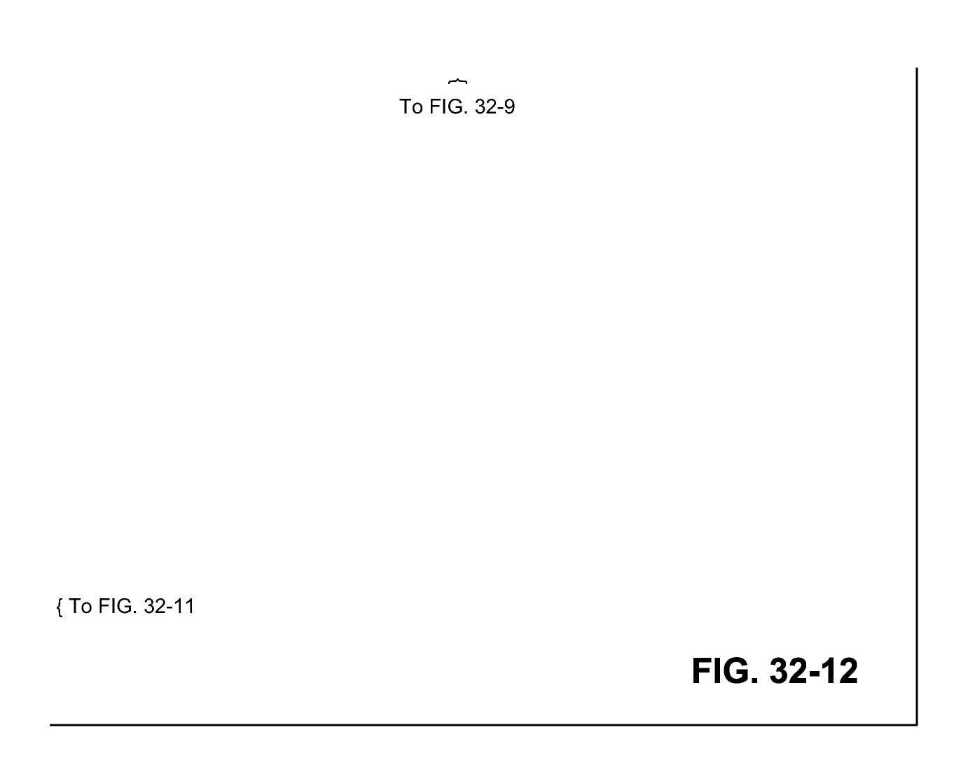

FIGS. 32-1 through 32-12 depict an example object model for a business object Customer Project Invoicing Agreement 32000. The business object 32000 has relationships with other objects 32002-32018, as shown with lines and arrows. The business object 32000 hierarchically comprises elements 32020-32080. The other objects 32002-32018 include respective elements 32082-32106 as shown.

The business object Customer Project Invoicing Agreement is an agreement between a seller and a customer that defines how expenses related to a customer project are to be invoiced for an agreed output. The business object Customer Project Invoicing Agreement belongs to the process component Customer Project Invoice Preparation. The business object Customer Project Invoicing Agreement (CPIA) refers to a sales order that is connected with a customer project. Such a sales order may include a main part of an agreement between two parties, whereas the CPIA may include a part that helps to determine how expenses for a connected customer project are invoiced. Direct access to data in business object Sales Order may be required to process data of business object Customer Project Invoice Requisition. A customer project invoicing agreement may include invoicing-related sales order data for creating a customer project invoice requisition. The structure of business object CustomerProjectInvoicingAgreement may include two main parts: Nodes directly under a Root node that replicates data of an associated SalesOrder Header, and a node Item and its sub-nodes that replicate data of an associated SalesOrder Item. Each instance of CustomerProjectInvoicingAgreement can contain one or more Item nodes directly under a Root node. The business object Customer Project Invoicing Agreement may be involved in a Sales Order Processing Customer Project Invoice Preparation Process Component Interaction Model.

Service Interface Request Customer Project Invoicing In, also referred to as CustomerProjectInvoicePreparationRequestCustomerProjectInvoicingIn, is an interface to maintain a customer project invoicing agreement. A Service Interface Request Customer Project Invoicing In is part of a Sales Order Processing Customer Project Invoice Preparation Process Component Interaction Models.

Maintain Customer Project Invoicing Agreement, also referred to as CustomerProjectInvoicePreparationRequestCustomerProjectInvoicingIn.MaintainCustomerProjectInvoicingAgreement can create, update, or cancel a customer project invoicing agreement. The operation is based on message type Customer Project Invoicing Agreement Maintain Request, derived from business object Customer Project Invoicing Agreement.

Service Interface Request Customer Project Invoicing Out, also referred to as CustomerProjectInvoicePreparationRequestCustomerProjectInvoicingOut is an interface to confirm that an invoice for a customer project is issued. The Service Interface Request Customer Project Invoicing Out is part of a Sales Order Processing Customer Project Invoice Preparation Process Component Interaction Models.

Confirm Customer Project Invoicing, also referred to as CustomerProjectInvoicePreparationRequestCustomerProjectInvoicingOut.ConfirmCustomerProjectInvoicing can confirm to a sales order that a customer invoice is created. The operation is based on message type Customer Project Invoicing Agreement Maintain Confirmation, derived from business object Customer Project Invoicing Agreement.

Customer Project Invoicing Agreement can include invoicing-relevant data of an associated sales order header. Additionally, the customer project invoicing agreement can store proposals and rules for determining sales order items and external representation of expenses for a given combination of project task and internal representation of expenses. Customer Project Invoicing Agreement may be time dependent on Validity Period. Invoicing-related data of a sales order may include invoice terms, pricing terms, parties, and so on. An internal representation of expenses may be an expense as it was confirmed on a project task, and can be a service product or a material or a text description.

An external representation of expenses may be an expense as it will be invoiced to a customer, and can be a service product or a material or a text description. The elements located directly at the node Customer Project Invoicing Agreement are defined by the data type: CustomerProjectInvoicingAgreementElements, and may include UUID, BaseCustomerTransactionDocumentReference, BaseCustomerTransactionDocumentKey, ProjectReference, BaseCustomerTransactionDocumentDateTime, BaseCustomerTransactionDocumentName, BaseCustomerTransactionDocumentBuyerID, BaseCustomerTransactionDocumentBuyerDateTime, BaseCustomerTransactionDocumentBuyerName, LastCustomerProjectInvoiceRequisitionReleasedDateTime, LastCustomerProjectInvoiceRequisitionReleasedUUID, SystemAdministrativeData, and Status. UUID is a universally unique identifier for a customer project invoicing agreement. UUID may be an alternative key and may be based on datatype GDT: UUID. BaseCustomerTransactionDocumentReference is a reference to a customer transaction document on which a customer project invoicing agreement is based. BaseCustomerTransactionDocumentReference may be based on datatype GDT: BusinessTransactionDocumentReference. BaseCustomerTransactionDocumentKey is a grouping of elements that uniquely identifies a base customer transaction document. BaseCustomerTransactionDocumentKey may be an alternative key, may be based on datatype KDT: BusinessTransactionDocumentKey, and may include BusinessTransactionDocumentID and BusinessTransactionDocumentTypeCode. BusinessTransactionDocumentID is a unique identifier for a business transaction document and may be based on datatype GDT: BusinessTransactionDocumentID. BusinessTransactionDocumentTypeCode is a coded representation of a document type that occurs in business transactions. Document type describes the business nature of similar documents and defines the basic features of documents. BusinessTransactionDocumentTypeCode may be based on datatype GDT: BusinessTransactionDocumentTypeCode. ProjectReference is a reference to a project associated with a customer project invoicing agreement. ProjectReference may be optional and may be based on datatype GDT: ProjectReference. BaseCustomerTransactionDocumentDateTime is a point in time at which a base customer transaction document becomes effective in financial accounting and period balances of accounts change. BaseCustomerTransactionDocumentDateTime may be optional and may be based on datatype GDT: GLOBAL_DateTime, with a qualifier of Document. BaseCustomerTransactionDocumentName is a name of a base customer transaction document associated with a customer project invoicing agreement. BaseCustomerTransactionDocumentName may be optional and may be based on datatype GDT: EXTENDED_Name, with a qualifier of BusinessTransactionDocument. BaseCustomerTransactionDocumentBuyerID is a unique identifier for a base customer transaction document associated with a customer project invoicing agreement as assigned by a buyer. BaseCustomerTransactionDocumentBuyerID may be optional and may be based on datatype GDT: BusinessTransactionDocumentID. BaseCustomerTransactionDocumentBuyerDateTime is a posting time of a base customer transaction document associated with a customer project invoicing agreement as assigned by a buyer. BaseCustomerTransactionDocumentBuyerDateTime may be optional and may be based on datatype GDT: GLOBAL_DateTime, with a qualifier of Buyer. BaseCustomerTransactionDocumentBuyerName is a name of a base customer transaction document associated with a customer project invoicing agreement as assigned by a buyer. BaseCustomerTransactionDocumentBuyerName may be optional and may be based on datatype GDT: MEDIUM_Name, with a qualifier of CustomerTransactionDocumentParty. LastCustomerProjectInvoiceRequisitionReleasedDateTime is a date and time at which a last customer project invoice requisition was released for a customer project invoicing agreement. LastCustomerProjectInvoiceRequisitionReleasedDateTime may be optional and may be based on datatype GDT: GLOBAL_DateTime, with a qualifier of Released. LastCustomerProjectInvoiceRequisitionReleasedUUID is a universally unique identifier for a last customer project invoice requisition that was released for a customer project invoicing agreement. LastCustomerProjectInvoiceRequisitionReleasedUUID may be optional and may be based on datatype GDT: UUID. SystemAdministrativeData is administrative data stored in a system, and may be based on datatype GDT: SystemAdministrativeData. Status is a current state of a customer project invoicing agreement aggregated from its items. Status may be based on datatype BOIDT: CustomerProjectInvoicingAgreementStatusElements, and may include ItemListFulfillmentProcessingStatusCode and ItemListInvoiceProcessingStatusCode. ItemListFulfillmentProcessingStatusCode is a status variable that shows a fulfillment status of a customer project invoicing agreement. The status may be aggregated from a fulfillment processing status at item level. ItemListFulfillmentProcessingStatusCode may be based on datatype GDT: NOTSTARTEDINPROCESSFINISHED_ProcessingStatusCode, with a qualifier of Fulfillment. ItemListInvoiceProcessingStatusCode is a status variable that shows an invoice processing status of a customer project invoicing agreement. The status may be aggregated from an invoice processing status at item level. ItemListInvoiceProcessingStatusCode may be based on datatype GDT: NOTSTARTEDINPROCESSFINISHED_ProcessingStatusCode, with a qualifier of Invoice.

The following composition relationships to subordinate nodes may exist: Item, with a cardinality of 1:CN; BusinessTransactionDocumentReference, with a cardinality of 1:CN; PricingTerms, with a cardinality of 1:C; InvoiceTerms, with a cardinality of 1:C; Location, with a cardinality of 1:C; SalesAndServiceBusinessArea, with a cardinality of 1:C; Party, with a cardinality of 1:CN; AccessControlList, with a cardinality of 1:1; PriceAndTaxCalculation, with a cardinality of 1:C; TextCollection, with a cardinality of 1:C; CashDiscountTerms, with a cardinality of 1:C; AttachmentFolder, with a cardinality of 1:C; and PaymentControl, with a cardinality of 1:C.

From the business object Sales Order/node Sales Order, a SalesOrderReference inbound aggregation relationship may exist, with a cardinality of 1:C. SalesOrderReference may be associated with a reference to a sales order for which a customer project invoicing agreement was created.

From the business object Identity/node Identity, a LastChangeIdentity and a CreationIdentity inbound association relationship may exist. LastChangeIdentity has a cardinality of 1:CN, and may be associated with an identity of a user who last changed a customer project invoicing agreement. CreationIdentity has a cardinality of 1:CN, and may be associated with an identity of a user who created a customer project invoicing agreement.

To node Party, the following specialization associations for navigation may exist: BillToParty, PayerParty, BuyerParty, SellerParty, ProductRecipientParty, VendorParty, SalesUnitParty, EmployeeResponsibleParty, InvoiceRequestResponsibleParty, and InvoiceRequestApproverParty. BillToParty has a target cardinality of C and may represent an association to a party that occurs in a specialization BillToParty. PayerParty has a target cardinality of C and may represent an association to a party that occurs in a specialization PayerParty. BuyerParty has a target cardinality of C and may represent an association to a party that occurs in a specialization BuyerParty. SellerParty has a target cardinality of C and may represent an association to a party that occurs in a specialization SellerParty. ProductRecipientParty has a target cardinality of C and may represent an association to a party that occurs in a specialization ProductRecipientParty. VendorParty has a target cardinality of C and may represent an association to a party that occurs in a specialization VendorParty. SalesUnitParty has a target cardinality of C and may represent an association to a party that occurs in a specialization SalesUnitParty. EmployeeResponsibleParty has a target cardinality of C and may represent an association to a party that occurs in a specialization EmployeeResponsibleParty. InvoiceRequestResponsibleParty has a target cardinality of C and may represent an association to a party that occurs in a specialization InvoiceRequestResponsibleParty. InvoiceRequestApproverParty has a target cardinality of C and may represent an association to a party that occurs in a specialization InvoiceRequestApproverParty. To node Location, a ServicePointLocation specialization association for navigation may exist. ServicePointLocation has a target cardinality of C and may represent an association to a location that occurs in a specialization ServicePointLocation.

Enterprise Service Infrastructure Actions may include Adjust Responsible Agent And Access Control List. Adjust Responsible Agent And Access Control List can Adjust responsible agents and corresponding entries in an access control list based on current responsibility settings.

Queries may include Query By Elements and Select All. A Query By Elements query returns a list of all customer project invoicing agreements including the specified selection criteria. The selection criteria may be specified by a logical ‘AND’ combination of query elements. The query elements are defined by the data type CustomerProjectInvoicingAgreementElementsQueryElements. These elements include: BaseCustomerTransactionDocumentID, ProjectReference, BaseCustomerTransactionDocumentName, BaseCustomerTransactionDocumentBuyerID, BuyerPartyKey, PartyTypeCode, PartyID, ProductKey, ProductTypeCode, ProductidentifierTypeCode, ProductID, BaseCustomerTransactionDocumentDateTime, ResponsibleEmployeePartyKey, PartyTypeCode, PartyID, ItemListFulfillmentProcessingStatusCode, ItemListInvoiceProcessingStatusCode, and SearchText. BaseCustomerTransactionDocumentID may be optional, is a unique identifier for a base customer transaction document, and may be based on datatype GDT: BusinessTransactionDocumentID. ProjectReference may be optional, is a reference to a project associated with a customer project invoicing agreement, and may be based on datatype GDT: ProjectReference. BaseCustomerTransactionDocumentName may be optional, is a name of a base customer transaction document associated with a customer project invoicing agreement, and may be based on datatypeGDT: EXTENDED_Name. BaseCustomerTransactionDocumentBuyerID may be optional, is a unique identifier for a base customer transaction document associated with a customer project invoicing agreement as assigned by a buyer, and may be based on datatype GDT: BusinessTransactionDocumentID. BuyerPartyKey may be optional, is a grouping of elements that uniquely identifies a buyer party associated with the customer project invoicing agreement, and may be based on datatype KDT: PartyKey, with a qualifier of Buyer. PartyTypeCode is a coded representation of a type of party, and may be based on datatype GDT: BusinessObjectTypeCode. PartyID is an identifier for a party, and may be based on datatype GDT: PartyID. ProductKey may be optional, is a grouping of elements that uniquely identifies a product associated with a customer project invoicing agreement, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. BaseCustomerTransactionDocumentDateTime may be optional, is a point in time at which a base customer transaction document becomes effective in financial accounting and at which the period balances of the concerned accounts change, and may be based on datatype GDT: GLOBAL_DateTime, with a qualifier of Document. ResponsibleEmployeePartyKey may be optional, is a grouping of elements that uniquely identifies a responsible employee party associated with a customer project invoicing agreement, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. ItemListFulfillmentProcessingStatusCode may be optional and is a status variable which shows a fulfillment status of a customer project invoicing agreement. This status is aggregated from a fulfillment processing status at item level. ItemListFulfillmentProcessingStatusCode may be based on datatype GDT: NOTSTARTEDINPROCESSFINISHED_ProcessingStatusCode, with a qualifier of Fulfillment. ItemListInvoiceProcessingStatusCode may be optional, and is a status variable which shows an invoice processing status of a customer project invoicing agreement. This status is aggregated from an invoice processing status at item level. ItemListInvoiceProcessingStatusCode may be based on datatype GDT: NOTSTARTEDINPROCESSFINISHED_ProcessingStatusCode, with a qualifier of Invoice. SearchText may be optional, is a limited character string to be searched, and may be based on datatype GDT: SearchText. For every query that includes the SearchText as a query parameter an application-specific subset of the other query parameters may be defined. The search terms may be assigned to the subset of query parameters in such a way that every search term is used exactly once in an assignment. Several search terms may be assigned to the same query parameter. For each of these assignments the query result is calculated. The total result is then the union of the results calculated per assignment. A Select All query provides the node IDs of all instances of this node, and may be used to enable an initial load of data for a Fast Search Infrastructure.

Item includes data used to invoice goods or services provided for an item of an associated sales order. The item includes, for example, information about products, parties involved, or pricing and invoicing terms specific to a customer. The elements located directly at the node Item are defined by the data type CustomerProjectInvoicingAgreementItemElements. These elements include: UUID, BaseCustomerTransactionDocumentItemReference, BaseCustomerTransactionDocumentItemKey, BusinessTransactionDocumentKey, BusinessTransactionDocumentID, BusinessTransactionDocumentTypeCode, BusinessTransactionDocumentItemID, ProjectReference, BaseCustomerTransactionDocumentItemCancellationReasonCode, BaseCustomerTransactionDocumentItemDateTime, BaseCustomerTransactionDocumentItemDescription, BaseCustomerTransactionDocumentItemBuyerID, BaseCustomerTransactionDocumentItemBuyerDateTime, BaseCustomerTransactionDocumentItemBuyerName, ProposedToBeInvoicedAmount, ProposedToBeInvoicedQuantity, ProposedToBeInvoicedQuantityTypeCode, AllocatedAmount, AllocatedQuantity, AllocatedQuantityTypeCode, ReleasedAmount, ReleasedQuantity, CustomerProjectInvoicingMethodCode, ReleasedQuantityTypeCode, NotToBeInvoicedAmount, NotToBeInvoicedQuantity, NotToBeInvoicedQuantityTypeCode, InvoicedAmount, InvoicedQuantity, InvoicedQuantityTypeCode, HierarchyRelationship, TypeCode, SystemAdministrativeData, Status, FulfillmentProcessingStatusCode, and InvoiceProcessingStatusCode. UUID is an alternative key, is a universally unique identifier of a customer project invoicing agreement item, and may be based on datatype GDT: UUID. BaseCustomerTransactionDocumentItemReference is a reference to a customer transaction document item on which a customer project invoicing agreement item is based, and may be based on datatype GDT: BusinessTransactionDocumentReference. BaseCustomerTransactionDocumentItemKey is an alternative key, is a grouping of elements that uniquely identifies a base customer transaction document item, and may be based on datatype KDT: BusinessTransactionDocumentItemKey. BusinessTransactionDocumentKey is a key of the BusinessTransactionDocument, and may be based on datatype KDT: BusinessTransactionDocumentKey. BusinessTransactionDocumentID is a unique identifier for a business transaction document, and may be based on datatype GDT: BusinessTransactionDocumentID. BusinessTransactionDocumentTypeCode is a coded representation of a document type that occurs in business transactions. The document type describes the business nature of similar documents and defines the basic features of this type of documents. BusinessTransactionDocumentTypeCode may be based on datatype GDT: BusinessTransactionDocumentTypeCode. BusinessTransactionDocumentItemID is a unique identifier of an item or subitem of a document within a business transaction, is unique in a context of a business transaction, and may be based on datatype GDT: BusinessTransactionDocumentItemID. ProjectReference may be optional, is a reference to a Project task associated with a customer project invoicing agreement item, and may be based on datatype GDT: ProjectReference. BaseCustomerTransactionDocumentItemCancellationReasonCode may be optional, is a reason for canceling a base customer transaction document item, and may be based on datatype GDT: CancellationReasonCode. BaseCustomerTransactionDocumentItemDateTime may be optional, is a point in time at which a base customer transaction document item becomes effective in financial accounting and at which the period balances of the concerned accounts change, and may be based on datatypeGDT: GLOBAL_DateTime. BaseCustomerTransactionDocumentItemDescription may be optional, is a short description of a base customer transaction document item associated with a customer project invoicing agreement item, and may be based on datatype GDT: SHORT_Description. BaseCustomerTransactionDocumentItemBuyerID may be optional, is a unique identifier of a base customer transaction document item associated with a customer project invoicing agreement item as assigned by a buyer, and may be based on datatype GDT: BusinessTransactionDocumentItemID. BaseCustomerTransactionDocumentItemBuyerDateTime may be optional, is a posting time of a base customer transaction document item associated with a customer project invoicing agreement item as assigned by a buyer, and may be based on datatype GDT: GLOBAL_DateTime, with a qualifier of Buyer. BaseCustomerTransactionDocumentItemBuyerName may be optional, is a name of a base customer transaction document item associated with a customer project invoicing agreement item as assigned by a buyer, and may be based on datatype GDT: MEDIUM_Name, with a qualifier of CustomerTransactionDocumentItemParty. ProposedToBeInvoicedAmount may be optional, is a representation of the summarized TotalCalculatedAmount of all a customer project expense list item splits that are not assigned to an Item Customer Project Expense List Expense Document Item Split Assignment node of customer project invoice requisition or for which the status NotifyofInvoiceAssignment is ‘NotAllocated’. ProposedToBeInvoicedAmount may be based on datatype GDT: Amount, with a qualifier of ToBeInvoiced. ProposedToBeInvoicedQuantity may be optional, is a representation of a summarized quantity of all a customer project expense list item splits that are not assigned to an Item Customer Project Expense List Expense Document Item Split Assignment node of customer project invoice requisition or for which the status NotifyofInvoiceAssignment is ‘NotAllocated’. ProposedToBeInvoicedQuantity may be based on datatype GDT: Quantity, with a qualifier of ToBeInvoiced. ProposedToBeInvoicedQuantityTypeCode may be optional, is a coded representation of a type of a proposed to be invoiced quantity, and may be based on datatype GDT: QuantityTypeCode, with a qualifier of ToBeInvoiced. AllocatedAmount may be optional, is a representation of the summarized TotalCalculatedAmount of all a customer project expense list item splits that are assigned to an Item Customer Project Expense List Expense Document Item Split Assignment node of customer project invoice requisition or for which the status NotifyofInvoiceAssignment is ‘Allocated’. AllocatedAmount may be based on datatype GDT: Amount, with a qualifier of Allocated.

AllocatedQuantity may be optional, is a representation of a summarized quantity of all a customer project expense list item splits that are assigned to an Item Customer Project Expense List Expense Document Item Split Assignment node of customer project invoice requisition or for which the status NotifyofInvoiceAssignment is ‘Allocated’, and may be based on datatype GDT: Quantity, with a qualifier of Allocated. AllocatedQuantityTypeCode may be optional, is a coded representation of a type of the not released allocated quantity. AllocatedQuantity may be based on datatype GDT: QuantityTypeCode, with a qualifier of Allocated. ReleasedAmount may be optional, is a representation of a summarized amount of all customer project invoice requisition items that are associated with an item and are released, and may be based on datatype GDT: Amount, with a qualifier of Released. ReleasedQuantity may be optional, is a representation of a summarized quantity of all customer project invoice requisition items that are associated with an item and are released, and may be based on datatype GDT: Quantity, with a qualifier of Released. CustomerProjectInvoicingMethodCode may be optional, is a coded representation of a method for invoicing project-based services, and may be based on datatype GDT: CustomerProjectInvoicingMethodCode. ReleasedQuantityTypeCode may be optional, is a coded representation of a type of a released allocated quantity, and may be based on datatype GDT: QuantityTypeCode, with a qualifier of Released. NotToBeInvoicedAmount may be optional, is a representation of a summarized amount of all expense document item splits that are written off, and may be based on datatype GDT: Amount, with a qualifier of ToBeInvoiced. NotToBeInvoicedQuantity may be optional, is a representation of a summarized quantity of all expense document item splits that are written off, and may be based on datatype GDT: Quantity, with a qualifier of ToBeInvoiced. NotToBeInvoicedQuantityTypeCode may be optional, is a coded representation of a type of a written-off quantity, and may be based on datatype GDT: QuantityTypeCode, with a qualifier of ToBeInvoiced. InvoicedAmount may be optional, is an amount that has been invoiced for a customer project invoicing agreement item, and may be based on datatype GDT: Amount, with a qualifier of Invoiced. InvoicedQuantity may be optional, is a quantity that has been invoiced for a customer project invoicing agreement item, and may be based on datatype GDT: Quantity, with a qualifier of Invoiced. InvoicedQuantityTypeCode may be optional, is a coded representation of a type of an invoiced quantity, and may be based on datatype GDT: QuantityTypeCode, with a qualifier of Invoiced. HierarchyRelationship may be optional, is a relationship between a subitem and a parent item, is used to describe item hierarchies, and may be based on datatype BOIDT: CustomerProjectInvoicingAgreementItemHierarchyRelationship. ParentItemUUID is a universally unique identifier for a parent item in an item hierarchy of a customer project invoicing agreement, and may be based on datatype GDT: UUID. TypeCode is a coded representation of a type of relationship of a subitem with its hierarchically higher parent item, and may be based on datatype GDT: BusinessTransactionDocumentItemHierarchyRelationshipTypeCode. SystemAdministrativeData includes Administrative data recorded by the system, such as system user and change dates/times, and may be based on datatype GDT: SystemAdministrativeData. Status is a current state in a life cycle of a customer project invoicing agreement, and may be based on datatype BOIDT: CustomerProjectInvoicingAgreementItemStatusElements. FulfillmentProcessingStatusCode is a status variable which informs about a fulfillment status of an item. The status values are derived from the expense tracking information included in a customer project invoicing agreement item. FulfillmentProcessingStatusCode may be based on datatype GDT: NOTSTARTEDINPROCESSFINISHED_ProcessingStatusCode, with a qualifier of Fulfillment. InvoiceProcessingStatusCode is a status variable which indicates an invoice processing status of a customer project invoicing agreement item, and may be based on datatype GDT: NOTSTARTEDINPROCESSFINISHED_ProcessingStatusCode, with a qualifier of Invoice.

The following composition relationships to subordinate nodes may exist: ItemTotalValues, with a cardinality of 1:C; ItemBusinessTransactionDocumentReference, with a cardinality of 1:CN; ItemPricingTerms, with a cardinality of 1:C; ItemInvoiceTerms, with a cardinality of 1:C; ItemLocation, with a cardinality of 1:C; ItemProduct, with a cardinality of 1:C; ItemParty, with a cardinality of 1:CN; ItemTextCollection, with a cardinality of 1:C; and ItemAttachmentFolder, with a cardinality of 1:C. A SalesOrderItemReference inbound aggregation relationship may exist from the business object Sales Order/node Item Cross DU, with a cardinality of 1:C, which is a reference to a sales order item for which this customer project invoicing agreement item was created. A ParentItem inbound association relationship may exist from the business object Customer Project Invoicing Agreement/node Item, with a cardinality of 1:C, which is a reference to a parent item in an item hierarchy. A LastChangeIdentity inbound association relationship may exist from the business object Identity/node Identity, with a cardinality of 1:CN, which is an identity of a user who last changed a customer project invoicing agreement item. A CreationIdentity inbound association relationship may exist from the business object Identity/node Identity, with a cardinality of 1:CN, which is an identity of a user who created a customer project invoicing agreement item.

The following specialization associations for navigation may exist to node ItemParty: BillToItemParty, with a target cardinality of C, which is an association to an item party that occurs in the specialization BillToItemParty; PayerItemParty, with a target cardinality of C, which is an association to an item party that occurs in the specialization PayerItemParty; BuyerItemParty, with a target cardinality of C, which is an association to an item party that occurs in the specialization BuyerItemParty; SellerItemParty, with a target cardinality of C, which is an association to an item party that occurs in the specialization SellerItemParty; ProductRecipientItemParty, with a target cardinality of C, which is an association to an item party that occurs in the specialization ProductRecipientItemParty; SalesUnitItemParty, with a target cardinality of C, which is an association to an item party that occurs in the specialization SalesUnitItemParty; EmployeeResponsibleItemParty, with a target cardinality of C, which is an association to an item party that occurs in the specialization EmployeeResponsibleItemParty; VendorItemParty, with a target cardinality of C, which is an association to an item party that occurs in the specialization VendorItemParty.

The following associations exist to node ItemLocation: ServicePointItemLocation, with a target cardinality of C, which is an association to an item location that occurs in the specialization ServicePointItemLocation. A PriceAndTaxCalculationItem association may exist to dependent object PriceAndTaxCalculation/node Item, with a target cardinality of C, which is a price and tax information assigned to an item. A ChildItem association may exist to node Item, with a target cardinality of CN, which is a reference to the subordinate Item nodes in an item hierarchy. In some implementations, for each ParentItem association relationship, there is one ChildItem association relationship that runs in an opposite direction between the same two item nodes.

A Notify of Expenses Incurred action may be used to determine a fulfillment processing status of a customer project invoicing agreement item. The Notify of Expenses Incurred may be called internally when tracking quantities and amounts are changed. The Notify of Expenses Incurred action may have preconditions that an action can be performed if the FulfillmentProcessing status variable has the value “Not Started” or “In Process.” In response to the Notify of Expenses Incurred action, the value of the FulfillmentProcessing status variable is set to “Not Started” or “In Process.” A Finish Fulfillment action may be performed on a customer project invoicing agreement item when a fulfillment is finished. The Finish Fulfillment action may be performed if no further confirmations for project tasks related to the customer project invoicing agreement item are expected. The Finish Fulfillment action may have preconditions that the action can be performed when the status variable FulfillmentProcessing has the value “Not Started” or “In Process.” In response to the Finish Fulfillment action, the value of the FulfillmentProcessing status variable is set to “Finished.” A Revoke Finish Fulfillment action revokes a FinishFulfillment action performed on a customer project invoicing agreement item. The Revoke Finish Fulfillment action may have preconditions that the action can be performed when the status variable FulfillmentProcessing has the value “Finished.” In response to the Revoke Finish Fulfillment action, the value of the FulfillmentProcessing status variable is set to “In Process.” A Notify Of Customer Invoice Issue action determines an InvoicingProcessing status. The Notify Of Customer Invoice Issue action may be called by an inbound process agent working on a customer invoice issued confirmation message. The Notify Of Customer Invoice Issue action may have a precondition that the action can be performed if the status variable InvoicingProcessing has the value “Not Started” or “In Process.” In response to the Notify Of Customer Invoice Issue action, a value of a status variable InvoicingProcessing is set to “Not Started” or “In Process.”

A Finish Invoicing action may be performed on a customer project invoicing agreement item when an invoicing for this item is finished and no more revenues are expected. The Finish Invoicing action may have preconditions that the action can be performed when the status variable InvoicingProcessing has the value “Not Started” or “In Process.” In response to the Finish Invoicing action, the value of the status variable InvoicingProcessing is set to “Finished.” A Revoke Finish Invoicing action may be used to to revoke the Finish Invoicing action performed on a customer project invoicing agreement item. The Revoke Finish Invoicing action may have preconditions that the action can be performed when the status variable InvoiceProcessing has the value “Finished.” In response to the Revoke Finish Invoicing action, the value of the InvoiceProcessing status variable is set to “In Process.” A Notify of Proposed To Be Invoiced Values Change action is used by a customer project expense list to change the ProposedToBeInvoicedQuantity and ProposedToBeInvoicedAmount. The Notify of Proposed To Be Invoiced Values Change action may include parameter action elements. The action elements are defined by the data type CustomerProjectInvoicingAgreementItemNotifyOfProposedToBeInvoicedValuesChangeActionElements. These elements include: DifferenceQuantity, DifferenceQuantityTypeCode, and DifferenceAmount. DifferenceQuantity may be optional, is a difference in a proposed to be invoiced quantity, and may be based on datatype GDT: Quantity, with a qualifier of Difference. DifferenceQuantityTypeCode may be optional, is a coded representation of the type of a difference quantity, and may be based on datatype GDT: QuantityTypeCode, with a qualifier of Difference. DifferenceAmount may be optional, is a difference in aproposed to be invoiced amount, and may be based on datatype GDT: Amount, with a qualifier of Difference.

A Notify of Allocated Values Change action is used by customer project invoice requisition to change the NotReleasedAllocatedQuantity and NotReleasedAllocatedAmount. The A Notify of Allocated Values Change action may include parameter action elements. The action elements are defined by the data type CustomerProjectInvoicingAgreementItemNotifyOfAllocatedValuesChangeActionElements. These elements include: DifferenceQuantity, DifferenceQuantityTypeCode, and DifferenceAmount. DifferenceQuantity may be optional, is a difference in a not released allocated quantity, and may be based on datatype GDT: Quantity, with a qualifier of Difference. DifferenceQuantityTypeCode may be optional, is a coded representation of a type of a difference quantity, and may be based on datatype GDT: QuantityTypeCode, with a qualifier of Difference. DifferenceAmount may be optional, is a difference in a not released allocated amount, and may be based on datatype GDT: Amount, with a qualifier of Difference.

A Notify of Released Values Change action is used by customer project invoice requisition to change the ReleasedAllocatedQuantity and ReleasedAllocatedAmount. The Notify of Released Values Change action may include parameter action elements. The action elements are defined by the data type CustomerProjectInvoicingAgreementItemNotifyOfReleasedValuesChangeActionElements. These elements include: DifferenceQuantity, DifferenceQuantityTypeCode, and DifferenceAmount. DifferenceQuantity may be optional, is a difference in a released allocated quantity, and may be based on datatype GDT: Quantity, with a qualifier of Difference. DifferenceQuantityTypeCode may be optional, is a coded representation of a type of a difference quantity, and may be based on datatype GDT: QuantityTypeCode, with a qualifier of Difference. DifferenceAmount may be optional, is a difference in a released allocated amount, and may be based on datatype GDT: Amount, with a qualifier of Difference.

A Notify of Not To Be Invoiced Values Change action is used by a customer project expense list to change the not to be invoiced quantity and amount. The Notify of Not To Be Invoiced Values Change action may include parameter action elements. The action elements are defined by the data type CustomerProjectInvoicingAgreementItemNotifyOfNotToBeInvoicedValuesChangeActionElements. These elements include: DifferenceQuantity, DifferenceQuantityTypeCode, and DifferenceAmount. DifferenceQuantity may be optional, is a difference in a not to be invoiced quantity, and may be based on datatype GDT: Quantity, with a qualifier of Difference. DifferenceQuantityTypeCode may be optional, is a coded representation of a type of a difference quantity, and may be based on datatype GDT: QuantityTypeCode, with a qualifier of Difference. DifferenceAmount may be optional, is a difference in the not to be invoiced amount, and may be based on datatype GDT: Amount, with a qualifier of Difference.

A Notify Of Invoiced Values Change action is used by a customer project expense list to change the InvoicedQuantity and InvoicedAmount. The Notify Of Invoiced Values Change action may include parameter action elements. The action elements are defined by the data type CustomerProjectInvoicingAgreementItemNotifyOfInvoicedValuesChangeActionElements. These elements include: DifferenceQuantity, DifferenceQuantityTypeCode, and DifferenceAmount. DifferenceAmount may be optional, is a difference in an invoiced amount, and may be based on datatype GDT: Amount, with a qualifier of Difference. DifferenceQuantity may be optional, is a difference in invoiced quantity, and may be based on datatype GDT: Quantity, with a qualifier of Difference. DifferenceQuantityTypeCode may be optional, is a coded representation of a type of a difference quantity, and may be based on datatype GDT: QuantityTypeCode, with a qualifier of Difference.

A Query By Elements query returns a list of customer project invoicing agreement items which match specified selection criteria. The selection criteria may be specified by a logical ‘AND’ combination of query elements. The query elements are defined by the data type CustomerProjectInvoicingAgreementItemElementsQueryElements. These elements include: BaseCustomerTransactionDocumentItemID, InvoicingMethodCode, and SearchText. BaseCustomerTransactionDocumentItemID may be optional, is a unique identifier for a base customer transaction document item, and may be based on datatype GDT: BusinessTransactionDocumentItemID. InvoicingMethodCode may be optional, is a coded representation of a method for invoicing project-based services, and may be based on datatype GDT: CustomerProjectInvoicingMethodCode. SearchText may be optional, is a limited character string to be searched, and may be based on datatype GDT: SearchText. For every query that includes the SearchText as a query parameter an application-specific subset of the other query parameters may be defined. The search terms may be assigned to the subset of query parameters in such a way that every search term is used exactly once in the assignment. Several search terms may be assigned to the same query parameter. For each of these assignments the query result is calculated. The total result is then the union of the results calculated per assignment.

Item Total Values includes the total values for an item resulting from the item's dependent nodes. Item Total Values includes the total quantity requested of an item in a customer project invoicing agreement, the net amount or net price of a customer project invoicing agreement, and other information. The elements located directly at the node Item Total Values are defined by the data type CustomerProjectInvoicingAgreementItemTotalValuesElements. These elements include: RequestedQuantity, RequestedQuantityTypeCode, NetAmount, NetPrice, TaxAmount, and GrossAmount. RequestedQuantity may be optional, is a total quantity requested of an item in a customer project invoicing agreement item, and may be based on datatype GDT: Quantity, with a qualifier of Requested. RequestedQuantityTypeCode may be optional, is a coded representation of a type of a requested quantity, and may be based on datatype GDT: QuantityTypeCode, with a qualifier of Requested. NetAmount may be optional, is a net amount of an item in a customer project invoicing agreement item, and may be based on datatype GDT: Amount, with a qualifier of Net. NetPrice may be optional, is a net price of an item in relation to a base quantity, and may be based on datatype GDT: Price, with a qualifier of Net. TaxAmount may be optional, is a tax amount of an item in a customer project invoicing agreement item, and may be based on datatype GDT: Amount, with a qualifier of Tax. GrossAmount may be optional, is a gross amount of an item in a customer project invoicing agreement item, and may be based on datatype GDT: Amount, with a qualifier of Gross.

Item Business Transaction Document Reference is a unique reference to other business documents that are of significance within a business process, such as customer project invoice requisition items that are the successors to a customer project invoicing agreement item in a document flow. An ItemBusinessTransactionDocumentReference can occur in the CustomerProjectInvoiceRequisitionItemReference specialization, which is a reference to a customer project invoice requisition item that is the successor to a customer project invoicing agreement item. The elements located directly at the node Item Business Transaction Document Reference are defined by the data type CustomerProjectInvoicingAgreementItemBusinessTransactionDocumentReferenceElements. These elements include: BusinessTransactionDocumentReference and BusinessTransactionDocumentRelationshipRoleCode. BusinessTransactionDocumentReference is a unique reference to a business transaction document item related to a customer project invoicing agreement, and may be based on datatype GDT: BusinessTransactionDocumentReference. BusinessTransactionDocumentRelationshipRoleCode is a coded representation of a role of a referenced business transaction document item, and may be based on datatype GDT: BusinessTransactionDocumentRelationshipRoleCode. A CustomerProjectInvoiceRequisitionItem inbound association relationship may exist from the business object Customer Project Invoice Requisition/node Item, with a cardinality of C:1, which is a reference to a customer project invoice requisition item that was created for a customer project invoicing agreement item.

Item Pricing Terms include item-specific agreements in a sales or service process that are used to determine a net value of a customer project invoicing agreement item. The elements located directly at the node Item Pricing Terms are defined by the data type CustomerProjectInvoicingAgreementItemPricingTermsElements. These elements include PriceDateTime, which may be optional, is a date and time used to determine the price components for an item, and may be based on datatype GDT: LOCALNORMALISED_DateTime, with a qualifier of Price.

Item Invoice Terms include item-specific agreements that apply for invoicing goods and services in the customer project invoicing agreement. The elements located directly at the node Item Invoice Terms are defined by the data type CustomerProjectInvoicingAgreementItemInvoiceTermsElements. These elements include ProposedInvoiceDate. ProposedInvoiceDate may be optional, is a proposal for an invoice date of a customer invoice item to be created for a customer project invoicing agreement item, and may be based on datatype GDT: Date, with a qualifier of Invoice.

Item Location is a place where goods are delivered or services to be invoiced are provided. The elements located directly at the node Item Location are defined by the data type CustomerProjectInvoicingAgreementItemLocationElements. These elements include: LocationID, LocationUUID, AddressReference, AddressHostUUID, BusinessObjectTypeCode, AddressHostTypeCode, PartyKey, PartyTypeCode, PartyID, InstalledBaseID, InstallationPointID, RoleCode, and RoleCategoryCode. LocationID may be optional, is an identifier for a location, and may be based on datatype GDT: LocationID. LocationUUID may be optional, is a universally unique identifier of a business object Location, and may be based on datatype GDT: UUID. AddressReference may be optional, is a reference to an address of a location, and may be based on datatype BOIDT: ObjectNodeLocationAddressReference. AddressHostUUID may be optional, is a universally unique identifier for an address of a business partner, an organizational unit or its specializations, the business object InstalledBase, or the business object InstallationPoint, and may be based on datatype GDT: UUID. BusinessObjectTypeCode may be optional, is a coded representation of a type of a business object in which an address referenced in the LocationAddressUUID is integrated as a dependent object, and may be based on datatype GDT: BusinessObjectTypeCode. AddressHostTypeCode may be optional, is a coded representation of an address host type of an address referenced by the AddressUUID or an address included using the Location Address composition, and may be based on datatype GDT: AddressHostTypeCode. PartyKey may be optional, is an alternative identifier of a party which represents a business partner or an organizational unit that references an address using the AddressUUID, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. InstalledBaseID may be optional, is an identifier for an installed base that references an address using the AddressUUID, and may be based on datatype GDT: InstalledBaseID. InstallationPointID may be optional, is an identifier for an installation point that references an address using the AddressUUID, and may be based on datatype GDT: InstallationPointID. RoleCode is a coded representation of a role of a location in a customer project invoicing agreement, and may be based on datatype GDT: LocationRoleCode. RoleCategoryCode is a coded representation of a role category of a location in a customer project invoicing agreement, and may be based on datatype GDT: LocationRoleCategoryCode.

The following composition relationships to subordinate nodes exist: ItemLocationAddress with a cardinality of 1:C. A InstallationPointAddressInformation inbound aggregation relationship may exist from the business object InstallationPoint/node Address Information, with a cardinality of C:C, which is address information of an Installation point to which or at which goods are delivered or a service is provided in the role ServicePoint. A Location inbound aggregation relationship may exist from the business object Location/node Location, with a cardinality of C:C, which is a location in the role ShipToLocation, to which or at which goods are delivered or a service is provided. A PartyAddressInformation inbound aggregation relationship may exist from the business object Party/node Address Information, with a cardinality of C:C, which is address information of a representative of a business partner or organizational center corresponding to a location. A UsedAddress specialization association for navigation may exist from business object UsedAddress/node root, with a target cardinality of C, which a master data or document-specific address used for a location. The Item Location Address dependent object inclusion node includes data used to describe a physical or logical location.

Item Product is the identification, description, and classification of a product material or service product in a customer project invoicing agreement item. The elements located directly at the node Item Product are defined by the data type CustomerProjectInvoicingAgreementItemProductElements. These elements include: ProductUUID, ProductKey, ProductTypeCode, ProductidentifierTypeCode, ProductID, QuantityMeasureUnitCode, QuantityTypeCode, ProductBuyerID, ProductCategoryHierarchyProductCategoryIDKey, ProductCategoryHierarchyID, ProductCategoryInternalID, ProductInternalID, ProductStandardID, PriceSpecificationProductGroupCode, PricingProductUUID, and CashDiscountDeductibleIndicator. ProductUUID may be optional, is a universally unique identifier of a product, and may be based on datatype GDT: UUID. ProductKey may be optional, is a grouping of elements that uniquely identifies a product associated with a customer project invoicing agreement item, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. QuantityMeasureUnitCode may be optional, is a coded representation of the unit of measurement, and may be based on datatype GDT: MeasureUnitCode. QuantityTypeCode may be optional, is a coded representation of a type of quantity in which a product is delivered, and may be based on datatype GDT: QuantityTypeCode. In some implementations, a unit may not be sufficient to define a type of a quantity, because a unit can be used in multiple ways. For example unit ‘kg’ can be used in quantity types for gross weight or net weight. On the other hand, multiple units may be valid for one quantity type. For example, the quantity type gross weight can be expressed with units ‘kg’ or ‘gram’. Therefore, a quantity type may be used, in addition to a unit, to define a quantity completely. ProductBuyerID may be optional, is an identifier for a product assigned by a buyer, and may be based on datatypeGDT: ProductPartyID. ProductCategoryHierarchyProductCategoryIDKey may be optional, is a grouping of elements that uniquely identifies a product category, and may be based on datatype KDT: ProductCategoryHierarchyProductCategoryIDKey. ProductCategoryHierarchyID is an identifier for a product category hierarchy, and may be based on datatype GDT: ProductCategoryHierarchyID. ProductCategoryInternalID is an identifier for a product category, and may be based on datatype GDT: ProductCategoryInternalID. ProductInternalID may be optional, is an identifier for a product, and may be based on datatype GDT: ProductInternalID. ProductStandardID may be optional, is a standard identifier for a product, and may be based on datatype GDT: ProductStandardID. PriceSpecificationProductGroupCode may be optional, is a coded representation of a group of products for which a same price determination applies, and may be based on datatype GDT: PriceSpecificationProductGroupCode. PricingProductUUID may be optional, is a universally unique identifier of a product that is used for pricing, and may be based on datatype GDT: UUID. CashDiscountDeductibleIndicator may be optional, specifies whether a cash discount is deducted for a product, and may be based on datatype GDT: Indicator, with a qualifier of CashDiscountDeductible. A Material inbound aggregation relationship may exist from the business object Material/node Material, with a cardinality of C:CN, which is a material to be invoiced. A ServiceProduct inbound aggregation relationship may exist from the business object Service Product/node Service Product, with a cardinality of C:CN, which is a service to be invoiced. In some implementations, either a material or a service product is specified.

Item Party is a natural or legal person, organization, organizational unit, or group that is involved in a customer project invoicing agreement in a party role. A party role specifies which rights and obligations the party has, and the processes that belong to the party. An ItemParty can be a reference to one of the specializations of a business partner, such as customer, or supplier, or a reference to the specialization Company of an organizational unit. The elements of the ItemParty include the elements of the Party node, but they do not refer to the whole business transaction, rather only to an item. The elements located directly at the node Item Party are defined by the data type CustomerProjectInvoicingAgreementItemPartyElements. These elements include: PartyUUID, PartyKey, PartyTypeCode, PartyID, RoleCategoryCode, RoleCode, AddressReference, and MainIndicator. PartyUUID may be optional, is a universally unique identifier for referencing a party involved in a customer project invoicing agreement Item, and may be based on datatype GDT: UUID. PartyKey may be optional, is a key of a party in a party role in a customer project invoicing agreement item, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. RoleCategoryCode may be optional, is a coded representation of a grouping of party roles according to process-controlling criteria, and may be based on datatype GDT: PartyRoleCategoryCode. RoleCode may be optional, is a coded representation of a party role, and may be based on datatype GDT: PartyRoleCode. AddressReference may be optional, is a reference to an address of a party, and may be based on datatype GDT: PartyAddressReference. MainIndicator is an indicator of whether a party has the predominant position towards other parties of a same role, and may be based on datatype GDT: Indicator, with a qualifier of Main. MainIndicator can be used to identify which party to use if there is more than one entry for a party role category.

The following composition relationships to subordinate nodes exist: ItemPartyContactParty, with a cardinality of 1:CN, and ItemPartyAddress with a cardinality of 1:C. A Party inbound aggregation relationship may exist from the business object Party/node Party, with a cardinality of C:CN, which is a referenced party in master data which is either: a customer to whom an invoice will be sent, who is requested to pay for the services to be invoiced or is the one who purchases a product or a service; or a company to which goods are delivered or services are provided. A UsedAddress specialization association for navigation may exist to transformed business object UsedAddress/node root, with a target cardinality of CN, which is a master-data address or document-specific address used for a party. The association represents the currently-used address of a business object node which can have multiple references for its address.

Item Party Contact Party is a natural person or an organizational unit that can be contacted for a respective party. The contact can be a contact person or a secretary, for example. Communication data may be available for the contact. The elements located directly at the node Item Party Contact Party are defined by the data type CustomerProjectInvoicingAgreementItemPartyContactPartyElements. These elements include: PartyUUID, PartyKey, PartyTypeCode, PartyID, AddressReference, and MainIndicator. PartyUUID may be optional, is a universally unique identifier for referencing a contact party involved in a customer project invoicing agreement Item, and may be based on datatype GDT: UUID. PartyKey may be optional, is a key of a contact party in this party role in a customer project invoicing agreement item, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. AddressReference may be optional, is a reference to an address of a contact party, and may be based on datatype GDT: PartyAddressReference. MainIndicator is an indicator of whether a party has a predominant position towards other parties of a same role, and may be based on datatype GDT: Indicator, with a qualifier of Main. MainIndicator can be used to identify which party to use if there is more than one entry for a party role category.

The following composition relationships to subordinate nodes exist: ItemPartyContactPartyAddress with a cardinality of 1:C. A Party inbound aggregation relationship may exist from the business object Party/node Party, with a cardinality of C:CN, which is an employee or an organizational unit that can assume the role of a contact party for an item. A UsedAddress specialization association for navigation may exist to transformed business object UsedAddress/node root, with a target cardinality of CN, which is a master data address or document-specific address used for a party, and is the currently-used address of a business object node which can have multiple references for its address.

Item Party Contact Party Address dependent object inclusion node is a document-specific address of a contact party. Data may be displayed via an Address dependent object. An Item Party Address dependent object inclusion node is a document-specific address of a party. Data may be displayed via the Address dependent object. Item Text Collection dependent object inclusion node is a set of multilingual textual descriptions including formatting information of a customer project invoicing agreement item. The Item Attachment Folder dependent object inclusion node is a collection of documents attached to a customer project invoicing agreement item.

Business Transaction Document Reference is a unique reference to other business documents that are of significance within a business process. BusinessTransactionDocumentReference includes reference to the customer project invoice requisitions that are successor documents to a customer project invoicing agreement in a document flow. A BusinessTransactionDocumentReference can occur in the following incomplete and disjoint specializations: CustomerProjectInvoiceRequisitionReference. CustomerProjectInvoiceRequisitionReference is a reference to a customer project invoice requisition that is a successor to a customer project invoicing agreement. The elements located directly at the node Business Transaction Document Reference are defined by the data type CustomerProjectInvoicingAgreementBusinessTransactionDocumentReferenceElements. These elements include BusinessTransactionDocumentReference and BusinessTransactionDocumentRelationshipRoleCode. BusinessTransactionDocumentReference is a unique reference to a business transaction document related to a customer project invoicing agreement, and may be based on datatype GDT: BusinessTransactionDocumentReference. BusinessTransactionDocumentRelationshipRoleCode is a coded representation of a role of a referenced business transaction document, and may be based on datatype GDT: BusinessTransactionDocumentRelationshipRoleCode. A CustomerProjectInvoiceRequisition inbound association relationship may exist from the business object Customer Project Invoice Requisition/node Customer Project Invoice Requisition, with a cardinality of C:1, which is a reference to a customer project invoice requisition that was created for a customer project invoicing agreement.

Pricing Terms includes agreements in a sales or service process that are used to determine a net value of a customer project invoicing agreement. The elements located directly at the node Pricing Terms are defined by the data type CustomerProjectInvoicingAgreementPricingTermsElements. These elements include: CurrencyCode, PriceDateTime, and CustomerGroupCode. CurrencyCode may be optional, is a coded representation of a currency, and may be based on datatype GDT: CurrencyCode. PriceDateTime may be optional, is a date and time used to determine the price components for a sales order associated with a customer project invoicing agreement, and may be based on datatype GDT: LOCALNORMALISED_DateTime, with a qualifier of Price. CustomerGroupCode may be optional, is a coded representation of a group of customers, and may be based on datatype GDT: CustomerGroupCode. CustomerGroupCode may be used for pricing and statistics purposes. Examples codes include: industrial enterprise, commercial enterprise, private customer.

Invoice Terms includes agreements that apply for invoicing goods and services in a customer project invoicing agreement. The elements located directly at the node Invoice Terms are defined by the data type CustomerProjectInvoicingAgreementInvoiceTermsElements. These elements include ProposedInvoiceDate and InvoicingBlockingReasonCode. ProposedInvoiceDate may be optional, is a proposal for an invoice date of a customer invoice item to be created for a customer project invoicing agreement item, and may be based on datatype GDT: Date, with a qualifier of Invoice. InvoicingBlockingReasonCode may be optional, is a coded representation of a reason for blocking an invoicing process, and may be based on datatype GDT: InvoicingBlockingReasonCode.

Location is a place where goods are delivered or services to be invoiced are provided. The elements located directly at the node Location are defined by the data type CustomerProjectInvoicingAgreementLocationElements. These elements include: LocationID, LocationUUID, AddressReference, AddressHostUUID, BusinessObjectTypeCode, AddressHostTypeCode, PartyKey, PartyTypeCode, PartyID, InstalledBaseID, InstallationPointID, RoleCode, and RoleCategoryCode. LocationID may be optional, is an identifier for a location, and may be based on datatype GDT: LocationID. LocationUUID may be optional, is a universally unique identifier for a business object Location, and may be based on datatype GDT: UUID. AddressReference may be optional, is a reference to an address of a location, and may be based on datatype BOIDT: ObjectNodeLocationAddressReference. AddressHostUUID may be optional, is a universally unique identifier for an address of a business partner, an organizational unit or its specializations, the business object InstalledBase, or the business object InstallationPoint, and may be based on datatype GDT: UUID. BusinessObjectTypeCode may be optional, is a coded representation of a type of a business object in which an address referenced in the LocationAddressUUID is integrated as a dependent object, and may be based on datatype GDT: BusinessObjectTypeCode. AddressHostTypeCode may be optional, is a coded representation of an address host type of an address referenced by the AddressUUID or an address included using the Location Address composition, and may be based on datatype GDT: AddressHostTypeCode. PartyKey may be optional, is an alternative identifier of a party which represents a business partner or an organizational unit that references an address using the AddressUUID, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. InstalledBaseID may be optional, is an identifier for an installed base that references an address using the AddressUUID, and may be based on datatype GDT: InstalledBaseID. InstallationPointID may be optional, is an identifier for an installation point that references an address using the AddressUUID, and may be based on datatype GDT: InstallationPointID. RoleCode is a coded representation of a role of a location in a customer project invoicing agreement, and may be based on datatype GDT: LocationRoleCode. RoleCategoryCode is a coded representation of a role category of a location in a customer project invoicing agreement, and may be based on datatype GDT: LocationRoleCategoryCode.

The following composition relationships to subordinate nodes exist: LocationAddress with a cardinality of 1:C. A InstallationPointAddressInformation inbound aggregation relationship may exist from the business object Installation Point/node Address Information, with a cardinality of C:C, which is address information of an Installation point to which or at which goods are delivered or a service is provided in the role ServicePoint. A Location inbound aggregation relationship may exist from the business object Location/node Location, with a cardinality of C:C, which is a location in the role ShipToLocation, to which or at which goods are delivered or a service is provided. A PartyAddressInformation inbound aggregation relationship may exist from the business object Party/node Address Information, with a cardinality of C:C, which is address information of a representative of a business partner or organizational center corresponding to a location. A UsedAddress specialization association for navigation may exist from business object UsedAddress/node root, with a target cardinality of C, which is aster data or document specific address used for a location. The Location Address dependent object inclusion node includes data used to describe a physical or logical location.

Sales And Service Business Area is a business-specific or service-specific area within an enterprise that is valid for a customer project invoicing agreement. The elements located directly at the node Sales And Service Business Area are defined by the data type CustomerProjectInvoicingAgreementSalesAndServiceBusinessAreaElements. These elements include: SalesOrganisationUUID, SalesGroupUUID, SalesOfficeUUID, ServiceOrganisationUUID, and DistributionChannelCode. SalesOrganisationUUID may be optional, is a universally unique identifier for a sales organization, and may be based on datatype GDT: UUID. SalesGroupUUID may be optional, is a universally unique identifier for a sales group, and may be based on datatype GDT: UUID. SalesOfficeUUID may be optional, is a universally unique identifier for a sales office, and may be based on datatype GDT: UUID. ServiceOrganisationUUID may be optional, is a universally unique identifier for a service organization, and may be based on datatype GDT: UUID. DistributionChannelCode may be optional, is a coded representation of a distribution channel by which goods and services reach customers, and may be based on datatype GDT: DistributionChannelCode.

A SalesGroup inbound aggregation relationship may exist from the business object Functional Unit/nodeFunctional Unit Cross DU, with a cardinality of C:CN, which is a functional unit in the specialization SalesGroup. A SalesOffice inbound aggregation relationship may exist from the business object Functional Unit/nodeFunctional Unit Cross DU, with a cardinality of C:CN, which is a functional unit in the specialization SalesOffice. A SalesOrganisation inbound aggregation relationship may exist from the business object Functional Unit/nodeFunctional Unit Cross DU, with a cardinality of C:CN, which is a functional unit in the specialization SalesOrganisation. A ServiceOrganisation inbound aggregation relationship may exist from the business object Functional Unit/nodeFunctional Unit Cross DU, with a cardinality of C:CN, which is a functional unit in the specialization ServiceOrganisation.

Party is a natural or legal person, organization, organizational unit, or group that is involved in a customer project invoicing agreement in a party role. A party role specifies which rights and obligations the party has, and the processes that belong to the party. A Party can be a reference to one of the specializations of a business partner such as customer, supplier, employee, or a reference to the specialization Company of an organizational unit. The elements located directly at the node Party are defined by the data type CustomerProjectInvoicingAgreementPartyElements. These elements include: PartyUUID, PartyKey, PartyTypeCode, PartyID, RoleCategoryCode, RoleCode, AddressReference, and MainIndicator. PartyUUID may be optional, is a universally unique identifier for referencing a party involved in a customer project invoicing agreement, and may be based on datatype GDT: UUID. PartyKey may be optional, is a key of a party in a party role in a customer project invoicing agreement, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. RoleCategoryCode may be optional, is a coded representation of a grouping of party roles according to process-controlling criteria, and may be based on datatype GDT: PartyRoleCategoryCode. RoleCode may be optional, is a coded representation of a party role, and may be based on datatype GDT: PartyRoleCode. AddressReference may be optional, is a reference to an address of a party, and may be based on datatype GDT: PartyAddressReference. MainIndicator is an indicator of whether a party has a predominant position towards other parties of a same role, and may be based on datatype GDT: Indicator, with a qualifier of Main. MainIndicator can be used to identify which party to use if there is more than one entry for a party role category.

The following composition relationships to subordinate nodes exist: PartyContactParty with a cardinality of 1:CN, and PartyAddress with a cardinality of 1:C. A Party inbound aggregation relationship may exist from the business object Party/node Party, with a cardinality of C:CN, which is a referenced party in the master data which is either: a customer to whom an invoice will be sent, who is requested to pay for the services to be invoiced or is the one who purchases a product or a service; or a company to which goods are delivered or services are provided. A UsedAddress specialization association for navigation may exist to transformed business object UsedAddress/node root, with a target cardinality of CN, which is a master data address or document-specific address used for a party, and is the currently-used address of a business object node which can have multiple references for its address. In some implementations, no party appears more than once in a same role.

Party Contact Party is a natural person or an organizational unit that can be contacted for a respective party. The elements located directly at the node Party Contact Party are defined by the data type CustomerProjectInvoicingAgreementPartyContactPartyElements. These elements include: PartyUUID, PartyKey, PartyTypeCode, PartyID, AddressReference, and MainIndicator. PartyUUID may be optional, is a universally unique identifier for referencing a contact party involved in a customer project invoicing agreement, and may be based on datatype GDT: UUID. PartyKey may be optional, is a key of a contact party in this party role in a customer project invoicing agreement, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. AddressReference may be optional, is a reference to an address of a contact party, and may be based on datatype GDT: PartyAddressReference. MainIndicator is an indicator of whether a party has a predominant position towards other parties of a same role, and may be based on datatype GDT: Indicator, with a qualifier of Main. MainIndicator can be used to identify which party to use if there is more than one entry for a party role category.

The following composition relationships to subordinate nodes exist: PartyContactPartyAddress with a cardinality of 1:C. A Party inbound aggregation relationship may exist from the business object Party/node Party, with a cardinality of C:CN, which is an employee or an organizational unit can play the role of a contact party for a document. A UsedAddress specialization association for navigation may exist to transformed business object UsedAddress/node root, with a target cardinality of CN, which is a master data address or document-specific address used for a party, and is the currently-used address of a business object node which can have multiple references for its address. The Party Contact Party Address dependent object inclusion node is a document-specific address of a contact party. Data may be displayed via the Address dependent object. The Party Address dependent object inclusion node is a document-specific address of a party. Data may be displayed via the Address dependent object. The Access Control List dependent object inclusion node is a list of access groups that have access to a customer project invoicing agreement during a validity period. The Price And Tax Calculation dependent object inclusion node is a summary of the price and taxation components identified for a customer project invoicing agreement. The Text Collection dependent object inclusion node is a set of multilingual textual descriptions including formatting information of a customer project invoicing agreement. The Cash Discount Terms dependent object inclusion node includes conditions agreed between business partners regarding payment periods for goods delivered or services performed, including cash discounts granted for punctual payment. The Attachment Folder dependent object inclusion node is a collection of documents attached to a customer project invoicing agreement. The Payment Control dependent object inclusion node is an agreement between a company and a business partner on processing payments for an individual business transaction.

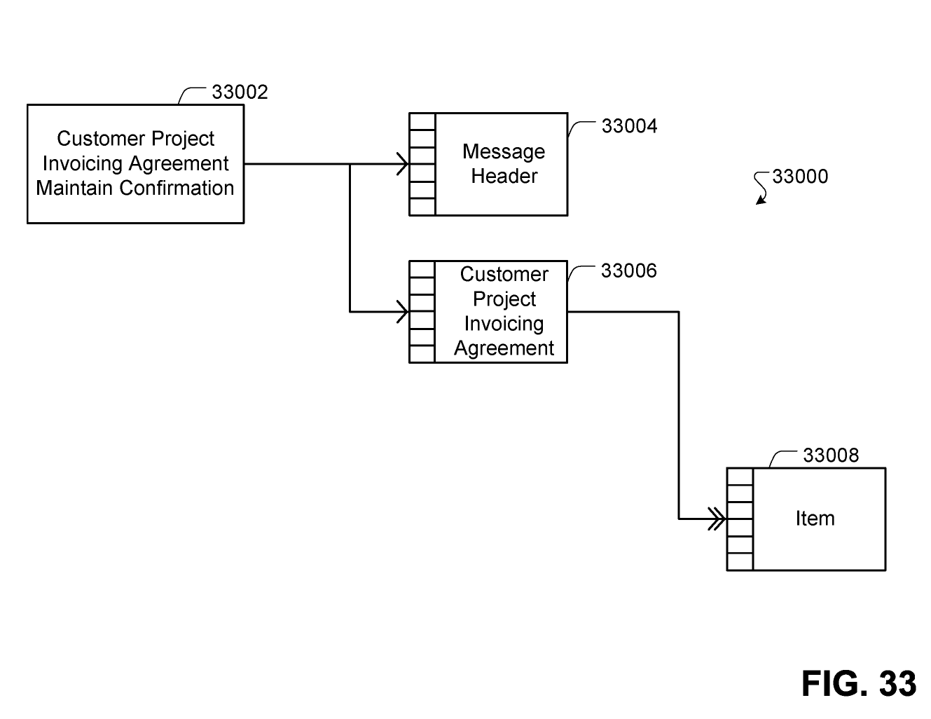

FIG. 33 depicts an example Customer Project Invoicing Agreement Maintain Confirmation Message Data Type 33000, which comprises elements 33002-33008, hierarchically related as shown. For example, the Customer Project Invoicing Agreement Maintain Confirmation 33002 includes a Message Header 33004.

The message type Customer Project Invoicing Agreement Maintain Confirmation is derived from the business object Customer Project Invoicing Agreement as a leading object together with its operation signature. The message type Customer Project Invoicing Agreement Maintain Confirmation is a confirmation for Sales Order Processing that a Customer Project Invoicing Agreement related to a sales order has been created or updated. The structure of the message type Customer Project Invoicing Agreement Maintain Confirmation is determined by the message data type CustomerProjectInvoicingAgreementMaintainConfirmationMessage. The message data type CustomerProjectInvoicingAgreementMaintainConfirmationMessage includes the object CustomerProjectInvoicingAgreement which is included in a business document, business information that is relevant for sending a business document in a message, the MessageHeader package, and the CustomerProjectInvoicingAgreement package. The message data type CustomerProjectInvoicingAgreementMaintainConfirmationMessage provides a structure for the message type Customer Project Invoicing Agreement Maintain Confirmation and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader. The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The CustomerProjectInvoicingAgreement package is a grouping of CustomerProjectInvoicingAgreement with its Item package and with the CustomerProjectInvoicingAgreement entity. CustomerProjectInvoicingAgreement includes the following attributes: ReconciliationPeriodCounterValue, ItemListCompleteTransmissionIndicator, and ActionCode. ReconciliationPeriodCounterValue may be optional, may be used for accounts payable internal communication, and may be based on datatype GDT:CounterValue. ItemListCompleteTransmissionIndicator may be based on datatype CDT:Indicator. ActionCode may be based on datatype GDT:ActionCode. CustomerProjectInvoicingAgreement includes the following non-node elements: BaseCustomerTransactionDocumentID, BaseCustomerTransactionDocumentUUID, and CustomerProjectInvoicingAgreementReference. BaseCustomerTransactionDocumentID may be based on datatype GDT:BusinessTransactionDocumentID. BaseCustomerTransactionDocumentUUID may be based on datatype GDT:UUID. CustomerProjectInvoicingAgreementReference may be based on datatype GDT:BusinessTransactionDocumentReference.

CustomerProjectInvoicingAgreement includes the node elements Item in a 1:N cardinality relationship. The CustomerProjectInvoicingAgreementItem package includes the Item entity. Item includes the following non-node elements: BaseCustomerTransactionDocumentItemID, BaseCustomerTransactionDocumentItemUUID, FulfillmentProcessingStatusCode, InvoiceProcessingStatusCode, and CustomerProjectInvoicingAgreementItemReference. BaseCustomerTransactionDocumentItemID may be based on datatype GDT:BusinessTransactionDocumentItemID. BaseCustomerTransactionDocumentItemUUID may be optional and may be based on datatype GDT:UUID. FulfillmentProcessingStatusCode may be based on datatype GDT:NOTSTARTEDINPROCESSFINISHED_ProcessingStatusCode. InvoiceProcessingStatusCode may be based on datatype GDT:NOTSTARTEDINPROCESSFINISHED_ProcessingStatusCode. CustomerProjectInvoicingAgreementItemReference may be based on datatype GDT:BusinessTransactionDocumentReference.

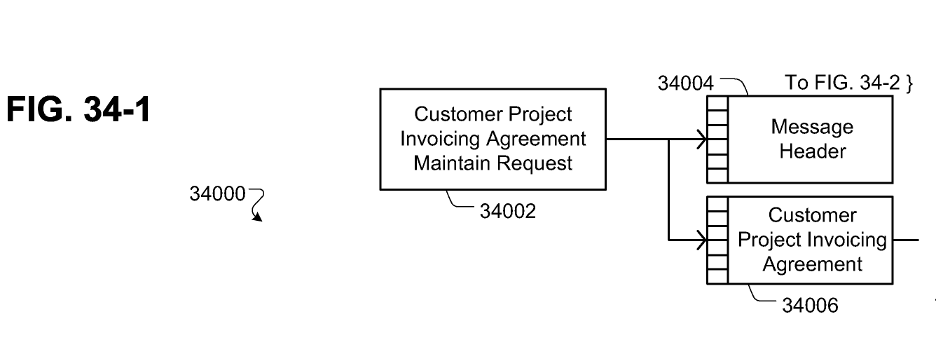

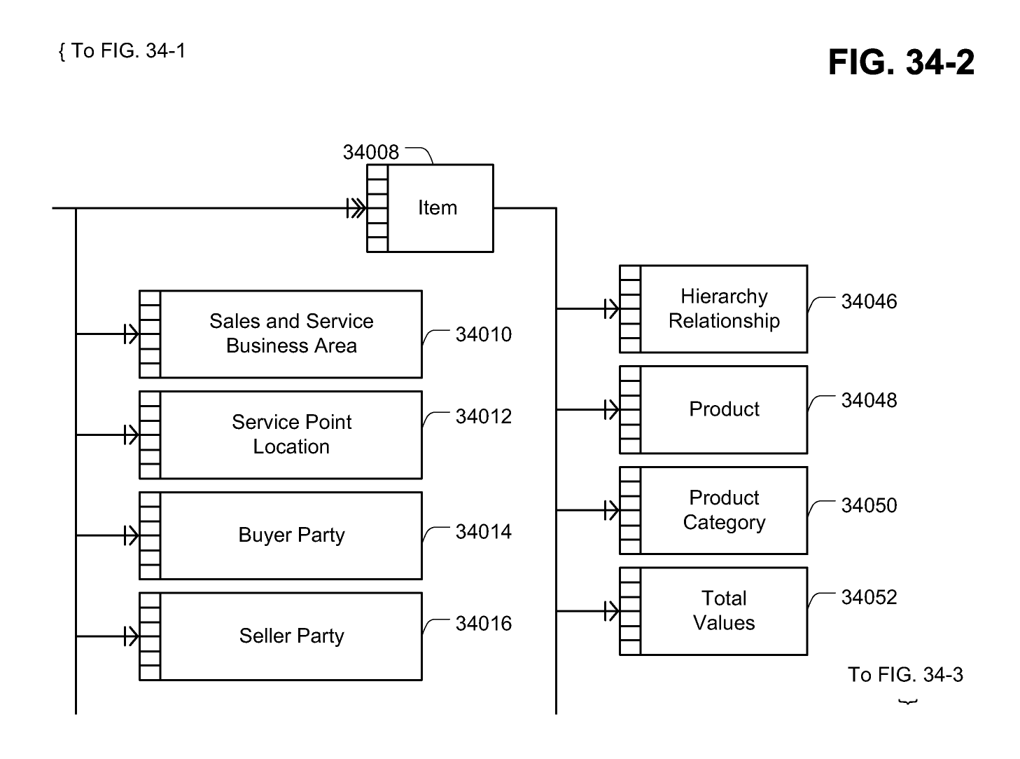

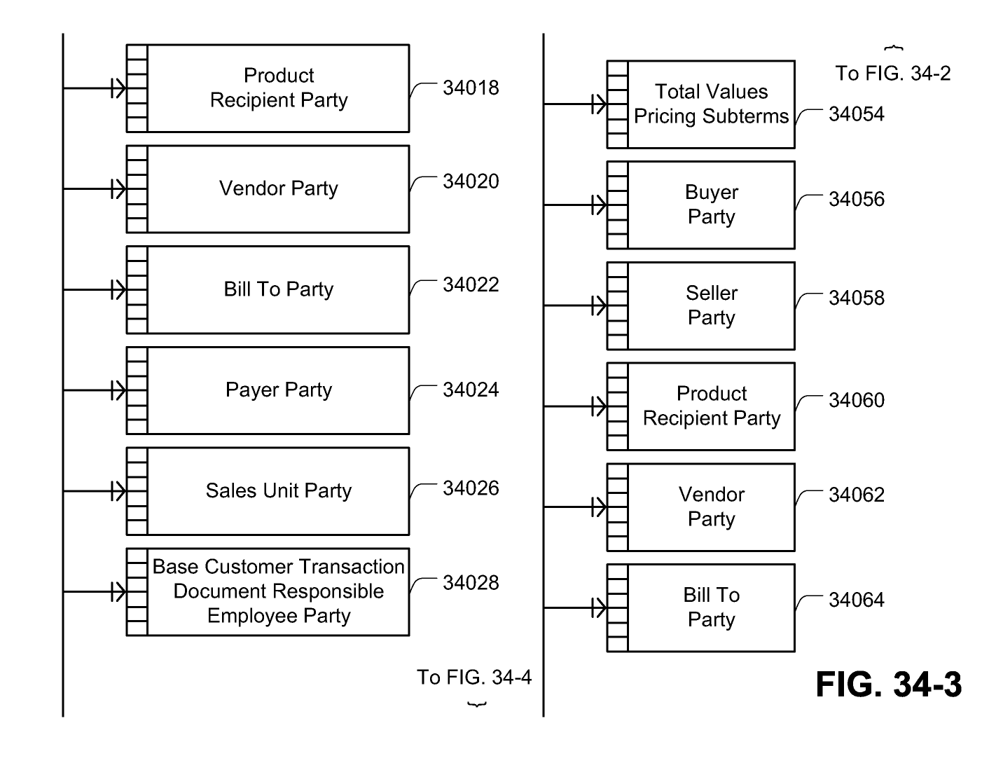

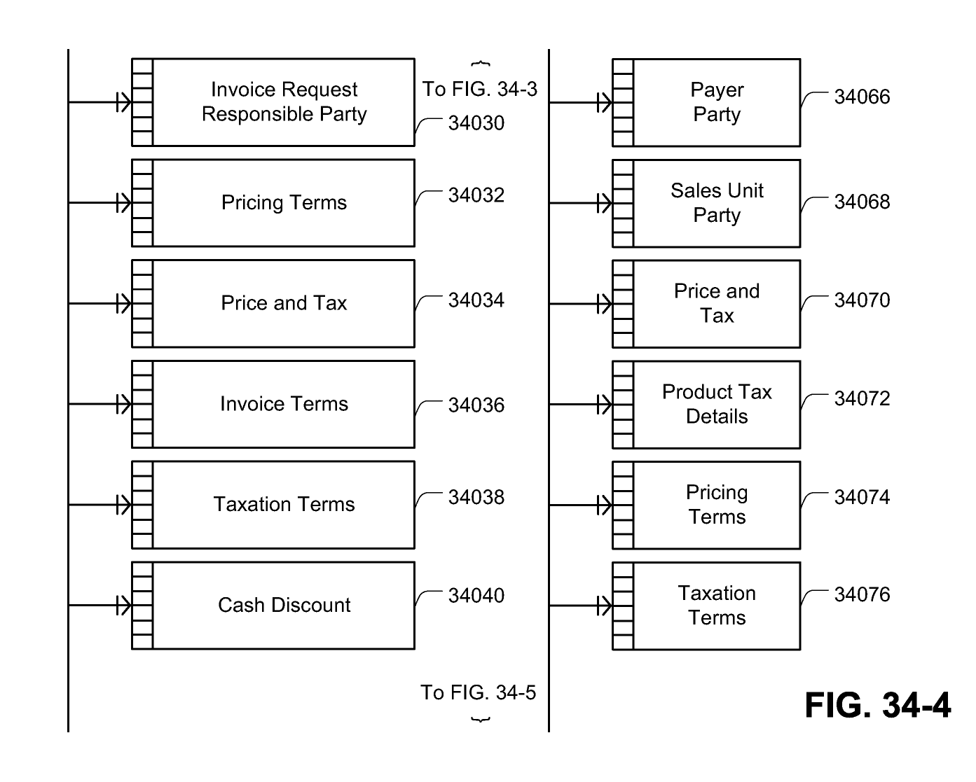

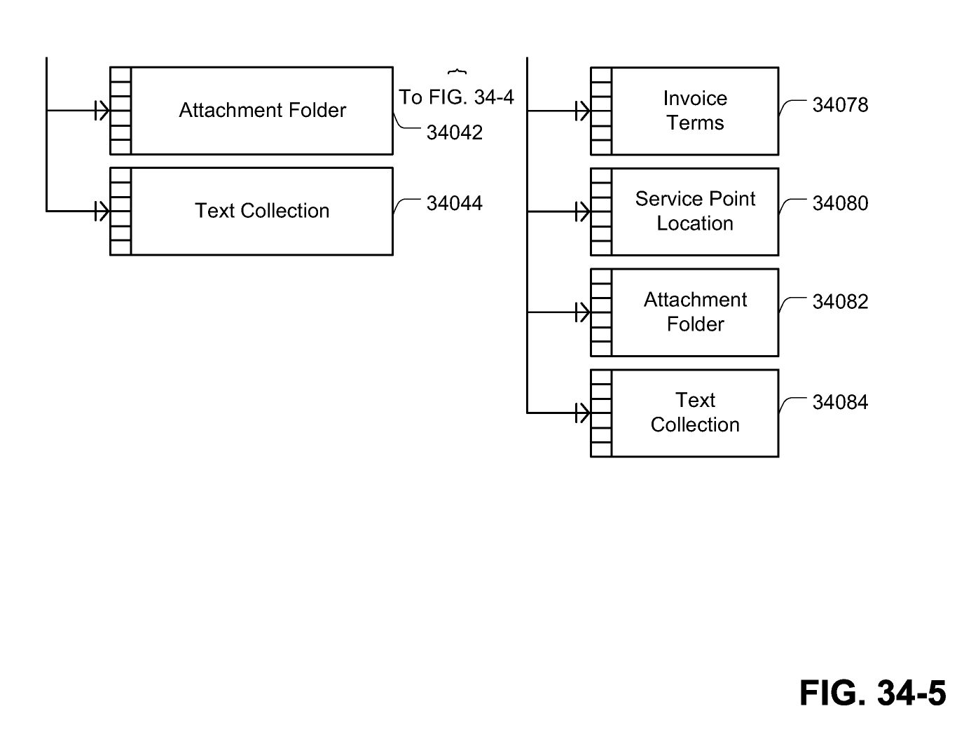

FIGS. 34-1 through 34-5 depict an example Customer Project Invoicing Agreement Maintain Request Message Data Type 34000, which comprises elements 34002-34084, hierarchically related as shown. For example, the Customer Project Invoicing Agreement Maintain Request 34002 includes a Message Header 34004.

The message type Customer Project Invoicing Agreement Maintain Request is derived from the business object Customer Project Invoicing Agreement as a leading object together with its operation signature. The message type Customer Project Invoicing Agreement Maintain Request is a request to the CustomerProjectInvoicePreparation for updating information used for Customer Project Invoice Preparations related to a base Customer Transaction Document. The structure of the message type Customer Project Invoicing Agreement Maintain Request is determined by the message data type CustomerProjectInvoicingAgreementMessage. The message data type CustomerProjectInvoicingAgreementMessage includes the object CustomerProjectInvoicingAgreement which is included in a business document, business information that is relevant for sending a business document in a message, the MessageHeader package, and the CustomerProjectInvoicingAgreement package. The message data type CustomerProjectInvoicingAgreementMessage provides a structure for the message type Customer Project Invoicing Agreement Maintain Request and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader. The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT: BusinessDocumentMessageHeaderParty. RecipientParty is of the type GDT:BusinessDocumentMessageHeaderParty. RecipientParty is the partner responsible for receiving a business document at a business application level.

The CustomerProjectInvoicingAgreement package is a grouping of CustomerProjectInvoicingAgreement with its PartyInformation and Item packages and with the CustomerProjectInvoicingAgreement entity. CustomerProjectInvoicingAgreement is an agreement between a seller and a customer that defines how the expenses related to a customer project are to be invoiced for an agreed output. CustomerProjectInvoicingAgreement includes the following attributes: ReconciliationPeriodCounterValue, ActionCode, and ItemListCompleteTransmissionIndicator. ReconciliationPeriodCounterValue is a counter for a reconciliation period. A reconciliation period is the time between two consecutive reconciliation messages in the same sequence context. ReconciliationPeriodCounterValue may be based on datatype GDT:CounterValue. ActionCode is a coded representation of an instruction to the recipient of a CustomerProjectInvoicingAgreementMaintainRequest describing whether to create a new or update an existing CustomerProject-InvoicingAgreement, and may be based on datatype GDT:ActionCode. ItemListCompleteTransmissionIndicator may be optional and may be based on datatype CDT:Indicator.

CustomerProjectInvoicingAgreement includes the following non-node elements: BaseCustomerTransactionDocumentID, BaseCustomerTransactionDocumentUUID, BaseCustomerTransactionDocumentName, BaseCustomerTransactionDocumentTypeCode, BaseCustomerTransactionDocumentDateTime, Buyer, BuyerDateTime, and BuyerName. BaseCustomerTransactionDocumentID is a unique identifier for a base customer transaction document associated to a CustomerProjectInvoicingAgreement. This base customer transaction document (e.g., a Sales Order) is the base document in the process component SalesOrderProcessing sending the message. BaseCustomerTransactionDocumentID may be based on datatype GDT:BusinessTransactionDocumentID. BaseCustomerTransactionDocumentUUID may be optional, is an internally assigned, universally unique identifier for a base customer transaction document associated to a CustomerProjectInvoicingAgreement, and may be based on datatype GDT:UUID. BaseCustomerTransactionDocumentName may be optional, is a short-text description of a base customer transaction document associated to a CustomerProjectInvoicingAgreement, and may be based on datatype CDT:EXTENDED_Name. BaseCustomerTransactionDocumentTypeCode is a coded representation of a type of a base customer transaction document associated to a CustomerProjectInvoicingAgreement, and may be based on datatype GDT:BusinessTransactionDocumentTypeCode. BaseCustomerTransactionDocumentDateTime may be optional, is a point in time at which a base customer transaction document becomes effective in financial accounting where the period balances of the concerned accounts change, and may be based on datatype CDT:GLOBAL_DateTime. Buyer ID may be optional, is a unique identifier for a base customer transaction document assigned by a buyer, and may be based on datatype GDT:BusinessTransactionDocumentID. BuyerDateTime may be optional, is a posting time of a base customer transaction document assigned by a buyer, and may be based on datatype CDT:GLOBAL_DateTime. BuyerName may be optional, is a short-text description for a base customer transaction document assigned by a buyer, and may be based on datatype CDT:MEDIUM_Name.

CustomerProjectInvoicingAgreement has relationships with the following node elements: SalesAndServiceBusinessArea in a 1:C cardinality relationship, ServicePointLocation in a 1:C cardinality relationship, BuyerParty in a 1:C cardinality relationship, SellerParty in a 1:C cardinality relationship, ProductRecipientParty in a 1:C cardinality relationship, VendorParty in a 1:C cardinality relationship, BillToParty in a 1:C cardinality relationship, PayerParty in a 1:C cardinality relationship, SalesUnitParty in a 1:C cardinality relationship, BaseCustomerTransactionDocumentResponsibleEmployeeParty in a 1:C cardinality relationship, InvoiceRequestResponsibleParty in a 1:C cardinality relationship, PricingTerms in a 1:C cardinality relationship, PriceAndTax in a 1:C cardinality relationship, InvoiceTerms in a 1:C cardinality relationship, TaxationTerms in a 1:C cardinality relationship, CashDiscount in a 1:C cardinality relationship, AttachmentFolder in a 1:C cardinality relationship, TextCollection in a 1:C cardinality relationship, PaymentControl in a 1:C cardinality relationship, and Item in a 1:N cardinality relationship.

SalesAndServiceBusinessArea is a business or service specific area within an enterprise that is valid for a base CustomerTransactionDocument, such as, for example, sales organization, service organization, distribution channel, and division. Sales Organisation is an organisational centre that structures a company according to its sales requirements. A sales organization is responsible for selling materials and services. A Sales Group is an organizational centre that performs and is responsible for sales transactions. A Sales Office is an organizational center in a geographical area of a sales organization. A sales office establishes contact between a firm and a regional market. A Service Organisation is an organizational centre where services are planned and prepared. A service organization is responsible for the commercial success within an existing organizational structure. A Distribution Channel is a channel through which saleable materials or services reach customers. SalesAndServiceBusinessArea includes the following non-node elements: DistributionChannelCode, SalesOrganisationID, SalesOrganisationUUID, SalesGroupID, SalesGroupUUID, SalesOfficeID, SalesOfficeUUID, ServiceOrganisationID, and ServiceOrganisationUUID.

DistributionChannelCode may be optional, is a coded representation of the distribution channel by which goods and services, and may be based on datatype GDT:DistributionChannelCode SalesOrganisationID may be optional, is an identifier for a sales organization that is responsible for an underlying business transaction document, and may be based on datatype GDT:OrganisationalCentreID. SalesOrganisationUUID may be optional, is a universally unique identifier for a sales organization, and may be based on datatype GDT:UUID. SalesGroupID may be optional, is an identifier for a sales group that is responsible for an underlying business transaction document, and may be based on datatype GDT:OrganisationalCentreID. SalesGroupUUID may be optional, is a universally unique identifier for a sales group, and may be based on datatype GDT:UUID. SalesOfficeID may be optional, is an identifier for a sales office that is responsible for an underlying business transaction document, and may be based on datatype GDT:OrganisationalCentreID. SalesOfficeUUID may be optional, is a universally unique identifier for a sales office, and may be based on datatype GDT:UUID. ServiceOrganisationID may be optional, is an identifier for a service organization that is responsible for an underlying business transaction document, and may be based on datatype GDT:OrganisationalCentreID. ServiceOrganisationUUID may be optional, is a universally unique identifier for a service organization, and may be based on datatype GDT:UUID.

ServicePointLocation is a Location at which services are provided. ServicePointLocation is typed by BusinessTransactionDocumentLocation. The CustomerProjectInvoicingAgreementPartyInformation package includes the following entities: BuyerParty, SellerParty, ProductRecipientParty, VendorParty, BillToParty, PayerParty, SalesUnitParty, BaseCustomerTransactionDocumentResponsibleEmployeeParty, and InvoiceRequestResponsibleParty. A BuyerParty is a company or person that purchases goods or services. BuyerParty is typed by BusinessTransactionDocumentParty. A SellerParty is a company or person that sells goods or services. SellerParty is typed by BusinessTransactionDocumentParty. SellerParty can also fulfill the functions of VendorParty, BillFromParty or PayeeParty. A ProductRecipientParty is a company or person to whom goods are delivered or for whom services are provided. ProductRecipientParty is typed by BusinessTransactionDocumentParty. If no ShipToLocation is explicitly specified, the ProductRecipientParty address is the delivery address. If no ProductRecipientParty is explicitly specified, the BuyerParty acts as ProductRecipientParty. A VendorParty is a company or person that delivers goods or provides services. VendorParty is typed by BusinessTransactionDocumentParty. A BillToParty is a company or person to which an invoice for goods or services is sent. BillToParty is typed by BusinessTransactionDocumentParty. If no BillToParty is explicitly specified, the BuyerParty acts as BillToParty. A PayerParty is a company or person that pays for goods or services. PayerParty is typed by BusinessTransactionDocumentParty. If no PayerParty is explicitly specified, the BillToParty acts as PayerParty. SalesUnitParty is typed by BusinessTransactionDocumentParty. BaseCustomerTransactionDocumentResponsibleEmployeeParty is a person employee that is responsible for an underlying business document. BaseCustomerTransactionDocumentResponsibleEmployeeParty is typed by BusinessTransactionDocumentParty. InvoiceRequestResponsibleParty is a party that is responsible for an invoice request. InvoiceRequestResponsibleParty is typed by BusinessTransactionDocumentParty. PricingTerms include agreements in a sales or service process that are used to determine the net value of a customer project invoice.

PricingTerms includes the following non-node elements: CurrencyCode, PricingProcedureCode, PriceDateTime, and CustomerGroupCode. CurrencyCode is a coded representation of a currency, and may be based on datatype GDT:CurrencyCode. PricingProcedureCode may be based on datatype GDT:PricingProcedureCode. PriceDateTime may be optional, is a date and time used to determine price components for a sales order associated with a customer project invoicing agreement, and may be based on datatype CDT:LOCALNORMALISED_DateTime. CustomerGroupCode may be optional, and is a coded representation of a group of customers. CustomerGroupCode may be used for pricing and statistics purposes. Examples codes include: industrial enterprise, commercial enterprise, and private customer. CustomerGroupCode may be based on datatype GDT:CustomerGroupCode.

PriceAndTax includes the following non-node elements: GrossAmount, NetAmount, and TaxAmount. GrossAmount may be optional and may be based on datatype CDT:Amount. NetAmount may be optional and may be based on datatype CDT:Amount. TaxAmount may be optional and may be based on datatype CDT:Amount. InvoiceTerms include agreements that apply for invoicing goods and services in a customer project invoicing process. InvoiceTerms includes the following non-node elements: ProposedInvoiceDate and InvoicingBlockingReasonCode. ProposedInvoiceDate may be optional, is a proposal for the invoice date of a customer invoice item to be created for a customer project invoicing agreement item, and may be based on datatype CDT:Date. InvoicingBlockingReasonCode may be optional, is a coded representation of a reason for blocking an invoicing process, and may be based on datatype GDT: InvoicingBlockingReasonCode.

TaxationTerms includes the following non-node elements: SellerCountryCode, SellerTaxID, SellerTaxIdentificationNumberTypeCode, BuyerCountryCode, BuyerTaxID, BuyerTaxIdentificationNumberTypeCode, EuropeanCommunityVATTriangulationIndicator, TaxDate, TaxDueDate, TaxExemptionCertificateID, CustomerTaxExemptionCertificateTaxExemptionReasonUUID, TaxExemptionReasonCode, and TaxExemptionReasonCodeRelevanceIndicator. SellerCountryCode may be optional, and may be based on datatype GDT:CountryCode. SellerTaxID may be optional, and may be based on datatype GDT:PartyTaxID. SellerTaxIdentificationNumberTypeCode may be optional, and may be based on datatype GDT:TaxIdentificationNumberTypeCode. BuyerCountryCode may be optional, and may be based on datatype GDT:CountryCode. BuyerTaxID may be optional, and may be based on datatype GDT:PartyTaxID. BuyerTaxIdentificationNumberTypeCode may be optional, and may be based on datatype GDT:TaxIdentificationNumberTypeCode. EuropeanCommunityVATTriangulationIndicator may be optional, and may be based on datatype CDT:Indicator. TaxDate may be optional, is a date when a tax is incurred, and may be based on datatype CDT:Date, with a qualifier of Tax. TaxDueDate may be optional, and may be based on datatype CDT:Date. TaxExemptionCertificateID may be optional, is an identifier of a certificate sent by a customer to a seller claiming exemption from product tax for purchases, and may be based on datatype GDT:TaxExemptionCertificateID. CustomerTaxExemptionCertificateTaxExemptionReasonUUID may be optional, is a universally unique identifier of a tax exemption reason of a customer tax exemption certificate, and may be based on datatype GDT:UUID. TaxExemptionReasonCode may be optional, is a coded representation of a reason for a tax exemption, and may be based on datatype GDT:TaxExemptionReasonCode. TaxExemptionReasonCodeRelevanceIndicator may be optional, and may be based on datatype CDT:Indicator. CashDiscount includes the following non-node elements: CashDiscountTerms and CashDiscountLevelCode. CashDiscountTerms may be optional and may be based on datatype GDT:CashDiscountTerms. CashDiscountLevelCode may be optional and may be based on datatype GDT: CashDiscountLevelCode. AttachmentFolder includes agreements that apply for invoicing goods and services in the customer project invoicing process. AttachmentFolder is typed by AttachmentFolder. TextCollection is a set of multilingual textual descriptions including formatting information of a base customer transaction document. TextCollection is typed by TextCollection. PaymentControl is typed by PaymentControl_V1.

The CustomerProjectInvoicingAgreementItem package includes the Item entity. Item is a summarization of information from a customer transaction document item that is to be taken into account for customer project invoices related to a customer transaction document item. Item includes the ActionCode attribute. ActionCode is a coded representation of an instruction to a recipient of a message of type CustomerProjectInvoicingAgreementMaintainRequest describing whether to create a new or update an existing CustomerProjectInvoicingAgreementItem. ActionCode may be based on datatype GDT:ActionCode.

CustomerProjectInvoicingAgreementItem includes the following non-node elements: BaseCustomerTransactionDocumentItemID, BaseCustomerTransactionDocumentItemUUID, BaseCustomerTransactionDocumentItemTypeCode, BaseCustomerTransactionDocumentItemDescription, BaseCustomerTransactionDocumentItemDateTime, CancellationReasonCode, BuyerID, BuyerDateTime, BuyerName, ProjectReference, CustomerProjectInvoicingMethodCode, and CashDiscountDeductibleIndicator. BaseCustomerTransactionDocumentItemID is a unique identifier for an item in a base customer transaction document associated to a CustomerProjectInvoicingAgreementItem, and may be based on datatype GDT:BusinessTransactionDocumentItemID. BaseCustomerTransactionDocumentItemUUID may be optional, is an internally assigned, universally unique identifier for an item in a base customer transaction document associated to a CustomerProjectInvoicingAgreementItem, and may be based on datatype GDT:UUID. BaseCustomerTransactionDocumentItemTypeCode is coded representation of the type of a base customer transaction document item associated to a CustomerProjectInvoicingAgreementItem, and may be based on datatype GDT:BusinessTransactionDocumentItemTypeCode. BaseCustomerTransactionDocumentItemDescription may be optional, is a short description of a base customer transaction document item associated to a CustomerProjectInvoicingAgreementItem, and may be based on datatype GDT: SHORT_Description. BaseCustomerTransactionDocumentItemDateTime may be optional, is a point in time at which a base customer transaction document item becomes effective in financial accounting and where period balances of concerned accounts change, and may be based on datatype CDT:GLOBAL_DateTime. CancellationReasonCode may be optional, is a coded representation of a rejection reason for a business transaction, and may be based on datatype GDT:CancellationReasonCode. BuyerID may be optional, is a unique identifier of an item associated with a customer project invoicing agreement item as assigned by a buyer, and may be based on datatype GDT:BusinessTransactionDocumentItemID. BuyerDateTime may be optional, is a posting time of an item associated with a customer project invoicing agreement item as assigned by a buyer, and may be based on datatype CDT:GLOBAL_DateTime. BuyerName may be optional, is a short-text description of a sales order item associated with a customer project invoicing agreement item as assigned by a buyer, and may be based on datatype CDT:MEDIUM_Name. ProjectReference may be optional, and may be based on datatype GDT:ProjectReference. CustomerProjectInvoicingMethodCode may be based on datatype GDT:CustomerProjectInvoicingMethodCode. CashDiscountDeductibleIndicator may be optional, and may be based on datatype CDT:Indicator.

CustomerProjectInvoicingAgreementItem has relationships with the following node elements: HierarchyRelationship in a 1:C cardinality relationship, Product in a 1:C cardinality relationship, TotalValues in a 1:C cardinality relationship, BuyerParty in a 1:C cardinality relationship, SellerParty in a 1:C cardinality relationship, ProductRecipientParty in a 1:C cardinality relationship, VendorParty in a 1:C cardinality relationship, BillToParty in a 1:C cardinality relationship, PayerParty in a 1:C cardinality relationship, SalesUnitParty in a 1:C cardinality relationship, PriceAndTax in a 1:C cardinality relationship, ProductTaxDetails in a 1:CN cardinality relationship, PricingTerms in a 1:C cardinality relationship, TaxationTerms in a 1:C cardinality relationship, InvoiceTerms in a 1:C cardinality relationship, ServicePointLocation in a 1:C cardinality relationship, AttachmentFolder in a 1:C cardinality relationship, and TextCollection in a 1:C cardinality relationship.

HierarchyRelationship is a relationship between a subitem and a parent item to describe item hierarchies. HierarchyRelationship includes the following non-node elements: ParentItemUUID and TypeCode. ParentItemUUID is an identifier of a parent item in an item hierarchy of a customer project invoicing agreement, and may be based on datatype GDT:UUID. TypeCode is a coded representation of the type of relationship of a subitem with its hierarchically higher parent item, and may be based on datatype GDT:BusinessTransactionDocumentItemHierarchyRelationship TypeCode. The CustomerProjectInvoicingAgreementItemProductInformation package includes the Product entity. Product is a commodity that is the object of the business activity of a company and serves to generate value for this company. A product can be tangible or intangible. A product can have relationships to other products or objects. For example, there can be a service for a specially manufactured product. Product is typed by BusinessTransactionDocumentProduct.

The CustomerProjectInvoicingAgreementItemTotalValues package includes the TotalValues entity. TotalValues includes total values of a base customer transaction document item resulting from dependent nodes of the item. TotalValues includes the following non-node elements: RequestedQuantity, RequestedQuantityTypeCode, NetAmount, NetPrice, TaxAmount, and GrossAmount. RequestedQuantity may be optional, and may be based on datatype CDT:Quantity. RequestedQuantityTypeCode may be optional, and may be based on datatype GDT:QuantityTypeCode. NetAmount may be optional, and may be based on datatype CDT:Amount. NetPrice may be optional, and may be based on datatype GDT:Price. TaxAmount may be optional, and may be based on datatype CDT:Amount. GrossAmount may be optional, and may be based on datatype CDT:Amount.

The CustomerProjectInvoicingAgreementItemPartyInformation package includes the following entities: BuyerParty, SellerParty, ProductRecipientParty, VendorParty, BillToParty, PayerParty, and SalesUnitParty. A BuyerParty is a company or person that purchases goods or services. BuyerParty is typed by BusinessTransactionDocumentParty. A SellerParty is a company or person that sells goods or services. SellerParty is typed by BusinessTransactionDocumentParty. A ProductRecipientParty is a company or person to whom goods are delivered or for whom services are provided. ProductRecipientParty is typed by BusinessTransactionDocumentParty. A VendorParty is a company or person that delivers goods or provides services. VendorParty is typed by BusinessTransactionDocumentParty. A BillToParty is a company or person to which the invoice for goods or services is sent. BillToParty is typed by BusinessTransactionDocumentParty. A PayerParty is a company or person that pays for goods or services. PayerParty is typed by BusinessTransactionDocumentParty. SalesUnitParty is typed by BusinessTransactionDocumentParty.

PriceAndTax includes the PriceComponent non-node element, which may be based on datatype GDT:PriceComponent. ProductTaxDetails includes the ProductTaxationCharacteristicsCode non-node element, which may be optional and which may be based on datatype GDT:ProductTaxationCharacteristicsCode. ProductTaxDetails includes the node element ProductTax in a 1:1 cardinality relationship, and the node element TransactionCurrencyProductTax in a 1:1 cardinality relationship. ProductTax is typed by ProductTax. TransactionCurrencyProductTax is typed by ProductTax. PricingTerms includes agreements in a sales or service process which are used to determine a net value of a CustomerProjectInvoicingAgreementItem. PricingTerms includes the PriceDateTime non-node element, which may be optional and which may be based on datatype CDT:LOCALNORMALISED_DateTime.

TaxationTerms includes the following non-node elements: SellerCountryCode, SellerTaxID, SellerTaxIdentificationNumberTypeCode, BuyerCountryCode, BuyerTaxID, BuyerTaxIdentificationNumberTypeCode, EuropeanCommunityVATTriangulationIndicator, TaxDate, TaxDueDate, TaxExemptionCertificateID, CustomerTaxExemptionCertificateTaxExemptionReasonUUID, TaxExemptionReasonCode, TaxExemptionReasonCodeRelevanceIndicator, FollowUpTaxExemptionCertificateID, and FollowUpCustomerTaxExemptionCertificateTaxExemptionReasonUUID. SellerCountryCode may be optional, and may be based on datatype GDT:CountryCode. SellerTaxID may be optional, and may be based on datatype GDT:PartyTaxID. SellerTaxIdentificationNumberTypeCode may be optional, and may be based on datatype GDT:TaxIdentificationNumberTypeCode. BuyerCountryCode may be optional, and may be based on datatype GDT:CountryCode. BuyerTaxID may be optional, and may be based on datatype GDT:PartyTaxID. BuyerTaxIdentificationNumberTypeCode may be optional, and may be based on datatype GDT:TaxIdentificationNumberTypeCode. EuropeanCommunityVATTriangulationIndicator may be optional, and may be based on datatype CDT:Indicator. TaxDate may be optional, is a date when a tax is incurred, and may be based on datatype CDT:Date, with a qualifier of Tax. TaxDueDate may be optional, and may be based on datatype CDT:Date. TaxExemptionCertificateID may be optional, is an identifier of a certificate sent by a customer to a seller claiming exemption from product tax for purchases, and may be based on datatype GDT:TaxExemptionCertificateID CustomerTaxExemptionCertificateTaxExemptionReasonUUID may be optional, is a universally unique identifier of a tax exemption reason of a customer tax exemption certificate, and may be based on datatype GDT:UUID. TaxExemptionReasonCode may be optional, is a coded representation of a reason for a tax exemption, and may be based on datatype GDT:TaxExemptionReasonCode. TaxExemptionReasonCodeRelevanceIndicator may be optional, is an indicator for whether to use the TaxExemptionReasonCode, and may be based on datatype CDT:Indicator. FollowUpTaxExemptionCertificateID may be optional, and may be based on datatype GDT:TaxExemptionCertificateID. FollowUpCustomerTaxExemptionCertificateTaxExemptionReasonUUID may be optional, is a universally unique identifier of a tax exemption reason of an additional customer tax exemption certificate, and may be based on datatype GDT:UUID.

InvoiceTerms includes item-specific agreements that apply for invoicing goods and services in a CustomerTransactionDocumentTemplate document. InvoiceTerms includes the ProposedInvoiceDate non-node element, which may be optional and which may be based on datatype CDT:Date. ServicePointLocation is a Location at which services are provided. ServicePointLocation is typed by BusinessTransactionDocumentLocation. AttachmentFolder is a collection of documents attached to an item of a base customer transaction document. AttachmentFolder is typed by AttachmentFolder. TextCollection is a collection of natural-language texts that refer to an item in a base customer transaction document. TextCollection is typed by TextCollection.

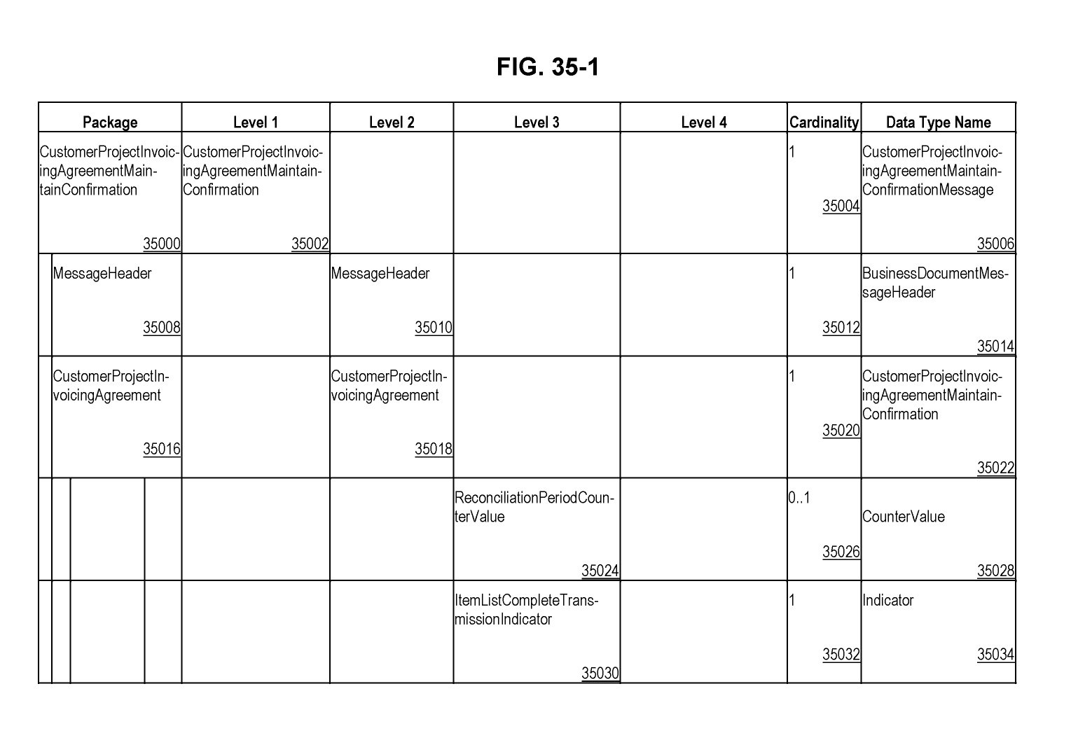

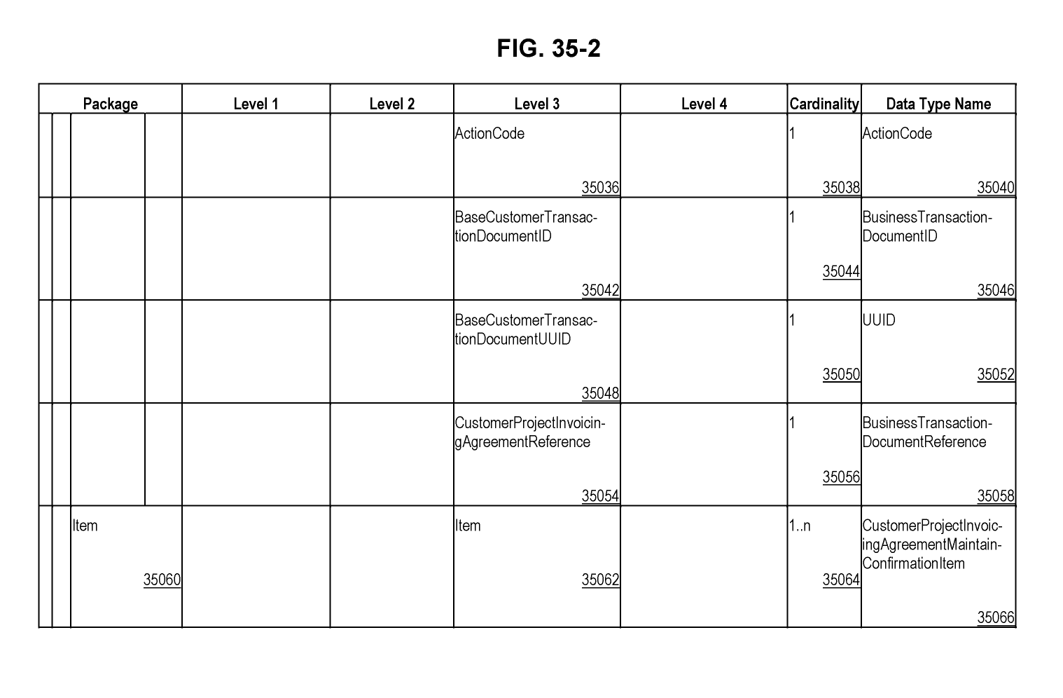

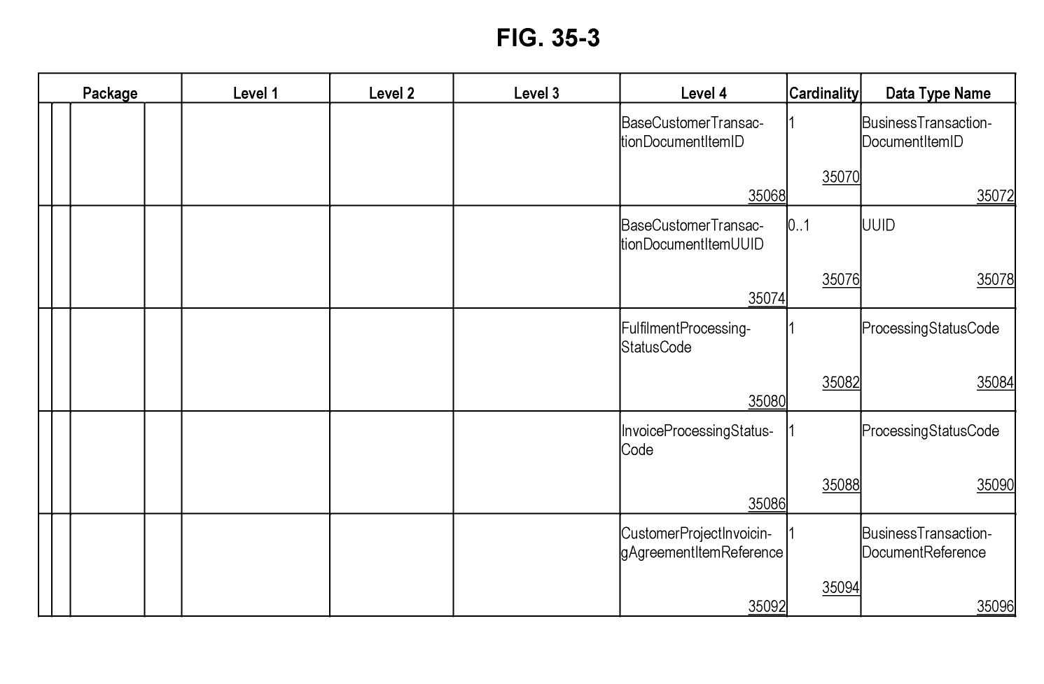

FIGS. 35-1 through 35-3 show an example configuration of an Element Structure that includes a CustomerProjectInvoicingAgreementMaintainConfirmation 35000 package. Specifically, these figures depict the arrangement and hierarchy of various components such as one or more levels of packages, entities, and datatypes, shown here as 35000 through 35096. As described above, packages may be used to represent hierarchy levels. Entities are discrete business elements that are used during a business transaction. Data types are used to type object entities and interfaces with a structure. For example, the CustomerProjectInvoicingAgreementMaintainConfirmation 35000 includes, among other things, a CustomerProjectInvoicingAgreementMaintainConfirmation 35002. Accordingly, heterogeneous applications may communicate using this consistent message configured as such.

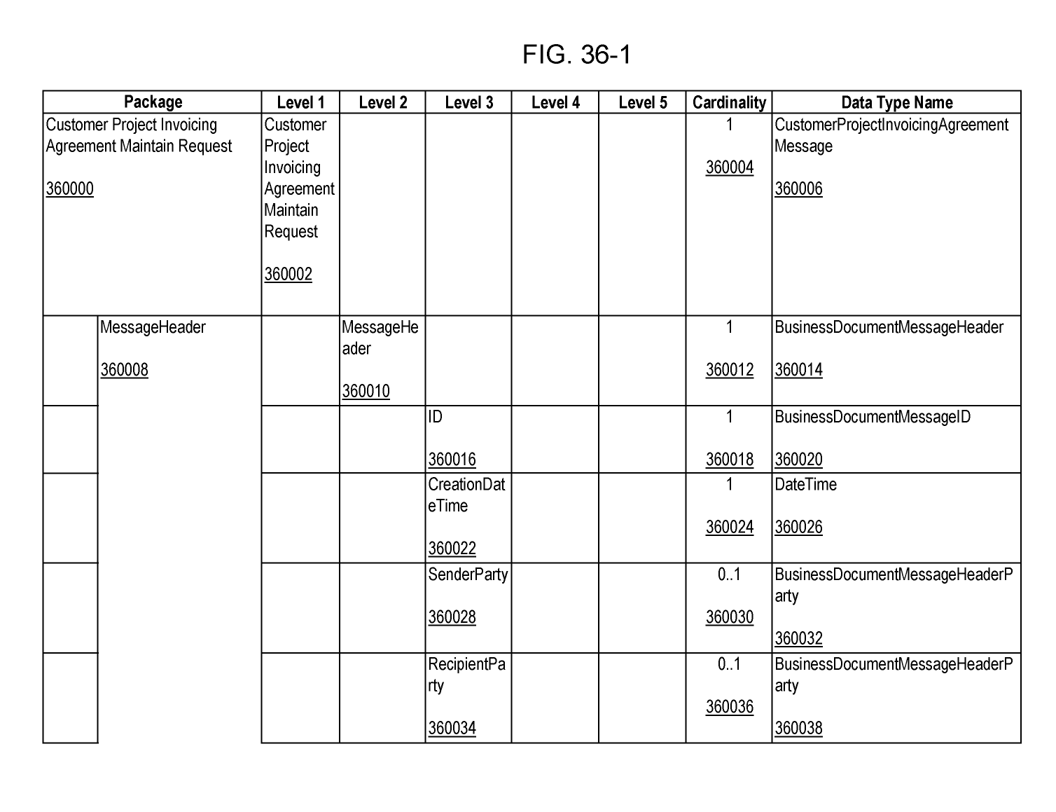

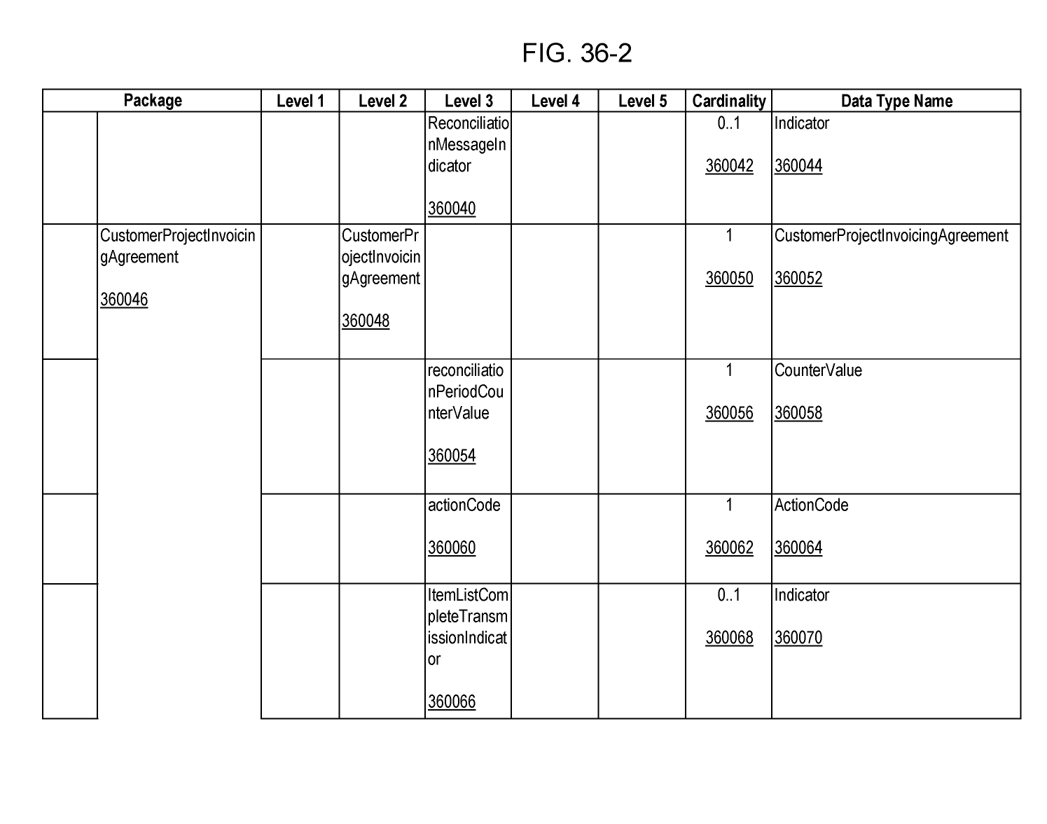

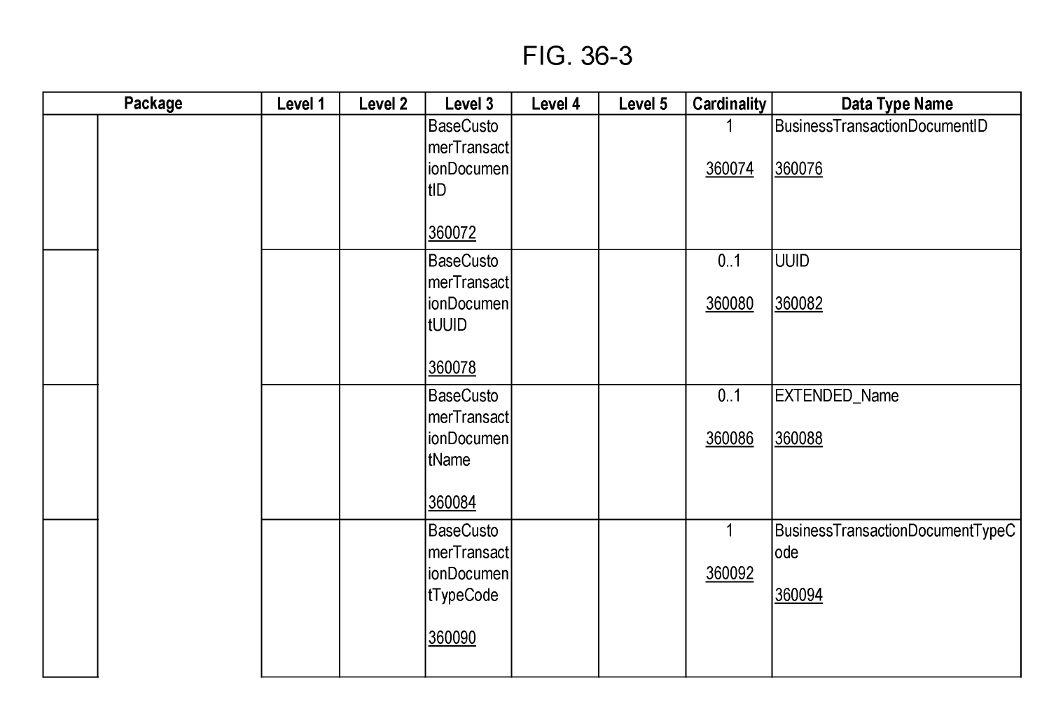

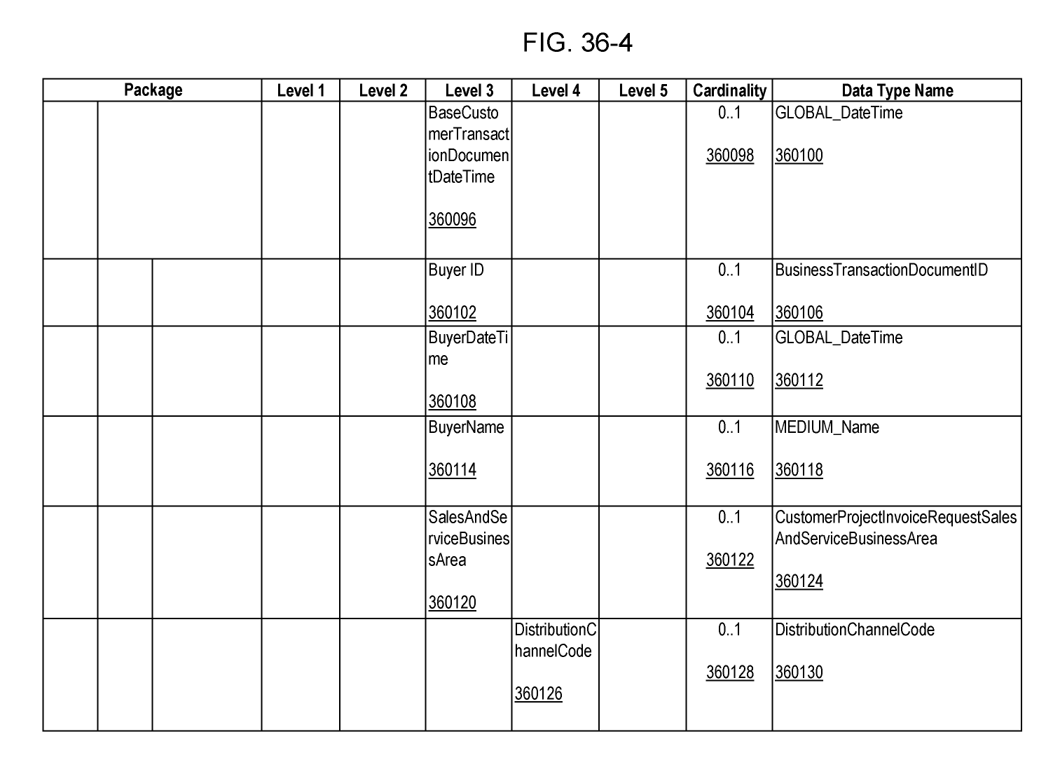

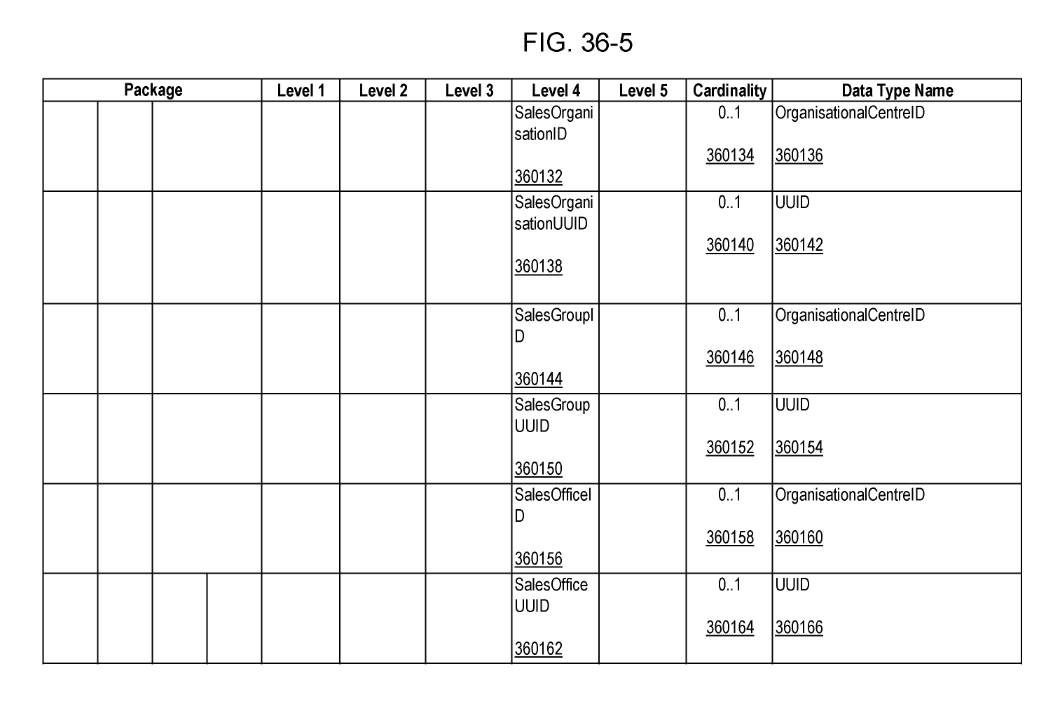

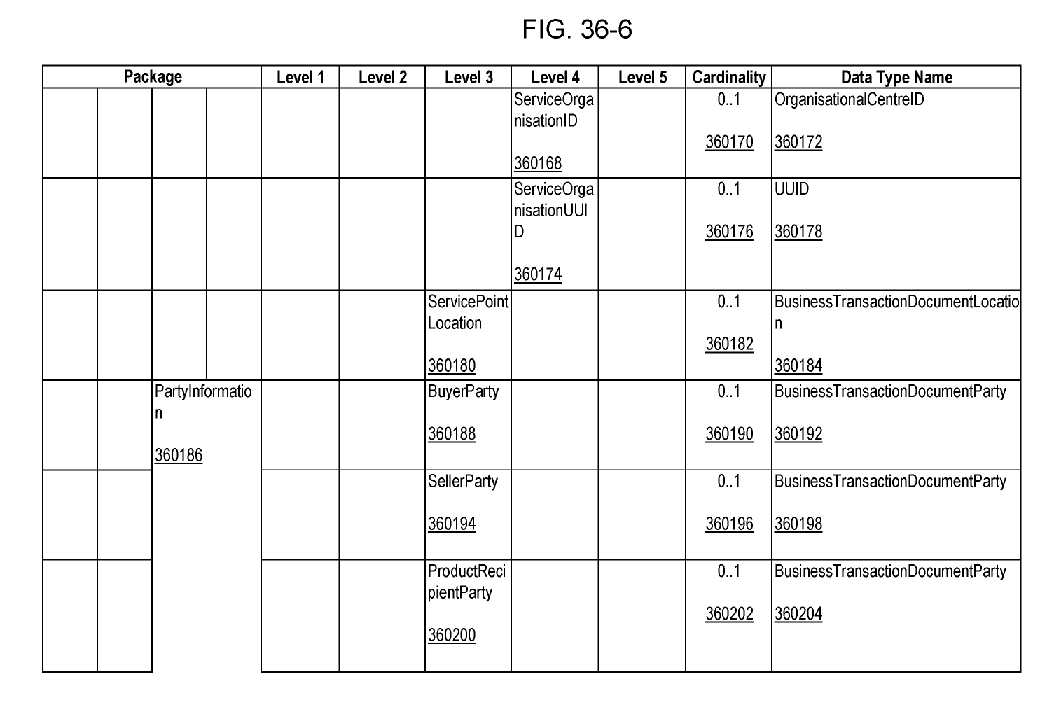

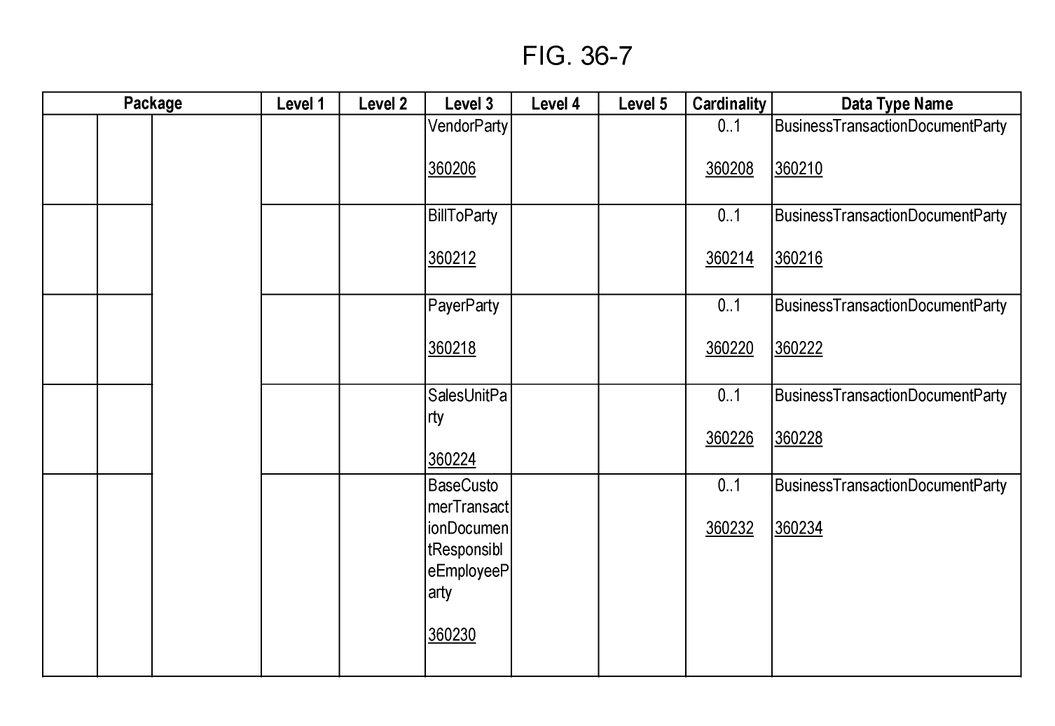

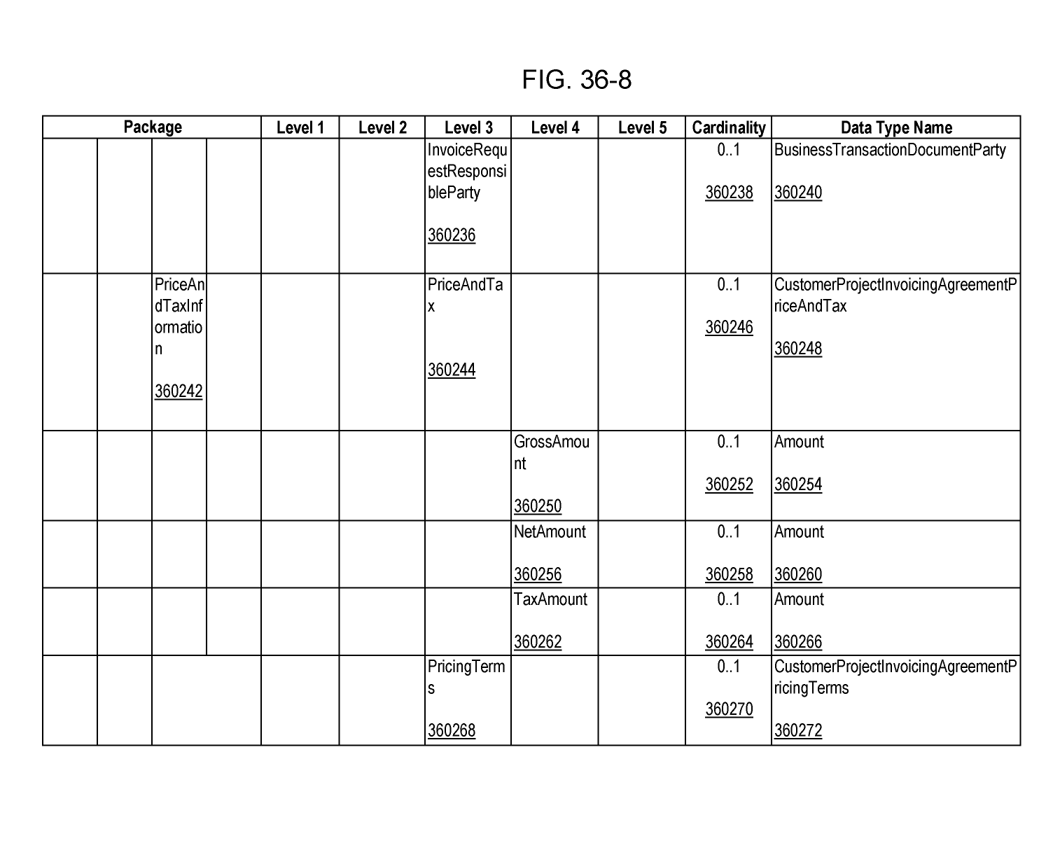

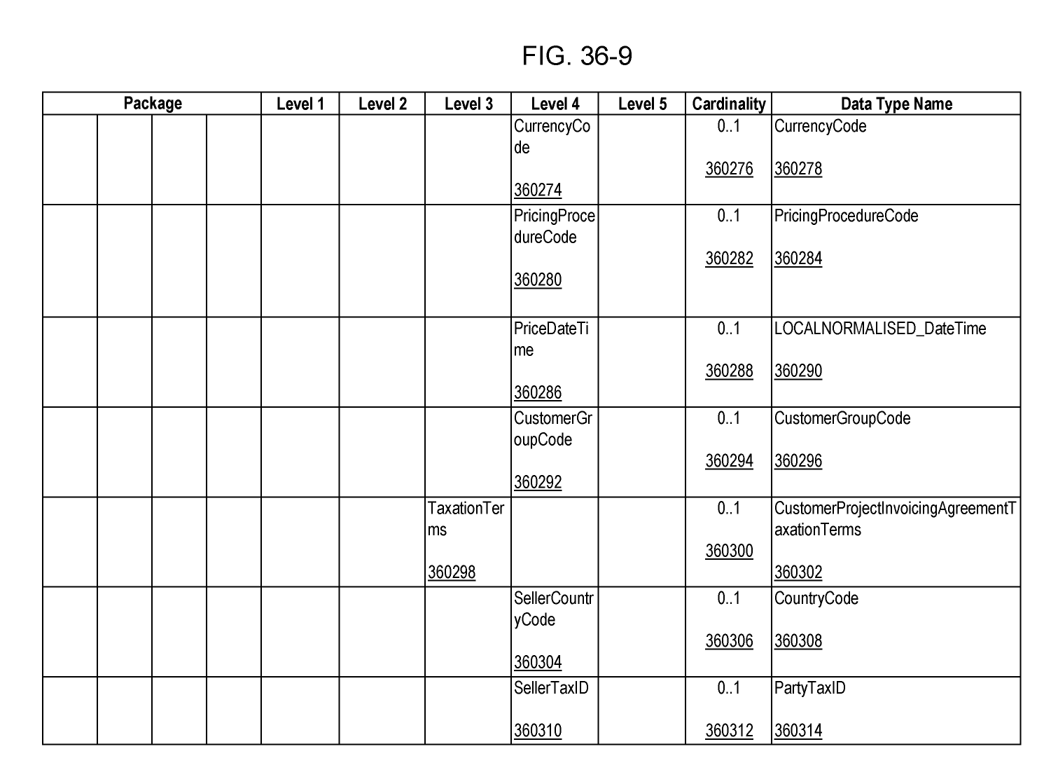

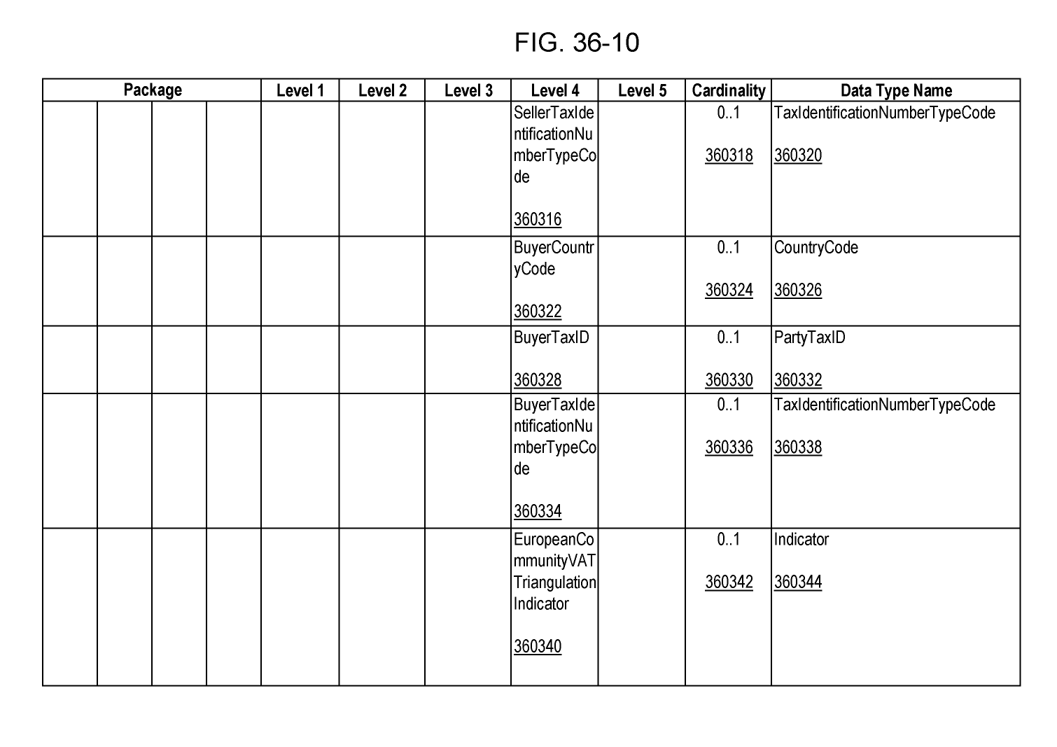

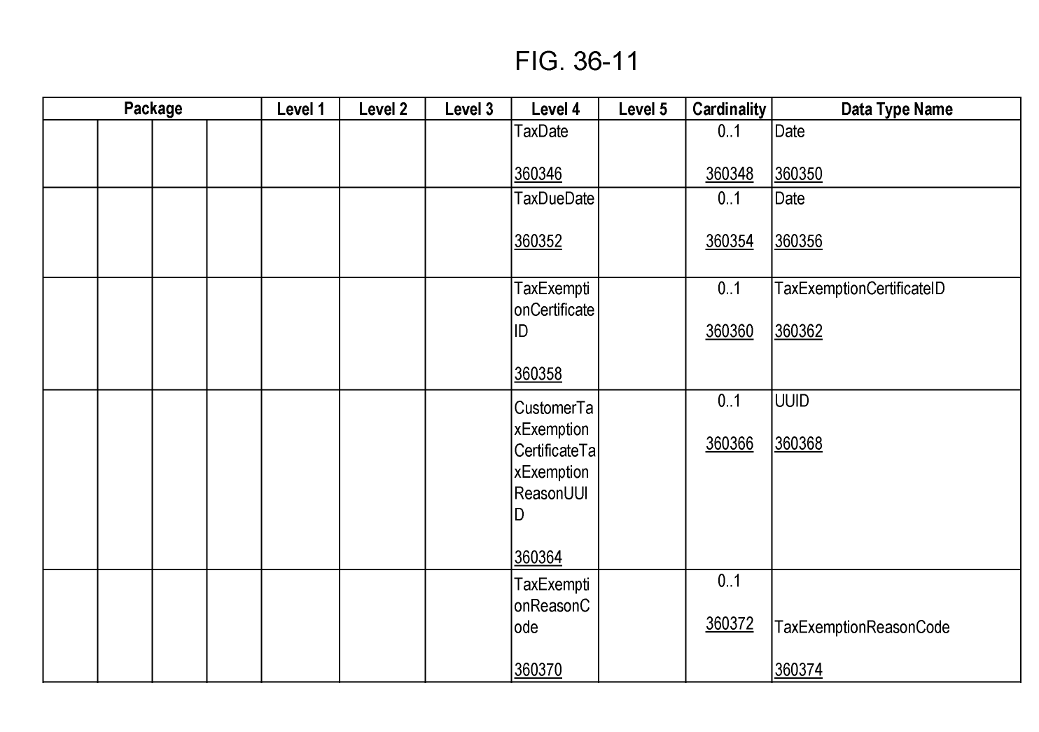

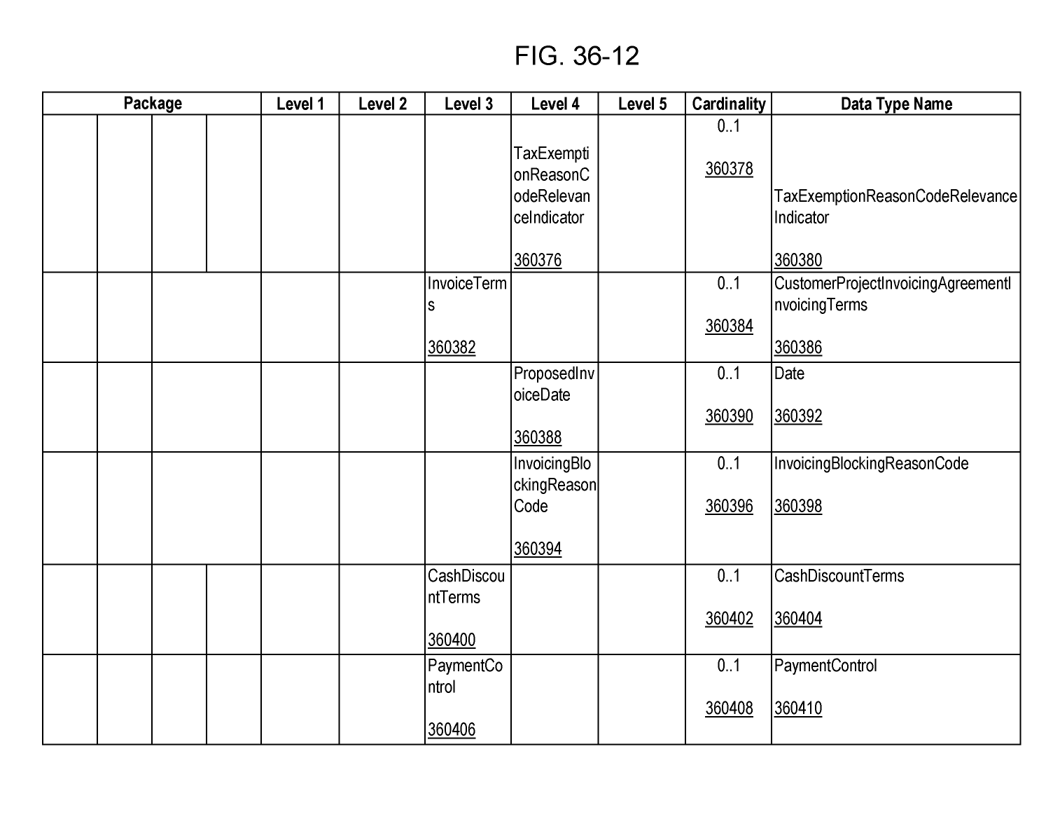

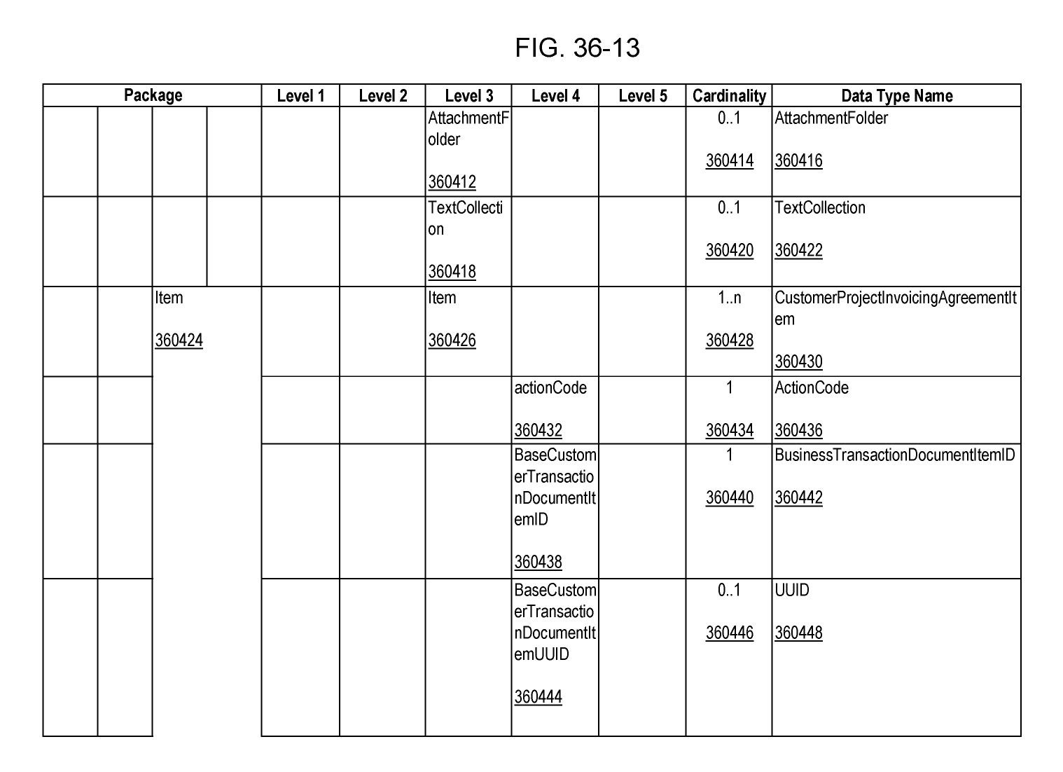

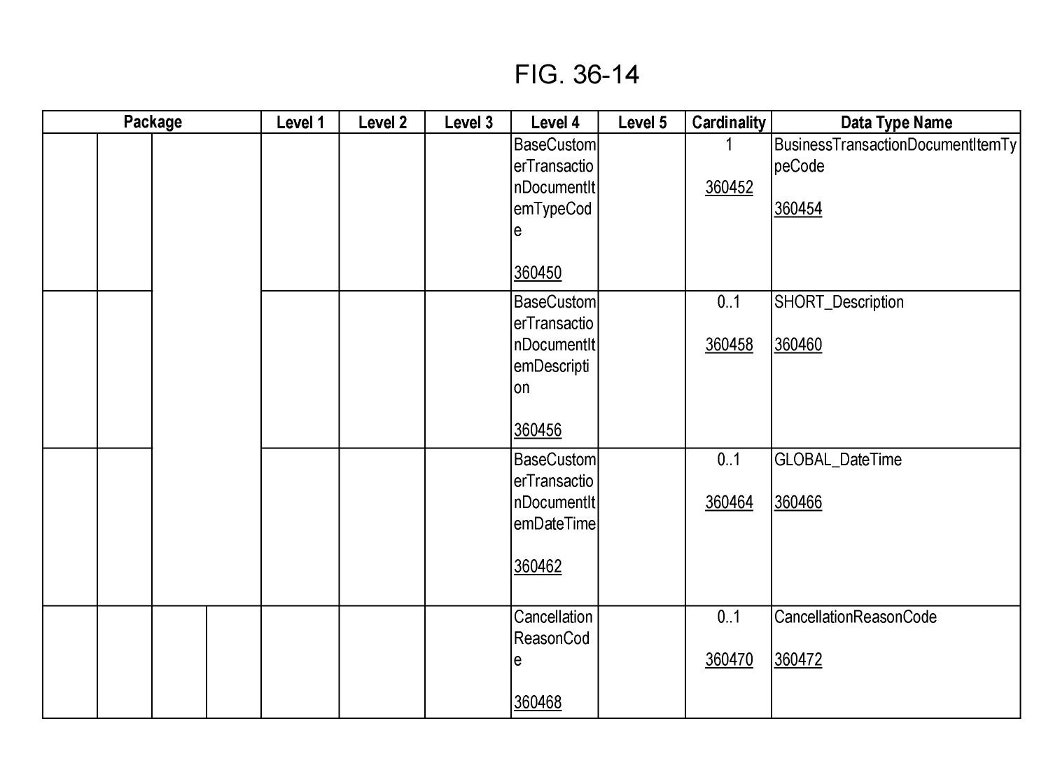

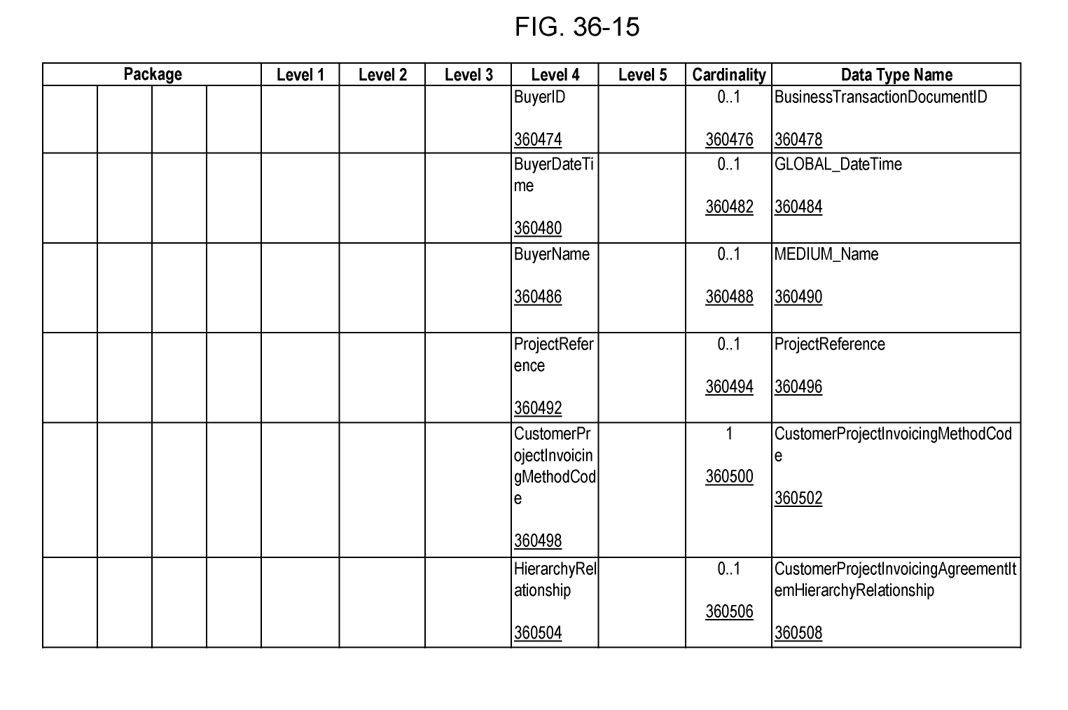

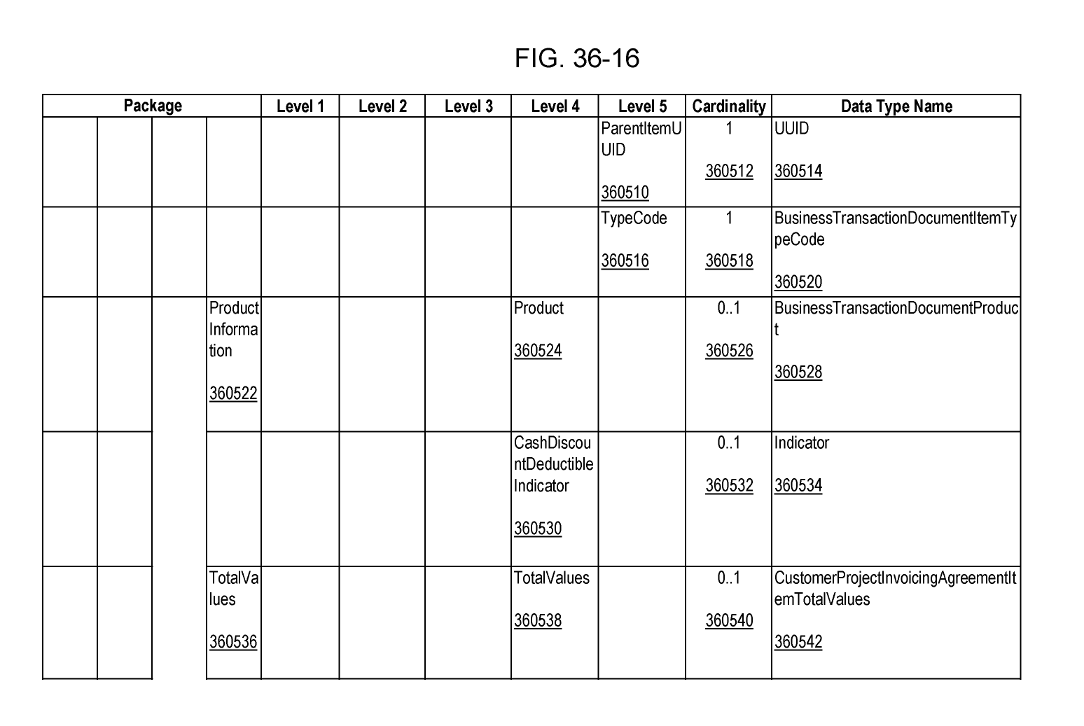

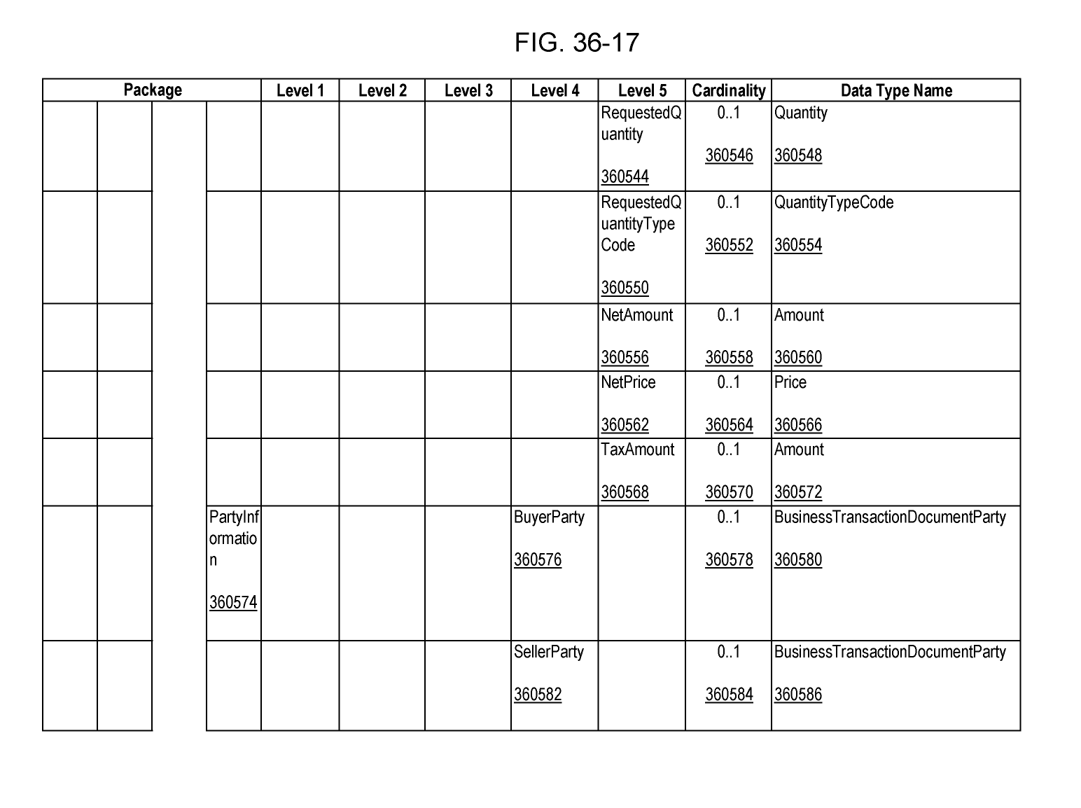

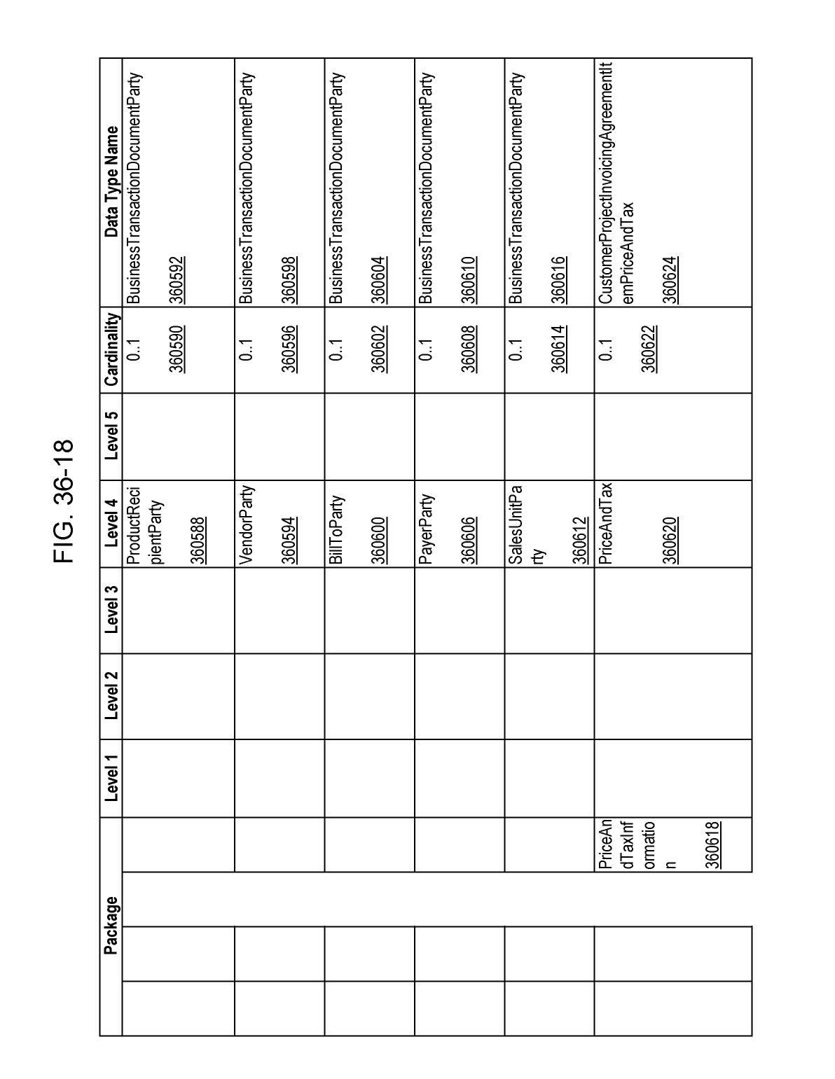

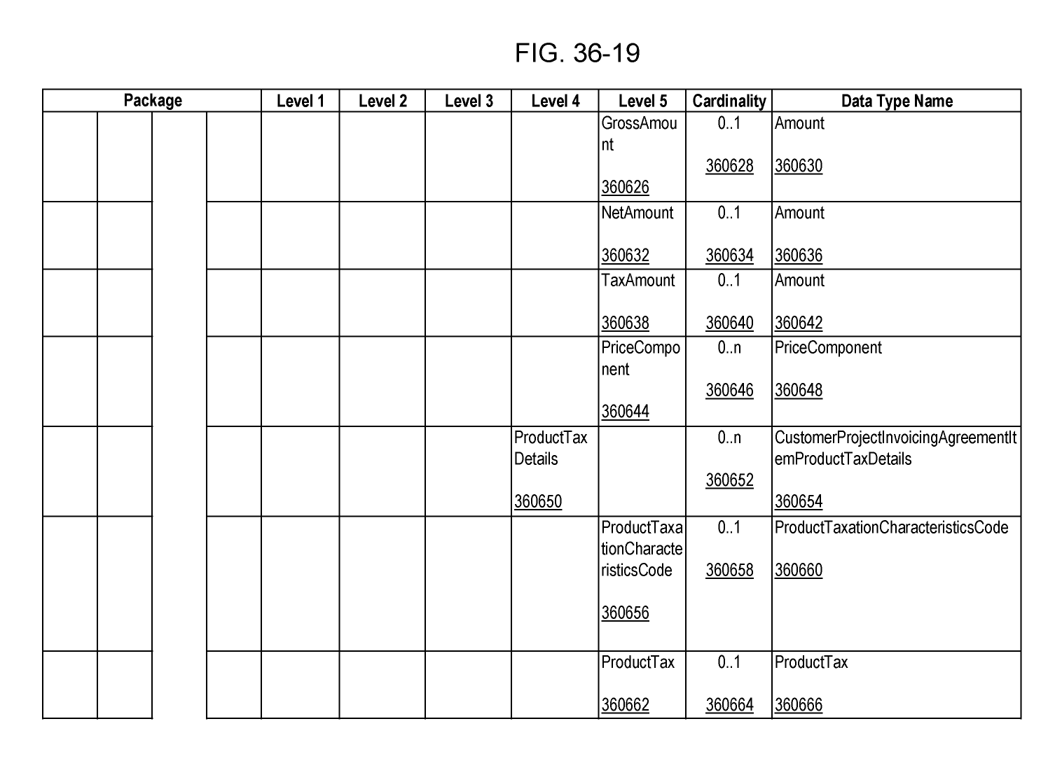

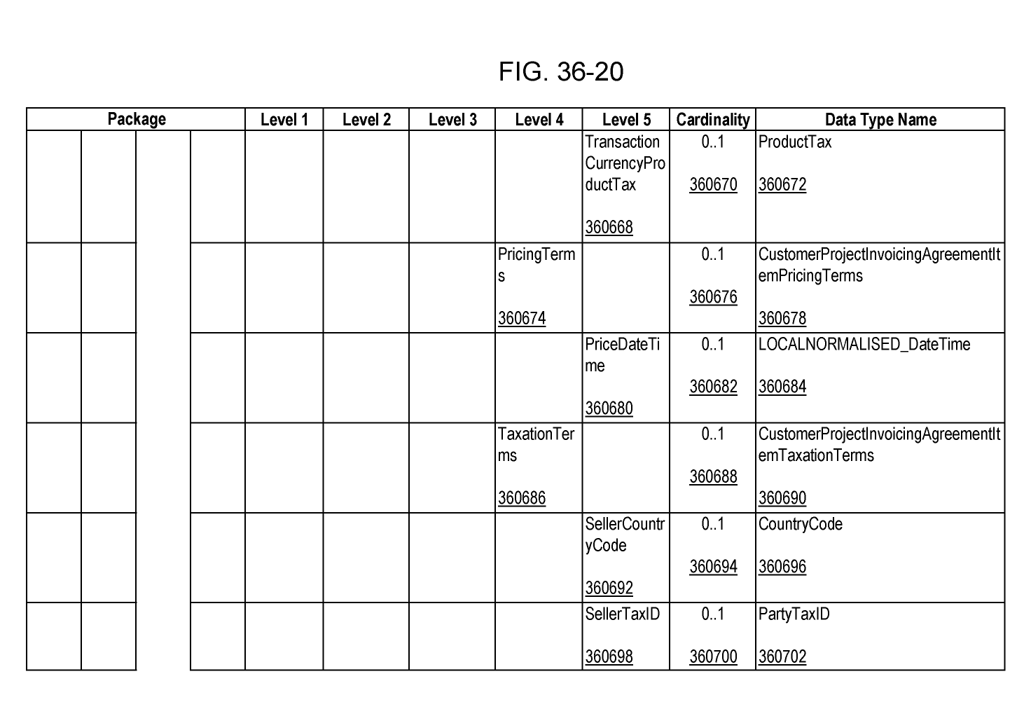

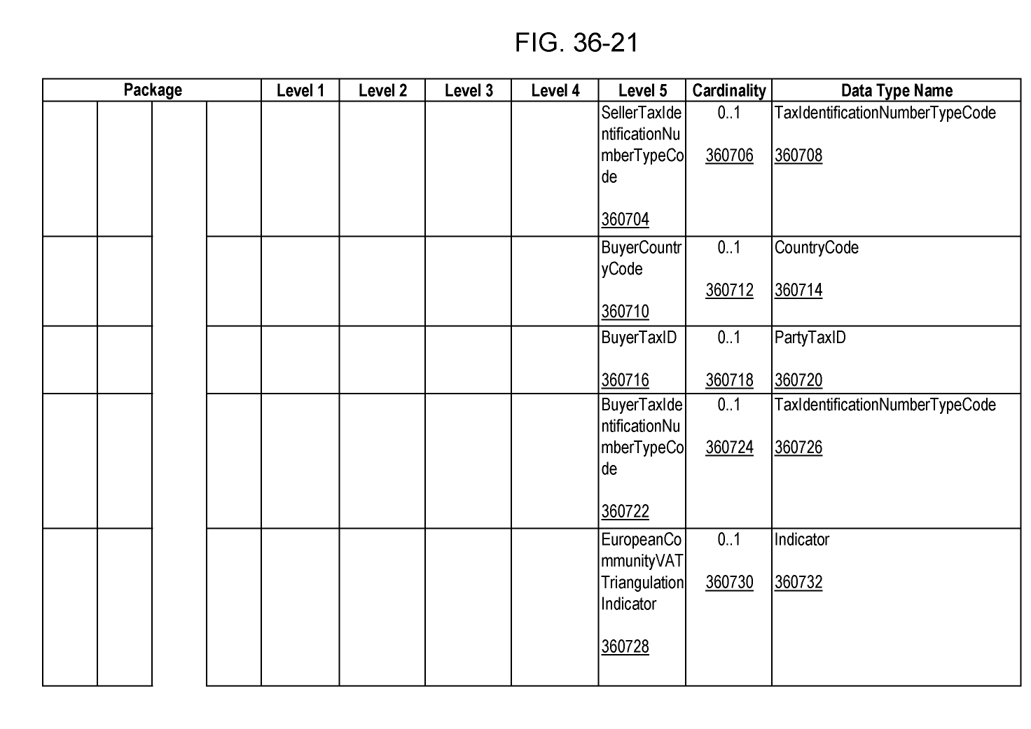

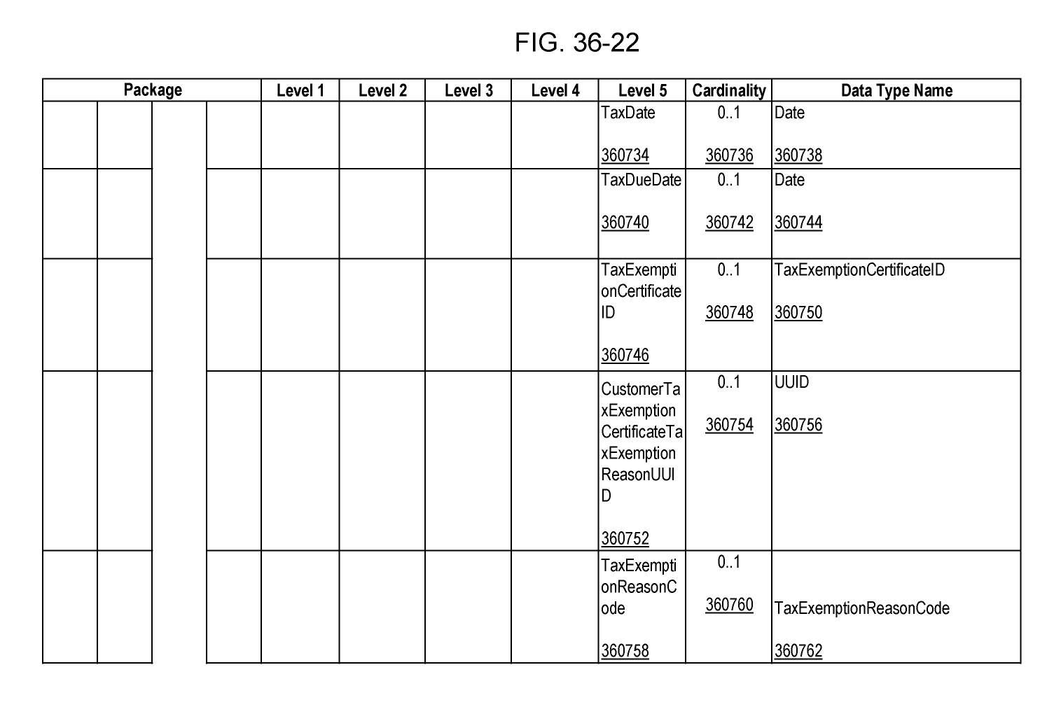

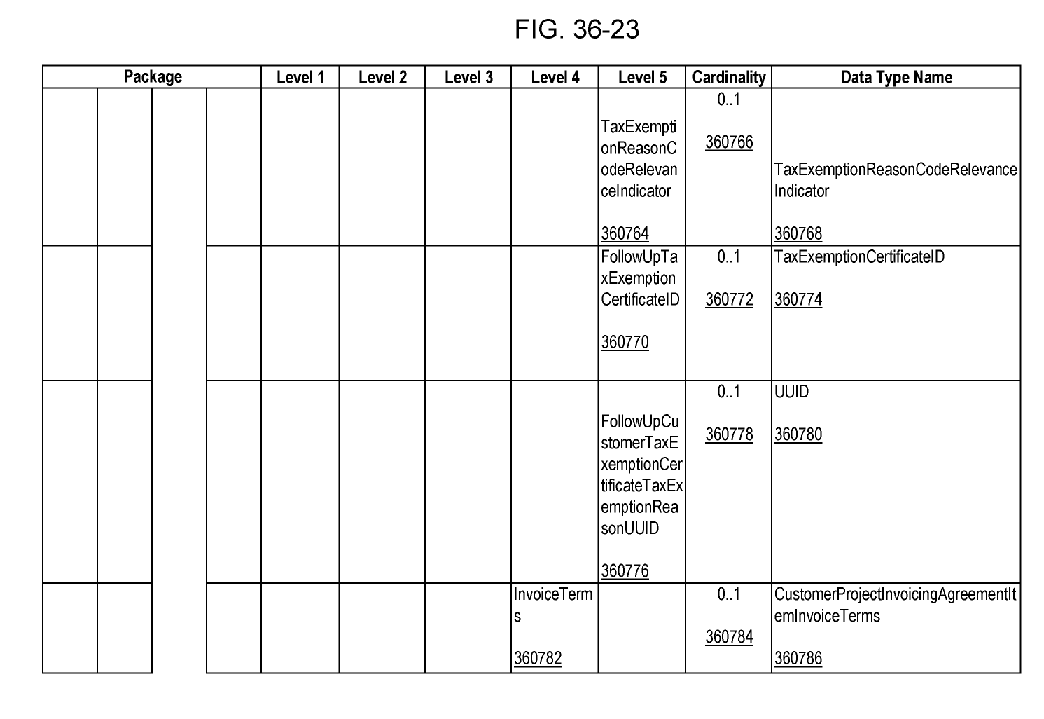

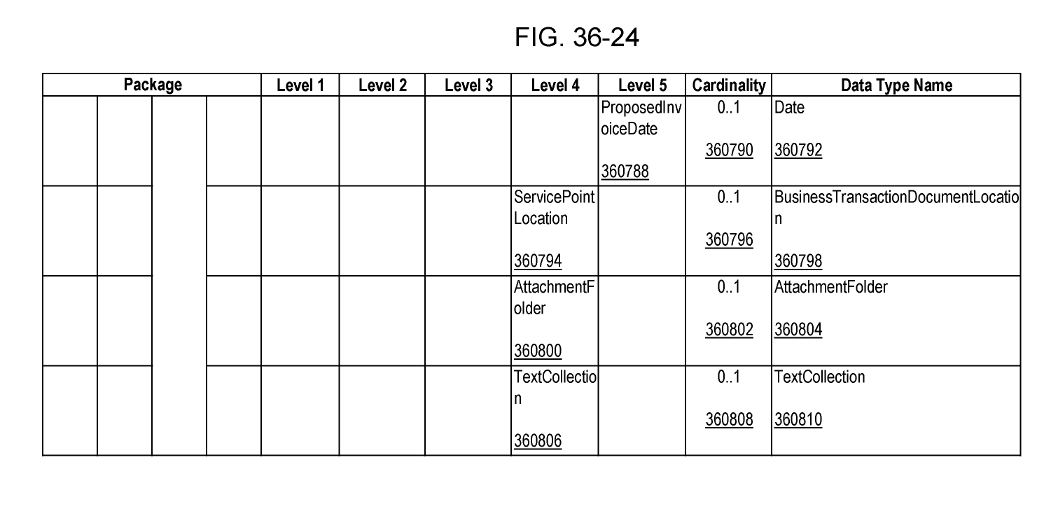

FIGS. 36-1 through 36-24 show an example configuration of an Element Structure that includes a CustomerProjectInvoicingAgreementMaintainRequest 360000 package. Specifically, these figures depict the arrangement and hierarchy of various components such as one or more levels of packages, entities, and datatypes, shown here as 360000 through 360810. As described above, packages may be used to represent hierarchy levels. Entities are discrete business elements that are used during a business transaction. Data types are used to type object entities and interfaces with a structure. For example, the CustomerProjectInvoicingAgreementMaintainRequest 360000 includes, among other things, a CustomerProjectInvoicingAgreementMaintainRequest 360002. Accordingly, heterogeneous applications may communicate using this consistent message configured as such.

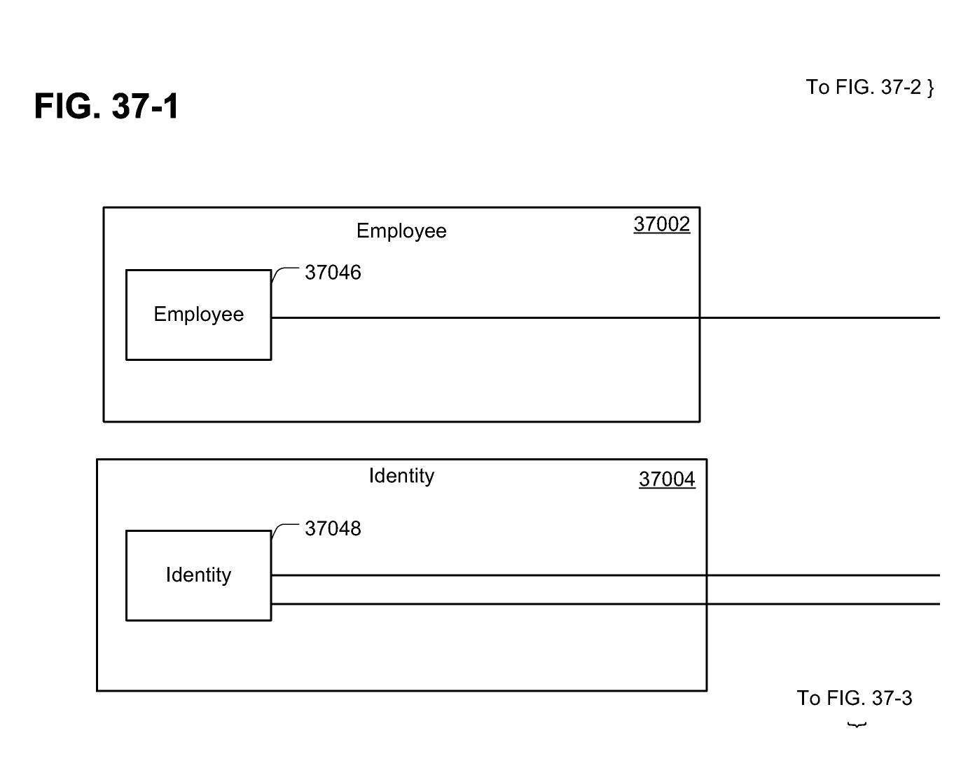

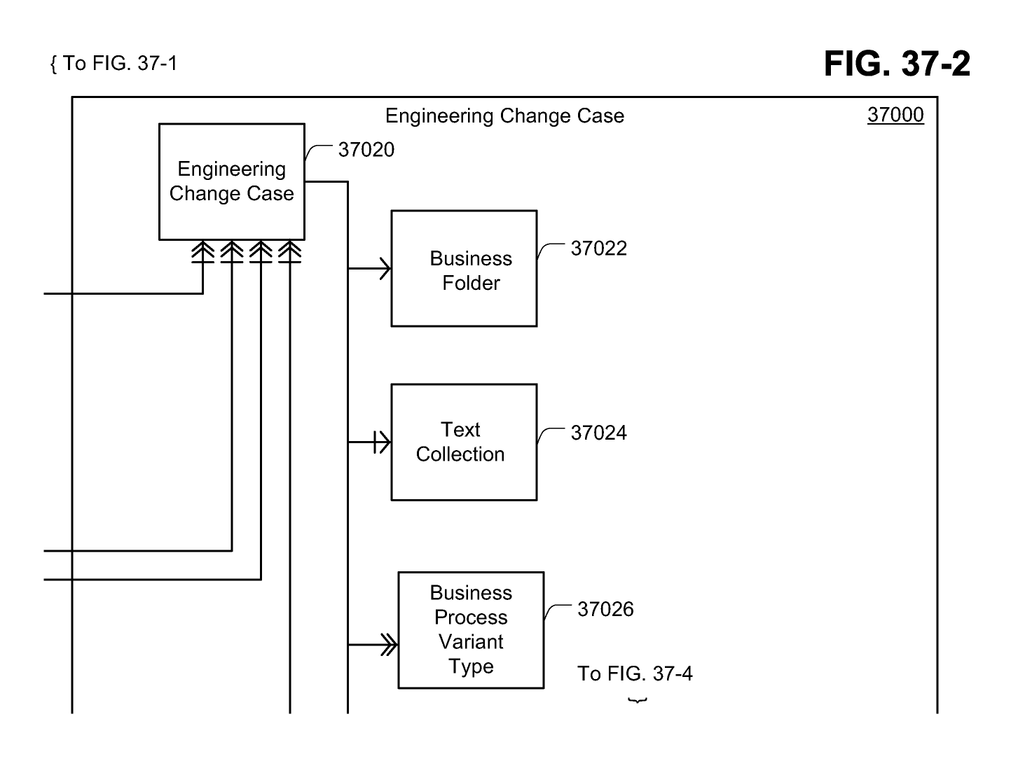

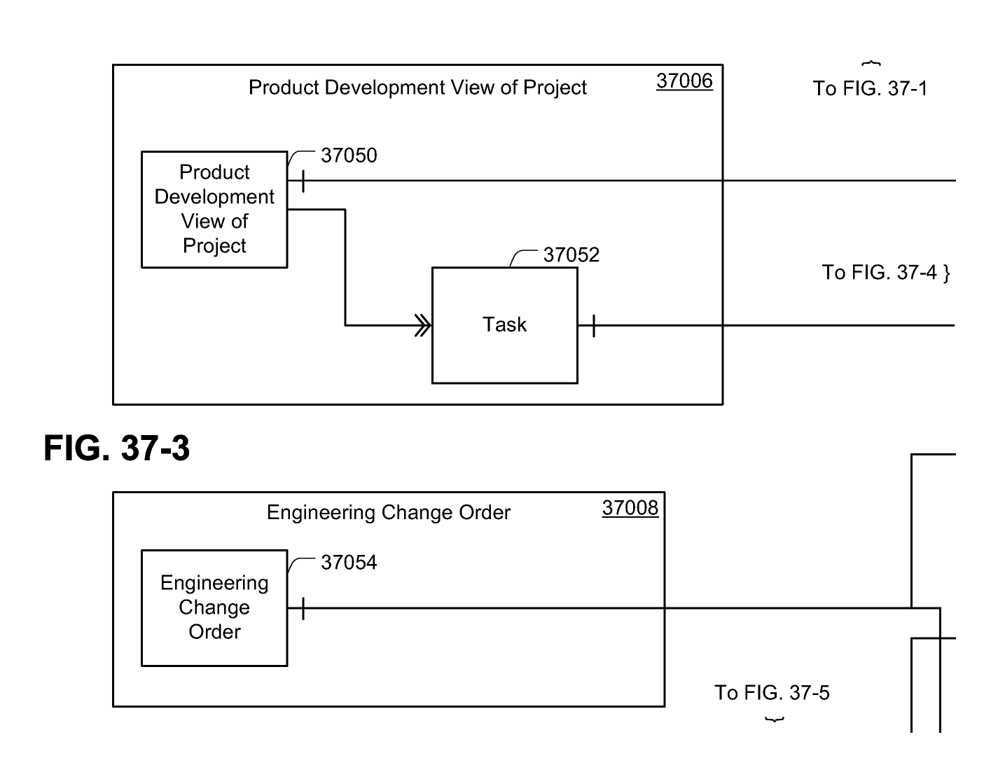

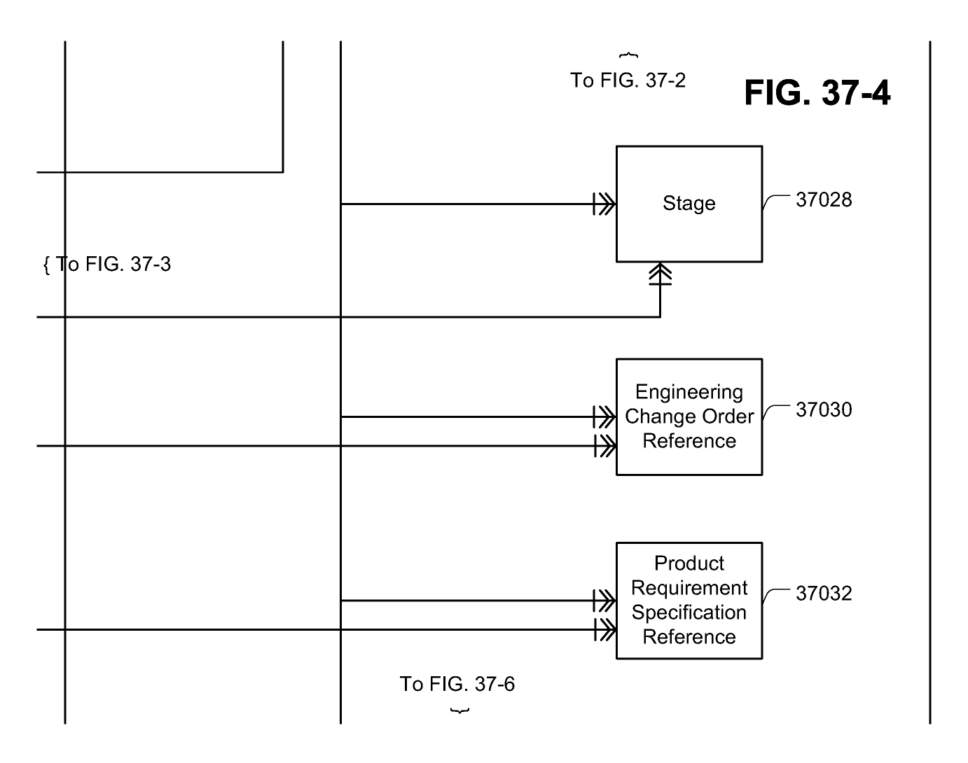

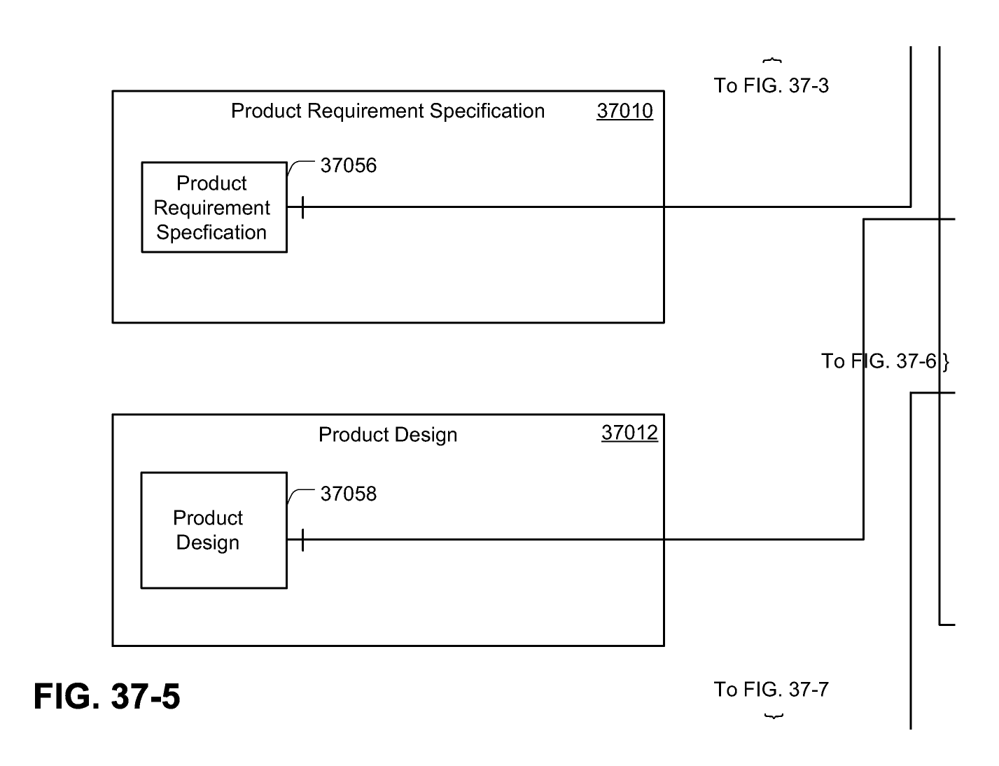

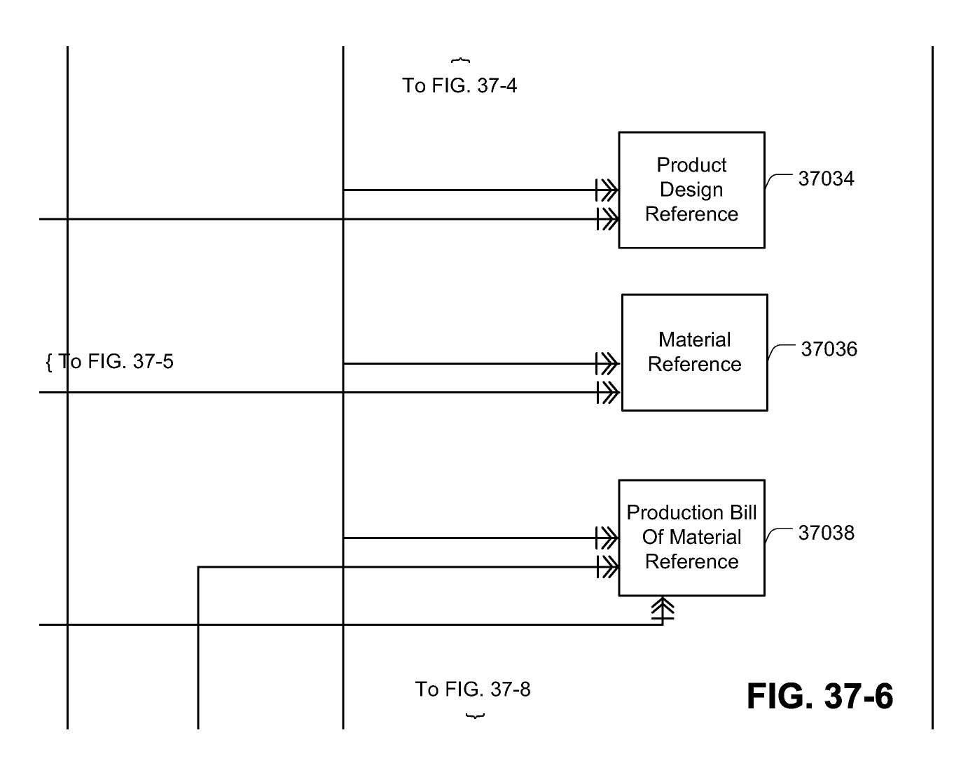

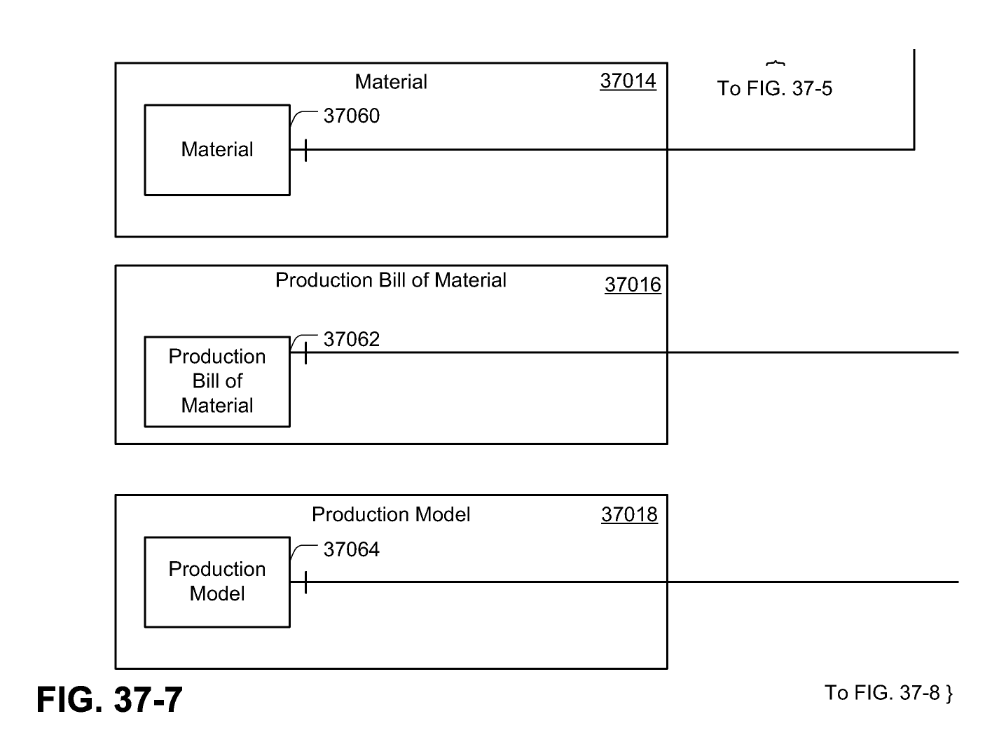

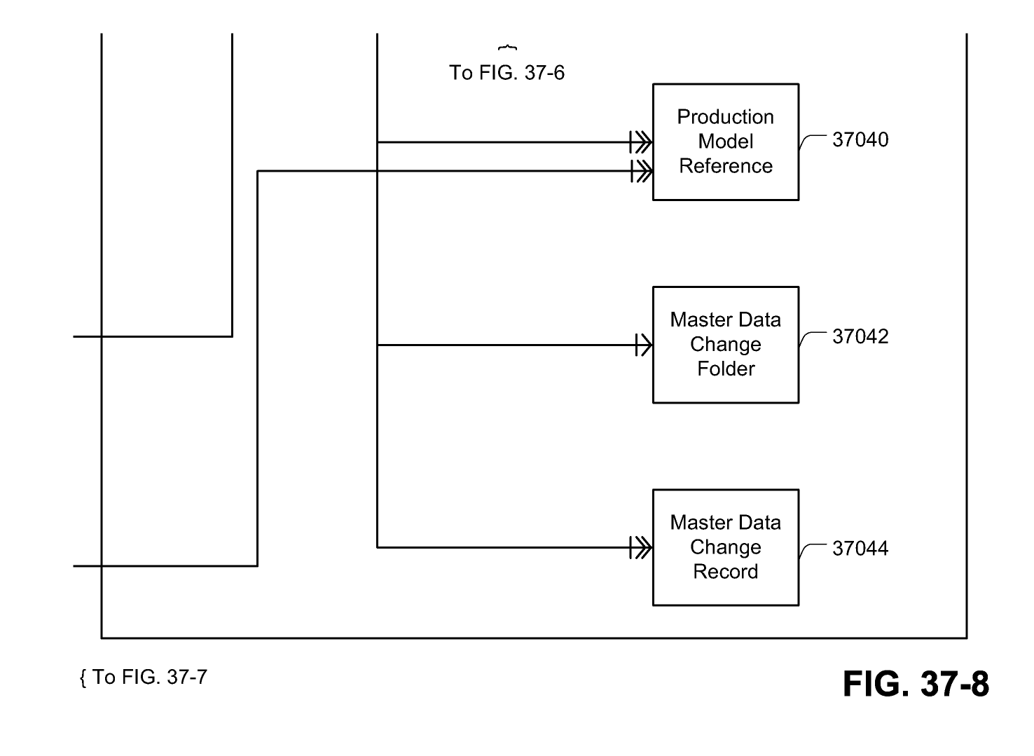

FIGS. 37-1 through 37-8 depict an example object model for a business object Engineering Change Case 37000. The business object 37000 has relationships with other objects 37002-37018, as shown with lines and arrows. The business object 37000 hierarchically comprises elements 37020-37044. The other objects 37002-37018 include respective elements 37046-37064 as shown.

The business object Engineering Change Case is a collection of documents, references, and decisions for the purpose of identifying a potential solution to problems that initiate an engineering change, such as: researching, designing, and validating engineering change alternatives; reviewing and deciding on an implementation of the change; and instructing the participants in the change and defining their responsibilities. The business object Engineering Change Case belongs to the process component Product Engineering. The business object Engineering Change Case includes a business folder and references to business objects that are relevant for engineering change case. The business object Engineering Change Case is involved in the following Process Component Interaction Models: Product Engineering_Project Processing and Product Engineering_Project Processing_Project Task Status Requiring.

The business object Engineering Change Case includes an Engineering Change Case root node, which includes information regarding a responsible person and an overall status of an engineering change. The elements located directly at the node Engineering Change Case are defined by the data type EngineeringChangeCaseElements. These elements include: UUID, ID, Name, EngineeringChangeTypeCode, EngineeringChangeReasonCode, EngineeringChangeRiskLevelCode, ResponsibleEmployeeUUID, ResponsibleEmployeeID, ProjectUUID, ProjectID, DueDateTime, PartialSystemAdministrativeData, Status, ProcessingStatusCode, CancellationStatusCode, BlockingStatusCode, and LifeCycleStatusCode.

UUID may be an alternative key, is a universally unique identifier of an engineering change case, and may be based on datatype GDT: UUID. ID may be an alternative key, is a unique identifier of an engineering change case which is intended to be human-readable, and may be based on datatype GDT: EngineeringChangeCaseID. Name may be optional, is a language-independent name for an engineering change case, and may be based on datatype GDT: LANGUAGEINDEPENDENT_LONG Name. EngineeringChangeTypeCode is a type of engineering change processed in an engineering change case, and may be based on datatype GDT: EngineeringChangeTypeCode. EngineeringChangeReasonCode may be optional, is a reason for an engineering change processed in an engineering change case, and may be based on datatype GDT: EngineeringChangeReasonCode. EngineeringChangeRiskLevelCode may be optional, classifies an expected risk when executing an engineering change, and may be based on datatype GDT: RiskLevelCode, with a qualifier of EngineeringChange. ResponsibleEmployeeUUID is a universally unique identifier of an employee who is responsible for the processing of an engineering change case, and may be based on datatype GDT: UUID. As a default the system may use an employee who has created an engineering change case. ResponsibleEmployeeID is an identifier of an employee who is responsible for the processing of an engineering change case, and may be based on datatype GDT: EmployeeID, with a qualifier of Responsible. ProjectUUID may be optional, is a universally unique identifier of a project that is relevant for an engineering change case, and may be based on datatype GDT: UUID. ProjectID may be optional, is an identifier of a project that is relevant for an engineering change case, and may be based on datatype GDT: ProjectID. DueDateTime is a point in time by which the processing of an engineering change case is targeted to be finished, and may be based on datatype GDT: LOCALNORMALISED_DateTime, with a qualifier of Due. As a default, the system may use the system timestamp when an engineering change case is created. PartialSystemAdministrativeData includes administrative data recorded by the system, and may be based on datatype GDT: SystemAdministrativeData, with a qualifier of Partial. PartialSystemAdministrativeData includes system users and change dates/times. In some implementations, PartialSystemAdministrativeData includes changes to the root node and the Text Collection node. Status is a current step in a life cycle of an engineering change case, and may be based on datatype BOIDT: EngineeringChangeCaseStatus. ProcessingStatusCode is information about whether an engineering change case has been processed, and may be based on datatype GDT: NOTSTARTEDINPROCESSFINISHED_ProcessingStatusCode. CancellationStatusCode is information about whether an engineering change case has been canceled, and may be based on datatype GDT: CancellationStatusCode. BlockingStatusCode is information about whether an engineering change case has been blocked, and may be based on datatype GDT: NOTBLOCKEDBLOCKED_BlockingStatusCode. LifeCycleStatusCode is a current step in a life cycle of an engineering change case, and may be based on datatype GDT: EngineeringChangeCaseLifeCycleStatusCode.

The following composition relationships to subordinate nodes exist: Business Folder with a cardinality of 1:1, Text Collection with a cardinality of 1:C, Business Process Variant Type with a cardinality of 1:N, Stage with a cardinality of 1:CN, Engineering Change Order Reference with a cardinality of 1:CN, Product Requirement Specification Reference with a cardinality of 1:CN, Product Design Reference with a cardinality of 1:CN, Material Reference with a cardinality of 1:CN, Production Bill Of Material Reference with a cardinality of 1:CN, with a cardinality of Production Model Reference 1:CN, Master Data Change Folder with a cardinality of 1:C, and Master Data Change Record with a cardinality of 1:CN. A Responsible Employee inbound association relationship may exist from the business object Employee/node Employee, with a cardinality of 1:CN, which specifies an employee who is responsible for an engineering change case. A Last Change Identity inbound association relationship may exist from the business object Identity/node Identity, with a cardinality of 1:CN, which identifies an identity that changed an engineering change case. A Creation Identity inbound association relationship may exist from the business object Identity/node Identity, with a cardinality of 1:CN, which identifies an identity that created an engineering change case. A Product Development View of Project inbound association relationship may exist from the business object Product Development View of Project/node Product Development View of Project, with a cardinality of C:CN, which denotes a project that is assigned to an engineering change case. A Current Stage specialization association for navigation to node Stage may exist, with a target cardinality of C, which identifies a stage that is currently processed and that has the highest sort criterion. A Main Business Process Variant Type specialization association for navigation may exist to node Business Process Variant Type, with a target cardinality of 1, which identifies a main business process variant type.

A Copy enterprise service infrastructure action may be used to copy an engineering change case. A copy of an engineering change case is useful if a new engineering change case needs to be created that has a similar structure and/or content, but has minor changes. In response to the Copy action, all status codes are initialised. The Copy Action may include parameter action elements. The action elements are defined by the data type EngineeringChangeCaseCopyActionElements. These elements include TargetEngineeringChangeCaseID, which is a unique identifier of an engineering change case that is created during copying. TargetEngineeringChangeCaseID may be based on datatype GDT: EngineeringChangeCaseID. A Start action may be used to start processing of an engineering change case. In response to the Start action, the processing status of an engineering change case may be set to “In Process.” A Finish action may be used to finish processing of an engineering change case. In response to the Finish action, the processing status of an engineering change case may be set to “Finished.” A ResumeProcessing action may be used to resume processing of an engineering change case. In response to the ResumeProcessing action, the processing status of an engineering change case may be set to “In Process.” A Cancel action may be used to cancel an engineering change case. In response to the Cancel action, the cancellation status of an engineering change may be set to “Canceled.” A Revoke Cancellation action may be used to revoke cancellation of an engineering change case. In response to the Revoke Cancellation action, the cancellation status of an engineering change may be set to “Not Canceled.” A Block action may be used to block an engineering change case. In response to the Block action, the blocking status of an engineering change may be set to “Blocked.” An Unblock action may be used to unblock an engineering change case. In response to the Unblock action, the blocking status of an engineering change may be set to “Not Blocked.”

A Query By Elements query may be used to return a list of all engineering change cases according to specified selection elements. The query elements are defined by the data type EngineeringChangeCaseElementsQueryElements. These elements include: ID, ResponsibleEmployeeID, ResponsibleEmployeePersonFamilyName, ResponsibleEmployeePersonGivenName, LifeCycleStatusCode, EngineeringChangeTypeCode, EngineeringChangeReasonCode, EngineeringChangeRiskLevelCode, DueDateTime, ProjectUUID, ProjectID, StageID, BusinessFolderStructureItemDescription, BusinessFolderElementTypeCode, EngineeringChangeOrderID, MaterialKey, ProductTypeCode, ProductidentifierTypeCode, ProductID, ProductRequirementSpecificationKey, RequirementSpecificationID, RequirementSpecificationVersionID, ProductionModelID, ProductionBillOfMaterialID, ProductDesignID, PartialSystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, LastChangeIdentityEmployeeID, and SearchText.

ID may be optional, and may be based on datatype GDT: EngineeringChangeCaseID. ResponsibleEmployeeID may be optional, and may be based on datatype GDT: EmployeeID, with a qualifier of Responsible. ResponsibleEmployeePersonFamilyName may be optional, is a family name of a responsible employee who is responsible for the processing of an engineering change case, and may be based on datatype GDT: LANGUAGEINDEPENDENT_MEDIUM_Name. ResponsibleEmployeePersonGivenName may be optional, is a given name of a responsible employee who is responsible for the processing of an engineering change case, and may be based on datatype GDT: LANGUAGEINDEPENDENT MEDIUM_Name. LifeCycleStatusCode may be optional, and may be based on datatype GDT: EngineeringChangeCaseLifeCycleStatusCode. EngineeringChangeTypeCode may be optional, and may be based on datatype GDT: EngineeringChangeTypeCode. EngineeringChangeReasonCode may be optional, and may be based on datatype GDT: EngineeringChangeReasonCode. EngineeringChangeRiskLevelCode may be optional, and may be based on datatype GDT: RiskLevelCode, with a qualifier of EngineeringChange. DueDateTime may be optional, and may be based on datatype GDT: LOCALNORMALISED_DateTime, with a qualifier of Due. ProjectUUID may be optional, and may be based on datatype GDT: UUID. ProjectID may be optional, and may be based on datatype GDT: ProjectID. StageID may be optional, and may be based on datatype GDT: EngineeringChangeCaseStageID. BusinessFolderStructureItemDescription may be optional, is a description of a structure item that is assigned to a reference node, and may be based on datatype GDT: LONG_Description. BusinessFolderElementTypeCode may be optional, is a business folder element type that is assigned to a reference node, and may be based on datatype GDT: BusinessFolderElementTypeCode. EngineeringChangeOrderID may be optional, is a unique identifier of an engineering change order that is referenced in an engineering change case, and may be based on datatype GDT: EngineeringChangeOrderID. MaterialKey may be optional, is a unique key of a material that is referenced in an engineering change case, and may be based on datatype KDT: ProductKey. ProductTypeCode is a coded representation of a product type, such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. ProductRequirementSpecificationKey may be optional, is a unique key of a product requirement specification that is referenced in an engineering change case, and may be based on datatype KDT: RequirementSpecificationKey. RequirementSpecificationID is an identifier for a requirement specification that is unique within a system, and may be based on datatype GDT: RequirementSpecificationID. RequirementSpecificationVersionID is an identifier for a version of a requirement specification, and may be based on datatype GDT: VersionID. ProductionModelID may be optional, is a unique identifier of a production model that is referenced in an engineering change case, and may be based on datatype GDT: ProductionModelID. ProductionBillOfMaterialID may be optional, is a unique identifier of a production bill of material that is referenced in an engineering change case, and may be based on datatype GDT: BillOfMaterialID. ProductDesignID may be optional, is a unique identifier of a product design that is referenced in an engineering change case, and may be based on datatype GDT: ProductDesignID. PartialSystemAdministrativeData may be optional and may be based on datatype QueryIDT: QueryElementSystemAdministrativeData. CreationDateTime may be optional, is a point in time that the goods tag is created date and time stamp, and may be based on datatype GDT: GLOBAL_DateTime. CreationIdentityUUID may be optional, is a globally unique identifier for a person who performed a creation, and may be based on datatype GDT: UUID. CreationIdentityID may be optional, is an identifier for a person who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made the last changes, and may be based on datatype GDT: UUID. LastChangeIdentityID may be optional, is an identifier for an identity who made last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID. SearchText may be optional, is free text including one or several search terms to search for engineering change cases, and may be based on datatype GDT: SearchText. For every query that includes the SearchText as query a parameter, an application-specific subset of the other query parameters may be defined. The search terms may be assigned to the subset of query parameters in such a way that every search term is used exactly once in an assignment. Several search terms may be assigned to the same query parameter. For each of these assignments, a query result is calculated. The total result is now the union of the results calculated per assignment.

A Select All query may be used to return the node IDs of all instances of a node, and may be used to enable an initial load of data for a fast search infrastructure. A Business Folder dependent object inclusion node is a folder for collecting and organizing documents, references, and decisions relevant for an engineering change case. In some implementations, if a business folder is used for an engineering change case, folders are created for the objects that trigger an engineering change case and for the objects that are the main focus of an engineering change case. There may also be a folder for a handover to execution with two subfolders for tracing master data changes and for the handover of relevant documents. The Text Collection dependent object inclusion node is a collection of natural-language text with additional information about an engineering change case.

A BusinessProcessVariantType defines the character of a business process variant of an engineering change case. It represents a typical way of processing of an engineering change case within a process component from a business point of view. A Business Process Variant is a configuration of a Process Component. A Business Process Variant belongs to only one process component. A process component is a software package that realizes a business process and exposes its functionality as services. The functionality may include business transactions. A process component includes one or more semantically related business objects. A business object may belong to only one process component. The elements located directly at the node Business Process Variant Type are defined by the data type EngineeringChangeCaseBusinessProcessVariantTypeElements. These elements include: BusinessProcessVariantTypeCode and MainIndicator. BusinessProcessVariantTypeCode is a coded representation of a business process variant type of an EngineeringChangeCaseBusinessProcessVariantType, and may be based on datatype GDT: BusinessProcessVariantTypeCode. MainIndicator is an indicator that specifies whether the current BusinessProcessVariantTypeCode is a code, and may be based on datatype GDT: Indicator, with a qualifier of Main. In some implementations, only one of the instances of the business process variant type is allowed to be designated as a main type.

Stage is a sequence step within the processing of an engineering change case. A stage can be assigned to a structure item of a Business Folder. A sequence may be defined by the SortCriterionText of a structure item. The elements located directly at the node Stage are defined by the data type EngineeringChangeCaseStageElements. These elements include: UUID, ID, BusinessFolderElementTypeCode, ProjectTaskUUID, and ProjectTaskID. UUID may be an alternative key, is a universally unique identifier of a stage, and may be based on datatype GDT: UUID. ID is a unique identifier of a stage, and may be based on datatype GDT: EngineeringChangeCaseStageID. BusinessFolderElementTypeCode is a type code of the elements that can be referenced by the Structure Item of the dependent object Business Folder, and may be based on datatype GDT: BusinessFolderElementTypeCode. ProjectTaskUUID may be optional, is a universally unique identifier of a project task which is relevant for a stage, and may be based on datatype GDT: UUID. ProjectTaskID may be optional, is an identifier of a project task which is relevant for a stage, and may be based on datatype GDT: ProjectElementID.

A Product Development View Of Project Task inbound association relationship may exist from the business object Product Development View of Project/node Task, with a cardinality of C:CN, which denotes the project task that is assigned to a stage of an engineering change case. Engineering Change Order Reference is a reference to an engineering change order and related information that is relevant for an engineering change. An engineering change order reference can be part of a case structure which is provided by a dependent object Business folder. The elements located directly at the node Engineering Change Order Reference are defined by the data type EngineeringChangeCaseEngineeringChangeOrderReferenceElements. These elements include: UUID, BusinessFolderElementTypeCode, EngineeringChangeOrderUUID, and EngineeringChangeOrderID. UUID may be an alternative key, is a unique identifier of an engineering change order reference, and may be based on datatype GDT: UUID. BusinessFolderElementTypeCode is a type of element that describes an engineering change order and can be referenced in a business folder, and may be based on datatype GDT: BusinessFolderElementTypeCode. EngineeringChangeOrderUUID may be optional, is a universally unique identifier of an engineering change order, and may be based on datatype GDT: UUID. EngineeringChangeOrderID may be optional, is a unique identifier of an engineering change order, and may be based on datatype GDT: EngineeringChangeOrderID. A Engineering Change Order inbound aggregation relationship may exist from the business object Engineering Change Order/node Engineering Change Order, with a cardinality of C:CN, which denotes an engineering change order that is referenced in a business folder of an engineering change case.

Product Requirement Specification Reference is a reference to a product requirement specification and related information that is relevant for an engineering change. The product requirement specification reference can be part of a case structure which is provided by a dependent object Business folder. The elements located directly at the node Product Requirement Specification Reference are defined by the data type EngineeringChangeCaseProductRequirementSpecificationReferenceElements. These elements include: UUID, BusinessFolderElementTypeCode, ProductRequirementSpecificationUUID, ProductRequirementSpecificationKey, RequirementSpecificationID, and RequirementSpecificationVersionID.UUID may be an alternative key, is a universally unique identifier of a product requirement specification reference, and may be based on datatype GDT: UUID. BusinessFolderElementTypeCode is a type of element that describes a product requirement specification and can be referenced in a business folder, and may be based on datatype GDT: BusinessFolderElementTypeCode. ProductRequirementSpecificationUUID may be optional, is a universally unique identifier of a product requirement specification, and may be based on datatype GDT: UUID. ProductRequirementSpecificationKey may be optional, is key of a product requirement specification, and may be based on datatype KDT: RequirementSpecificationKey. RequirementSpecificationID is an identifier for a requirement specification that is unique within a system, and may be based on datatype GDT: RequirementSpecificationID. RequirementSpecificationVersionID is an identifier for a version of a requirement specification, and may be based on datatype GDT: VersionID. A Product Requirement Specification inbound aggregation relationship may exist from the business object Product Requirement Specification/node Product Requirement Specification, with a cardinality of C:CN, which denotes a product requirement specification that is referenced in a business folder of an engineering change case.

Product Design Reference is a reference to a product design and related information that is relevant for an engineering change. The product design reference can be part of a case structure which is provided by a dependent object Business folder. The elements located directly at the node Product Design Reference are defined by the data type EngineeringChangeCaseProductDesignReferenceElements. These elements include: UUID, BusinessFolderElementTypeCode, ProductDesignUUID, ProductDesignID, ProductDesignVersionUUID, and ProductDesignVersionID. UUID may be an alternative key, is a universally unique identifier of a product design reference, and may be based on datatype GDT: UUID. BusinessFolderElementTypeCode is a type of element that describes a product design and that can be referenced in a business folder, and may be based on datatype GDT: BusinessFolderElementTypeCode. ProductDesignUUID may be optional, is a universally unique identifier of a product design, and may be based on datatype GDT: UUID. ProductDesignID may be optional, is a unique identifier of a product design, and may be based on datatype GDT: ProductDesignID. ProductDesignVersionUUID may be optional, is a universally unique identifier of a product design version, and may be based on datatype GDT: UUID. ProductDesignVersionID may be optional, is a unique identifier of a product design version, may be based on datatype GDT: VersionID, and may be unique within a product design. A Product Design inbound aggregation relationship may exist from the business object Product Design/node Product Design, with a cardinality of C:CN, which denotes a product design that is referenced in a business folder of an engineering change case. In some implementations, either the product design or the product design version is referenced.

A Material Reference is a reference to a material and related information that is relevant for an engineering change. The material reference can be part of a case structure which is provided by a dependent object Business folder. The elements located directly at the node Material Reference are defined by the data type EngineeringChangeCaseMaterialReferenceElements. These elements include: UUID, BusinessFolderElementTypeCode, MaterialUUID, MaterialKey, ProductTypeCode, ProductidentifierTypeCode, and ProductID. UUID may be an alternative key, is a universally unique identifier of a material reference, and may be based on datatype GDT: UUID. BusinessFolderElementTypeCode is a type of element that describes a material and that can be referenced in a business folder, and may be based on datatype GDT: BusinessFolderElementTypeCode. MaterialUUID may be optional, is a unique identifier of a material, and may be based on datatype GDT: UUID. MaterialKey may be optional, is key of a material, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. A Material inbound aggregation relationship may exist from the business object Material/node Material, with a cardinality of C:CN, which denotes a material that is referenced in a business folder of an engineering change case.

A Production Bill Of Material Reference is a reference to a production bill of material and related information that is relevant for an engineering change. The production bill of material reference can be part of a case structure which is provided by a dependent object Business folder. The elements located directly at the node Production Bill Of Material Reference are defined by the data type EngineeringChangeCaseProductionBillOfMaterialReferenceElements. These elements include: UUID, BusinessFolderElementTypeCode, ProductionBillOfMaterialUUID, ProductionBillOfMaterialID, EngineeringChangeOrderUUID, and EngineeringChangeOrderID. UUID may be an alternative key, is a universally unique identifier of a production bill of material reference, and may be based on datatype GDT: UUID. BusinessFolderElementTypeCode is a type of element that describes a production bill of material and that can be referenced in a business folder, and may be based on datatype GDT: BusinessFolderElementTypeCode. ProductionBillOfMaterialUUID may be optional, is a universally unique identifier of a production bill of material, and may be based on datatype GDT: UUID. ProductionBillOfMaterialID may be optional, is a unique identifier of a production bill of material, and may be based on datatypeGDT: BillOfMaterialID. EngineeringChangeOrderUUID may be optional, is a universally unique identifier of an engineering change order that has changed or may change a production bill of material, and may be based on datatype GDT: UUID. EngineeringChangeOrderID may be optional, is a unique identifier of an engineering change order that has changed or may change a production bill of material, and may be based on datatype GDT: EngineeringChangeOrderID. A Production Bill Of Material inbound aggregation relationship may exist from the business object Production Bill of Material/node Production Bill of Material, with a cardinality of C:CN, which denotes a production bill of material that is referenced in a business folder of an engineering change case. A Engineering Change Order inbound association relationship may exist from the business object Engineering Change Order/node Engineering Change Order, with a cardinality of C:CN, which is an engineering change order that has changed or will change a production bill of material.

Production Model Reference is a reference to a production model and related information that is relevant for an engineering change. The production model reference can be part of a case structure which is provided by a dependent object Business folder. The elements located directly at the node Production Model Reference are defined by the data type EngineeringChangeCaseProductionModelReferenceElements. These elements include: UUID, BusinessFolderElementTypeCode, ProductionModelUUID, and ProductionModelID. UUID may be an alternative key, is a universally unique identifier of a production model reference, and may be based on datatype GDT: UUID. BusinessFolderElementTypeCode is a type of element that describes a production model and that can be referenced in a business folder, and may be based on datatype GDT: BusinessFolderElementTypeCode. ProductionModelUUID may be optional, is a universally unique identifier of production model, and may be based on datatype GDT: UUID. ProductionModelID may be optional, is a unique identifier of a production model, and may be based on datatype GDT: ProductionModelID. A Production Model inbound aggregation relationship may exist from the business object Production Model/node Production Model, with a cardinality of C:CN, which denotes a production model that is referenced in a business folder of an engineering change case.

Master Data Change Folder is a folder for documenting master data changes and related activities performed in a handover process. The Master Data Change Folder can be part of a case structure which is provided by a dependent object Business folder. The elements located directly at the node Master Data Change Folder are defined by the data type EngineeringChangeCaseMasterDataChangeFolderElements. These elements include: UUID, BusinessFolderElementTypeCode, and TotalNumberValue. UUID may be an alternative key, is a universally unique identifier of a master data change folder, and may be based on datatype GDT: UUID. BusinessFolderElementTypeCode is a type code of the elements that can be referenced by a structure item of a dependent object Business Folder, and may be based on datatype GDT: BusinessFolderElementTypeCode. TotalNumberValue may be optional, is a total amount of master data change records that is below a master data change folder in a case structure, and may be based on datatype GDT: NumberValue, with a qualifier of Total. The case structure may be provided by a dependent object business folder.

Master Data Change Record is a record including an instruction related to a change of a master data object. A master data change record can be part of a case structure which is provided by a dependent object business folder. The elements located directly at the node Master Data Change Record are defined by the data type EngineeringChangeCaseMasterDataChangeRecordElements. These elements include: UUID, BusinessFolderElementTypeCode, ObjectNodeReference, and EngineeringChangeHandoverinstructionCode. UUID may be an alternative key, is a universally unique identifier of a master data change record, and may be based on datatype GDT: UUID. BusinessFolderElementTypeCode is a type code of the elements that can be referenced by a structure item of a dependent object Business folder, and may be based on datatype GDT: BusinessFolderElementTypeCode. ObjectNodeReference may be optional, is a reference to a master data business object, and may be based on datatype GDT: ObjectNodeReference. In some implementations, business object types that refer to master data business objects are selected. EngineeringChangeHandoverinstructionCode may be optional, is an instruction for a handover process detailing how to proceed with the execution of a master data change, and may be based on datatype GDT: EngineeringChangeHandoverinstructionCode. In some implementations, in a case structure which is provided by a dependent object business folder, a master data change record may be located below a master data change folder.

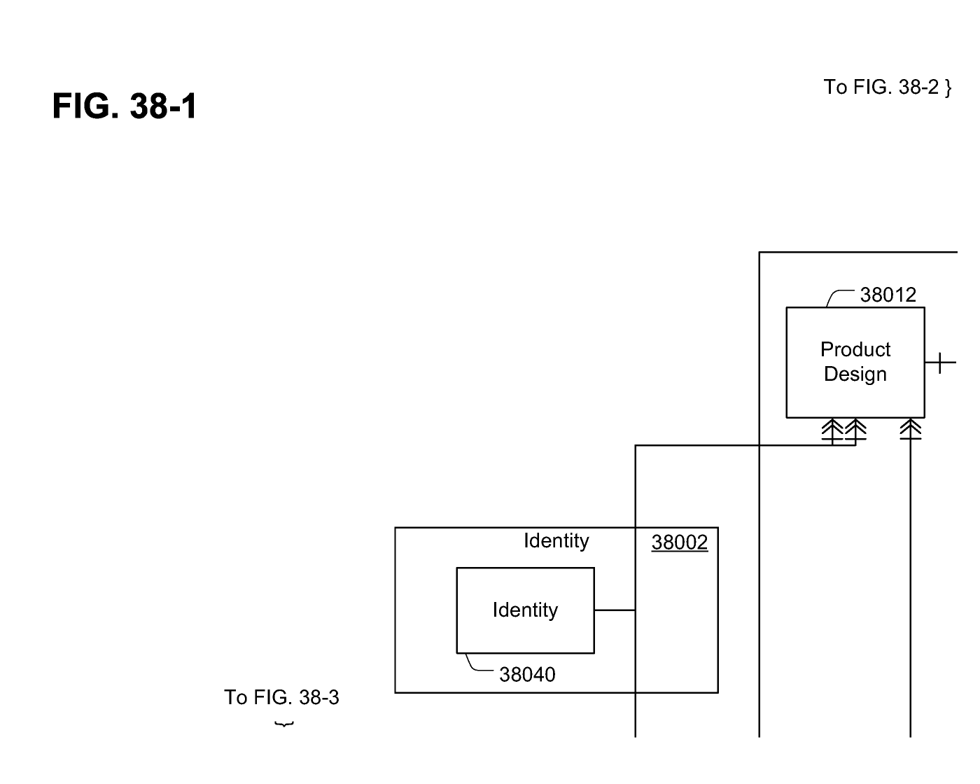

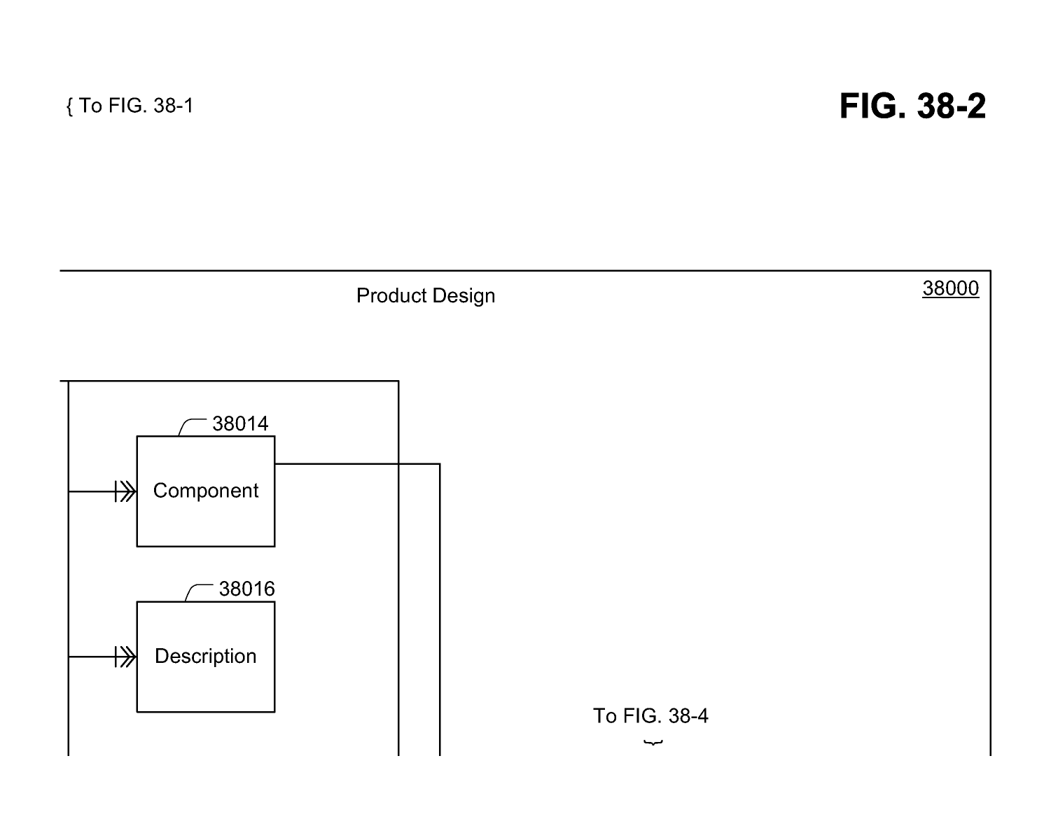

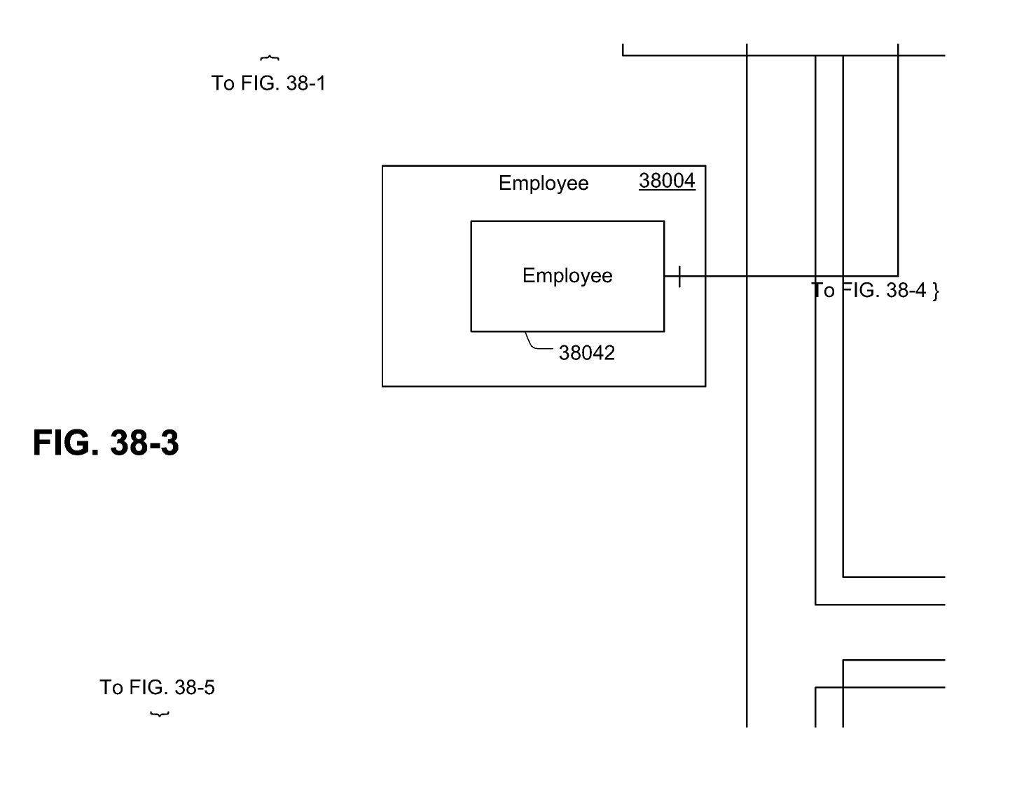

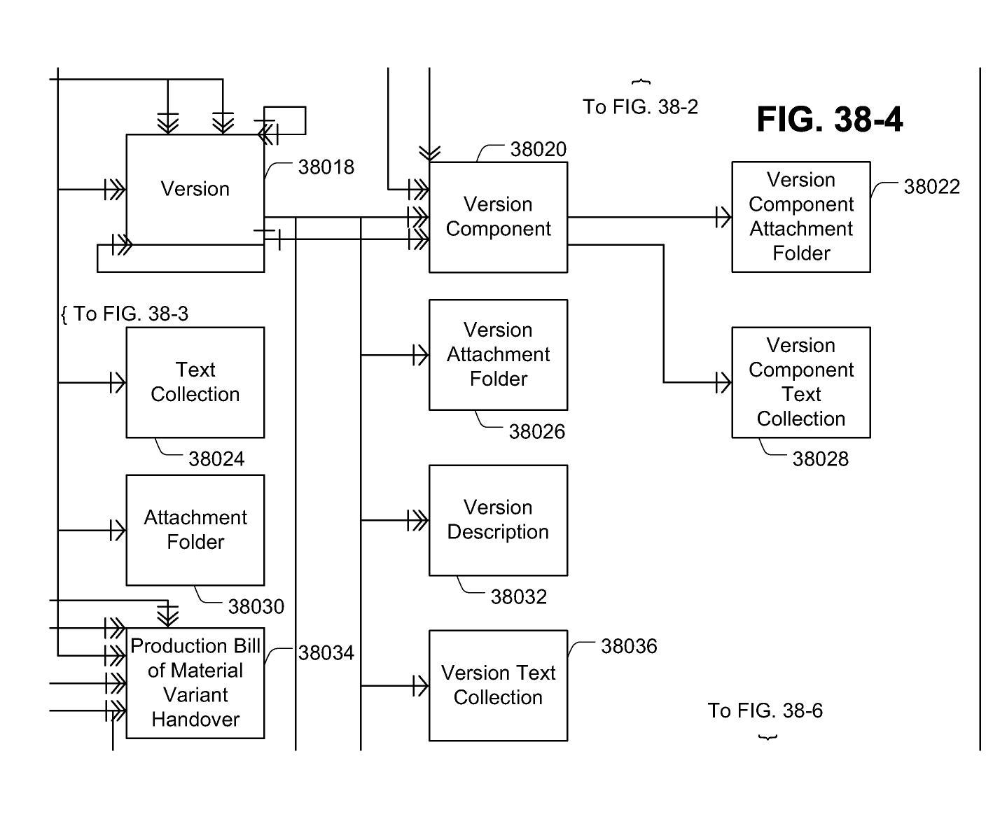

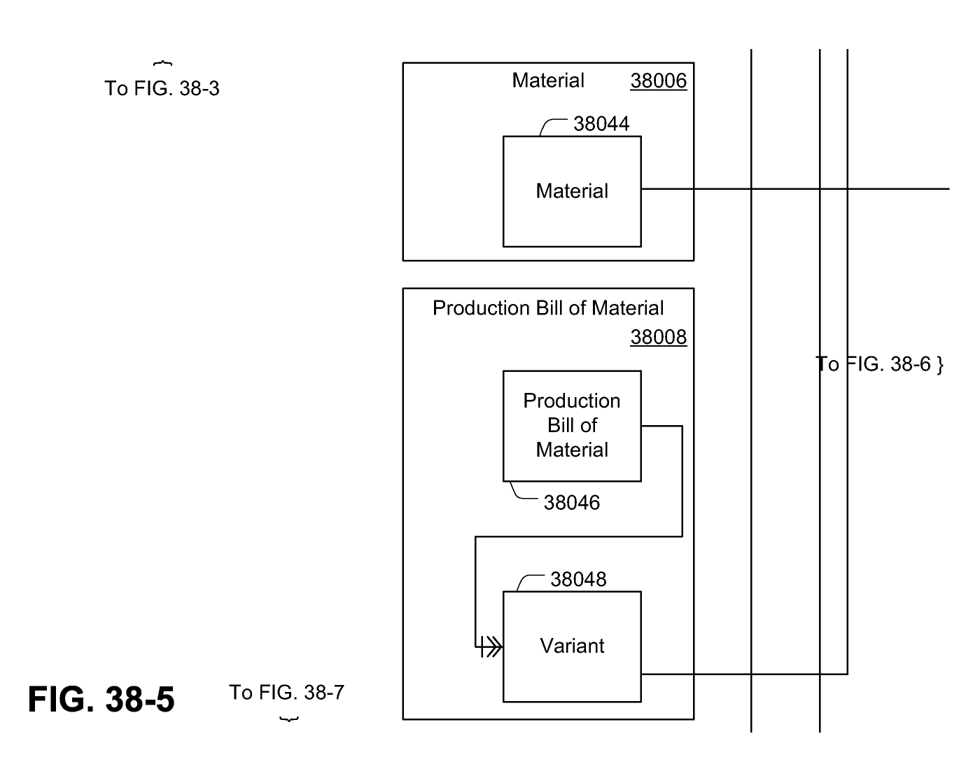

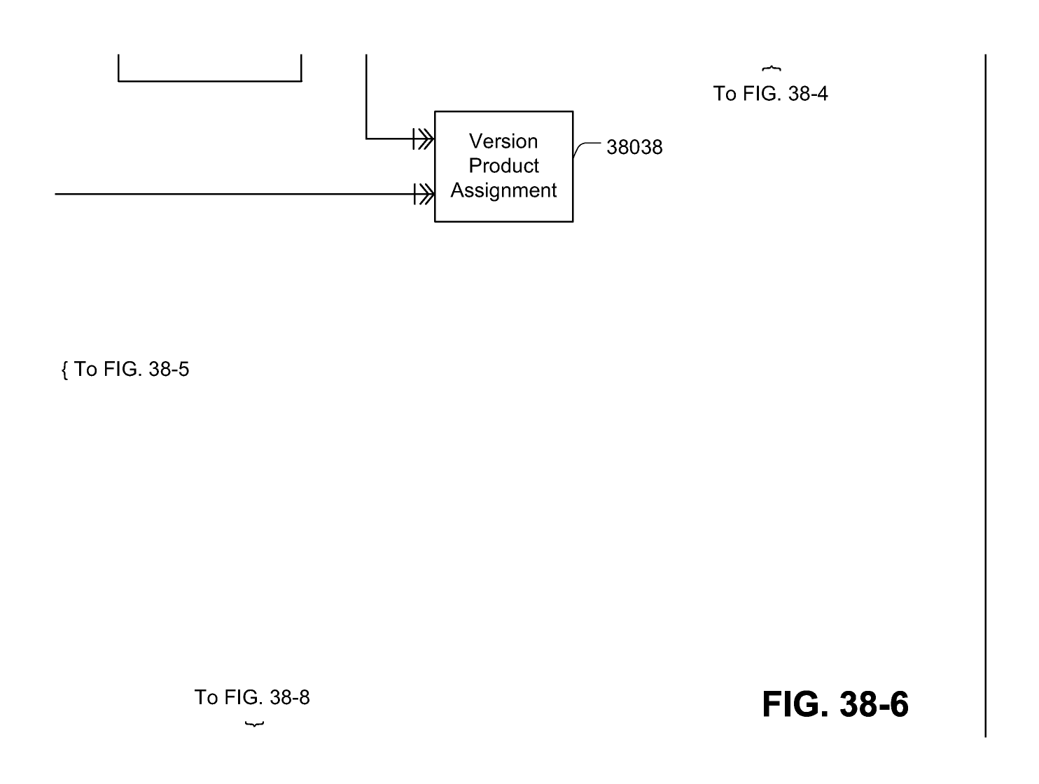

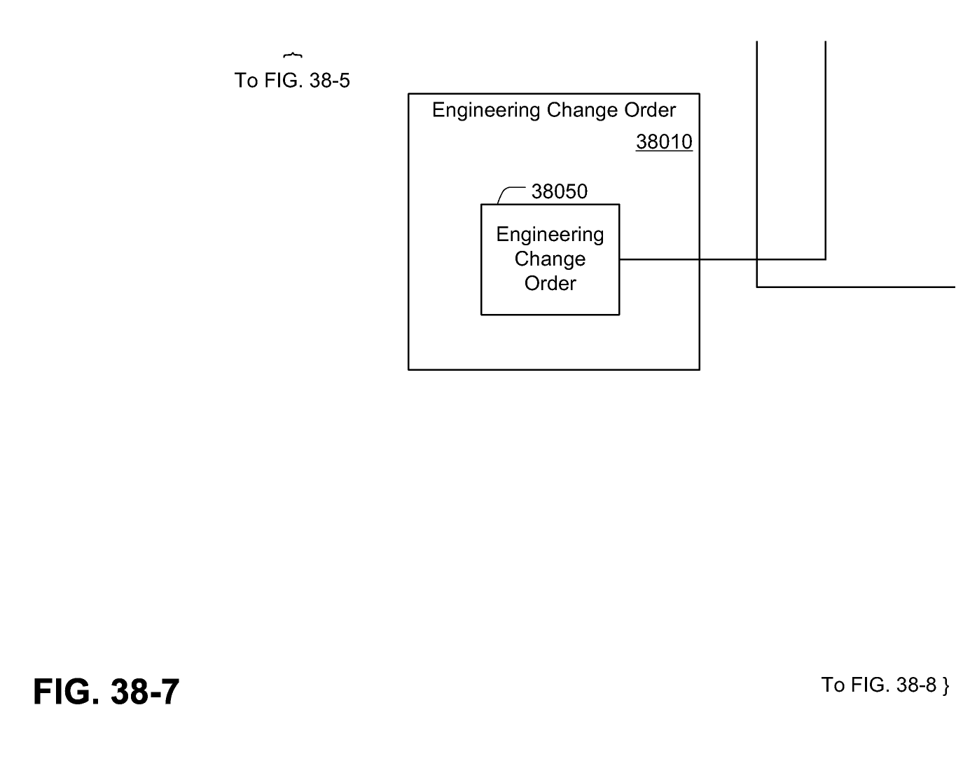

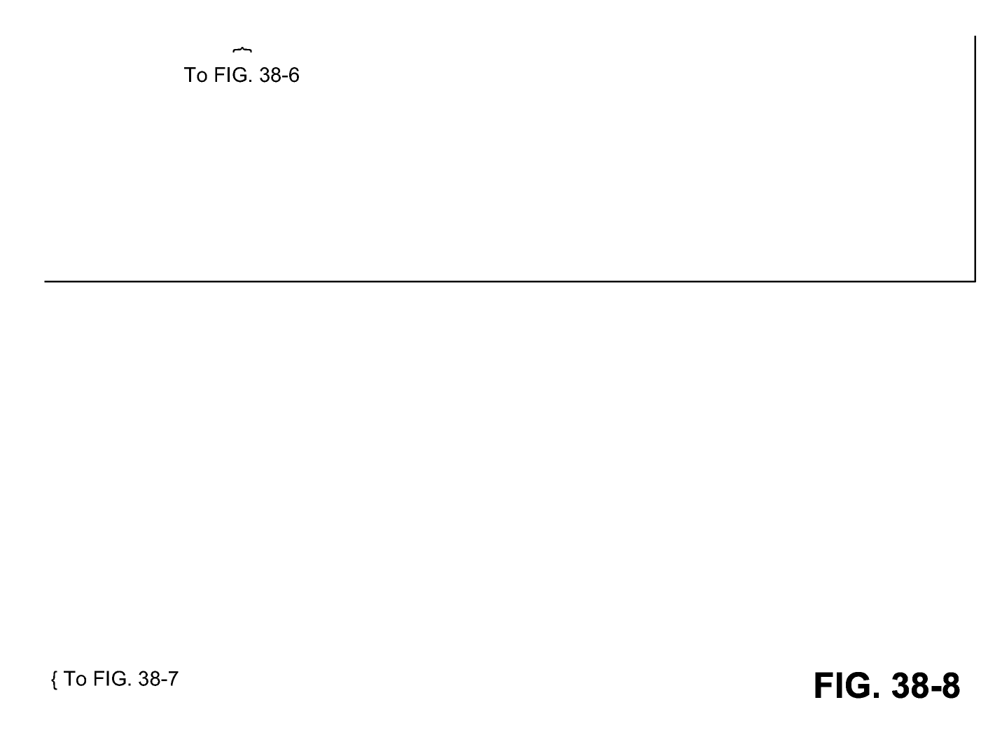

FIGS. 38-1 through 38-8 depict an example object model for a business object Product Design 38000. The business object 38000 has relationships with other objects 38002-38010, as shown with lines and arrows. The business object 38000 hierarchically comprises elements 38012-38038. The other objects 38002-38010 include respective elements 38040-38050 as shown.

The business object Product Design is a description of a product as designed by engineering. The business object Product Design includes design-related documents and a list of components. The business object Product Design belongs to the process component Product Engineering Foundation. A product design may represent different categories of designs, such as mechanical, electrical, or software designs, or the combination of these. A product design can either represent a single-level assembly or a part, and can be used to integrate design information with engineering systems, as the basis for a product development process and as a starting point for subsequent business process steps within the lifecycle of a product, such as in manufacturing. The business object Product Design includes the products that it represents, and the components which it can be divided into and that are represented by other product designs. Both products and components are version-dependent. The business object Product Design is involved in the following Process Component Interaction Models: External Engineering System_Product Engineering Foundation and Input and Output Management_Product Engineering Foundation. A connected computer aided design or team data management system can create product designs via web-services. A corresponding object in a computer aided design/team data management system is referred to as engineering design. A product design can also be created manually.

The business object Product Design includes a Product Design root node. The elements located directly at the node Product Design are defined by the data type ProductDesignElements. These elements include: UUID, ID, CategoryCode, ResponsibleEmployeeUUID, ResponsibleEmployeeID, EngineeringDesignIdentification, EngineeringDesignBusinessSystemID, EngineeringDesignBusinessSystemName, EngineeringDesignID, EngineeringDesignInternalID, MostRecentlyCreatedVersionUUID, and SystemAdministrativeData. UUID may be an alternative key, is a universally unique identifier of a product design, and may be based on datatype GDT: UUID. ID may be an alternative key, is a unique identifier of a product design, and may be based on datatype GDT: ProductDesignID. CategoryCode may be optional, is a category of a product design, and may be based on datatype GDT: ProductDesignCategoryCode. ResponsibleEmployeeUUID may be optional, is a universally unique identifier of an employee who is responsible for a product design, and may be based on datatype GDT: UUID. ResponsibleEmployeeID may be optional, is an identifier of an employee who is responsible for a product design, and may be based on datatype GDT: EmployeeID, with a qualifier of Responsible. EngineeringDesignIdentification may be optional, is unique identification of a product design given by an engineering system, and may be based on datatype BOIDT: ProductDesignEngineeringDesignIdentification. EngineeringDesignBusinessSystemID may be optional, is an identifier of a business system of an engineering design, and may be based on datatype GDT: BusinessSystemID, with a qualifier of EngineeringDesign. EngineeringDesignBusinessSystemName may be optional, is a name of a business system of an engineering design, and may be based on datatype GDT: LANGUAGEINDEPENDENT_LONG_Name, with a qualifier of BusinessSystem. EngineeringDesignID may be optional, is a unique identifier of a product design given by an engineering system, may be based on datatype GDT: EngineeringDesignID, and may be unique within a context of an engineering business system. EngineeringDesignInternalID may be optional, is an internal identifier of a product design given by an engineering system, and may be based on datatype GDT: EngineeringDesignInternalID. MostRecentlyCreatedVersionUUID may be optional, is a universally unique identifier of a most recently created product design version, and may be based on datatype GDT: UUID. In some implementations, the most recently created product design version is not obsolete. SystemAdministrativeData includes administrative data recorded by the system, and may be based on datatype GDT: SystemAdministrativeData. SystemAdministrativeData may include system users and change dates/times.

The following composition relationships to subordinate nodes exist: Component with a cardinality of 1:CN, Description with a cardinality of 1:CN, Version with a cardinality of 1:CN, Text Collection with a cardinality of 1:C, Attachment Folder with a cardinality of 1:C, and ProductionBillOfMaterialVariantHandover with a cardinality of 1:CN. A Responsible Employee inbound association relationship may exist from the business object Employee/node Employee, with a cardinality of C:CN, which specifies an employee who is responsible for a product design. A Creation Identity inbound association relationship may exist from the business object Identity/node Identity, with a cardinality of 1:CN, which identifies an identity that created a product design. A Last Change Identity inbound association relationship may exist from the business object Identity/node Identity, with a cardinality of 1:CN, which identifies an identity that changed a product design. A Version Determination specialization association for navigation may exist to node Version, with a target cardinality of C, which identifies a product design version taking into account a specified method to determine the version. The association may include filter element. The filter elements are defined by the data type ProductDesignVersionDeterminationFilterElements. These elements include ValidityDate and ValidityDeterminationCode. ValidityDate may be optional, specifies a date on which product design versions are to be valid, and may be based on datatype GDT: Date. VersionDeterminationCode is a coded representation of a method describing how to determine a product design version, and may be based on datatype GDT: ProductDesignVersionDeterminationMethodCode. A Most Recently Created Version specialization association for navigation may exist to node Version, with a target cardinality of C, which identifies a most recently created product design version. In some implementations, the version does not have the status “Obsolete.”

A Select All query provides the NodeIDs of all instances of a node, and may be used to enable an initial load of data for a fast search infrastructure. A Query By Elements query provides a list of all product designs that satisfy a selection criteria specified by query elements. The query elements are defined by the data type ProductDesignElementsQueryElements. These elements include: ID, EngineeringDesignBusinessSystemID, EngineeringDesignBusinessSystemName, EngineeringDesignID, EngineeringDesignInternalID, ResponsibleEmployeeID, ResponsibleEmployeePersonGivenName, ResponsibleEmployeePersonFamilyName, CategoryCode, Description, SystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID. ID may be optional, and may be based on datatype GDT: ProductDesignID. EngineeringDesignBusinessSystemID may be optional, and may be based on datatype GDT: BusinessSystemID, with a qualifier of EngineeringDesign. EngineeringDesignBusinessSystemName may be optional, and may be based on datatype GDT: LANGUAGEINDEPENDENT_LONG_Name, with a qualifier of BusinessSystem. EngineeringDesignID may be optional, and may be based on datatype GDT: EngineeringDesignID. EngineeringDesignInternalID may be optional, and may be based on datatype GDT: EngineeringDesignInternalID. ResponsibleEmployeeID may be optional, and may be based on datatype GDT: EmployeeID, with a qualifier of Responsible. ResponsibleEmployeePersonGivenName may be optional, and may be based on datatype GDT: LANGUAGEINDEPENDENT_MEDIUM_Name, with a qualifier of Given. ResponsibleEmployeePersonFamilyName may be optional, and may be based on datatype GDT: LANGUAGEINDEPENDENT_MEDIUM_Name, with a qualifier of Family. CategoryCode may be optional, and may be based on datatype GDT: ProductDesignCategoryCode. Description may be optional, and may be based on datatype GDT: MEDIUM_Description. SystemAdministrativeData may be optional and may be based on datatype QueryIDT: QueryElementSystemAdministrativeData. CreationDateTime may be optional, is a point in time date and time stamp of the creation, and may be based on datatype GDT: GLOBAL_DateTime. CreationIdentityUUID may be optional, is a globally unique identifier for an identity who performed a creation, and may be based on datatype GDT: UUID. CreationIdentityID may be optional, is an identifier for an identity who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made the last changes, and may be based on datatype GDT: UUID. LastChangeIdentityID may be optional, is an identifier for an identity who made the last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID. SearchText may be optional, includes free text including one or several search terms to search for product designs, and may be based on datatype GDT: SearchText. For every query that includes the SearchText as a query parameter an application-specific subset of the other query parameters may be defined. The search terms are assigned to the subset of query parameters in such a way that every search term is used exactly once in an assignment. Several search terms may be assigned to the same query parameter. For each of these assignments the query result is calculated. The total result is now the union of the results calculated per assignment.

Component is a part of a product design which can be used in several versions. The elements located directly at the node Component are defined by the data type ProductDesignComponentElements. These elements include: UUID, ID, Key, ProductDesignUUID, and ProductDesignComponentID. UUID may be an alternative key, is a universally unique identifier of a product design component, and may be based on datatype GDT: UUID. ID is a unique identifier of a product design component, may be based on datatype GDT: ProductDesignComponentID, and may be unique within a product design. Key may be an alternative key, is a key of a product design component, and may be based on datatype KDT: ProductDesignComponentKey. ProductDesignUUID is a universally unique identifier of a product design, and may be based on datatype GDT: UUID. ProductDesignComponentID is a unique identifier of a product design component, may be based on datatype GDT: ProductDesignComponentID, and may be unique within a product design.

Description is a language-dependent description of a product design. The elements located directly at the node Description are defined by the data type ProductDesignDescriptionElements. These elements include Description, which is a language-dependent description of a product design which may be based on datatype GDT: MEDIUM_Description. Version is a specific version of a product design. A new product design version does not invalidate previous versions. The elements located directly at the node Version are defined by the data type ProductDesignVersionElements. These elements include: UUID, ID, Name, EngineeringDesignVersionIdentification, EngineeringDesignVersionID, EngineeringDesignVersionInternalID, ManuallyCreatedIndicator, PredecessorVersionUUID, PredecessorVersionEngineeringDesignVersionIdentification, EngineeringDesignBusinessSystemID, EngineeringDesignBusinessSystemName, EngineeringDesignID, EngineeringDesignInternalID, EngineeringDesignVersionID, EngineeringDesignVersionInternalID, EngineeringDesignChangeOrderID, ApplicationLogUUID, BaseQuantity, BaseQuantityTypeCode, ProposedProcurementMethodCode, ValidityStartDate, ActivationDate, ActivationTime, EngineeringDesignVersionStatusName, EngineeringDesignVersionStatus,EngineeringDesignVersionResponsibleEngineerPersonFamily Name, EngineeringDesignVersionResponsibleEngineerPersonGivenName, EngineeringDesignVersionReleaseDate, EngineeringDesignVersionReplicationCancelledIndicator, EngineeringDesignVersionPrimaryViewableCreationDateTime, EngineeringDesignVersionCreationDateTime, EngineeringDesignVersionLastChangeDateTime, SystemAdministrativeData, AssemblyIndicator, Status, LifeCycleStatusCode, ActivationStatusCode, Blocking StatusCode, ObsolescenceStatusCode, ReviewProcessingStatusCode, ExecutionUsageBlockingStatusCode, EngineeringDesignVersionReleaseStatusCode, ConsistencyStatusCode, Key, ProductDesignID, and ProductDesignVersionID. UUID may be an alternative key, is a universally unique identifier of a product design version, and may be based on datatype GDT: UUID. ID is a unique identifier of a product design version, may be based on datatype GDT: VersionID, and may be unique within a product design. Name may be optional, is a ame of a product design version, and may be based on datatype GDT: LANGUAGEINDEPENDENT_MEDIUM_Name. EngineeringDesignVersionIdentification may be optional, is a unique identification of a product design version given by an engineering system that is defined within a product design root node, and may be based on datatype BOIDT: ProductDesignVersionEngineeringDesignVersionIdentification. EngineeringDesignVersionID may be optional, is a unique identifier of a product design version given by an engineering system, may be based on datatype GDT: EngineeringDesignVersionID, and may be unique within a product design. EngineeringDesignVersionInternalID may be optional, is an internal identifier of a product design version given by an engineering system, may be based on datatype GDT: EngineeringDesignVersionInternalID, and may be unique within a product design. ManuallyCreatedIndicator indicates whether a product design version is created manually, and may be based on datatype GDT: Indicator, with a qualifier of Created. PredecessorVersionUUID may be optional, is a universally unique identifier of a preceding version, and may be based on datatype GDT: UUID. PredecessorVersionEngineeringDesignVersionIdentification may be optional, is an identification of a preceding version given by an indicated engineering system, and may be based on datatype BOIDT: ProductDesignVersionPredecessorEngineeringDesignVersionIdentification. EngineeringDesignBusinessSystemID may be optional, is an identifier of a business system of an engineering design, and may be based on datatype GDT: BusinessSystemID, with a qualifier of EngineeringDesign. EngineeringDesignBusinessSystemName may be optional, is a name of a business system of an engineering design, and may be based on datatype GDT: LANGUAGEINDEPENDENT_LONG Name, with a qualifier of BusinessSystem. EngineeringDesignID may be optional, is a unique identifier of a product design given by an engineering system, may be based on datatype GDT: EngineeringDesignID, may be unique within a context of a engineering business system. EngineeringDesignInternalID may be optional, is an internal identifier of a product design given by an engineering system, and may be based on datatype GDT: EngineeringDesignInternalID. EngineeringDesignVersionID may be optional, is a unique identifier of a product design version given by an engineering system, and may be based on datatype GDT: EngineeringDesignVersionID. EngineeringDesignVersionInternalID may be optional, is an internal identifier of a product design version given by an engineering system, and may be based on datatype GDT: EngineeringDesignVersionInternalID. EngineeringDesignChangeOrderID may be optional, is a unique identifier of an engineering change order for an engineering design, may be based on datatype GDT: EngineeringDesignChangeOrderID, and may be provided by an engineering system. ApplicationLogUUID may be optional, is a universally unique identifier of a corresponding application log, and may be based on datatype GDT: UUID. BaseQuantity may be optional, is Base quantity of a product design version, and may be based on datatype GDT: POSITIVE_Quantity, with a qualifier of Base. BaseQuantityTypeCode may be optional, is a type of a base quantity of a product design version, and may be based on datatype GDT: QuantityTypeCode, with a qualifier of Base. ProposedProcurementMethodCode may be optional, is a coded representation of a method that is proposed for a procurement of a product assigned to a product design, may be based on datatype GDT: ProcurementMethodCode, may be independent from a procurement method code of an assigned product, and can be used as a proposal when the product is created. ValidityStartDate may be optional, is a date from which a version is valid to be used in subsequent processes, such as for conversion to a production bill of material, and may be based on datatype GDT: Date, with a qualifier of ValidityStart. ActivationDate may be optional, is an activation date of a version, and may be based on datatype GDT: Date, with a qualifier of Activation. The activation date may be given, for example, in UTC (Coordinated Universal Time). ActivationTime may be optional, is AN activation time of a version, and may be based on datatype GDT: Time, with a qualifier of Activation. The activation time may be given in UTC. EngineeringDesignVersionStatusName may be optional, is a status of an engineering design version, and may be based on datatype GDT: LANGUAGEINDEPENDENT_MEDIUM_Name, with a qualifier of EngineeringDesignVersionStatus. EngineeringDesignVersionResponsibleEngineerPersonFamilyName may be optional, is a family name of a responsible engineer of an engineering design version, and may be based on datatype GDT: LANGUAGEINDEPENDENT_MEDIUM_Name, with a qualifier of Family. EngineeringDesignVersionResponsibleEngineerPersonGivenName may be optional, is a given name of a responsible engineer of an engineering design version, and may be based on datatype GDT: LANGUAGEINDEPENDENT_MEDIUM_Name, with a qualifier of Given. EngineeringDesignVersionReleaseDate may be optional, is a release date of a version in an engineering system that is defined within a product design root node, and may be based on datatype GDT: Date, with a qualifier of Release. EngineeringDesignVersionReplicationCancelledIndicator indicates whether the replication of an engineering design version has been cancelled, and may be based on datatype GDT: Indicator, with a qualifier of Cancelled. EngineeringDesignVersionPrimaryViewableCreationDateTime may be optional, is a creation date/time date and time stamp of a primary viewable file of an engineering design version, and may be based on datatype GDT: GLOBAL_DateTime, with a qualifier of Creation. GLOBAL_DateTime may be at least accurate to the second. EngineeringDesignVersionCreationDateTime may be optional, is a creation date/time date and time stamp of an engineering design version, and may be based on datatype GDT: GLOBAL_DateTime, with a qualifier of Creation. EngineeringDesignVersionLastChangeDateTime may be optional, is a time date and time stamp of a last change of an engineering design version, and may be based on datatype GDT: GLOBAL_DateTime, with a qualifier of Change. SystemAdministrativeData includes administrative data recorded by the system, and may be based on datatype GDT: SystemAdministrativeData. SystemAdministrativeData may include system users and change dates/times. AssemblyIndicator indicates whether a version is an assembly, and may be based on datatype GDT: Indicator, with a qualifier of Assembly. In some implementations, a version is an assembly if it has at least one component. Status is a status of a product design version, and may be based on datatype BOIDT: ProductDesignVersionStatus. LifeCycleStatusCode is a current step in a life cycle of a product design version, and may be based on datatype GDT: ProductDesignVersionLifeCycleStatusCode. ActivationStatusCode is a coded representation of an activation status of a product design version, and may be based on datatype GDT: INACTIVEACTIVE_ActivationStatusCode. BlockingStatusCode is a coded representation of a blocking status of a product design version, and may be based on datatype GDT: NOTBLOCKEDBLOCKED_BlockingStatusCode. ObsolescenceStatusCode is a coded representation of an obsolescence status of a product design version, and may be based on datatype GDT: ObsolescenceStatusCode. ReviewProcessingStatusCode is a coded representation of a review processing status of a product design version, and may be based on datatype GDT: ProcessingStatusCode, with a qualifier of Review. ExecutionUsageBlockingStatusCode includes information about whether a product design version has been blocked, and may be based on datatype GDT: NOTBLOCKEDBLOCKED_BlockingStatusCode, with a qualifier of ExecutionUsage. EngineeringDesignVersionReleaseStatusCode includes information about the release status of an engineering design version, and may be based on datatype GDT: EngineeringDesignVersionReleaseStatusCode. ConsistencyStatusCode is a coded representation of the consistency of a product design version, and may be based on datatype GDT: ConsistencyStatusCode. Key may be an alternative key, is a key of a product design version, and may be based on datatype KDT: ProductDesignVersionKey. ProductDesignID is a unique identifier of a product design, and may be based on datatype GDT: ProductDesignID. ProductDesignVersionID is a unique identifier of a product design version, may be based on datatype GDT: VersionID, and may be unique within a context of a product design.

The following composition relationships to subordinate nodes exist: Version Component with a cardinality of 1:CN, Version Attachment Folder with a cardinality of 1:C, Version Description with a cardinality of 1:CN, Version Text Collection with a cardinality of 1:C, and Version Product Assignment with a cardinality of 1:CN.

A Creation Identity inbound association relationship may exist from the business object Identity/node Identity, with a cardinality of 1:CN, which identifies an identity that created a product design version. A Last Change Identity inbound association relationship may exist from the business object Identity/node Identity, with a cardinality of 1:CN, which identifies an identity that changed a product design version. A ReferencingVersion inbound association relationship may exist From the business object Product Design/node Version, with a cardinality of C:CN, which is a version that includes a reference to another version. A PredecessorVersion inbound association relationship may exist From the business object Product Design/node Version, with a cardinality of C:CN, which is a preceding version. An Application Log specialization association for navigation may exist to business object Application Log/node Application Log, with a target cardinality of C, which identifies an application log that corresponds to a product design version.

An Activate enterprise service infrastructure action activates a product design version. The Activate action may have preconditions that the action is enabled when the activation status variable has the value “Inactive”, the consistency status variable has the value “Consistent”, the execution usage blocking status variable has the status “Not Blocked”, the lifecycle status variable has the value “In Preparation” or “Review Finished”, or when the engineering design version release status variable has the value “Released.” In response to the Activate action, the activation status variable has the value “Active.” This action can, for example, be executed by the user on a user interface. A Flag As Obsolete action flags a product design version as obsolete. The Flag As Obsolete action may have preconditions that the action is enabled when the obsolescence status variable has the value “Not Obsolete” or when the engineering design version release status variable does not have the value “Not Released.” In response to the Flag As Obsolete action, the obsolescence status variable has the value “Obsolete.” This action can, for example, be executed by the user on a user interface. A Revoke Obsolescence action puts a product design version back to the status “Blocked.” The Revoke Obsolescence action may have preconditions that the action is enabled when the obsolescence status variable has the value “Obsolete” or the engineering design version release status variable does not have the value “Not Released.” In response to the Revoke Obsolescence action, the obsolescence status variable has the value “Not Obsolete.” This action can, for example, be executed by the user on a user interface. A Unblock Execution Usage action unblocks a product design version for usage in execution. The Unblock Execution Usage action may have preconditions that the action is enabled when the execution usage blocking status variable has the status “Blocked”, the lifecycle status variable has the value “In Preparation” or “Review Finished”, or the engineering design version release status variable does not have the value “Not Released.” In response to the Unblock Execution Usage action, the execution usage blocking status variable has the status “Not Blocked.” This action can, for example, be executed by the user on a user interface. A Block Execution Usage action blocks a product design version for usage in execution. The Block Execution Usage action may have preconditions that the action is enabled when the execution usage blocking status variable has the status “Not Blocked”, the lifecycle status variable has the value “In Preparation” or “Review Finished”, or the engineering design version release status variable does not have the value “Not Released.” In response to the Block Execution Usage action, the execution usage blocking status variable has the status “Blocked.” This action can, for example, be executed by the user on a user interface. A Notify Of Engineering Design Version Release action notifies a product design version that an engineering design version has been released. The Notify Of Engineering Design Version Release action may have preconditions that the action is enabled when the engineering design version release status variable has the value “Not Released.” In response to the Notify Of Engineering Design Version Release action, the engineering design version release status variable has the value “Released.” This action is called by the agent which creates the product design via incoming message. A Notify Of Engineering Design Version Cancel Release action notifies a product design version that a release of an engineering design version has been cancelled. The Notify Of Engineering Design Version Cancel Release action may have preconditions that the action is enabled when the engineering design version release status variable has the value “Released.” In response to the Notify Of Engineering Design Version Cancel Release action, the engineering design version release status variable has the value “Release Cancelled.” This action is called by the agent which creates the product design via incoming message. A Notify Of Engineering Design Version Discard Release action notifies a product design version that a release of an engineering design version has been discarded. The Notify Of Engineering Design Version Discard Release action may have preconditions that the action is enabled when the engineering design version release status variable has the value “Not Released.” In response to the Notify Of Engineering Design Version Discard Release action, the engineering design version release status variable has the value “Discarded.” This action is called by the agent which creates the product design via incoming message. A Block action blocks a product design version. The Block action may have preconditions that the action is enabled when the blocking status variable has the status “Not Blocked”, the obsolescence status variable has the value “Not obsolete”, and the engineering design version release status variable does not have the value “Not Released.” In response to the Block action, the blocking status variable has the status “Blocked.” This action can, for example, be executed by the user on a user interface. An Unblock action unblocks a product design version. The Unblock action may have preconditions that the action is enabled when the blocking status variable has the status “Blocked” and the obsolescence status variable has the value “Not obsolete.” In response to the Unblock action, the blocking status variable has the status “Not Blocked.” This action can, for example, be executed by the user on a user interface. A Start Review action starts a review process of a product design version. The Start Review action may have preconditions that the action is enabled when the review processing status variable has the value “Not Started”, the consistency status variable has the value “Consistent”, the lifecycle status variable has the value “In Preparation”, and the engineering design version release status variable has the value “Released.” In response to the Start Review action, the review processing status variable has the value “In Process.” This action can, for example, be executed by the user on a user interface. A Finish Review action finishes a review process of a product design version. The Finish Review action may have preconditions that the action is enabled when the review processing status variable has the value “In Process.” In response to the Finish Review action, the review processing status variable has the value “Finished.” This action can, for example, be executed by the user on a user interface. A Revoke Start Review action revokes the start of a review process of a product design version. The Revoke Start Review action may have preconditions that the action is enabled when the review processing status variable has the value “In Process.” In response to the Revoke Start Review action, the review processing status variable has the value “Not Started.” This action can, for example, be executed by the user on a user interface. A FinishReviewAndActivate action finishes a review process of a product design version and activates the product design. The FinishReviewAndActivate action may have preconditions that the action is enabled when the review processing status variable has the value “In Process.” In response to the FinishReviewAndActivate action, the review processing status variable has the value “Finished” and the activation status variable has the value “Active.” This action can, for example, be executed by the user on a user interface.

A Copy action copies a product design version. The copy action may include parameter action elements. The action elements are defined by the data type ProductDesignVersionCopyActionElements. These elements include: TargetProductDesignID, TextCollectionIncludeIndicator, AttachmentFolderIncludeIndicator, and ProductAssignmentIncludeIndicator. TargetProductDesignID may be optional, is an identifier of a product design to which a version is to be copied, and may be based on datatype GDT: ProductDesignID. If no product design with the indicated identifier exists, a product design is created. If no identifier is indicated, a product design is created and its identifier is determined automatically. TextCollectionIncludeIndicator indicates whether text collections are to be included in a copy, and may be based on datatype GDT: Indicator, with a qualifier of Include. AttachmentFolderIncludeIndicator indicates if attachment folders are to be included in a copy, and may be based on datatype GDT: Indicator, with a qualifier of Include. ProductAssignmentIncludeIndicator indicates if product assignments are to be included in a copy, and may be based on datatype GDT: Indicator, with a qualifier of Include.

A CopyProductAssignment action takes over a product assignment of another product design version. The CopyProductAssignment action may include parameter action elements. The action elements are defined by the data type ProductDesignVersionCopyProductAssignmentActionElements. These elements include: SourceProductDesignVersionKey, ProductDesignID, and ProductDesignVersionID. SourceProductDesignVersionKey is a key of a product design version from which a product assignment is to be copied, and may be based on datatype KDT: ProductDesignVersionKey. ProductDesignID is a unique identifier of a product design, and may be based on datatype GDT: ProductDesignID. ProductDesignVersionID is a unique identifier of a product design version, may be based on datatype GDT: VersionID, and may be unique within a context of a product design.

A Create Production Bill Of Material action creates a production bill of material from a product design version. The Create Production Bill Of Material action may include parameter action elements. The action elements are defined by the data type ProductDesignVersionCreateProductionBillOfMaterialActionElements. These elements include: ProductionBillOfMaterialVariantKey, BillOfMaterialVariantID, BillOfMaterialID, EngineeringChangeOrderID, EngineeringChangeOrderValidityStartDate, and ProductDesignExplosionDate. ProductionBillOfMaterialVariantKey is a key of a production bill of material variant to be created, and may be based on datatype KDT: BillOfMaterialVariantKey. BillOfMaterialVariantID is an identifier for a variant of a bill of material, and may be based on datatype GDT: BillOfMaterialVariantID. BillOfMaterialID is an identifier for a bill of material, and may be based on datatype GDT: BillOfMaterialID. EngineeringChangeOrderID may be optional, is an identifier of an engineering change order for a creation of a production bill of material, and may be based on datatype GDT: EngineeringChangeOrderID. EngineeringChangeOrderValidityStartDate may be optional, is a validity start date of an engineering change order for a creation of a production bill of material, and may be based on datatype GDT: Date, with a qualifier of ValidityStart. ProductDesignExplosionDate may be optional, is a date at which a product design is exploded for a production bill of material variant creation, and may be based on datatype GDT: Date, with a qualifier of Explosion.

A Query By Elements query provides a list of all product design versions that satisfy the selection criteria specified by the query elements. The query elements are defined by the data type ProductDesignVersionElementsQueryElements. These elements include: Key, ProductDesignVersionID, Description, ProductDesignDescription, Name, LifeCycleStatusCode, ExecutionUsageBlockingStatusCode, EngineeringDesignVersionReleaseStatusCode, ConsistencyStatusCode, ManuallyCreatedIndicator, AssemblyIndicator, MostRecentlyCreatedIndicator, ValidityStartDate, ActivationDate, ProductDesignResponsibleEmployeeID, ProductDesignResponsibleEmployeePersonGivenName, ProductDesignResponsibleEmployeePersonFamilyName, SystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, LastChangeIdentityEmployeeID, ProductDesignVersionComponentProductDesignVersionKey, ProductDesignID, ProductDesignVersionID, ProductKey, ProductTypeCode, ProductidentifierTypeCode, ProductID, ProductDescription, ProductDesignEngineeringDesignBusinessSystemID, ProductDesignEngineeringDesignBusinessSystemName, ProductDesignEngineeringDesignID, ProductDesignEngineeringDesignInternalID, EngineeringDesignVersionID, EngineeringDesignVersionInternalID, EngineeringDesignVersionStatusName, EngineeringDesignVersionReplicationCancelledIndicator, EngineeringDesignVersionResponsibleEngineerPersonFamilyName, EngineeringDesignVersionResponsibleEngineerPersonGivenName, EngineeringDesignChangeOrderID, ProductionBillOfMaterialVariantKey, BillOfMaterialVariantID, BillOfMaterialID, and SearchText. Key may be optional, and may be based on datatype KDT: ProductDesignVersionKey. ProductDesignID is a unique identifier of a product design, and may be based on datatype GDT: ProductDesignID. ProductDesignVersionID is a unique identifier of a product design version, may be based on datatype GDT: VersionID, and may be unique within a context of a product design. Description may be optional, and may be based on datatype GDT: MEDIUM_Description. ProductDesignDescription may be optional, and may be based on datatype GDT: MEDIUM_Description, with a qualifier of ProductDesign. Name may be optional, and may be based on datatype GDT: LANGUAGEINDEPENDENT_MEDIUM_Name. LifeCycleStatusCode may be optional, and may be based on datatype GDT: ProductDesignVersionLifeCycleStatusCode. ExecutionUsageBlockingStatusCode may be optional, and may be based on datatype GDT: NOTBLOCKEDBLOCKED_BlockingStatusCode, with a qualifier of ExecutionUsage. EngineeringDesignVersionReleaseStatusCode may be optional, and may be based on datatype GDT: EngineeringDesignVersionReleaseStatusCode. ConsistencyStatusCode may be optional, and may be based on datatype GDT: ConsistencyStatusCode. ManuallyCreatedIndicator may be optional, and may be based on datatype GDT: Indicator, with a qualifier of Created. AssemblyIndicator may be optional, and may be based on datatype GDT: Indicator, with a qualifier of Assembly. MostRecentlyCreatedIndicator may be optional, indicates if only the versions which were created most recently are to be returned by the query, and may be based on datatype GDT: Indicator, with a qualifier of Created. ValidityStartDate may be optional, and may be based on datatype GDT: Date, with a qualifier of ValidityStart. ActivationDate may be optional, and may be based on datatype GDT: Date, with a qualifier of Activation. ProductDesignResponsibleEmployeeID may be optional, is an identifier of a responsible employee who is responsible for the processing of a product design, and may be based on datatype GDT: EmployeeID, with a qualifier of Responsible. ProductDesignResponsibleEmployeePersonGivenName may be optional, is a given name of a responsible employee who is responsible for the processing of a product design, and may be based on datatype GDT: LANGUAGEINDEPENDENT_MEDIUM_Name, with a qualifier of Given. ProductDesignResponsibleEmployeePersonFamilyName may be optional, is a family name of a responsible employee who is responsible for the processing of a product design, and may be based on datatype GDT: LANGUAGEINDEPENDENT_MEDIUM_Name, with a qualifier of Family. SystemAdministrativeData may be optional and may be based on datatype QueryIDT: QueryElementSystemAdministrativeData. CreationDateTime may be optional, is a point in time date and time stamp of a creation, and may be based on datatype GDT: GLOBAL_DateTime. CreationIdentityUUID may be optional, is a globally unique identifier for an identity who performed a creation, and may be based on datatype GDT: UUID. CreationIdentityID may be optional, is an identifier for an identity who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made the last changes, and may be based on datatype GDT: UUID. LastChangeIdentityID may be optional, is an identifier for an identity who made the last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID. ProductDesignVersionComponentProductDesignVersionKey may be optional, and may be based on datatype KDT: ProductDesignVersionKey. ProductDesignID is a unique identifier of a product design, and may be based on datatype GDT: ProductDesignID. ProductDesignVersionID is a unique identifier of a product design version, and may be based on datatype GDT: VersionID, and may be unique within a context of a product design. ProductKey may be optional, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. ProductDescription may be optional, and may be based on datatype GDT: SHORT_Description, with a qualifier of Product. ProductDesignEngineeringDesignBusinessSystemID may be optional, and may be based on datatype GDT: BusinessSystemID, with a qualifier of EngineeringDesign. ProductDesignEngineeringDesignBusinessSystemName may be optional, and may be based on datatype GDT: LANGUAGEINDEPENDENT_LONG_Name, with a qualifier of BusinessSystem. ProductDesignEngineeringDesignID may be optional, and may be based on datatype GDT: EngineeringDesignID. ProductDesignEngineeringDesignInternalID may be optional, and may be based on datatype GDT: EngineeringDesignInternalID. EngineeringDesignVersionID may be optional, and may be based on datatype GDT: EngineeringDesignVersionID. EngineeringDesignVersionInternalID may be optional, and may be based on datatype GDT: EngineeringDesignVersionInternalID. EngineeringDesignVersionStatusName may be optional, and may be based on datatype GDT: LANGUAGEINDEPENDENT_MEDIUM_Name, with a qualifier of EngineeringDesignVersionStatus. EngineeringDesignVersionReplicationCancelledIndicator may be optional, and may be based on datatype GDT: Indicator, with a qualifier of Cancelled. EngineeringDesignVersionResponsibleEngineerPersonFamilyName may be optional, and may be based on datatype GDT: LANGUAGEINDEPENDENT_MEDIUM_Name, with a qualifier of Family. EngineeringDesignVersionResponsibleEngineerPersonGivenName may be optional, and may be based on datatype GDT: LANGUAGEINDEPENDENT_MEDIUM_Name, with a qualifier of Given. EngineeringDesignChangeOrderID may be optional, and may be based on datatype GDT: EngineeringDesignChangeOrderID. ProductionBillOfMaterialVariantKey may be optional, is a production bill of material variant key which was created from a product design version, and may be based on datatype KDT: BillOfMaterialVariantKey. BillOfMaterialVariantID is an identifier for a variant of a bill of material, and may be based on datatype GDT: BillOfMaterialVariantID. BillOfMaterialID is an identifier for a bill of material, and may be based on datatype GDT: BillOfMaterialID. SearchText may be optional, includes free text including one or several search terms to search for product design versions, and may be based on datatype GDT: SearchText. For every query that includes the SearchText as a query parameter, an application-specific subset of the other query parameters may be defined. The search terms may be assigned to the subset of query parameters in such a way that every search term is used exactly once in the assignment. Several search terms may be assigned to the same query parameter. For each of these assignments, the query result is calculated. The total result is then the union of the results calculated per assignment.

Version Component is a part of a product design used in a version. Version Component may be represented by another product design. The product design that is represented by a component can itself include components. The elements located directly at the node Version Component are defined by the data type ProductDesignVersionComponentElements. These elements include: UUID, ProductDesignComponentUUID, ProductDesignComponentKey, ProductDesignUUID, ProductDesignComponentID, BaseQuantity, BaseQuantityTypeCode, ProductDesignUUID, ProductDesignID, ProductDesignEngineeringDesignIdentification, EngineeringDesignBusinessSystemID, EngineeringDesignBusinessSystemName, EngineeringDesignID, EngineeringDesignInternalID, ProductDesignVersionUUID, ProductDesignVersionKey, ProductDesignID, ProductDesignVersionID, ProductDesignVersionEngineeringDesignVersionIdentification, EngineeringDesignVersionID, and EngineeringDesignVersionInternalID. UUID may be an alternative key, is a universally unique identifier of the version component, and may be based on datatype GDT: UUID. ProductDesignComponentUUID is a universal unique identifier of a component which is referenced by a version component, and may be based on datatype GDT: UUID. ProductDesignComponentKey is a key of a component which is referenced by a version component, and may be based on datatype KDT: ProductDesignComponentKey. ProductDesignUUID is a universally unique identifier of a product design, and may be based on datatype GDT: UUID. ProductDesignComponentID is a unique identifier of a product design component, may be based on datatype GDT: ProductDesignComponentID, and may be unique within a product design. In some implementations, within a version, a component may be referenced by at most one version component. BaseQuantity may be optional, is a base quantity of a version component, and may be based on datatype GDT: POSITIVE_Quantity, with a qualifier of Base. BaseQuantityTypeCode may be optional, is a type of a base quantity of a version component, and may be based on datatype GDT: QuantityTypeCode, with a qualifier of Base. ProductDesignUUID may be optional, is a universally unique identifier of a referenced product design, and may be based on datatype GDT: UUID. ProductDesignID may be optional, is a unique identifier of a referenced product design, and may be based on datatype GDT: ProductDesignID. ProductDesignEngineeringDesignIdentification may be optional, is a unique identifier of a referenced product design given by an engineering system, and may be based on datatype BOIDT: ProductDesignEngineeringDesignIdentification. EngineeringDesignBusinessSystemID may be optional, is an identifier of a business system of an engineering design, and may be based on datatype GDT: BusinessSystemID, with a qualifier of EngineeringDesign. EngineeringDesignBusinessSystemName may be optional, is a name of a business system of an engineering design, and may be based on datatype GDT: LANGUAGEINDEPENDENT_LONG_Name, with a qualifier of BusinessSystem. EngineeringDesignID may be optional, is a unique identifier of a product design given by an engineering system, may be based on datatype GDT: EngineeringDesignID, and may be unique within a context of an engineering business system. EngineeringDesignInternalID may be optional, is an internal identifier of a product design given by an engineering system, and may be based on datatype GDT: EngineeringDesignInternalID. ProductDesignVersionUUID may be optional, is a universally unique identifier of a referenced product design version, and may be based on datatype GDT: UUID. ProductDesignVersionKey may be optional, is a unique identifier of a referenced product design version, and may be based on datatype KDT: ProductDesignVersionKey. ProductDesignID is a unique identifier of a product design, and may be based on datatype GDT: ProductDesignID. ProductDesignVersionID is a unique identifier of a product design version, may be based on datatype GDT: VersionID, and may be unique within a context of a product design. ProductDesignVersionEngineeringDesignVersionIdentification may be optional, is a unique identifier of a referenced product design version given by an engineering system, and may be based on datatype BOIDT: ProductDesignVersionEngineeringDesignVersionIdentification. EngineeringDesignVersionID may be optional, is a unique identifier of a product design version given by an engineering system, may be based on datatype GDT: EngineeringDesignVersionID, and may be unique within a product design. EngineeringDesignVersionInternalID may be optional, is an internal identifier of a product design version given by an engineering system, and may be based on datatype GDT: EngineeringDesignVersionInternalID.

The following composition relationships to subordinate nodes exist: Version Component Attachment Folder with a cardinality of 1:C, and Version Component Text Collection with a cardinality of 1:C. A Component inbound aggregation relationship may exist from the business object Product Design/node Component, with a cardinality of 1:N, which is a component of a product design version component. A Product Design inbound aggregation relationship may exist from the business object Product Design/node Product Design, with a cardinality of C:CN, which is a different product design which is a part of the current product design version. A Product Design Version inbound aggregation relationship may exist from the business object Product Design/node Version, with a cardinality of C:CN, which is a different product design version which is a part of a current product design version.

A Version Component Attachment Folder dependent object inclusion node is a folder for collecting and organizing documents, references, and decisions relevant for a specific version component of a product design. A Version Component Text Collection dependent object inclusion node is a collection of natural-language text with additional information about a product design version component. A Version Attachment Folder dependent object inclusion node is a folder for collecting and organizing documents, references, and decisions relevant for a specific version of a product design, which may include a viewable for a computer aided design file in a lean format or a link to a file. A Version Description is a language-dependent description of a product design version. The elements located directly at the node Version Description are defined by the data type ProductDesignVersionDescriptionElements. These elements include Description, which is a language-dependent description of a product design version which may be based on datatype GDT: MEDIUM_Description. A Version Text Collection dependent object inclusion node is a collection of natural-language text with additional information about a product design version.

Version Product Assignment is a product that is represented by a product design version. The elements located directly at the node Version Product Assignment are defined by the data type ProductDesignVersionProductAssignmentElements. These elements include: UUID, ProductUUID, ProductKey, ProductTypeCode, ProductidentifierTypeCode, ProductID, and DefaultIndicator. UUID may be an alternative key, is a universal unique identifier of a version product, and may be based on datatype GDT: UUID. ProductUUID is a universal unique identifier of an assigned product, and may be based on datatype GDT: UUID. ProductKey is a key of an assigned product, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. DefaultIndicator is an indicator for a default product, and may be based on datatype GDT: Indicator, with a qualifier of Default.

A Material inbound aggregation relationship may exist from the business object Material/node Material, with a cardinality of 1:CN, which is a material assigned to a product design version. A Text Collection dependent object inclusion node is a collection of natural-language text with additional information about a product design. An Attachment Folder dependent object inclusion node is a folder for collecting and organizing documents, references, and decisions relevant for a product design.

Production Bill of Material Variant Handover includes information about a handover of a product design version to a production bill of material variant. The elements located directly at the node Production Bill of Material Variant Handover are defined by the data type ProductDesignProductionBillOfMaterialVariantHandoverElements. These elements include: UUID, ProductDesignVersionUUID, ProductDesignVersionKey, ProductDesignID, ProductDesignVersionID, EngineeringChangeOrderUUID, EngineeringChangeOrderID, ProductionBillOfMaterialVariantUUID, ProductionBillOfMaterialVariantKey, BillOfMaterialVariantID, BillOfMaterialID, ChangeAllowedIndicator, and SystemAdministrativeData. UUID may be an alternative key, is a universally unique identifier of a product design production bill of material variant handover, and may be based on datatype GDT: UUID. ProductDesignVersionUUID is a universally unique identifier of a product design version that was handed over to a production bill of material variant, and may be based on datatype GDT: UUID. ProductDesignVersionKey is a key of a product design version that was handed over to a production bill of material variant, and may be based on datatype KDT: ProductDesignVersionKey. ProductDesignID is a unique identifier of a product design, and may be based on datatype GDT: ProductDesignID. ProductDesignVersionID is a unique identifier of a product design version, may be based on datatype GDT: VersionID, and may be unique within a context of a product design. EngineeringChangeOrderUUID may be optional, is a universally unique identifier of an engineering change order that was used for a handover, and may be based on datatype GDT: UUID. EngineeringChangeOrderID may be optional, is an identifier of an engineering change order that was used for a handover, and may be based on datatype GDT: EngineeringChangeOrderID. ProductionBillOfMaterialVariantUUID is a universally unique identifier of a production bill of material variant that results from a handover, and may be based on datatype GDT: UUID. ProductionBillOfMaterialVariantKey is Key of a production bill of material variant that results from a handover, and may be based on datatype KDT: BillOfMaterialVariantKey. BillOfMaterialVariantID is an identifier for a variant of a bill of material, and may be based on datatype GDT: BillOfMaterialVariantID. BillOfMaterialID is an identifier for a bill of material, and may be based on datatype GDT: BillOfMaterialID. ChangeAllowedIndicator indicates if changes are allowed, and may be based on datatype GDT: Indicator, with a qualifier of ChangeAllowed. In some implementations, changes might not be allowed if a production bill of material variant handover has been created via an action. SystemAdministrativeData includes administrative data recorded by the system, and may be based on datatype GDT: SystemAdministrativeData.

An Engineering Change Order inbound aggregation relationship may exist from the business object Engineering Change Order/node Engineering Change Order, with a cardinality of 1:CN, which specifies the engineering change order of a handover. A Product Design Version inbound aggregation relationship may exist from the business object Product Design/node Version, with a cardinality of 1:CN, which is a product design version that was handed over to a production bill of material variant. A Production Bill Of Material Variant inbound aggregation relationship may exist from the business object Production Bill of Material/node Variant, with a cardinality of 1:CN, which specifies the production bill of material variant of a handover. A Last Change Identity inbound association relationship may exist from the business object Identity/node Identity, with a cardinality of 1:CN, which identifies an identity that changed a production bill of material variant handover. A Creation Identity inbound association relationship may exist from the business object Identity/node Identity, with a cardinality of 1:CN, which identifies an identity that created a production bill of material variant handover.

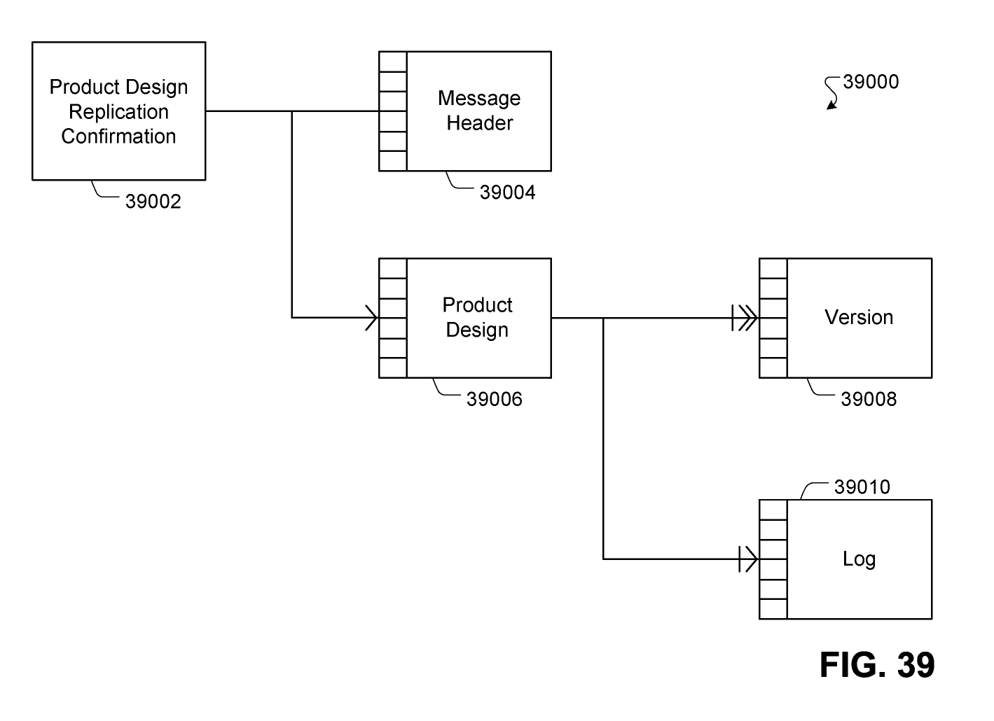

FIG. 39 depicts an example Product Design Replication Confirmation Message Data Type 39000, which comprises elements 39002-39010, hierarchically related as shown. For example, the Product Design Replication Confirmation 39002 includes a Message header 39004.

The message type Product Design Replication Confirmation is derived from the business object Product Design as a leading object together with its operation signature. The message type Product Design Replication Confirmation is a confirmation about a requested replication of a product design. The structure of the message type Product Design Replication Confirmation is determined by the message data type ProductDesignReplicationConfirmationMessage. The message data type ProductDesignReplicationConfirmationMessage includes the object ProductDesign which is included in a business document, business information that is relevant for sending a business document in a message, the MessageHeader package, and the ProductDesign package. This message data type Product Design Replication Confirmation provides a structure for the Product Design Replication Confirmation message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The ProductDesign package is a grouping of ProductDesign with its Version and Log packages and with the ProductDesign entity. ProductDesign is a description of a product as designed by engineering. Typically, it includes design-related documents and a list of components. ProductDesign includes the ActionCode attribute. ActionCode is a coded representation of the actions used to create or change product designs at a message recipient, and may be based on datatype GDT:ActionCode. ProductDesign includes the following non-node elements: ID, EngineeringDesignBusinessSystemName, EngineeringDesignBusinessSystemID, EngineeringDesignID, and EngineeringDesignInternalID. ID is a unique identifier of a product design and may be based on datatype GDT:ProductDesignID. EngineeringDesignBusinessSystemName is a ame of a business system of an engineering design, and may be based on datatype CDT:LANGUAGEINDEPENDENT_LONG_Name. EngineeringDesignBusinessSystemID is an identifier of a business system of an engineering design and may be based on datatype GDT:BusinessSystemID. EngineeringDesignID is a unique identifier of a product design given by an engineering system and may be based on datatype GDT:EngineeringDesignID. EngineeringDesignInternalID is an internal identifier of a product design given by an engineering system, and may be based on datatype GDT:EngineeringDesignInternalID.

ProductDesign includes the node element Version in a 1:CN cardinality relationship and the node element Log in a 1:C cardinality relationship. The ProductDesignVersion package includes the Version entity. Version represents a specific version of a product design. Version includes the ActionCode attribute. ActionCode is a coded representation of the actions used to create or change product designs at a message recipient, and may be based on datatype GDT:ActionCode. Version includes the following non-node elements: ID, Name, EngineeringDesignVersionID, and EngineeringDesignVersionInternalID. ID is a unique identifier of a product design version, and may be based on datatype GDT:VersionID. Name is a name of a product design version, and may be based on datatype CDT:LANGUAGEINDEPENDENT_MEDIUM_Name. EngineeringDesignVersionID is a unique identifier of a product design version given by an engineering system, and may be based on datatype GDT:EngineeringDesignVersionID. EngineeringDesignVersionInternalID is an internal identifier of a product design version given by an engineering system, and may be based on datatype GDT:EngineeringDesignVersionInternalID.

The ProductDesignLog package includes the Log entity. Log is a sequence of messages that occur as a result of the replication request for a product design. Log may be based on datatype GDT Log.

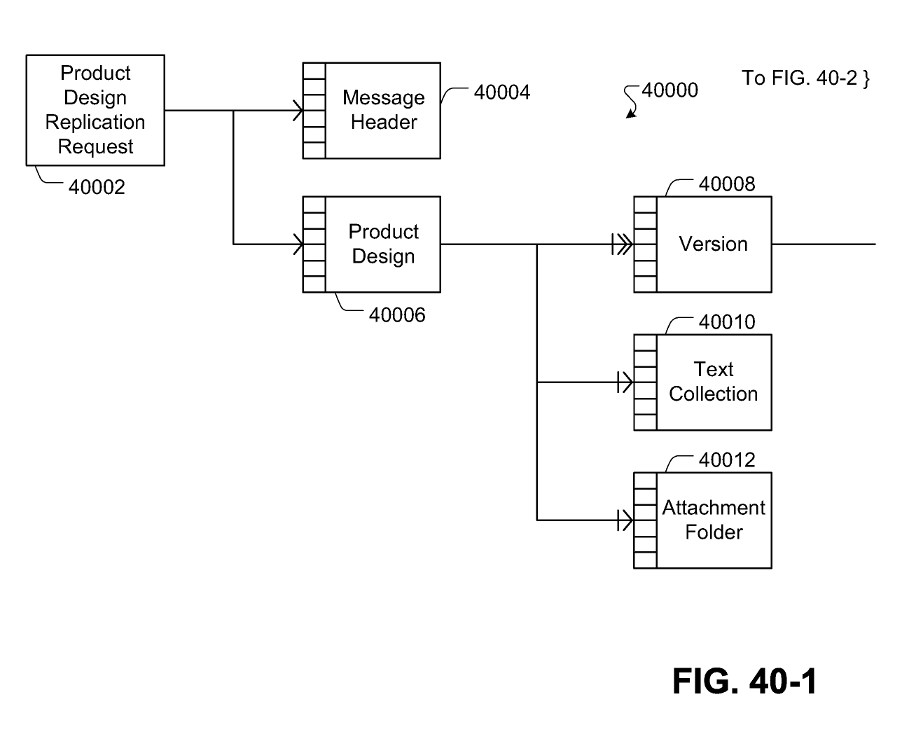

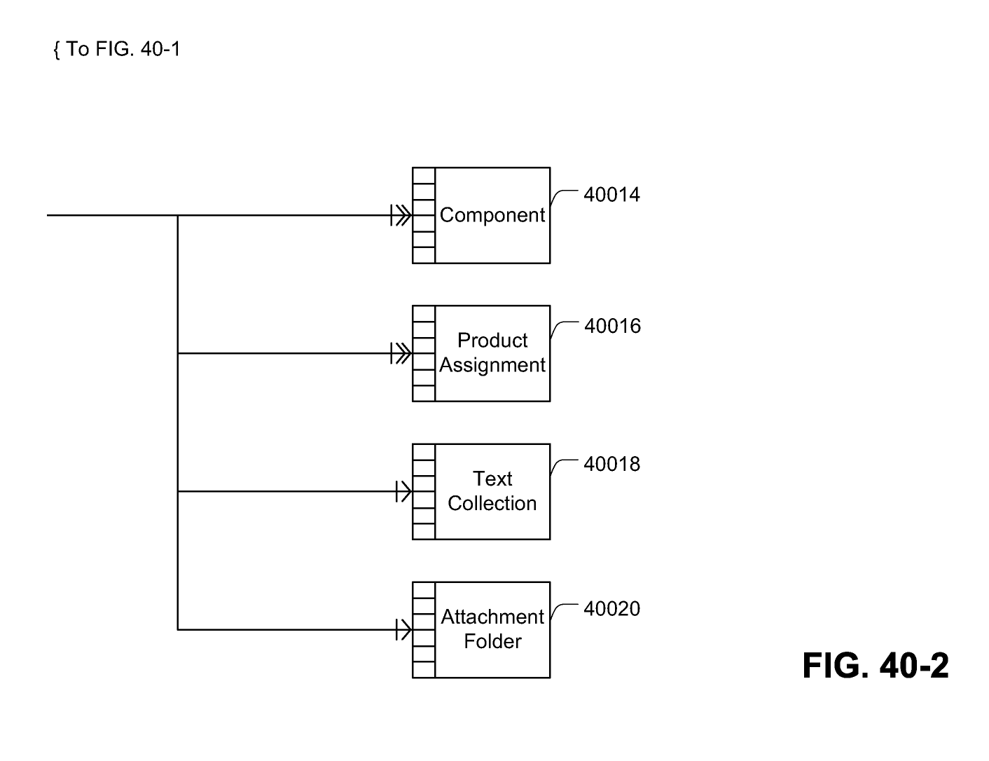

FIGS. 40-1 through 40-2 depict an example Product Design Replication Request Message Data Type 40000, which comprises elements 40002-40020, hierarchically related as shown. For example, the Product Design Replication Request 40002 includes a Message Header 40004.

The message type Product Design Replication Request is derived from the business object Product Design as A leading object together with its operation signature. The message type Product Design Replication Request is a request from an engineering system to replicate a product design. The structure of the message type Product Design Replication Request is determined by the message data type ProductDesignReplicationRequestMessage. The message data type ProductDesignReplicationRequestMessage includes the object ProductDesign which is included in a business document, business information that is relevant for sending a business document in a message, the MessageHeader package, and a productDesign package. The message data type ProductDesignReplicationRequestMessage provides a structure for a product Design Replication Request message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

A productDesign package is a grouping of ProductDesign with its Version, TextCollection, and AttachmentFolder packages and with a productDesign entity. ProductDesign is a description of a product as designed by engineering. Typically, ProductDesign includes design-related documents and a list of components. ProductDesign includes the ActionCode and VersionListCompleteTransmissionIndicator attributes. ActionCode is a coded representation of the actions used to create or change product designs at the message recipient, and may be based on datatype GDT:ActionCode. VersionListCompleteTransmissionIndicator indicates whether a transferred list of versions is transferred completely, and may be based on datatype CDT:Indicator. ProductDesign includes the following non-node elements: ID, CategoryCode, EngineeringDesignBusinessSystemName, EngineeringDesignBusinessSystemID, EngineeringDesignID, EngineeringDesignInternalID, and Description. ID may be optional, is unique identifier of a product design and may be based on datatype GDT:ProductDesignID. CategoryCode may be optional, is a category of a product design and may be based on datatype GDT:ProductDesignCategoryCode. EngineeringDesignBusinessSystemName may be optional, is a name of a business system of an engineering design, and may be based on datatype CDT:LANGUAGEINDEPENDENT_LONG_Name. EngineeringDesignBusinessSystemID is an identifier of a business system of an engineering design and may be based on datatype GDT:BusinessSystemID. EngineeringDesignID may be optional is a unique identifier of a product design given by an engineering system and may be based on datatype GDT:EngineeringDesignID. EngineeringDesignInternalID is an internal identifier of a product design given by an engineering system and may be based on datatype GDT:EngineeringDesignInternalID. Description is a language-dependent description of a product design and may be based on datatype GDT:MEDIUM_Description.

ProductDesign may include the node element Version in a 1:CN cardinality relationship, the node element TextCollection in a 1:C cardinality relationship, and the node element AttachmentFolder in a 1:C cardinality relationship. A productDesignVersion package includes the Version entity. Version represents a specific version of a product design. Version includes the ActionCode and VersionListCompleteTransmissionIndicator attributes. ActionCode is a coded representation of the actions used to create or change product designs at the message recipient, and may be based on datatype GDT:ActionCode. VersionListCompleteTransmissionIndicator indicates whether a transferred list of versions is transferred completely, and may be based on datatype CDT:Indicator. Version includes the following non-node elements: EngineeringDesignVersionID, EngineeringDesignVersionInternalID, PredecessorVersionEngineeringDesignBusinessSystemName, PredecessorVersionEngineeringDesignBusinessSystemID, PredecessorVersionEngineeringDesignID, PredecessorVersionEngineeringDesignInternalID, PredecessorVersionEngineeringDesignVersionID, PredecessorVersionEngineeringDesignVersionInternalID, EngineeringDesignChangeOrderID, BaseQuantity, BaseQuantityTypeCode, ProposedProcurementMethodCode, EngineeringDesignVersionStatusName, EngineeringDesignVersionResponsibleEngineerPersonFamilyName, EngineeringDesignVersionResponsibleEngineerPersonGivenName, EngineeringDesignVersionReleaseDate, EngineeringDesignVersionReplicationCancelledIndicator, EngineeringDesignVersionPrimaryViewableCreationDateTime, EngineeringDesignVersionCreationDateTime, EngineeringDesignVersionLastChangeDateTime, ExecutionUsageBlockingStatusCode, EngineeringDesignVersionReleaseStatusCode, and Description. EngineeringDesignVersionID may be optional, is a unique identifier of a product design version given by an engineering system, and may be based on datatype GDT:EngineeringDesignVersionID. EngineeringDesignVersionInternalID is an internal identifier of a product design version given by an engineering system, and may be based on datatype GDT:EngineeringDesignVersionInternalID. PredecessorVersionEngineeringDesignBusinessSystemName may be optional, is a business system name of a preceding engineering design version, and may be based on datatype CDT:LANGUAGEINDEPENDENT_LONG_Name. PredecessorVersionEngineeringDesignBusinessSystemID may be optional, is an identifier of a business system of a preceding engineering design version, and may be based on datatype GDT:BusinessSystemID. PredecessorVersionEngineeringDesignID may be optional, is an engineering design identifier of a preceding engineering design version, and may be based on datatype GDT:EngineeringDesignID. PredecessorVersionEngineeringDesignInternalID may be optional, is an internal engineering design identifier of a preceding engineering design version, and may be based on datatype GDT:EngineeringDesignInternalID. PredecessorVersionEngineeringDesignVersionID may be optional, is an identifier of a preceding engineering design version, and may be based on datatype GDT:EngineeringDesignVersionID. PredecessorVersionEngineeringDesignVersionInternalID may be optional, is an internal identifier of a preceding engineering design version, and may be based on datatype GDT:EngineeringDesignVersionInternalID. EngineeringDesignChangeOrderID may be optional, is a unique identifier of an engineering change order for an engineering design, and may be based on datatype GDT:EngineeringDesignChangeOrderID. BaseQuantity may be optional, is a base quantity of a version to be assembled, and may be based on datatype CDT:POSITIVE_Quantity. BaseQuantityTypeCode may be optional, is a type of a base quantity of a version, and may be based on datatype GDT:QuantityTypeCode. ProposedProcurementMethodCode may be optional, is a coded representation of a method that is proposed for the procurement of a product assigned to a product design. ProposedProcurementMethodCode is independent from the procurement method code of the assigned product. ProposedProcurementMethodCode can be used as proposal when a product is created, and may be based on datatype GDT:ProcurementMethodCode. EngineeringDesignVersionStatusName may be optional, is a status of an engineering design version, and may be based on datatype CDT:LANGUAGEINDEPENDENT_MEDIUM_Name. EngineeringDesignVersionResponsibleEngineerPersonFamilyName may be optional, is a family name of a responsible engineer of a product design version, and may be based on datatype CDT:LANGUAGEINDEPENDENT_MEDIUM_Name. EngineeringDesignVersionResponsibleEngineerPersonGivenName may be optional, is a given name of a responsible engineer of an engineering design version, and may be based on datatype CDT:LANGUAGEINDEPENDENT_MEDIUM_Name. EngineeringDesignVersionReleaseDate may be optional, is a release date of an engineering design version in an engineering system, and may be based on datatype CDT:Date. EngineeringDesignVersionReplicationCancelledIndicator may be optional, indicates if the version is deleted in an engineering system that is defined within a product design root node, and may be based on datatype CDT:Indicator. EngineeringDesignVersionPrimaryViewableCreationDateTime may be optional, is a creation date/time date and time stamp of a primary viewable file of an engineering design version, and may be based on datatype CDT:GLOBAL_DateTime. EngineeringDesignVersionCreationDateTime may be optional, is a creation date/time date and time stamp of an engineering design version, and may be based on datatype CDT:GLOBAL_DateTime. EngineeringDesignVersionLastChangeDateTime may be optional, is a date and time stamp of a last change of an engineering design version, and may be based on datatype CDT:GLOBAL_DateTime. ExecutionUsageBlockingStatusCode may be optional and may be based on datatype GDT:NOTBLOCKEDBLOCKED_BlockingStatusCode. EngineeringDesignVersionReleaseStatusCode may be based on datatype GDT:EngineeringDesignVersionReleaseStatusCode. Description is a language-dependent description of a product design version, and may be based on datatype GDT:MEDIUM_Description.

ProductDesign may include the node element Component in a 1:CN cardinality relationship, the node element ProductAssignment in a 1:CN cardinality relationship, the node element TextCollection in a 1:C cardinality relationship, and the node element AttachmentFolder in a 1:C cardinality relationship. The ProductDesignVersionComponent package includes the Component entity. Component is a part of a product design used in a version. Component may be represented by another product design.

Component includes the following non-node elements: ProductDesignComponentID, BaseQuantity, BaseQuantityTypeCode, EngineeringDesignBusinessSystemName, EngineeringDesignBusinessSystemID, EngineeringDesignID, EngineeringDesignInternalID, EngineeringDesignVersionID, and EngineeringDesignVersionInternalID. ProductDesignComponentID may be optional and is an identifier of a component which is referenced by a version component. If a product design component with the specified identifier doesn't exist, the corresponding component may be created automatically during the inbound processing. ProductDesignComponentID may be based on datatype GDT:ProductDesignComponentID. BaseQuantity is a base quantity of a version component, and may be based on datatype CDT:POSITIVE_Quantity. BaseQuantityTypeCode is a type of a base quantity of a version component, and may be based on datatype GDT:QuantityTypeCode. EngineeringDesignBusinessSystemName may be optional, is a business system name of a referenced engineering design, and may be based on datatype CDT:LANGUAGEINDEPENDENT_LONG_Name. EngineeringDesignBusinessSystemID may be optional, is a business system identifier of a referenced engineering design, and may be based on datatype GDT:BusinessSystemID. EngineeringDesignID is an identifier of a referenced engineering design, and may be based on datatype GDT:EngineeringDesignID. EngineeringDesignInternalID is an internal identifier of a referenced engineering design, and may be based on datatype GDT:EngineeringDesignInternalID. EngineeringDesignVersionID may be optional, is an identifier of a referenced engineering design version, and may be based on datatype GDT:EngineeringDesignVersionID. EngineeringDesignVersionInternalID may be optional, is an internal identifier of a referenced engineering design version, and may be based on datatype GDT:EngineeringDesignVersionInternalID.

The ProductDesignVersionProductAssignment package includes the ProductAssignment entity. ProductAssignment is a product that is represented by a product design version. ProductAssignment includes the Product and DefaultIndicator non-node elements. Product is a proposal for a product assignment, and may be based on datatype GDT:INTERNAL_BusinessTransactionDocumentProduct. DefaultIndicator is an indicator for a default product, and may be based on datatype CDT:Indicator. The ProductDesignVersionTextCollection package includes the TextCollection entities. TextCollection is a collection of natural-language text with additional information about a product design version. TextCollection may be typed by TextCollection. The ProductDesignVersionAttachmentFolder package includes the AttachmentFolder entity. AttachmentFolder is a folder for collecting and organizing documents, references, and decisions relevant for a product design version. AttachmentFolder may be typed by AttachmentFolder. The ProductDesignTextCollection package includes the TextCollection entity. TextCollection is a collection of natural-language text with additional information about a product design. TextCollection may be typed by TextCollection. The ProductDesignAttachmentFolder package includes the AttachmentFolder entity. AttachmentFolder is a folder for collecting and organizing documents, references, and decisions relevant for a product design.

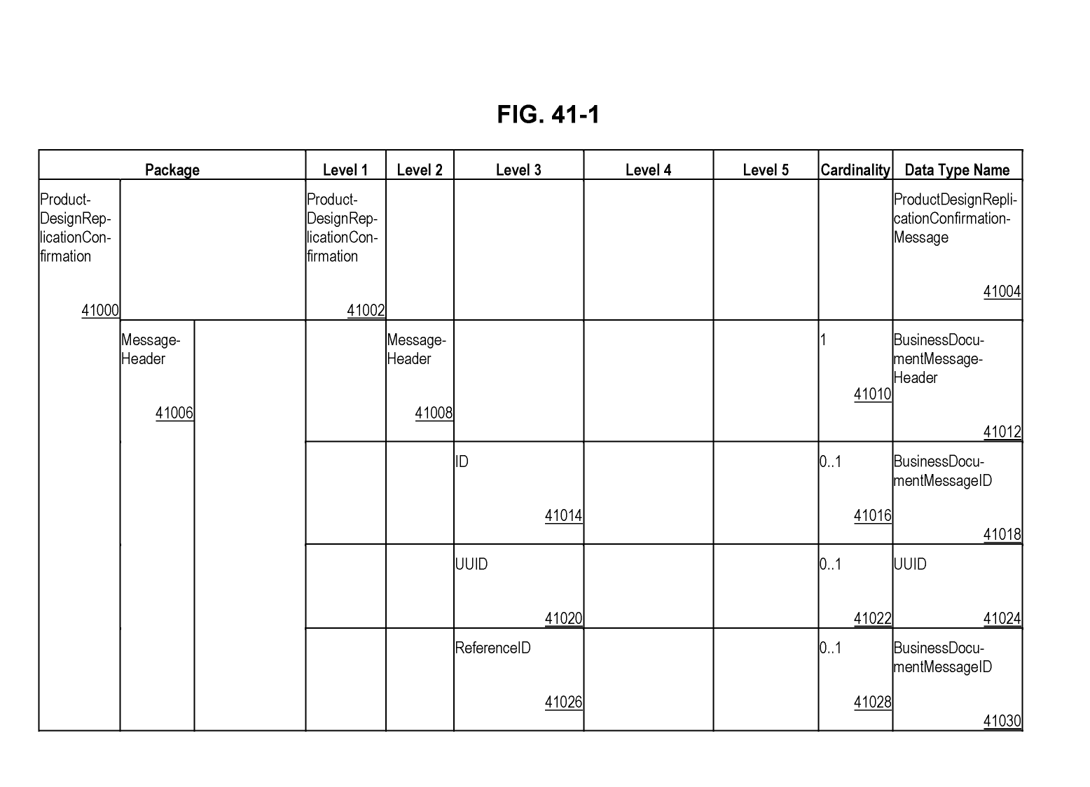

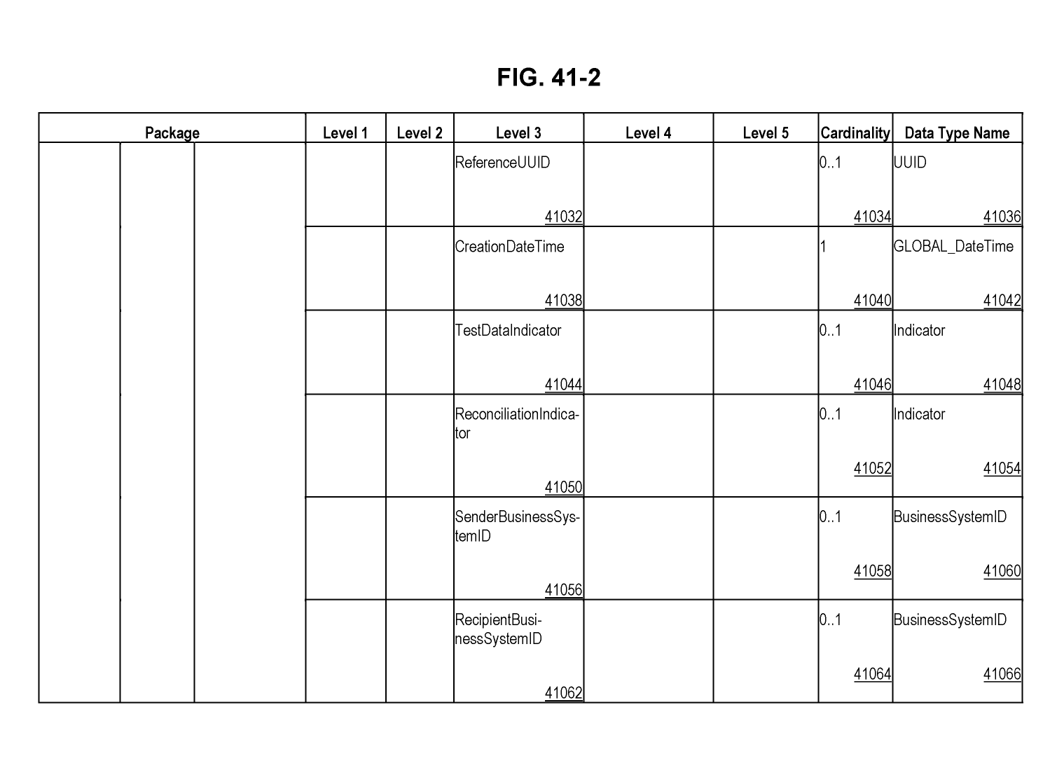

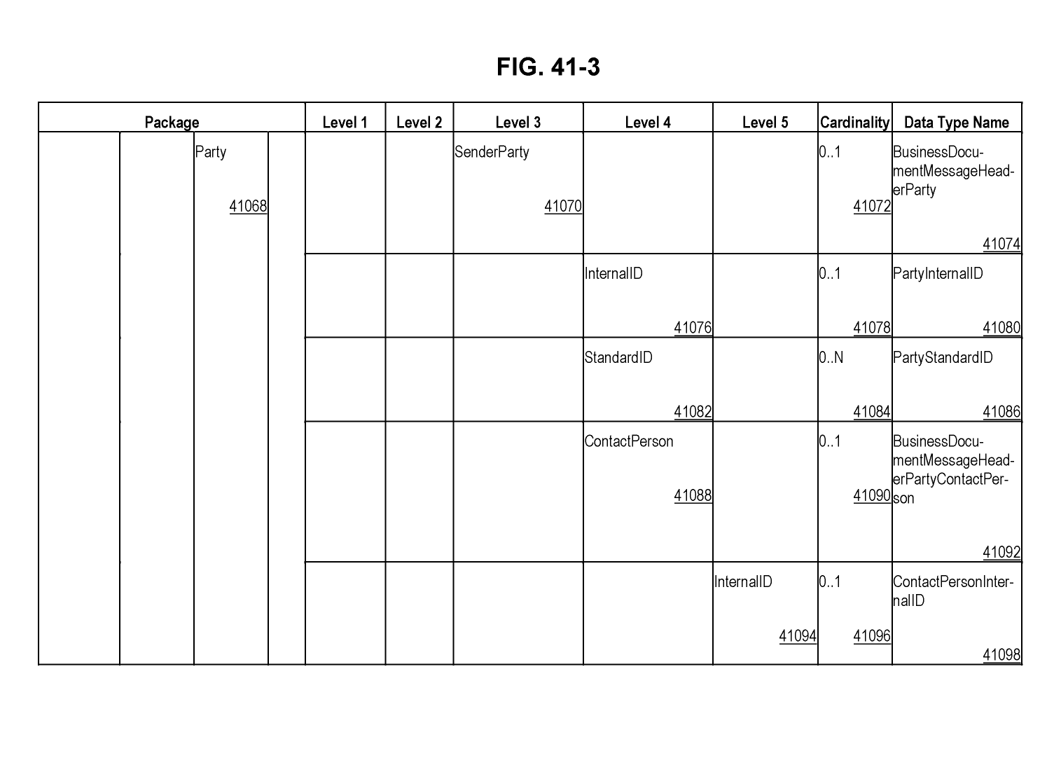

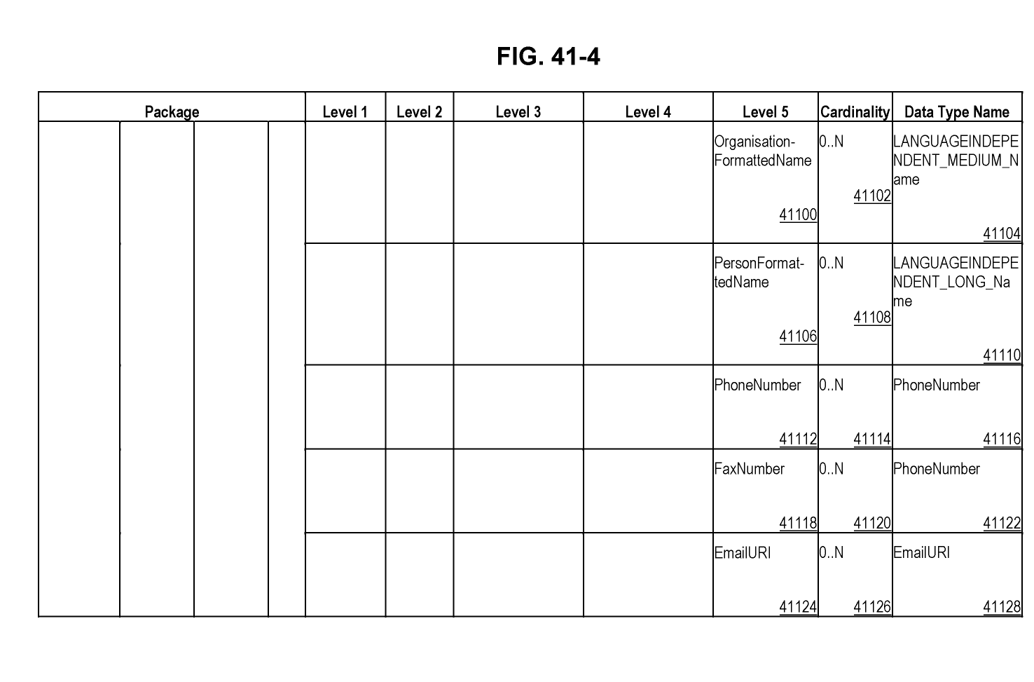

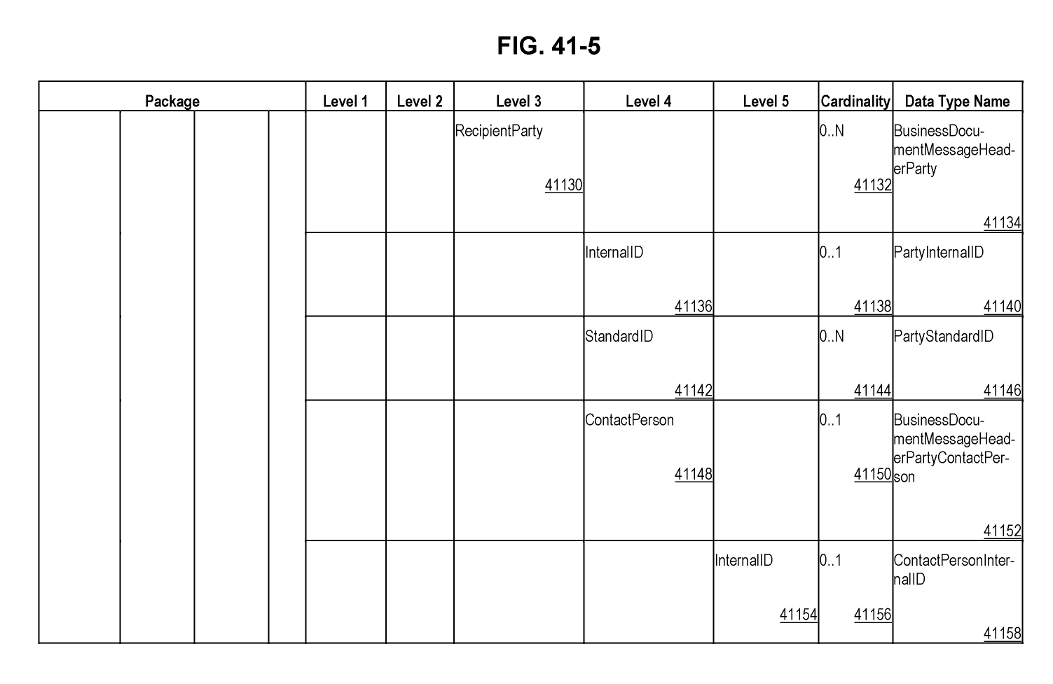

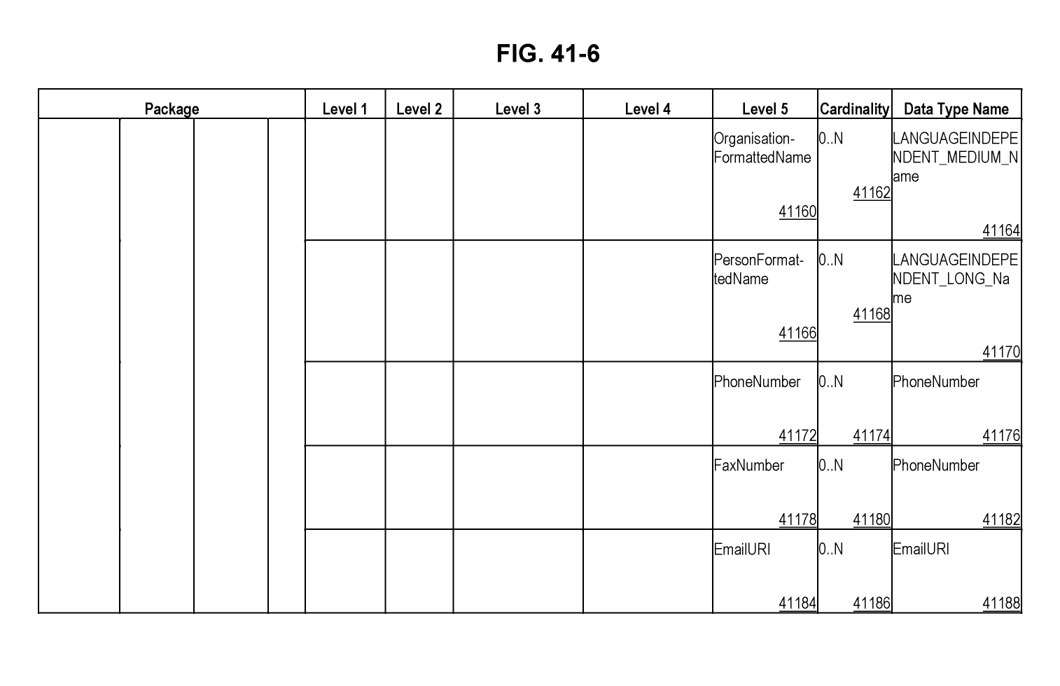

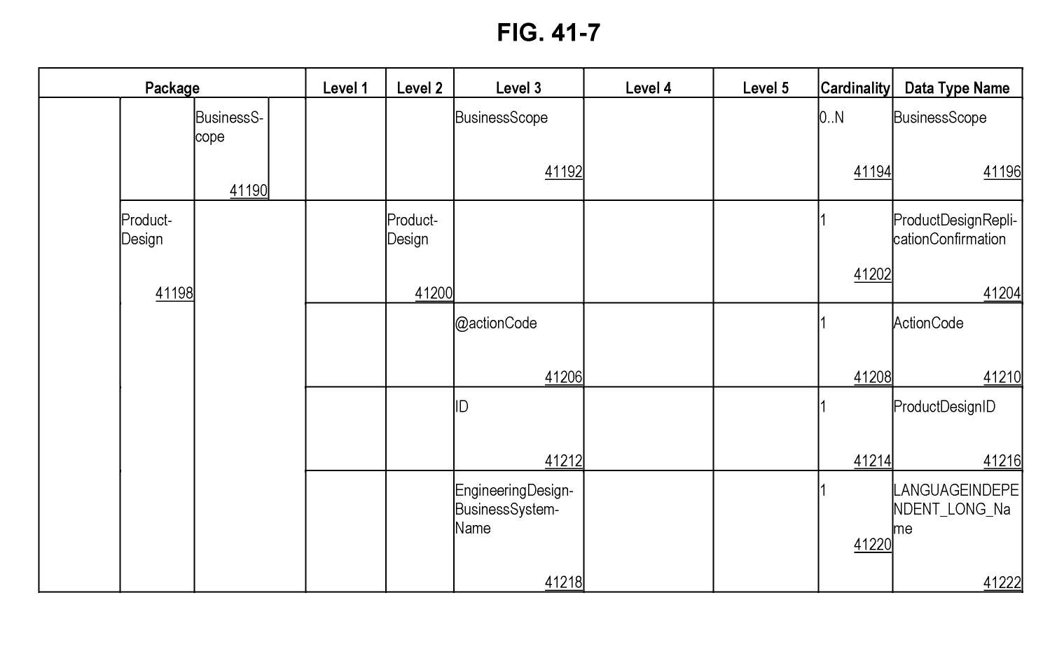

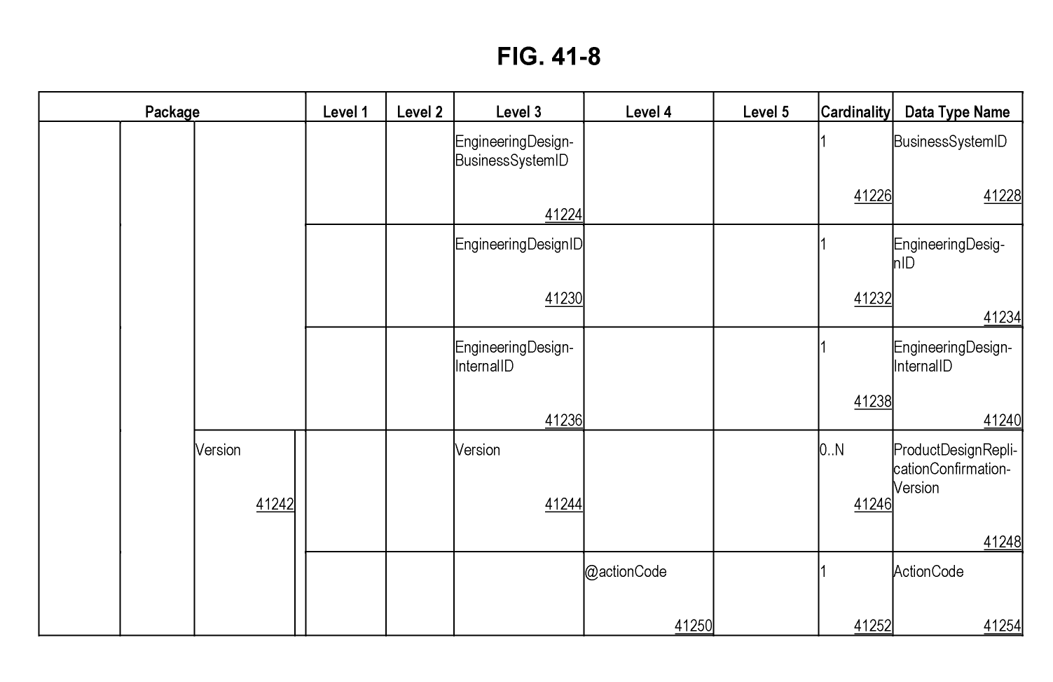

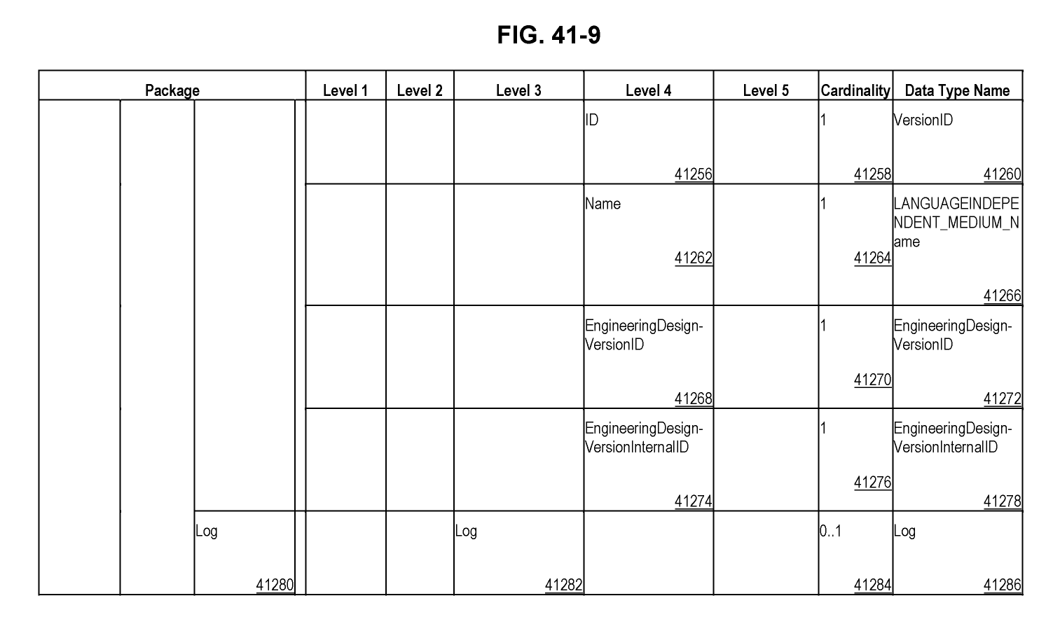

FIGS. 41-1 through 41-9 show an example configuration of an Element Structure that includes a ProductDesignReplicationConfirmation 41000 package. Specifically, these figures depict the arrangement and hierarchy of various components such as one or more levels of packages, entities, and datatypes, shown here as 41000 through 41286. As described above, packages may be used to represent hierarchy levels. Entities are discrete business elements that are used during a business transaction. Data types are used to type object entities and interfaces with a structure. For example, the ProductDesignReplicationConfirmation 41000 includes, among other things, a ProductDesignReplicationConfirmation 41002. Accordingly, heterogeneous applications may communicate using this consistent message configured as such.

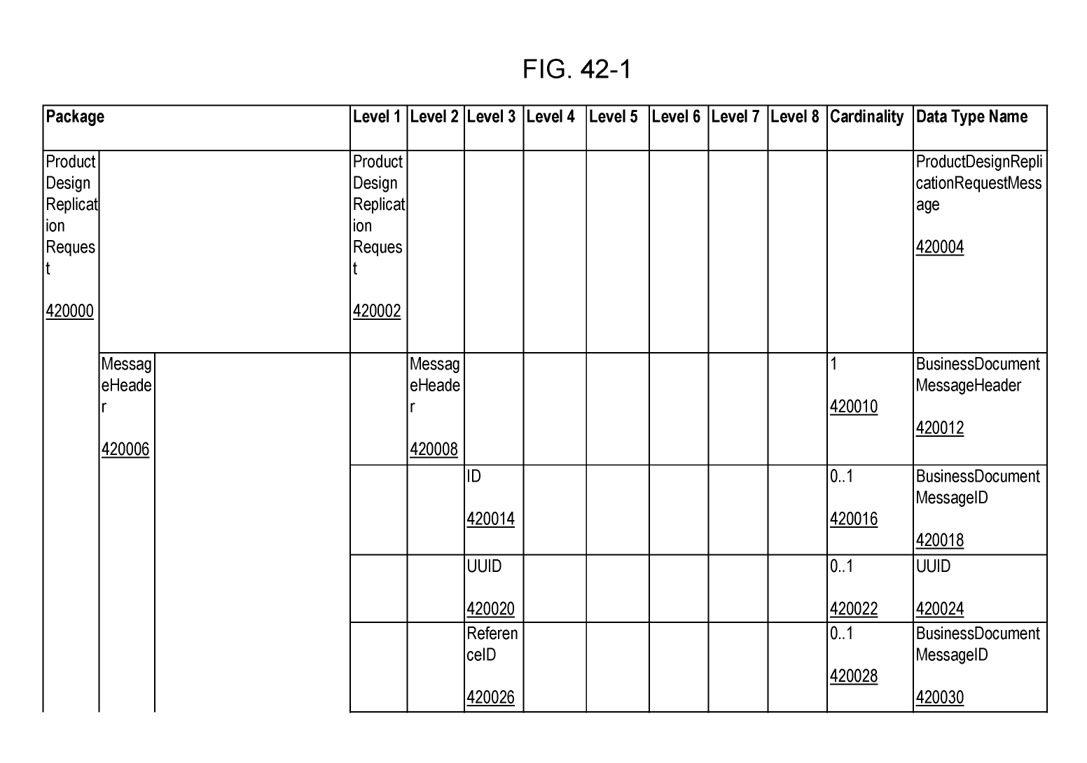

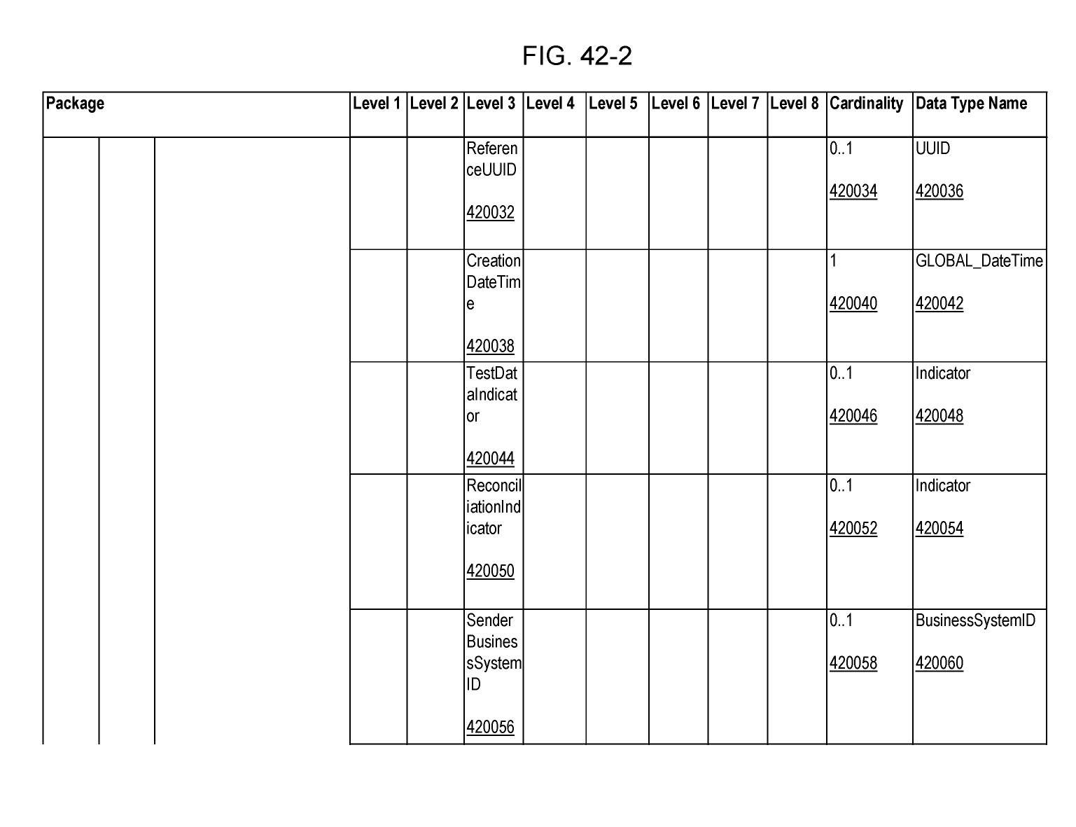

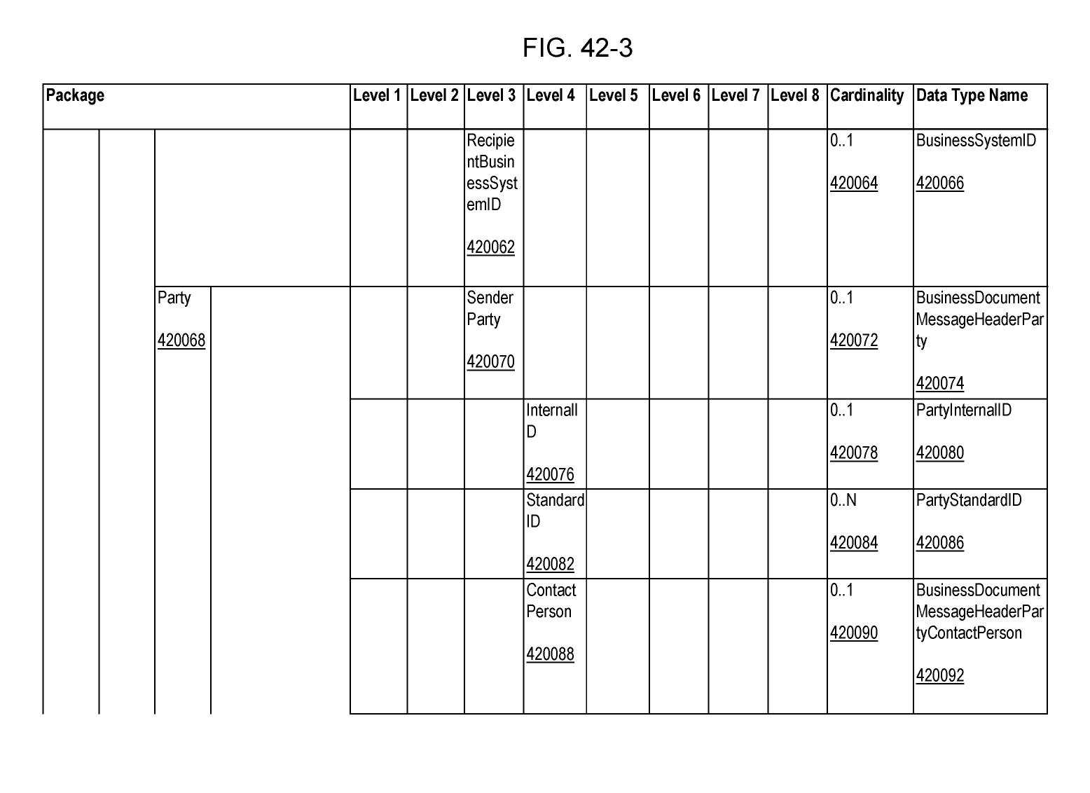

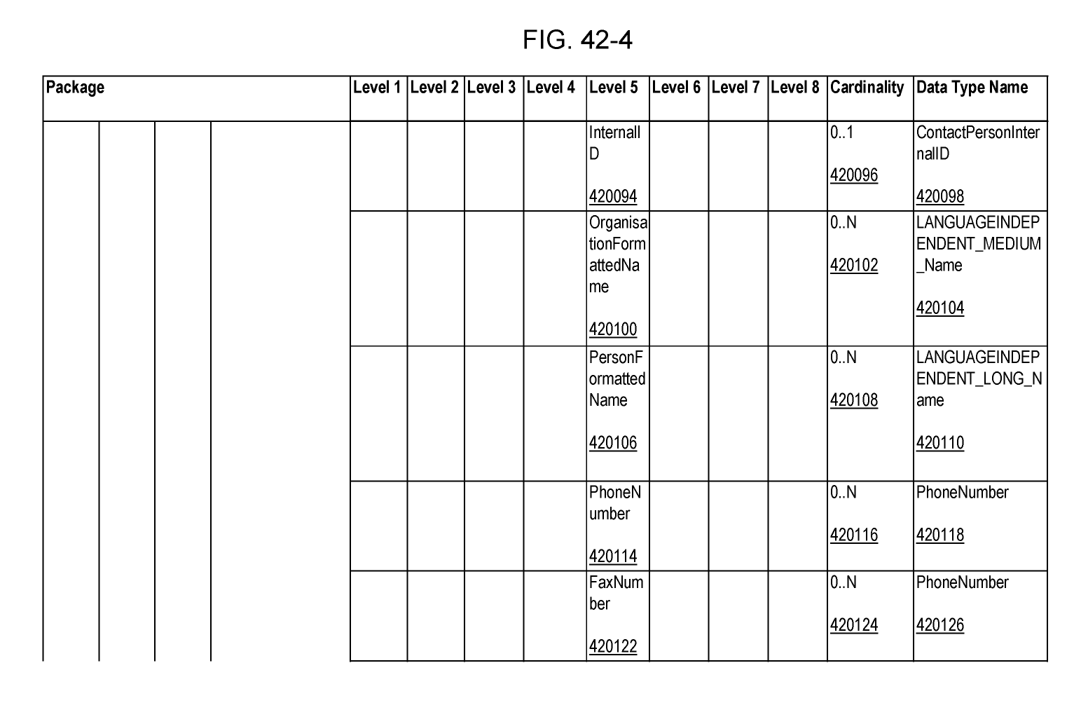

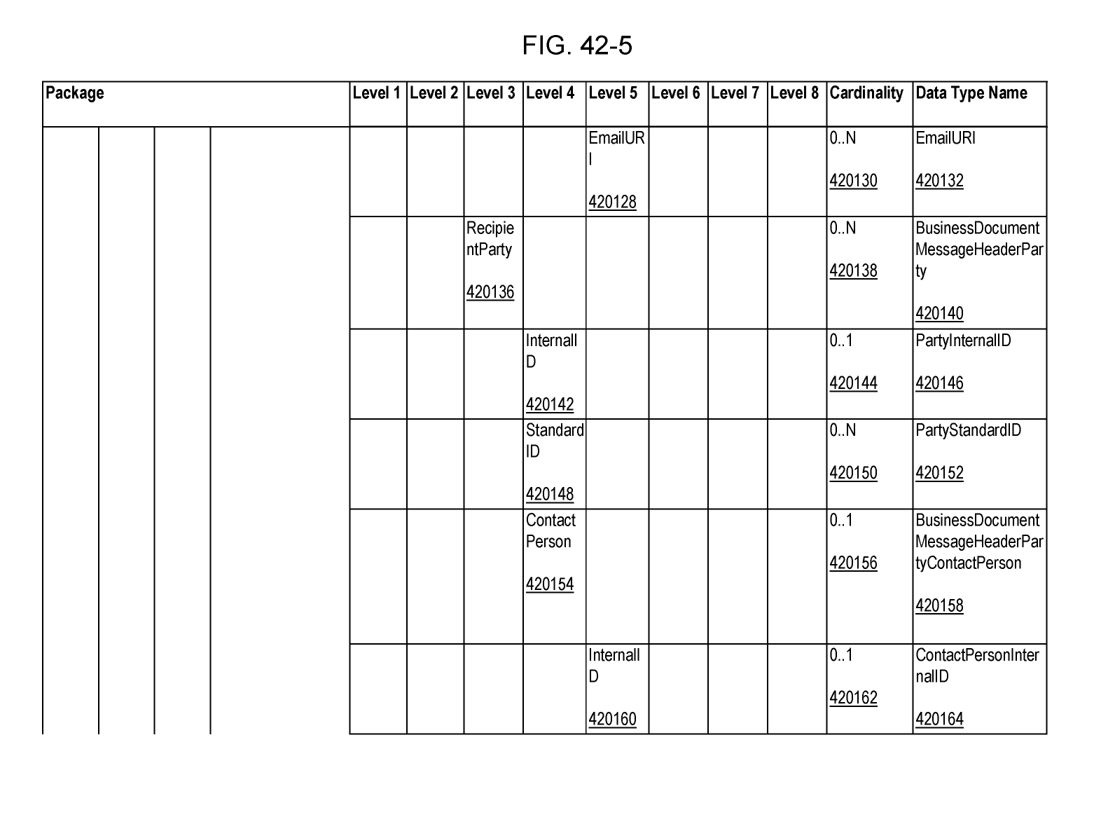

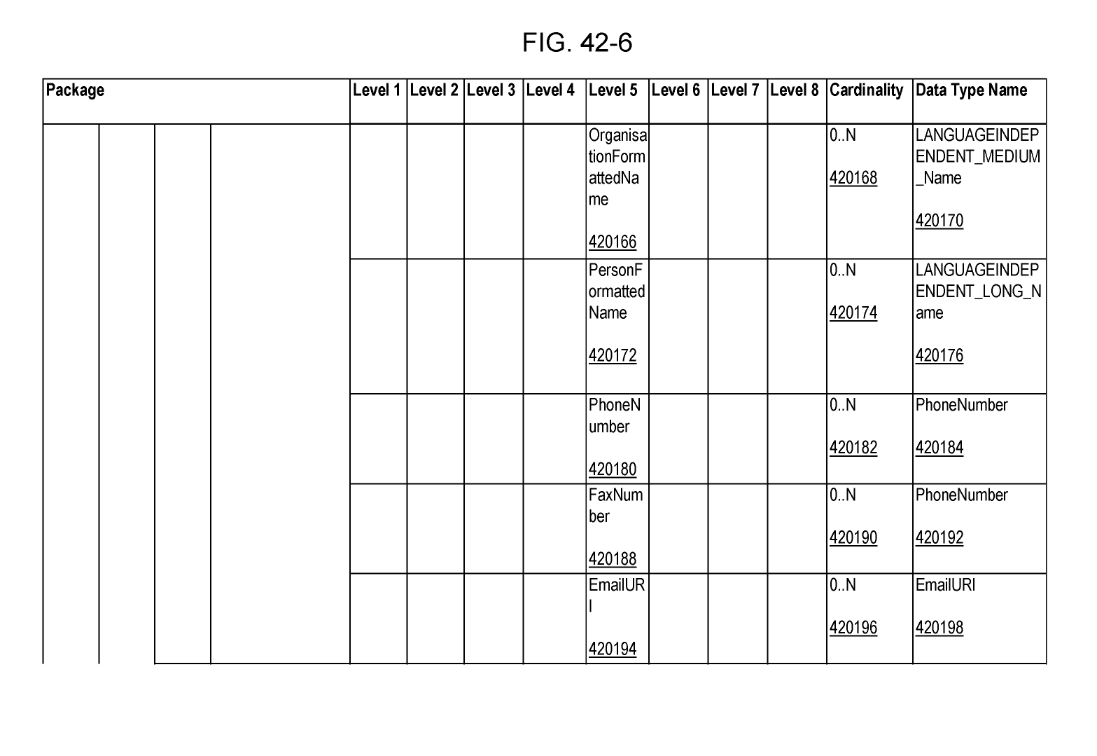

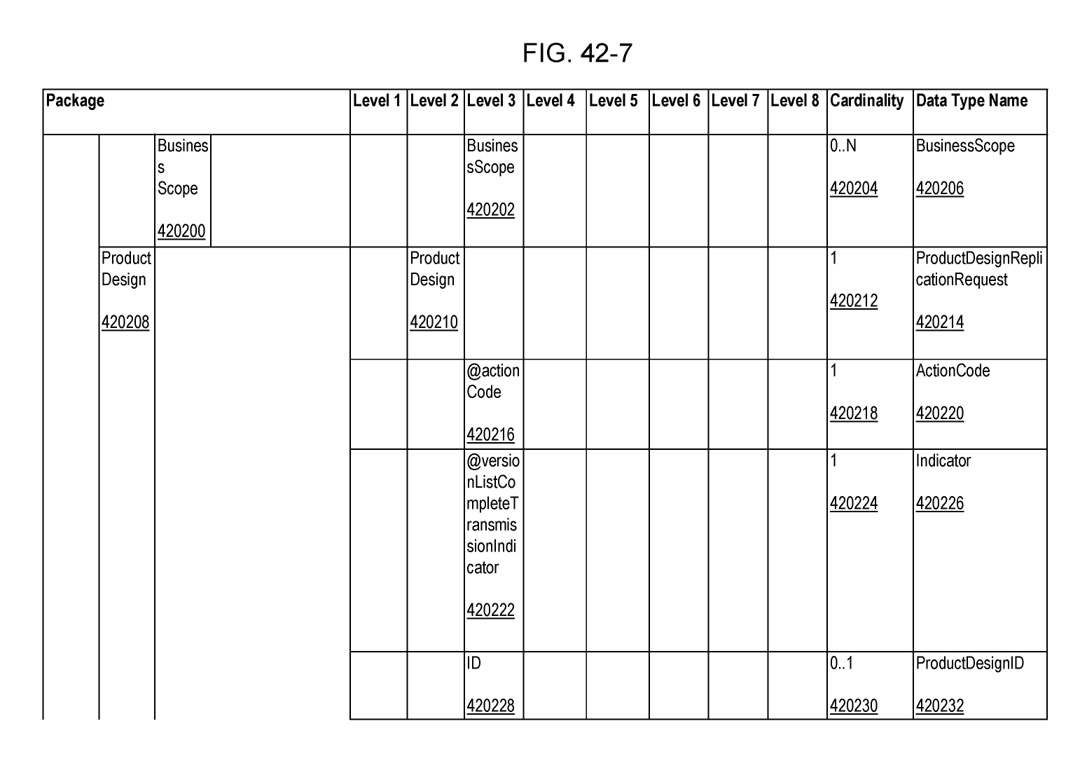

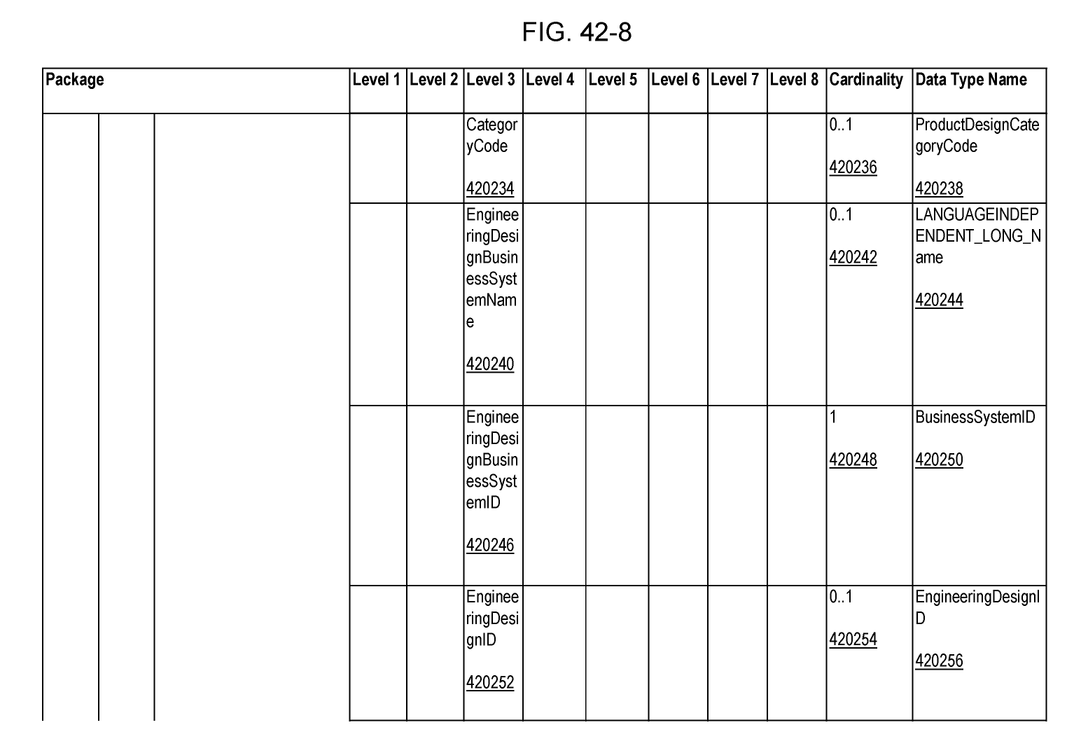

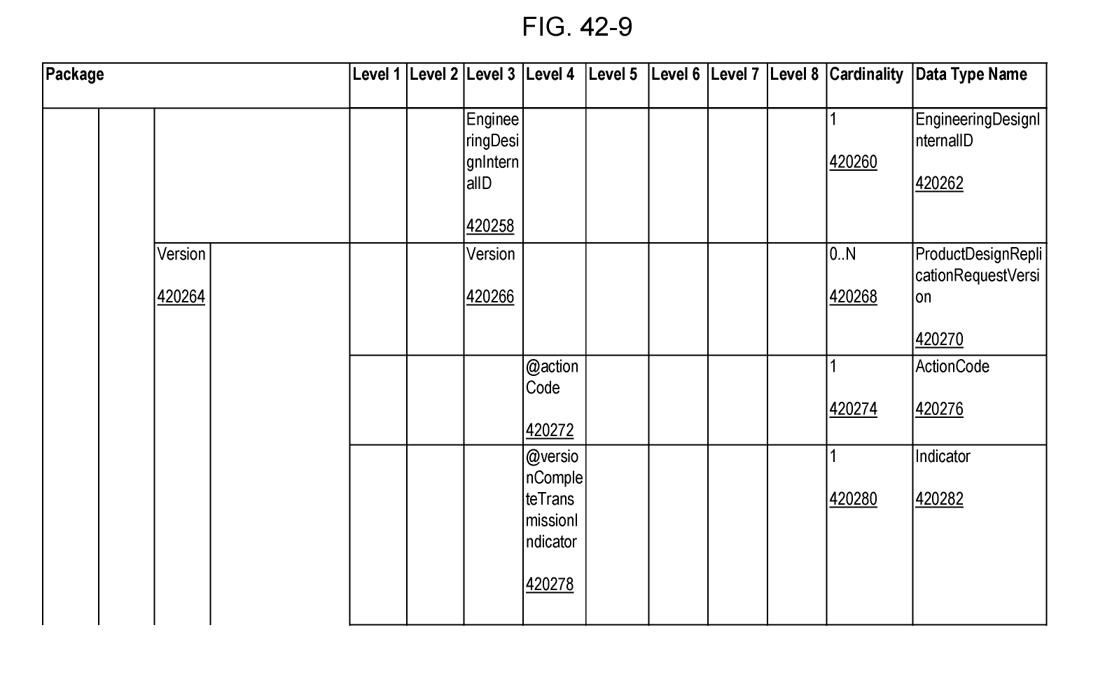

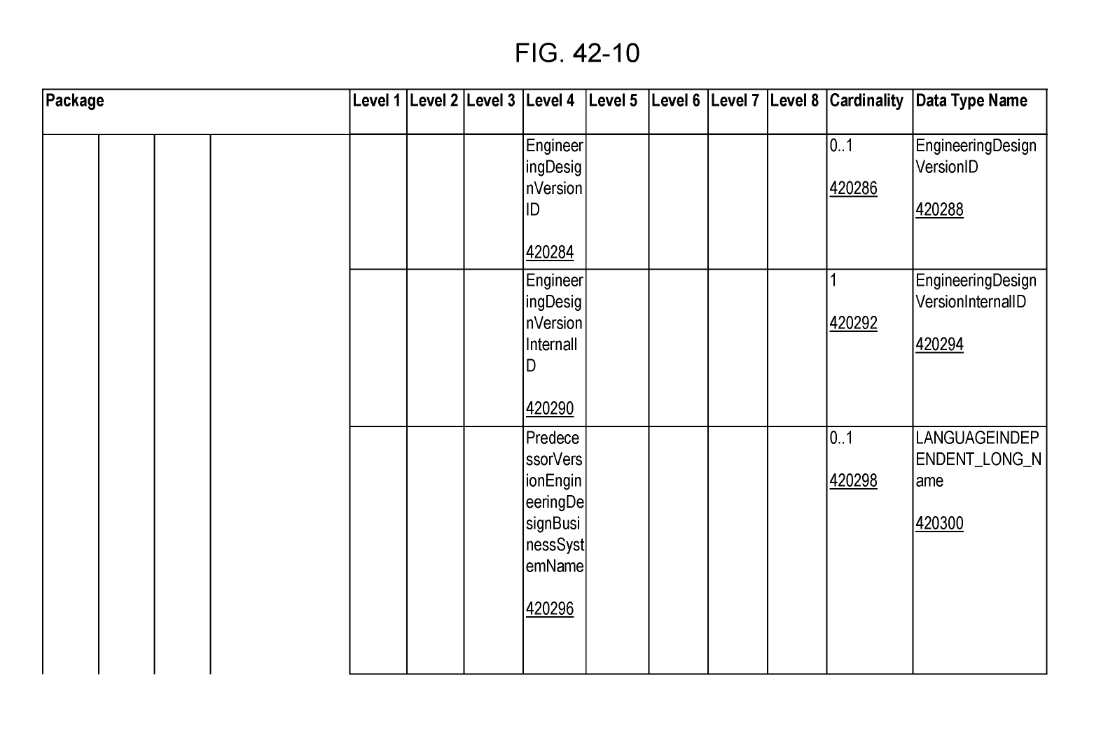

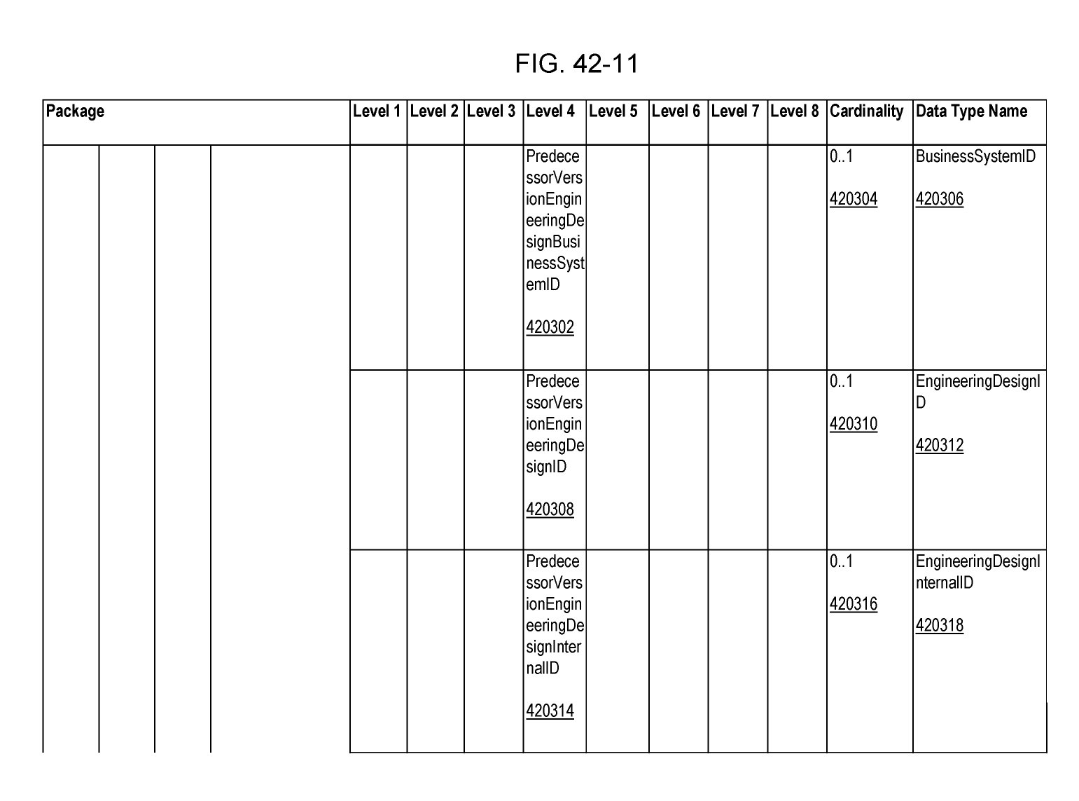

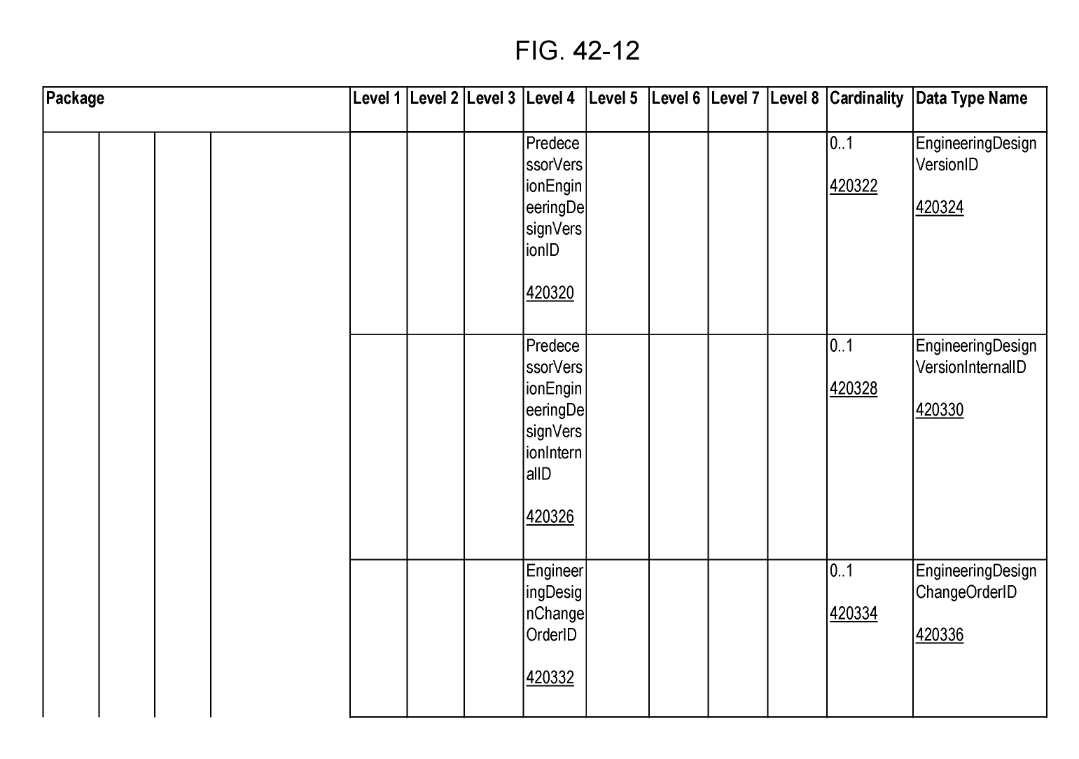

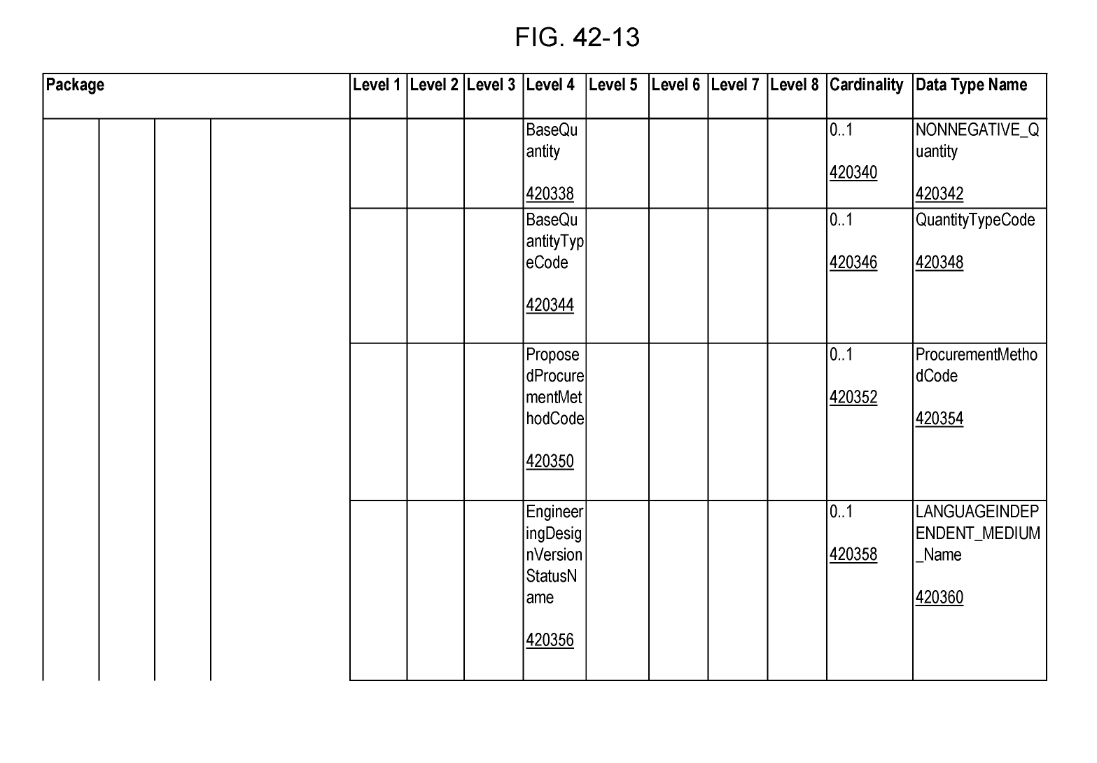

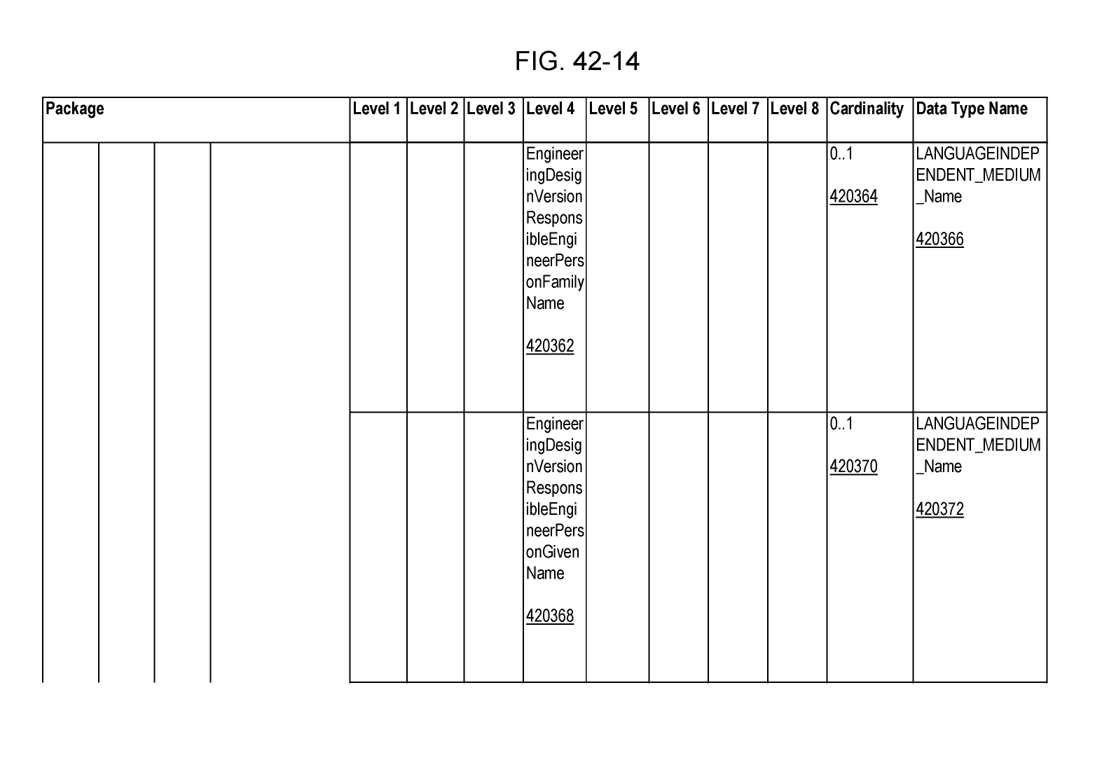

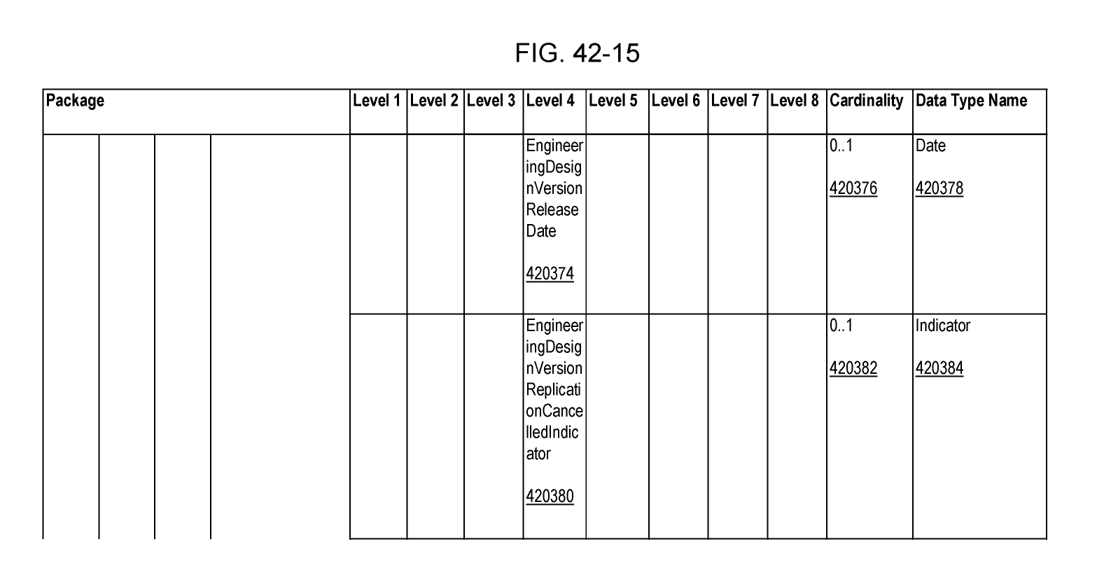

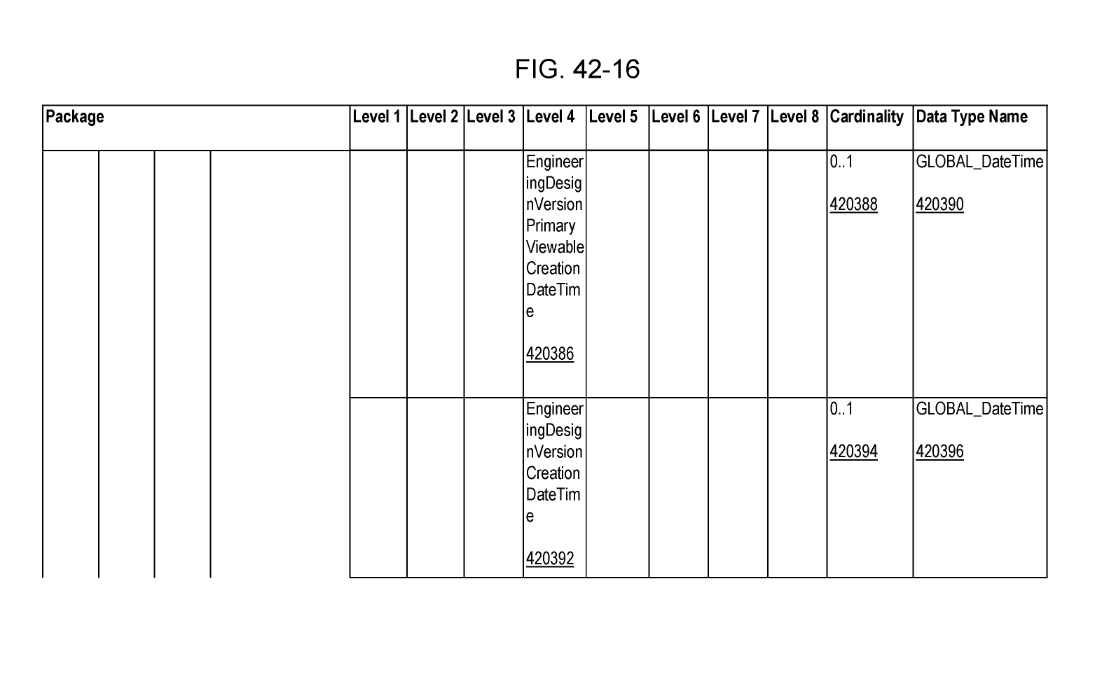

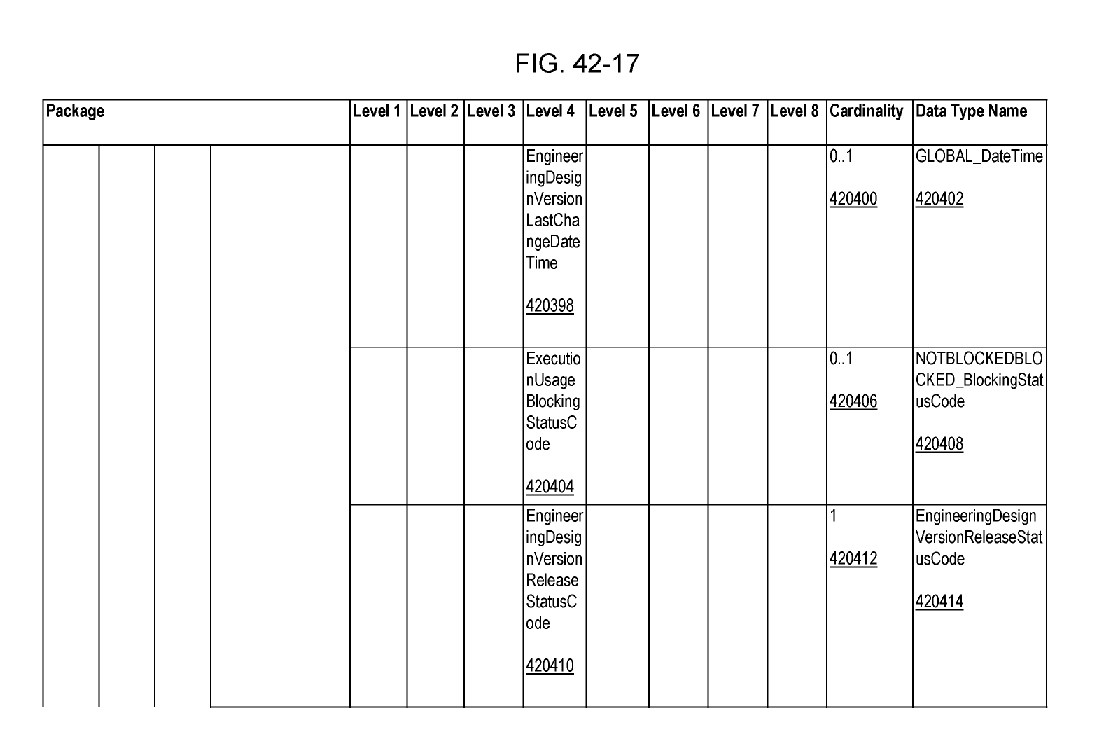

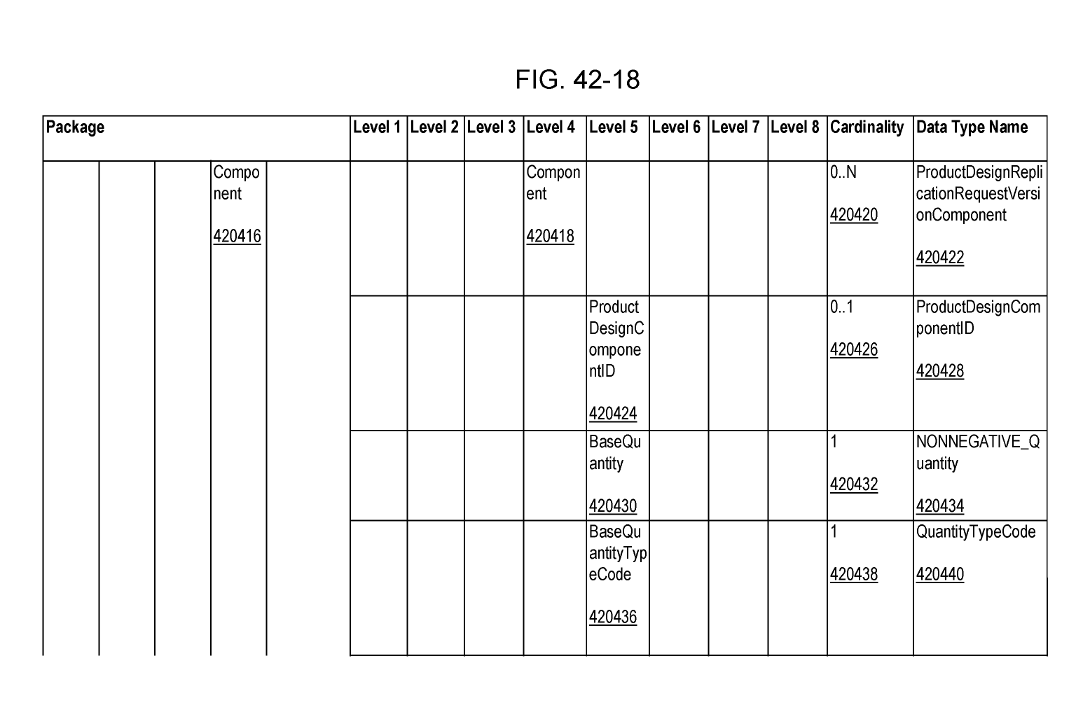

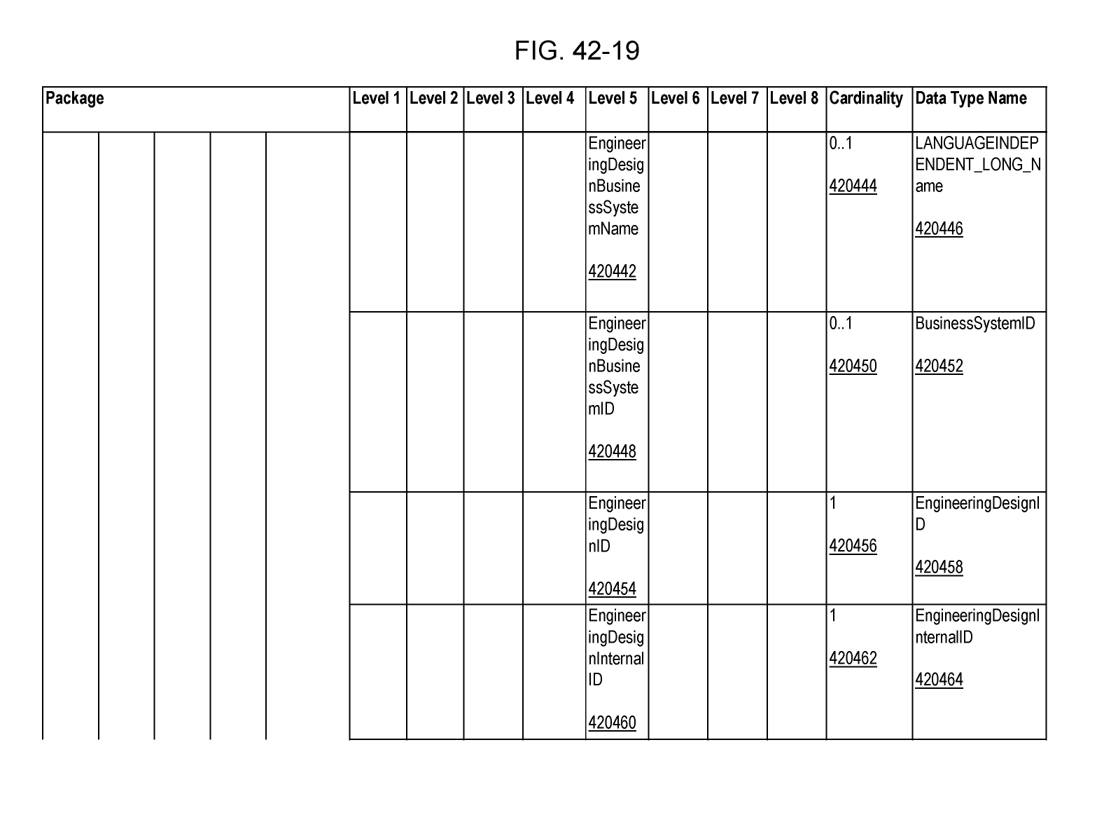

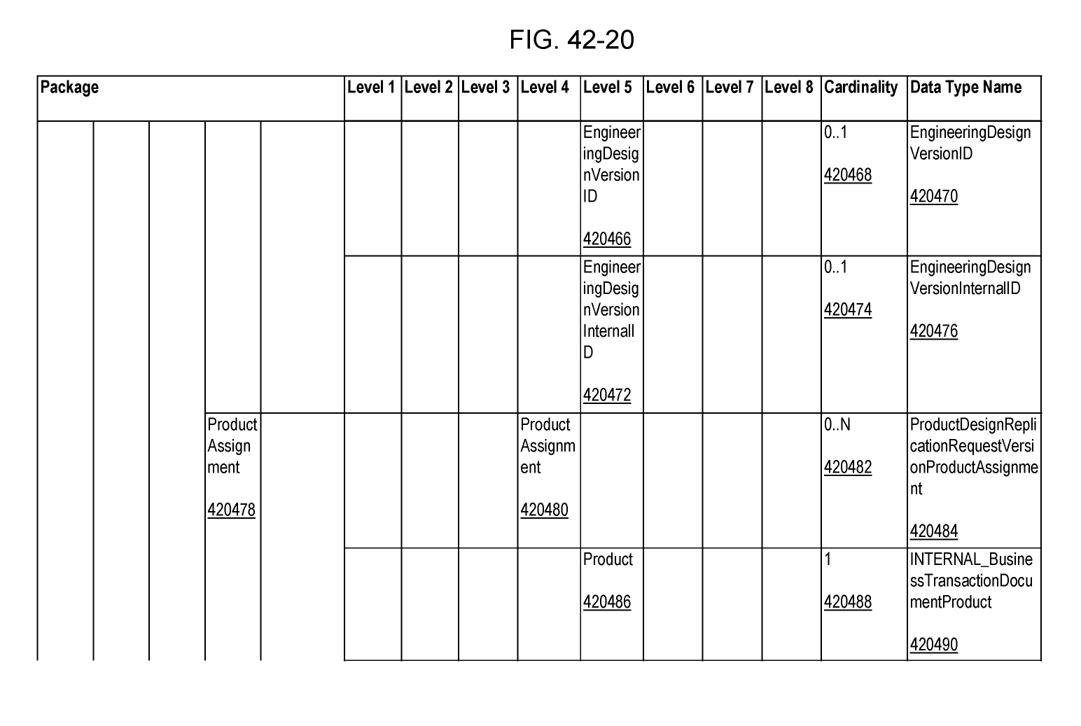

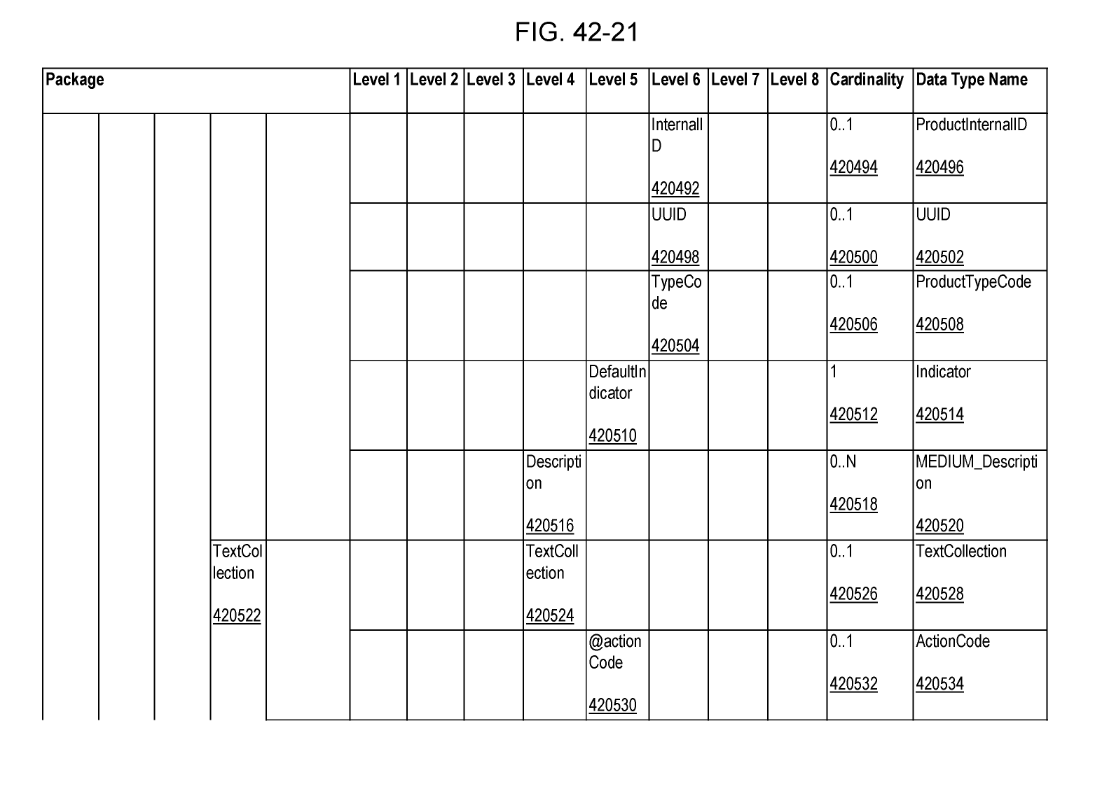

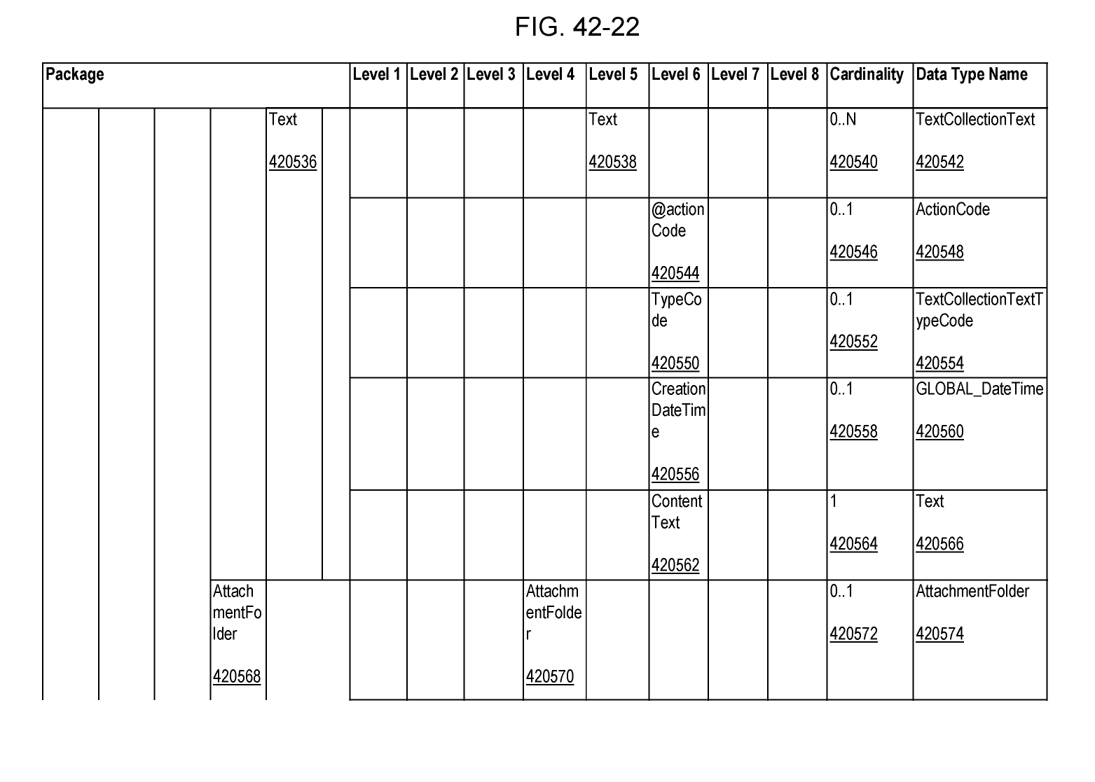

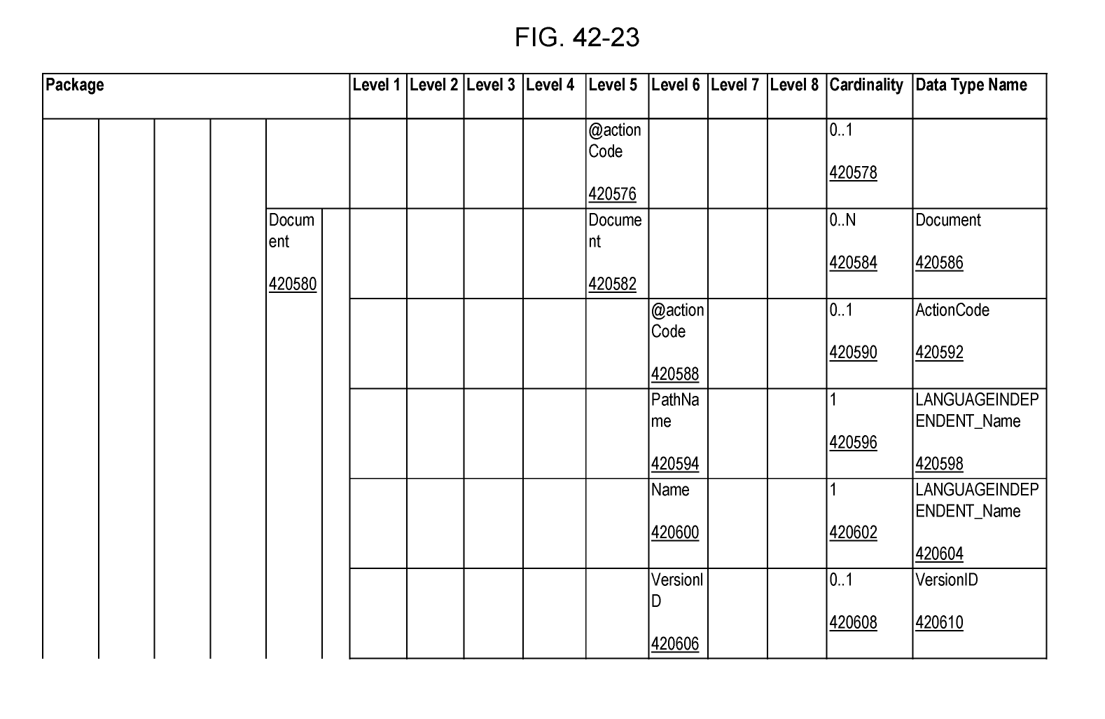

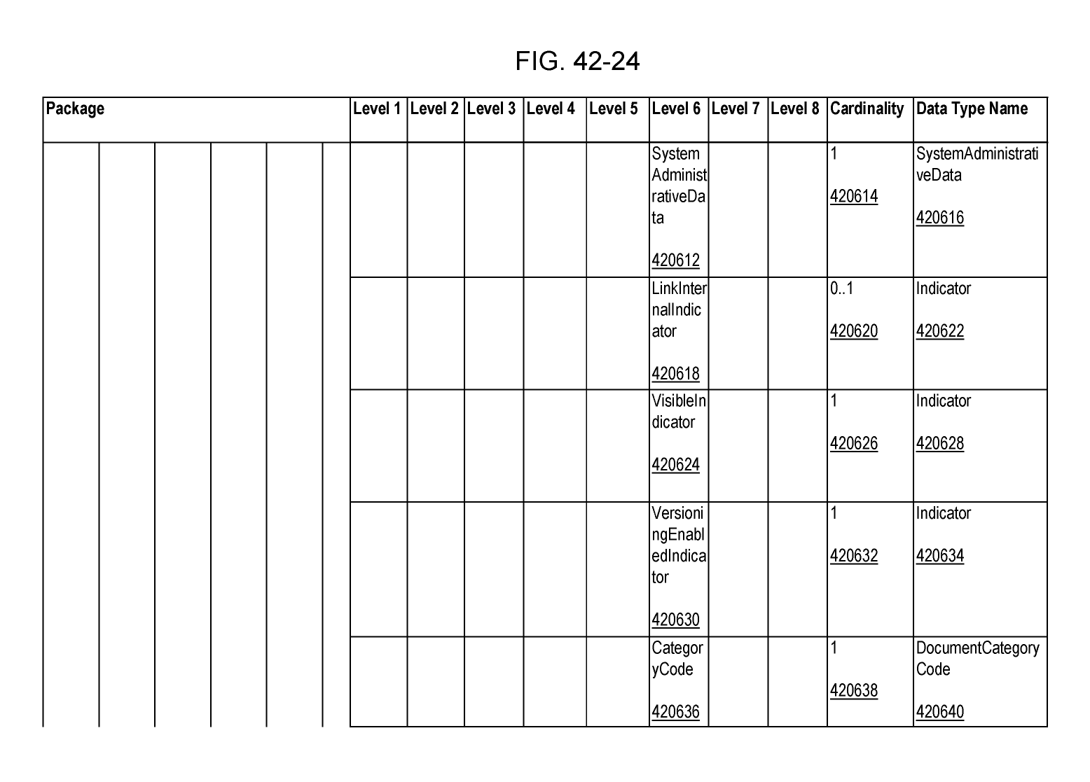

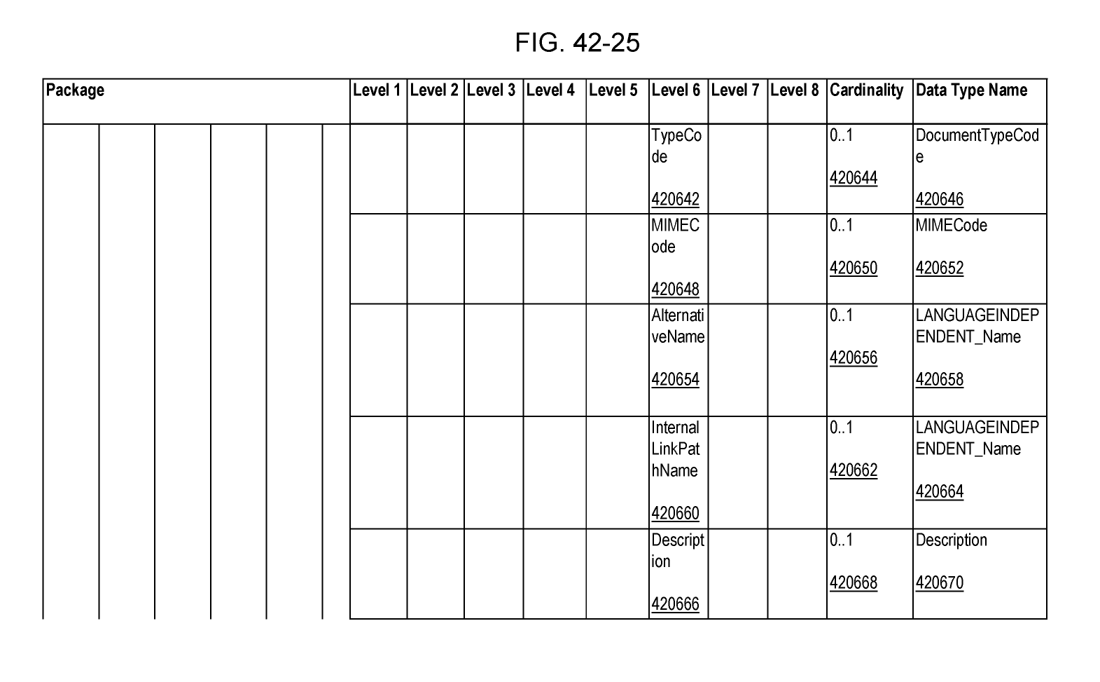

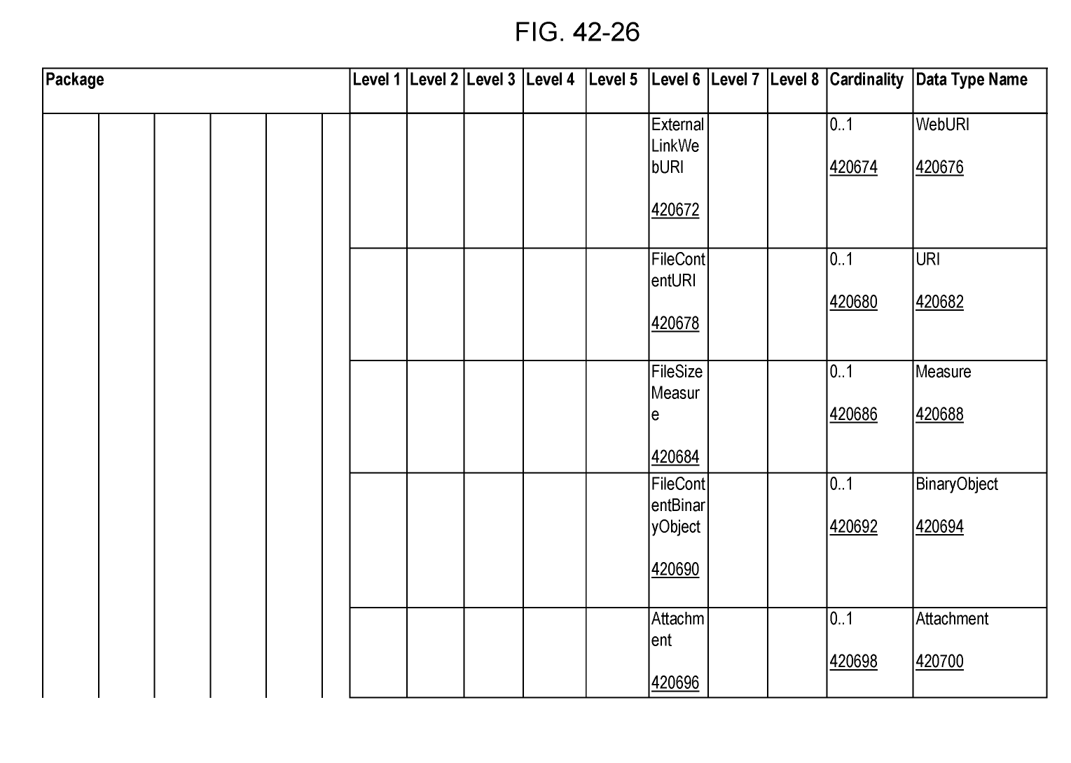

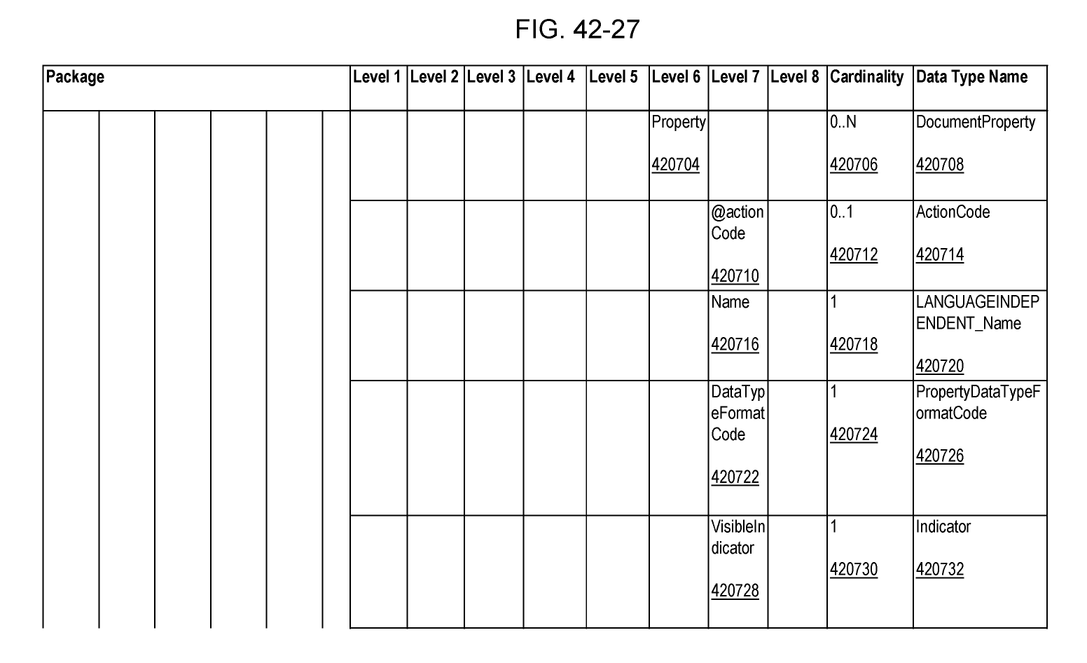

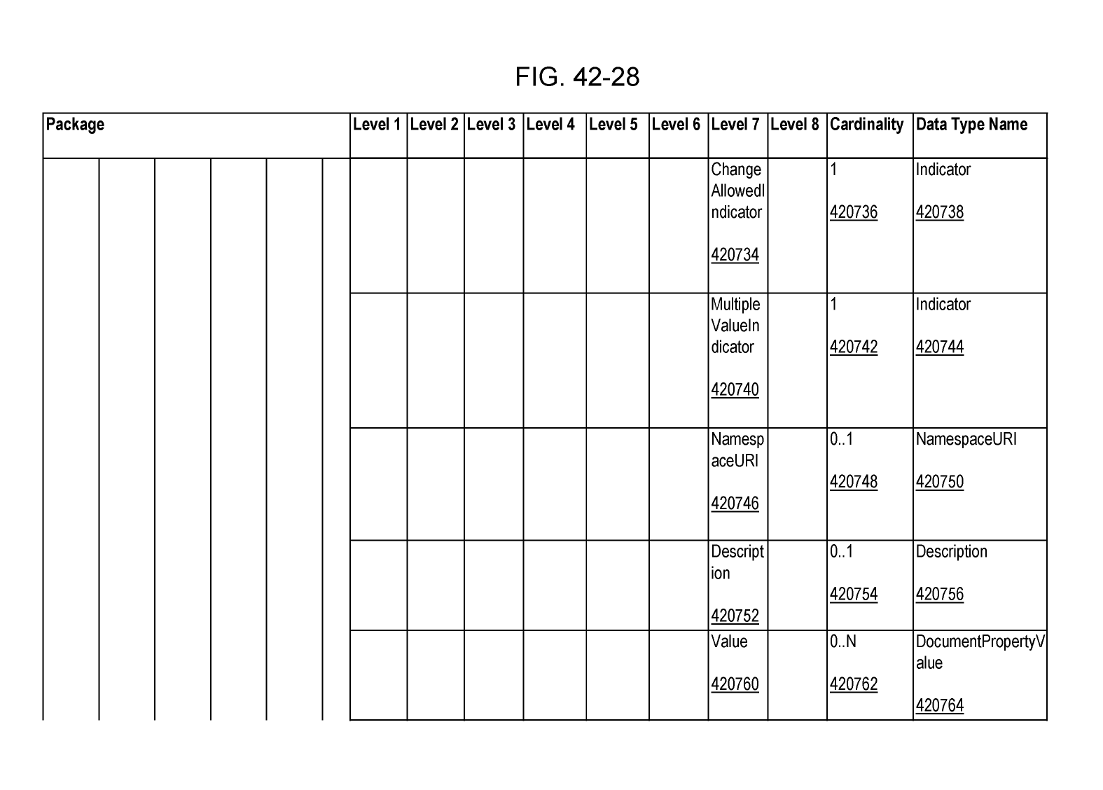

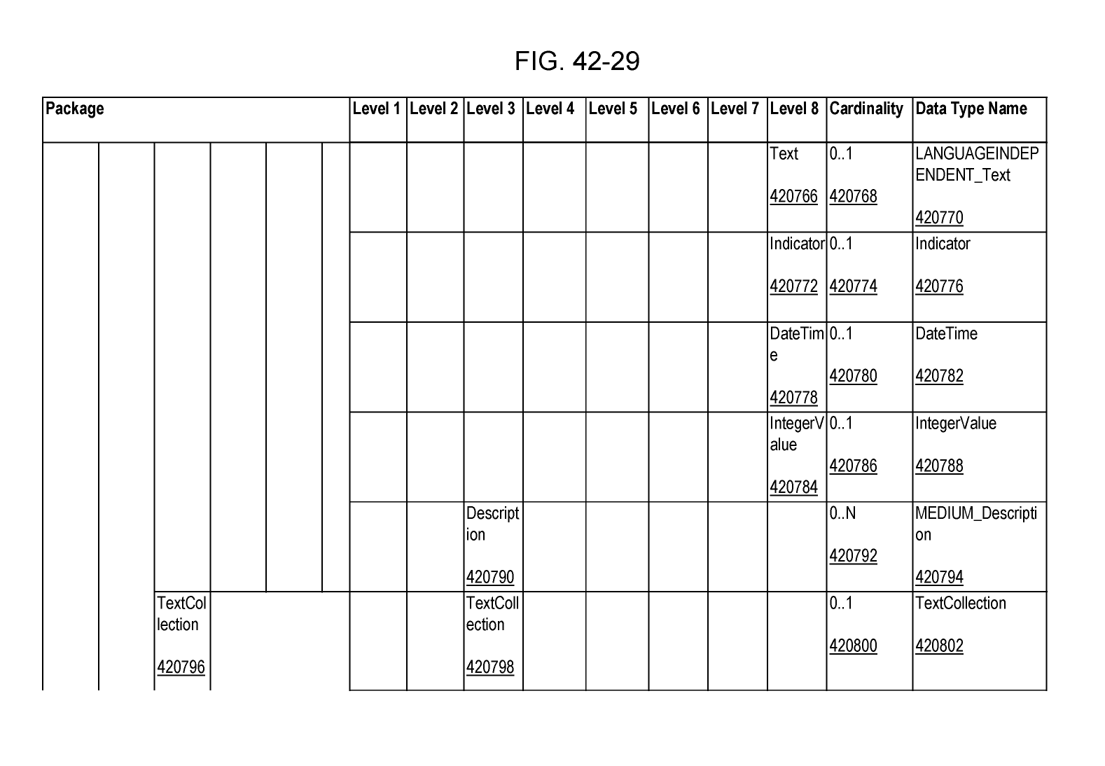

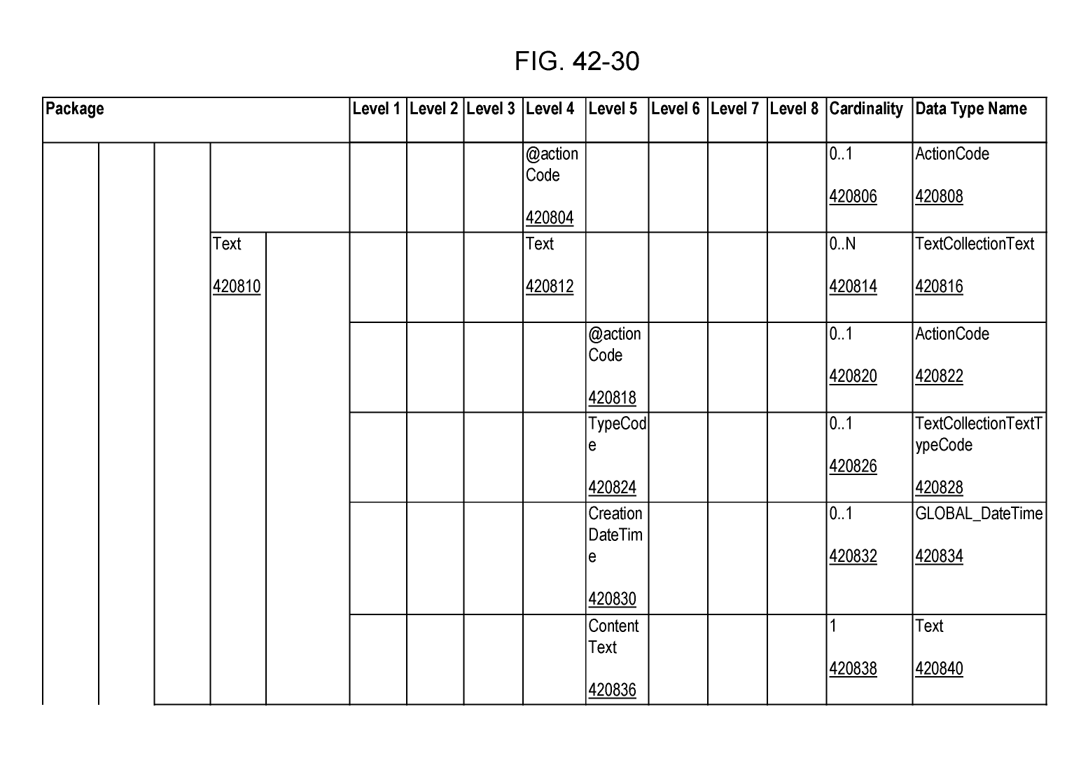

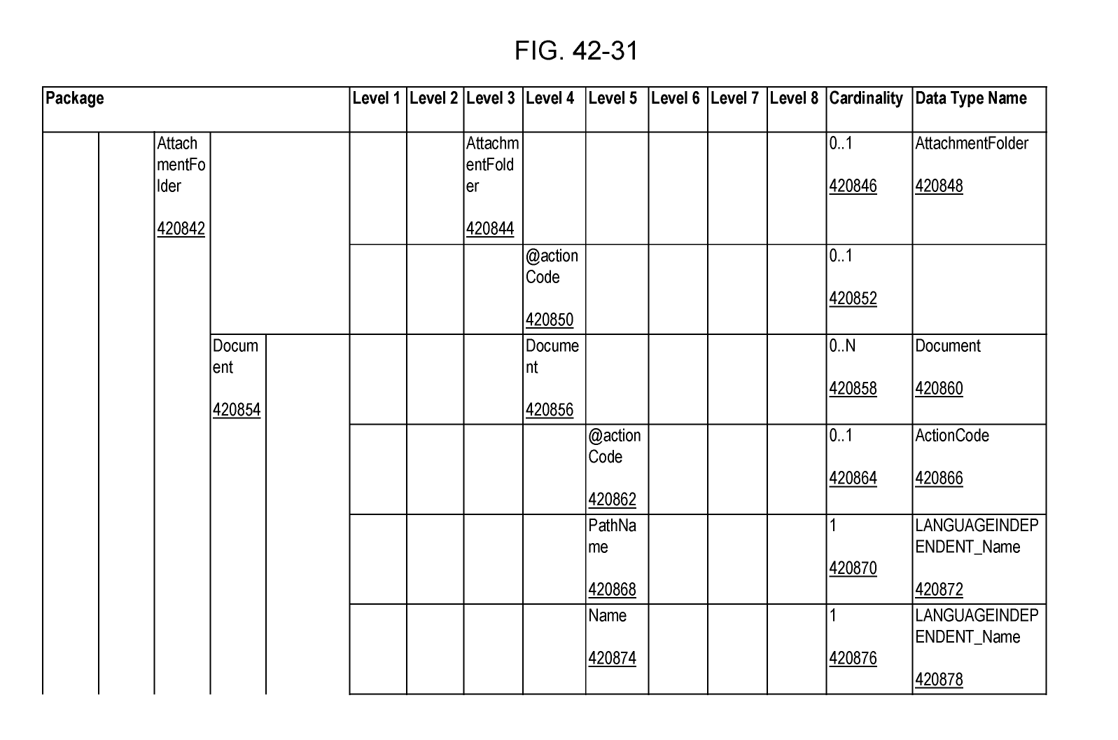

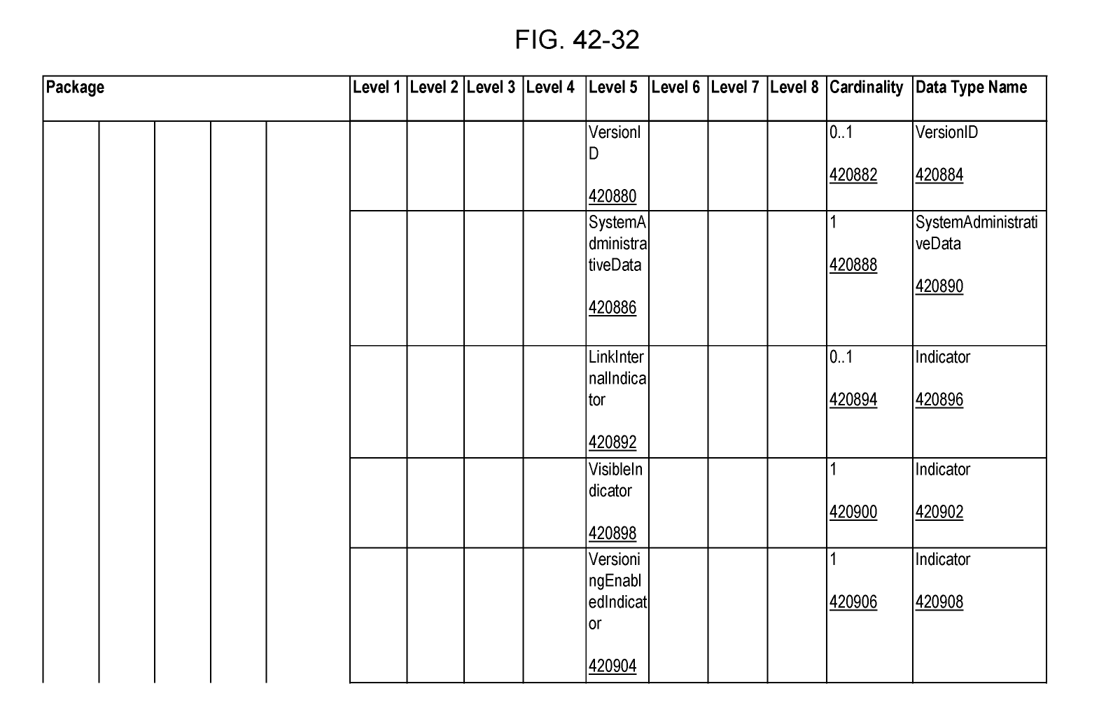

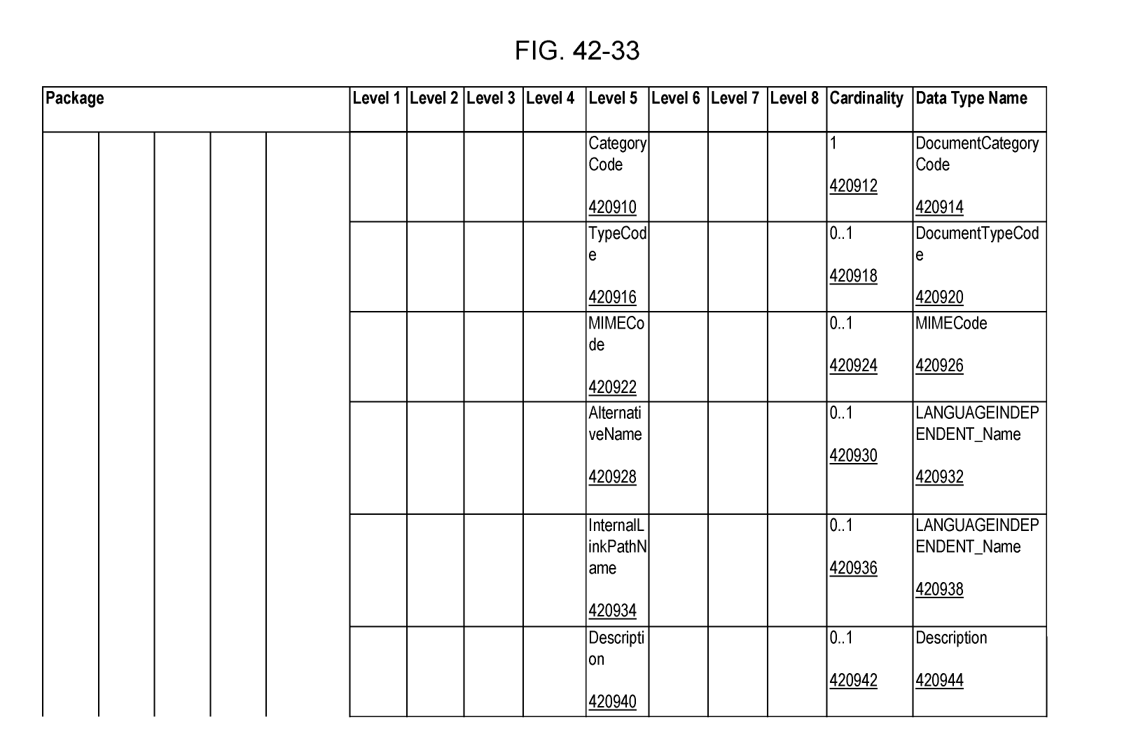

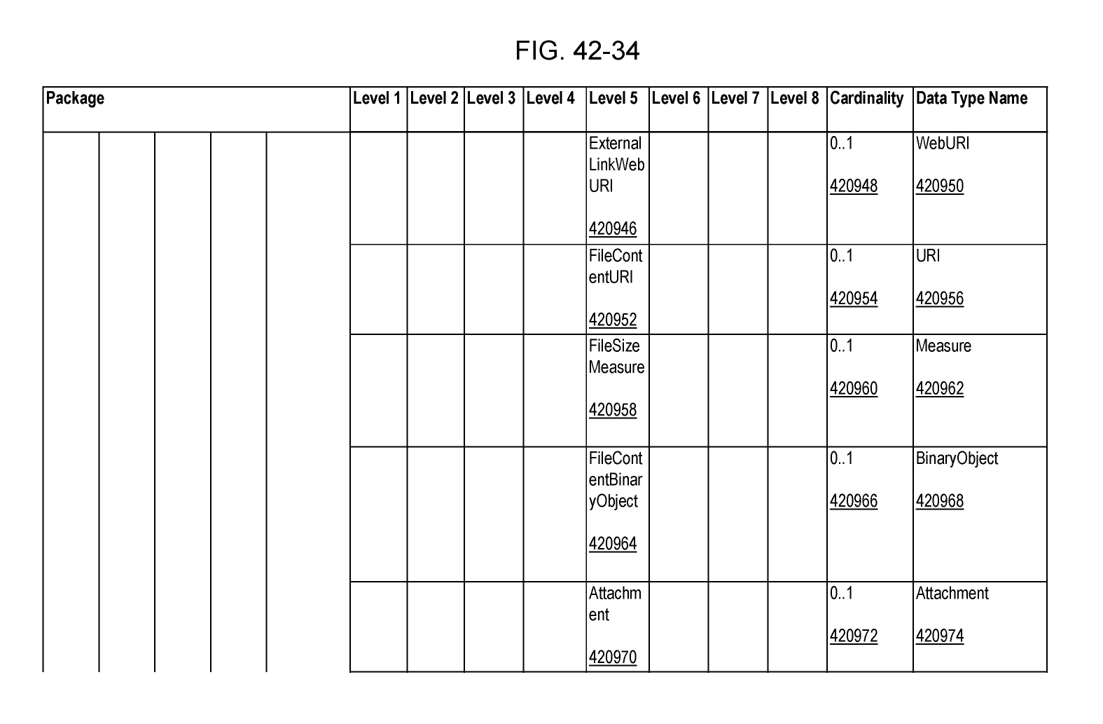

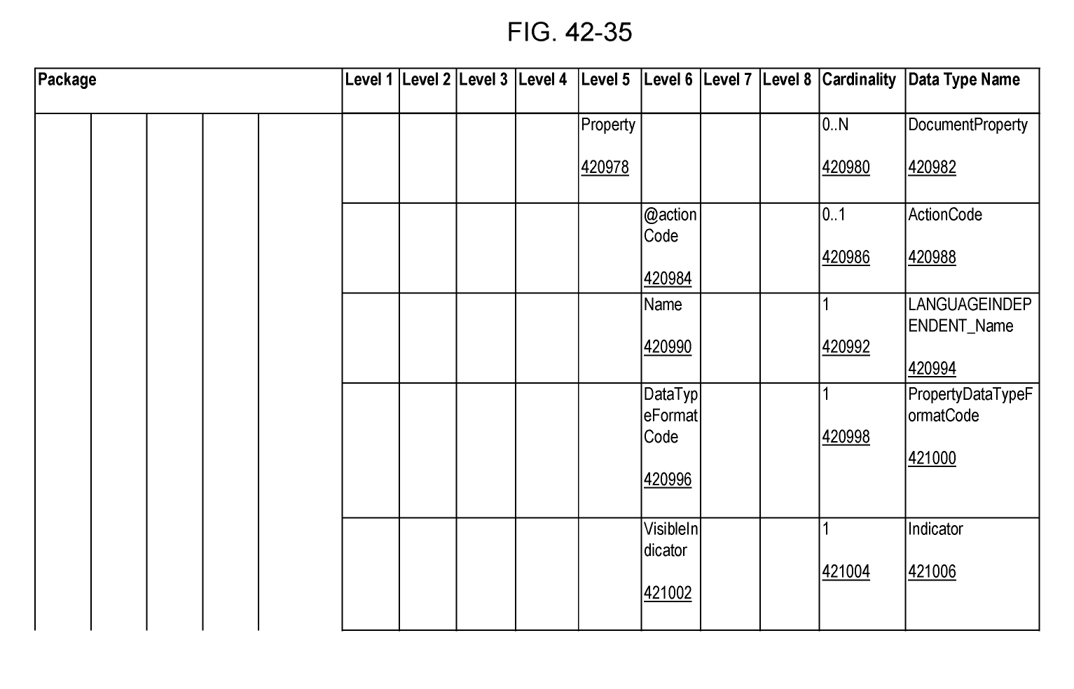

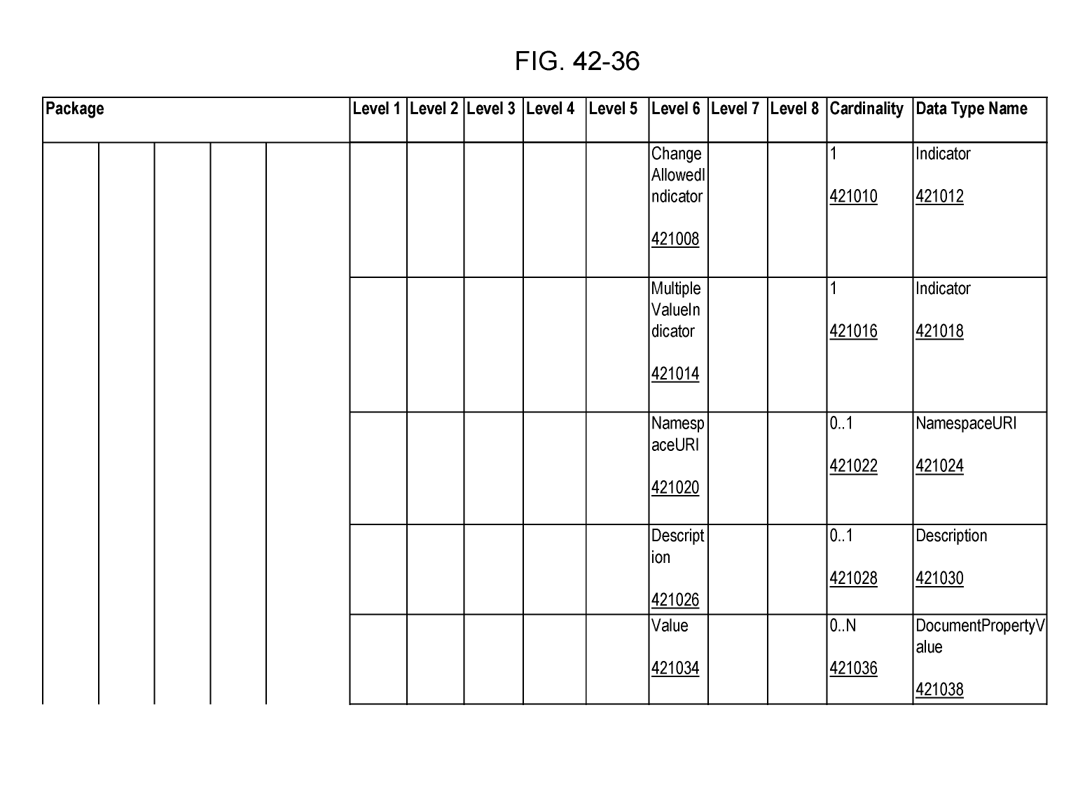

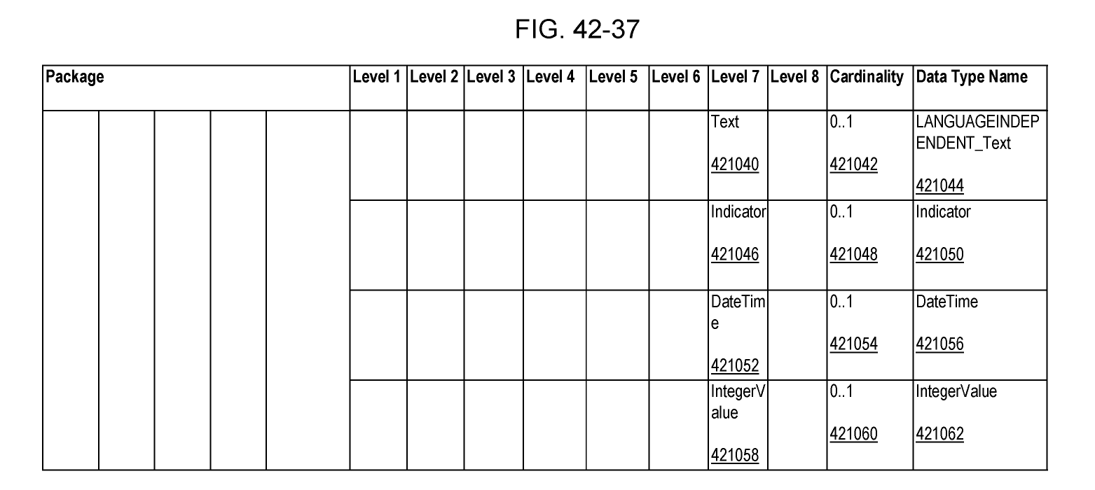

FIGS. 42-1 through 42-37 show an example configuration of an Element Structure that includes a ProductDesignReplicationRequest 420000 package. Specifically, these figures depict the arrangement and hierarchy of various components such as one or more levels of packages, entities, and datatypes, shown here as 420000 through 421062. As described above, packages may be used to represent hierarchy levels. Entities are discrete business elements that are used during a business transaction. Data types are used to type object entities and interfaces with a structure. For example, the ProductDesignReplicationRequest 420000 includes, among other things, a ProductDesignReplicationRequest 420002. Accordingly, heterogeneous applications may communicate using this consistent message configured as such.

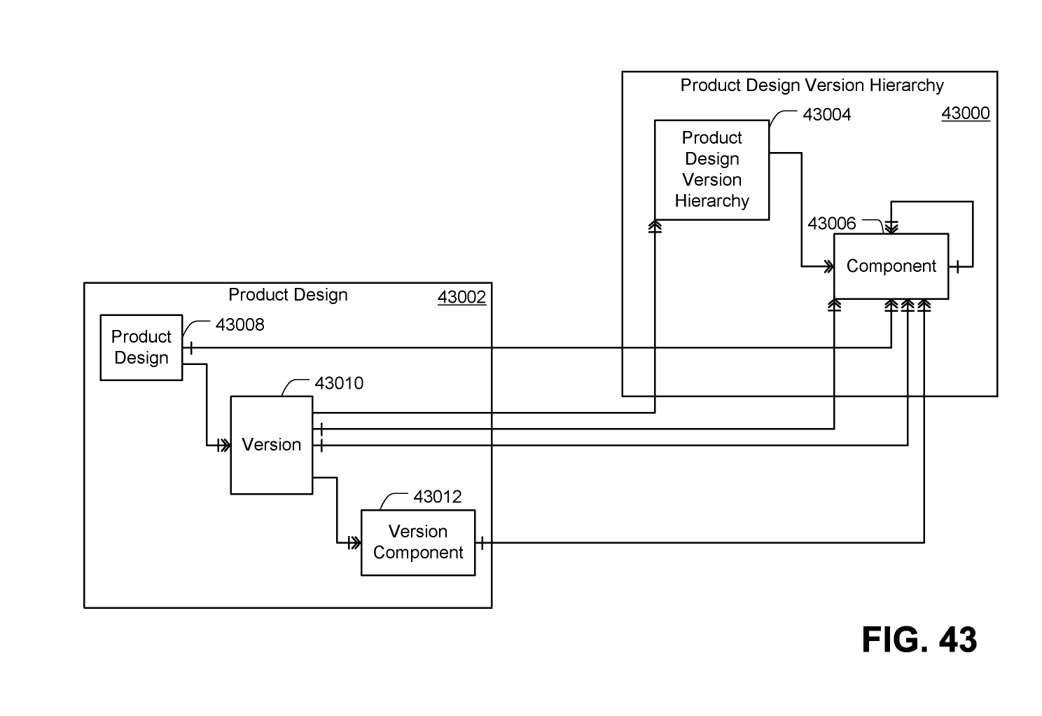

FIG. 43 depicts an example object model for a business object Product Design Version Hierarchy 43000. The business object 43000 has relationships with a Product Design object 43002, as shown with lines and arrows. The business object 43000 hierarchically comprises elements 43004, 43006. The Product Design object 43002 includes respective elements 43008-43012 as shown.

The business object Product Design Version Hierarchy is a hierarchy of a product design version. The business object Product Design Version Hierarchy belongs to the process component Product Engineering Foundation. A hierarchy is an explosion of a product design version, including the product design versions referenced by its components at all levels. A hierarchy can be used to show the overall structure of a complex product as designed by engineering. For example, a version of the product design Bicycle includes the following product designs as components: Frame, Front Wheel, Rear Wheel, Gear Shift and Handle Bar. Each version of the product design Gear Shift is also an assembly, encapsulates the product designs Chain, Gear, Chain Ring, and Lever as components, and may be used by several product designs. The hierarchy of a version of the product design Bicycle is a two level hierarchy of product design assemblies. In general, a product design version hierarchy includes components that establish a tree of product design versions.

The business object Product Design Version Hierarchy includes a Product Design Version Hierarchy Transformation Node root node. The elements located directly at the node Product Design Version Hierarchy are defined by the data type ProductDesignVersionHierarchyElements. These elements include: UUID, ProductDesignVersionUUID, ProductDesignVersionKey, ProductDesignID, ProductDesignVersionID, ProductDesignVersionBaseQuantity, ProductDesignVersionBaseQuantityTypeCode, Quantity, ExplosionDate, MaximumHierarchyLevelOrdinalNumberValue, and InactiveVersionIncludedIndicator. UUID may be an alternative key, is an identifier of a product design version hierarchy instance, and may be based on datatype GDT: UUID. ProductDesignVersionUUID is a universally unique identifier of a product design version for which a hierarchy is built up, and may be based on datatype GDT: UUID. ProductDesignVersionKey is a key of a product design version for which a hierarchy is built up, and may be based on datatype KDT: ProductDesignVersionKey. ProductDesignID is a unique identifier of a product design, and may be based on datatype GDT: ProductDesignID. ProductDesignVersionID is unique identifier of a product design version, and may be based on datatype GDT: VersionID. The product design version is unique within the context of a product design. ProductDesignVersionBaseQuantity may be optional, is a base quantity of a product design version, and may be based on datatype GDT: NONNEGATIVE_Quantity, with a qualifier of Base. A base quantity expresses an output quantity of a product design version. ProductDesignVersionBaseQuantityTypeCode may be optional, is a type of a base quantity of a product design version, and may be based on datatype GDT: QuantityTypeCode, with a qualifier of Base. Quantity may be optional, is a quantity of a root level as specified in a hierarchical explosion, and may be based on datatype GDT: NONNEGATIVE_Quantity. ExplosionDate may be optional, is a date used to determine the newest valid version on sub-levels in a hierarchical explosion, and may be based on datatype GDT: Date, with a qualifier of Explosion. MaximumHierarchyLevelOrdinalNumberValue may be optional, is a maximum number of levels of a hierarchy at an initial explosion when an instance of the object is created, and may be based on datatype GDT: OrdinalNumberValue, with a qualifier of HierarchyLevel. MaximumHierarchyLevelOrdinalNumberValue may be used for creation of the instance of the hierarchy and for printforms. If the MaximumHierarchyLevelOrdinalNumberValue is initial, the explosion will be executed as far as possible. InactiveVersionIncludedIndicator indicates that all versions with lifecycle status not equal to obsolete on sub-levels should be taken into account, and may be based on datatype GDT: Indicator, with a qualifier of Included.

The following composition relationships to subordinate nodes exist: Component with a cardinality of 1:N. A Product Design Version inbound aggregation relationship may exist from the business object Product Design/node Version, with a cardinality of 1:CN, which identifies the product design version for which the hierarchy is built up. A Product Design specialization association for navigation may exist to business object Product Design/node Product Design, with a target cardinality of 1, which identifies the product design that is referenced by a product design version hierarchy. In some implementations, the following node attributes are derived from the same original node instance Product Design Version: ProductDesignVersionKey, ProductDesignVersionUUID, ProductDesignVersionBaseQuantity, and ProductDesignVersionBaseQuantityTypeCode.

A Query By Version And Explosion Criteria query rquery returns the result of a hierarchical explosion. The query elements are defined by the data type ProductDesignVersionHierarchyVersionAndExplosionCriteriaQueryElements. These elements include: ProductDesignVersionKey, ProductDesignID, ProductDesignVersionID, ExplosionDate, MaximumHierarchyLevelOrdinalNumberValue, and InactiveVersionIncludedIndicator. ProductDesignVersionKey may be based on datatype KDT: ProductDesignVersionKey. ProductDesignID is a unique identifier of a product design, and may be based on datatype GDT: ProductDesignID. ProductDesignVersionID is a unique identifier of a product design version, and may be based on datatype GDT: VersionID. The product design version is unique within the context of a product design. ExplosionDate may be optional, and may be based on datatype GDT: Date, with a qualifier of Explosion. MaximumHierarchyLevelOrdinalNumberValue may be optional, and may be based on datatype GDT: OrdinalNumberValue, with a qualifier of HierarchyLevel. InactiveVersionIncludedIndicator and may be based on datatype GDT: Indicator, with a qualifier of Included.

A Component Transformation node includes detail of a product design version component. At the top level, the information of the product design version as the starting point of the hierarchical explosion is shown. There may be only one instance of the component assigned to the top level. The component node may include information from lower levels. Here it includes the information of the product design version component as well as a referenced product design and its version as determined within a hierarchical explosion path. The elements located directly at the node Component are defined by the data type ProductDesignVersionHierarchyComponentElements. These elements include: UUID, ParentComponentUUID, TopLevelProductDesignVersionUUID, ProductDesignVersionComponentUUID, ProductDesignUUID, ProductDesignVersionUUID, ProductDesignVersionComponentBaseQuantity, ProductDesignVersionComponentBaseQuantityTypeCode, Quantity, HierarchyLevelOrdinalNumberValue, and LeafIndicator. UUID may be an alternative key, is an identifier of a product design version hierarchy component instance, and may be based on datatype GDT: UUID. ParentComponentUUID may be optional, is an identifier of a parent node instance, and may be based on datatype GDT: UUID. TopLevelProductDesignVersionUUID may be optional, is a universally unique identifier of a product design version, may be based on datatype GDT: UUID, may be a product design version for which a hierarchy is built up, and may be filled on a top level of a hierarchy. ProductDesignVersionComponentUUID may be optional, is a universally unique identifier of a product design version component, and may be based on datatype GDT: UUID. ProductDesignUUID may be optional, is a universally unique identifier of a referenced product design, and may be based on datatype GDT: UUID. This element may not be maintained on a node instance which represents the top level. ProductDesignVersionUUID may be optional, is a universally unique identifier of a referenced product design version as selected within a hierarchical explosion, and may be based on datatype GDT: UUID. This element may not be maintained on a node instance which represents the top level. ProductDesignVersionComponentBaseQuantity may be optional, is a base quantity of a product design version component, and may be based on datatype GDT: NONNEGATIVE_Quantity, with a qualifier of Base. ProductDesignVersionComponentBaseQuantityTypeCode may be optional, is a quantity type code as specified in the referenced Product Design Version Component, and may be based on datatype GDT: QuantityTypeCode, with a qualifier of Base. Quantity may be optional, is a calculated quantity along a hierarchy path of an explosion, and may be based on datatype GDT: NONNEGATIVE_Quantity. HierarchyLevelOrdinalNumberValue is an identifying level of a component node within a hierarchical path, and may be based on datatype GDT: OrdinalNumberValue, with a qualifier of HierarchyLevel. LeafIndicator indicates that the current level is a leaf of a hierarchy, and may be based on datatype GDT: Indicator, with a qualifier of Leaf. The hierarchy additionally interprets a node as leaf if there occurs conversion errors of quantities within an explosion on a path.

A Top Level Product Design Version inbound aggregation relationship may exist from the business object Product Design/node Version, with a cardinality of C:CN, which identifies a product design version that is referenced by a component at top level. A Product Design inbound association relationship may exist from the business object Product Design/node Product Design, with a cardinality of C:CN, which identifies a product design that is referenced by a component. A Product Design Version inbound association relationship may exist from the business object Product Design/node Version, with a cardinality of C:CN, which identifies a product design version that is referenced by the component. A Product Design Version Component inbound association relationship may exist from the business object Product Design/node Version Component, with a cardinality of C:CN, which identifies the product design version component that is referenced by the component. A ParentComponent inbound association relationship may exist from the business object Product Design Version Hierarchy/node Component, with a cardinality of C:CN, which is a relation to the parent node to build up the hierarchy path of the explosion. The top-level component representing the starting product design version of the hierarchy may not have as target a ParentComponent, but rather a Component-relationship to the Root node. A ChildComponent specialization association for navigation may exist to the own business object/node Component, with a target cardinality of CN, which is a component which is child of a certain component. In some implementations, the element TopLevelProductDesignVersionUUID is only filled for the component node instance assigned to the top level, and has the same value as that referenced at root level.

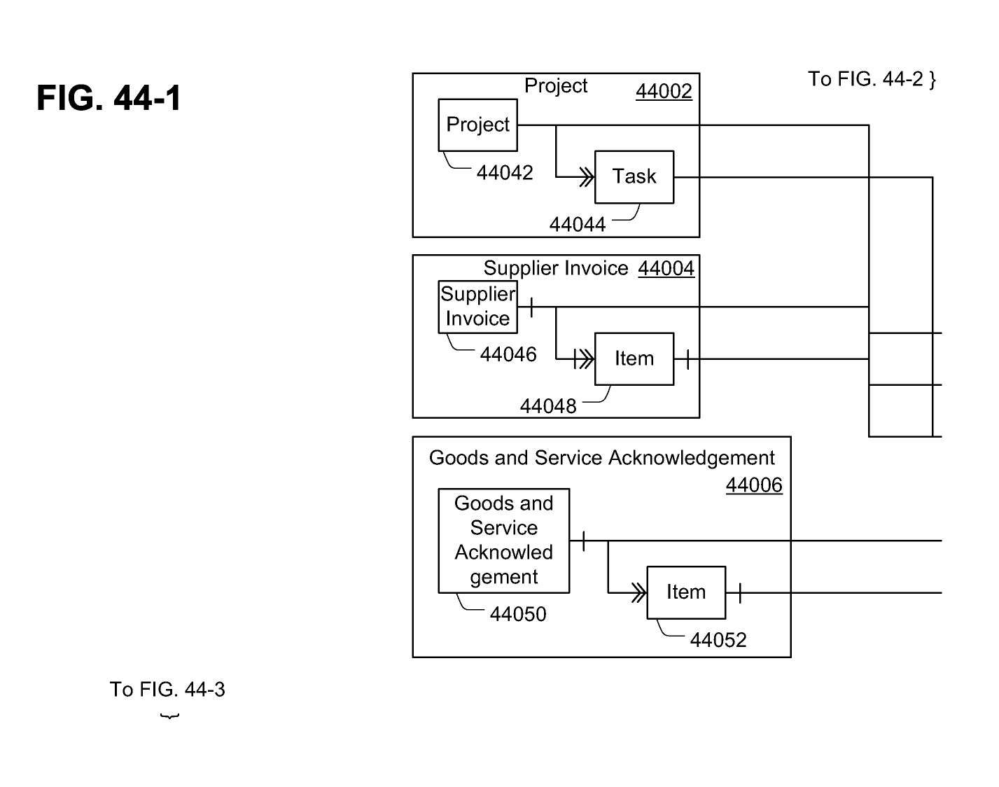

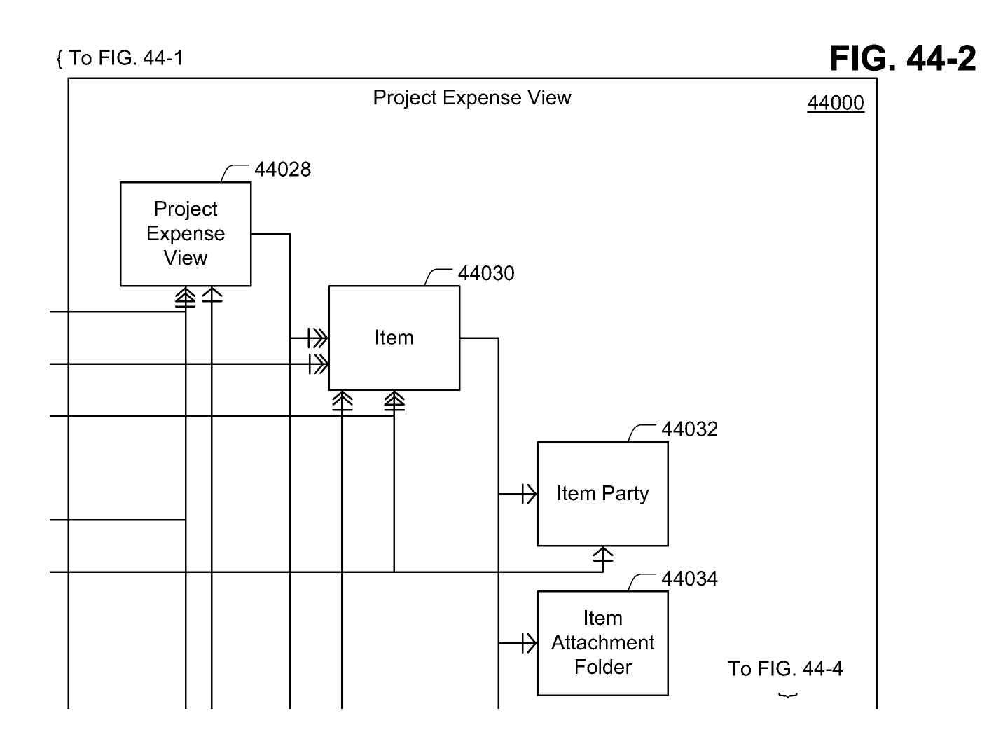

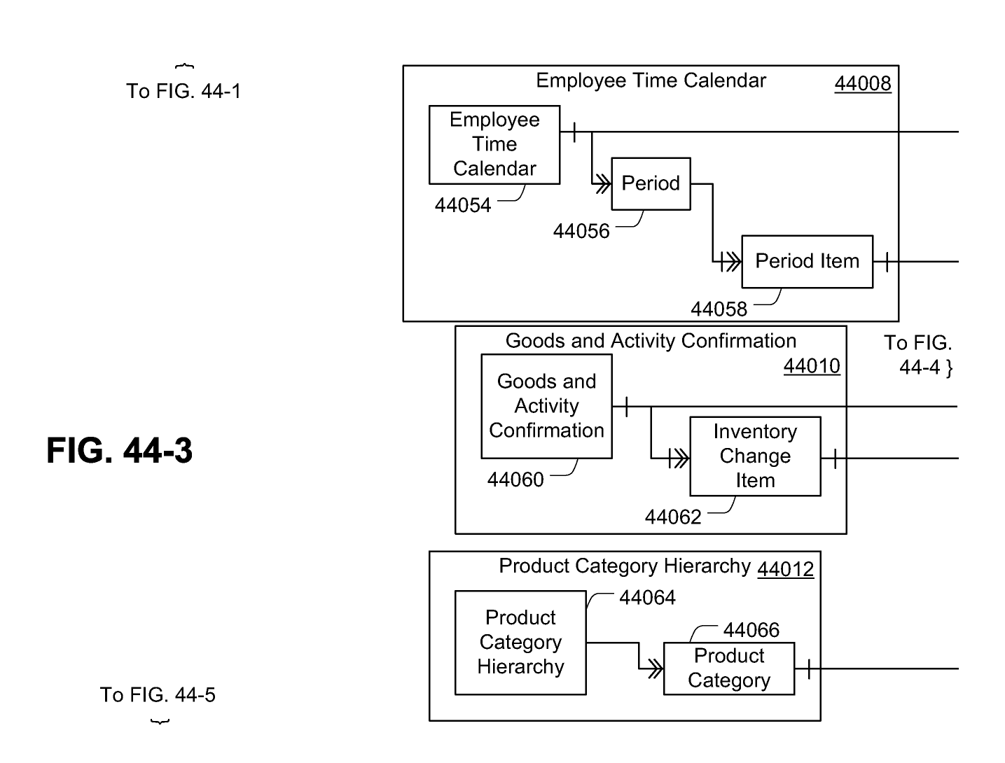

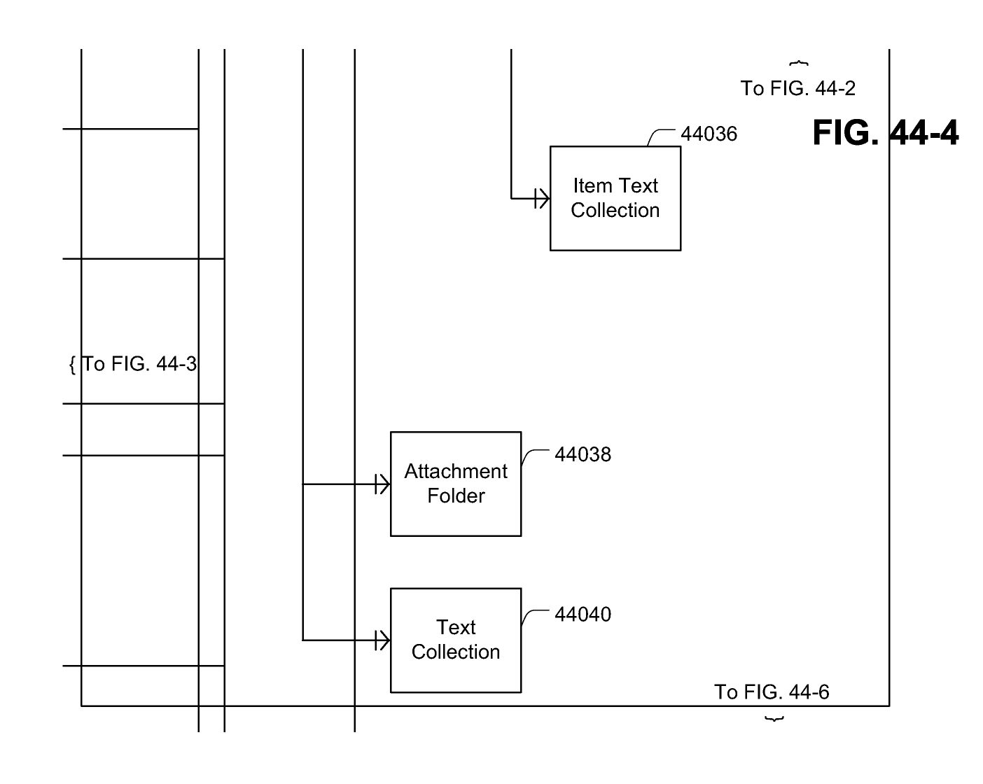

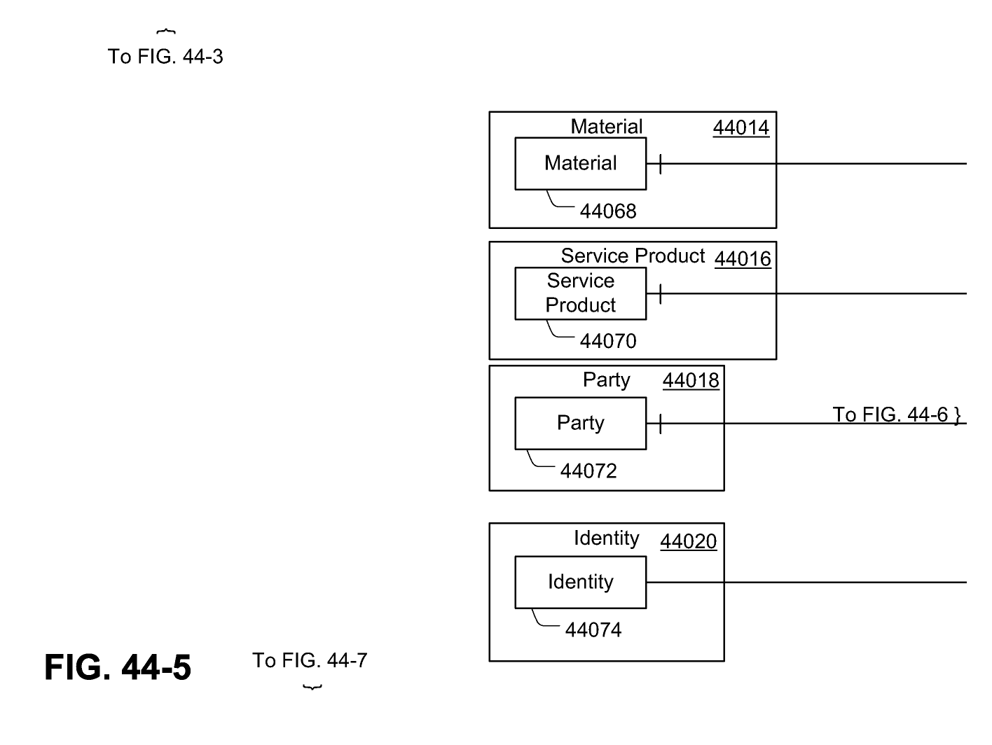

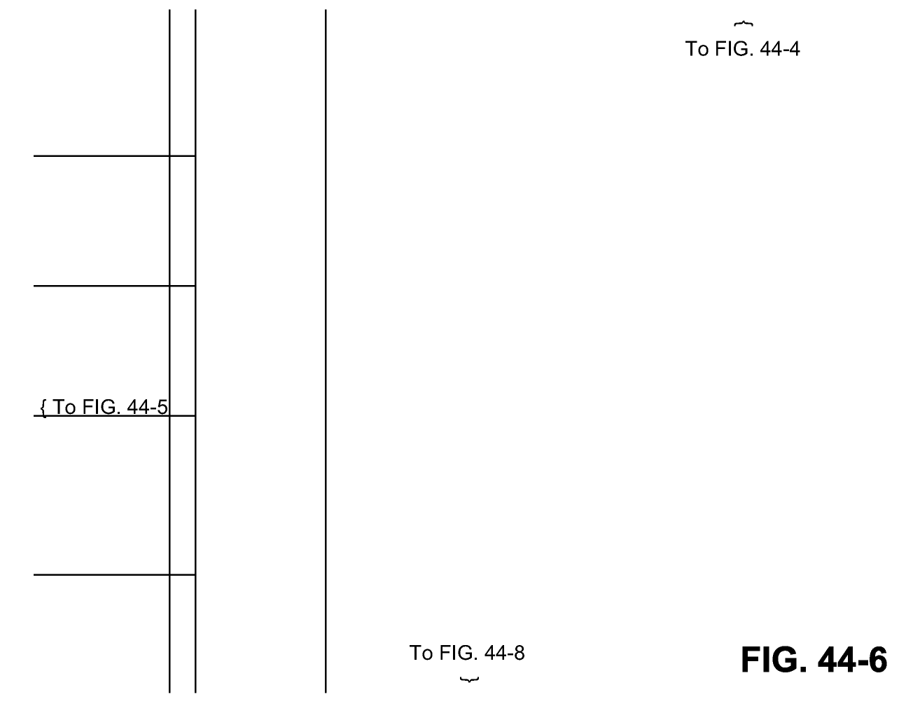

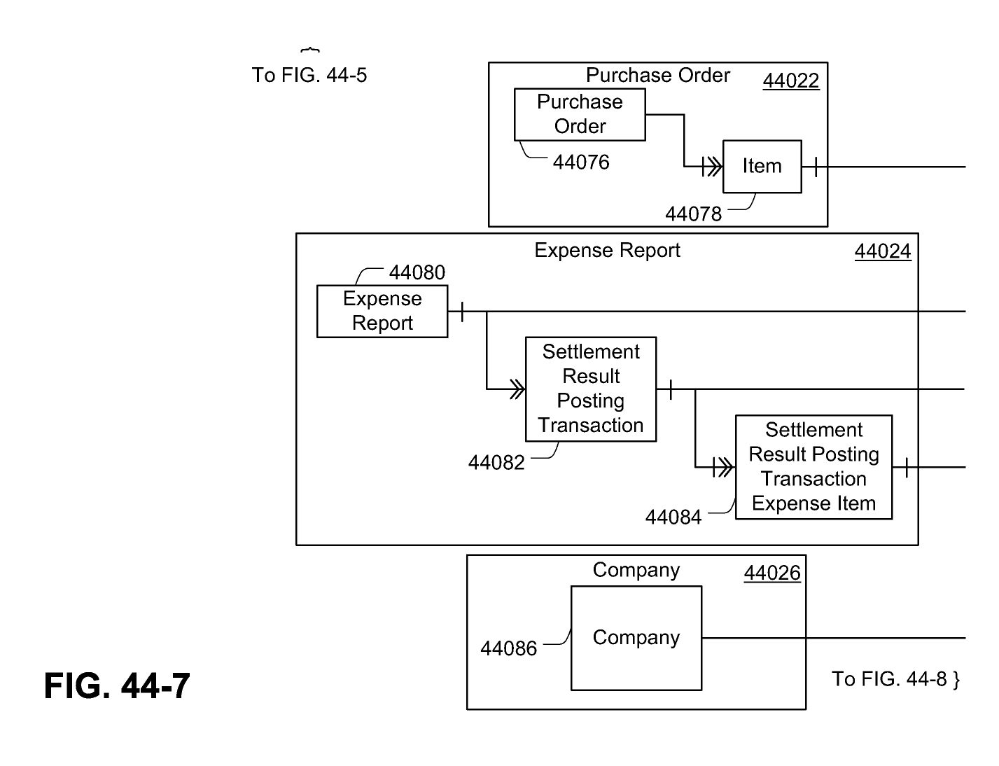

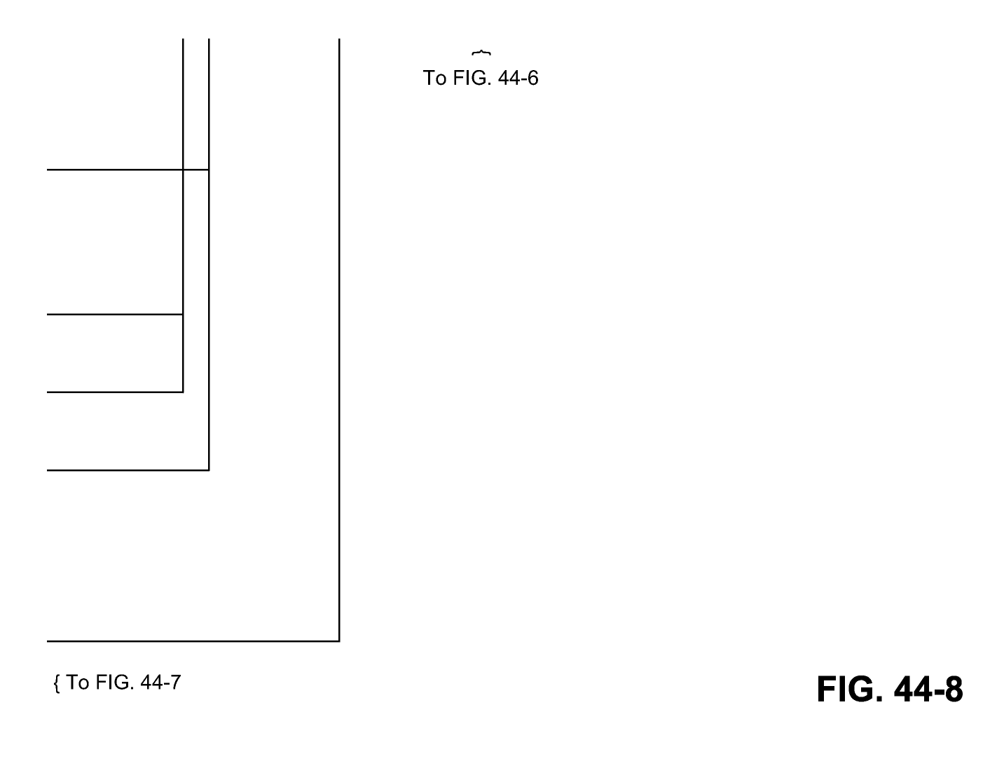

FIGS. 44-1 through 44-8 depict an example object model for a business object Project Expense View 44000. The business object 44000 has relationships with other objects 44002-44026, as shown with lines and arrows. The business object 44000 hierarchically comprises elements 44028-44040. The other objects 44002-44026 include respective elements 44042-44086 as shown.

The business object Project Expense View is a project management view of a project-related expense resulting from a business transaction. The business object Project Expense View belongs to the process component Project Processing. The project-related expense can be incurred as a result of services provided or materials consumed for a project task, for example. The project expense view can be used to compare planned and actual values. A project expense view includes: items which represent expenses incurred on a project task, item parties involved in incurred expense, and information about texts and attachments received from recording objects. The business object Project Expense View is involved in the following Process Component Interaction Models: Expense and Reimbursement Management_Project Processing, Goods and Service Acknowledgement_Project Processing, Inventory Processing_Project Processing, and Supplier Invoice Processing_Project Processing. A service interface Project Expense Notification In may have a technical name of ProjectProcessingProjectExpenseNotificationIn. The service interface Project Expense Notification In is part of the following Process Component Interaction Models: Expense and Reimbursement Management_Project Processing, Goods and Service Acknowledgement_Project Processing, Inventory Processing_Project Processing, and Supplier Invoice Processing_Project Processing. The service interface ProjectProcessingProjectExpenseNotificationIn is an interface to maintain a project expense, and may include a Maintain Project Expense View operation with a technical name of ProjectProcessingProjectExpenseNotificationln.MaintainProjectExpenseView. The ProjectProcessingProjectExpenseNotificationln.MaintainProjectExpenseView operation may be used to create or cancel a project expense, and may be based on message type Project Expense View Notification derived from business object Project Expense View.

The business object Project Expense View includes a Project Expense View root node, which is a view of an expense incurred on a project task. The elements located directly at the node Project Expense View are defined by the data type ProjectExpenseViewElements. These elements include: UUID, ProjectExpenseViewID, ExpenseDocumentReference, ExpenseDocumentIncludingBusinessObjectReference, ExpenseDocumentReference, ExpenseDocumentTransactionUUID, SystemAdministrativeData, CancellationStatusCode, and MigratedDataAdaptationTypeCode. UUID may be an alternative key, is a universally unique identifier of a project expense view for referencing purposes, and may be based on datatype GDT: UUID. ProjectExpenseViewID may be an alternative key, is a unique identifier of a project expense view, and may be based on datatype GDT: ProjectExpenseViewID. ExpenseDocumentReference may be optional, is a reference to an item of a business object responsible for a recording or cancellation of an expense incurred on a project task, and may be based on datatype GDT: ObjectNodeReference. In some implementations, the UUID or Object ID, formatted ID, object type code and object node type code information are filled in the ExpenseDocumentReference. ExpenseDocumentIncludingBusinessObjectReference may be optional, is a reference to a business object that includes a document in which an expense or a cancellation of an expense incurred on a project task was recorded, and may be based on datatype GDT: ObjectNodeReference. In some implementations, the ExpenseDocumentIncludingBusinessObjectReference may not be filled if it is same as the ExpenseDocumentReference. In some implementations, the UUID or Object ID, formatted ID, object type code and object node type code information are filled in the ExpenseDocumentIncludingBusinessObjectReference. ExpenseDocumentTransactionUUID may be optional, is a universally unique identifier of a transaction during which an expense document was created or changed, and may be based on datatype GDT: UUID. SystemAdministrativeData includes administrative data that provides information about creation and change dates as well as a system user who performed actions, and may be based on datatype GDT: SystemAdministrativeData. CancellationStatusCode is a coded representation of a cancellation status of a project expense view, and may be based on datatype GDT: CancellationStatusCode. The cancellation status on a root node is set for recordings from business object goods and activity confirmation, employee time calendar, and supplier invoice. MigratedDataAdaptationTypeCode may be optional, is a coded representation of a type of data adaptation performed during migration, and may be based on datatype GDT: MigratedDataAdaptationTypeCode. While migrating data from a source system to a target system, data may be adapted, for example, business documents or business objects may be taken over completely or partially.

The following composition relationships to subordinate nodes exist: Item with a cardinality of 1:CN, Attachment Folder with a cardinality of 1:C, and Text Collection with a cardinality of 1:C. An Employee Time Calendar inbound association relationship may exist from the business object Employee Time Calendar/node Employee Time Calendar Cross DU, with a cardinality of C:C, which specifies an employee time calendar responsible for a recording of an expense on a project task. An Expense Report inbound association relationship may exist from the business object Expense Report/node Expense Report Cross DU, with a cardinality of C:C, which specifies an expense report responsible for a recording on a project task. An Expense Report Settlement Result Posting Transaction inbound association relationship may exist from the business object Expense Report/node Settlement Result Posting Transaction Cross DU, with a cardinality of C:C, which specifies an expense report settlement result posting transaction responsible for a recording on a project task. A Goods and Activity Confirmation inbound association relationship may exist from the business object Goods and Activity Confirmation/node Goods and Activity Confirmation Cross DU, with a cardinality of C:C, which specifies a goods and activity confirmation responsible for a recording of an expense on a project task. A Goods and Service Acknowledgement inbound association relationship may exist from the business object Goods and Service Acknowledgement/node Goods and Service Acknowledgement Cross DU, with a cardinality of C:C, which specifies a goods and service acknowledgement responsible for a recording of an expense on a project task. A Creation Identity inbound association relationship may exist from the business object Identity/node Identity, with a cardinality of 1:CN, which is an identity of a user who created a project expense view. A Last Change Identity inbound association relationship may exist from the business object Identity/node Identity, with a cardinality of 1:CN, which is an identity of a user who last changed a project expense view. A Supplier Invoice inbound association relationship may exist from the business object Supplier Invoice/node Supplier Invoice Cross DU, with a cardinality of C:C, which specifies a supplier invoice responsible for a recording of an expense on a project task. In some implementations, ExpenseDocumentReference and ExpenseDocumentIncludingBusinessObjectReference information are not filled if the MigratedDataAdaptationTypeCode on the root node is filled.

A Query By Elements may be used to query elements for the root node. The query elements are defined by the data type ProjectExpenseViewElementsQueryElements. These elements include: ProjectExpenseViewID, ProjectID, ProjectTaskID, ExpenseDocumentReferenceObj ectTypeCode, SystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, LastChangeIdentityEmployeeID, SearchText, ExpenseDocumentReferenceFormattedID, ExpenseDocumentReferenceObjectID, and ExpenseDocumentReferenceUUID. ProjectExpenseViewID may be optional, and may be based on datatype GDT: ProjectExpenseViewID. ProjectID may be optional, and may be based on datatype GDT: ProjectID. ProjectTaskID may be optional, and may be based on datatype GDT: ProjectElementID. ExpenseDocumentReferenceObjectTypeCode may be optional, and may be based on datatype GDT: ObjectTypeCode. SystemAdministrativeData may be optional and may be based on datatype QueryIDT: QueryElementSystemAdministrativeData. CreationDateTime may be optional, is a point in time date and time stamp of a creation, and may be based on datatype GDT: GLOBAL_DateTime. CreationIdentityUUID may be optional, is a globally unique identifier for an identity who performed a creation, and may be based on datatype GDT: UUID. CreationIdentityID may be optional, is an identifier for an identity who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made the last changes, and may be based on datatype GDT: UUID. LastChangeIdentityID may be optional, is an identifier for an identity who made the last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID. SearchText may be optional, and may be based on datatype GDT: SearchText. SearchText may include free text including one or several search terms to search for a project expense view. For every query that includes the SearchText as a query parameter an application-specific subset of the other query parameters may be defined. The search terms may be assigned to the subset of query parameters in such a way that every search term is used exactly once in an assignment. Several search terms may be assigned to the same query parameter. For each of these assignments the query result is calculated. The total result is the union of the results calculated per assignment. ExpenseDocumentReferenceFormattedID may be optional, and may be based on datatype GDT: ObjectNodeFormattedID. ExpenseDocumentReferenceObjectID may be optional, and may be based on datatype GDT: ObjectID. ExpenseDocumentReferenceUUID may be optional, and may be based on datatype GDT: UUID. A Select All query provides the NodeIDs of all instances of a node, and may be used to enable an initial load of data for a fast search infrastructure.

Item is a representation of an item from an operational document where an expense originated. Item may be time dependent on Period. Item may be used to provide information about an expense incurred on a project task, such as a quantity or amount expended for a material or service product. The elements located directly at the node Item are defined by the data type ProjectExpenseViewItemElements. These elements include: UUID, ProjectExpenseViewItemID, ProjectUUID, ProjectTaskUUID, ExpenseDocumentItemReference, PurchaseOrderItemReference, GoodsAndServiceAcknowledgementItemReference, EmployeeTimeCalendarPeriodItemID, ProductUUID, Description, ProductCategoryIDKey, ProductCategoryHierarchyID, ProductCategoryInternalID, GeneralLedgerAccountAliasCode, ExpenseReportExpenseCategoryCode, ExpenseReportReceiptID, BaseMeasureUnitName, DeductionIndicator, TotalQuantity, TotalQuantityTypeCode, ExpenseRelevanceIndicator, TotalAmount, ExpenseIncurrencePeriod, CheckedIndicator, SetDate, Note, SystemAdministrativeData, CancellationStatusCode, ExpenseDocumentItemLastNotificationDateTime, CancelledItemUUID, ProductKey, ProductTypeCode, ProductidentifierTypeCode, ProductID, ProductCategoryUUID, CompanyResponsibleUUID, ServiceProviderCompanyUUID, and BillableIndicator. UUID may be an alternative key, is a universally unique identifier of an item of a project expense view for referencing purposes, and may be based on datatype GDT: UUID. ProjectExpenseViewItemID is an identifier for an item of a project expense view, and may be based on datatype GDT: ProjectExpenseViewItemID. ProjectUUID is a universally unique identifier of a project on which expenses were incurred, and may be based on datatype GDT: UUID. ProjectTaskUUID is a universally unique identifier of a project task on which expenses were incurred, and may be based on datatype GDT: UUID. ExpenseDocumentItemReference may be optional, is a reference to an item of a business object responsible for a recording or cancellation of an expense incurred on a project task, and may be based on datatype GDT: ObjectNodeReference. In some implementations, the UUID or Object ID, formatted ID, object type code and object node type code information are filled in an ExpenseDocumentItemReference. PurchaseOrderItemReference may be optional, is a reference to a purchase order item to which a recording supplier invoice item or goods and service acknowledgement item belongs, and may be based on datatype GDT: BusinessTransactionDocumentReference. GoodsAndServiceAcknowledgementItemReference may be optional, is a reference to a goods and service acknowledgement item to which a recording supplier invoice item belongs, and may be based on datatype GDT: BusinessTransactionDocumentReference. EmployeeTimeCalendarPeriodItemID may be optional, is a unique identifier of an employee time calendar period item, and may be based on datatype GDT: BusinessTransactionDocumentID. ProductUUID may be optional, is a unique identifier of a product used for a project task on which an expense was incurred, and may be based on datatype GDT: UUID. Description may be optional, is a description of an expense incurred, and may be based on datatype GDT: MEDIUM_Description. ProductCategoryIDKey may be optional, is a key of ProductCategory in a business document, and may be based on datatype KDT: ProductCategoryHierarchyProductCategoryIDKey. ProductCategoryHierarchyID is an identifier for a product category hierarchy, and may be based on datatype GDT: ProductCategoryHierarchyID. ProductCategoryInternalID is an identifier for a product category, and may be based on datatype GDT: ProductCategoryInternalID. GeneralLedgerAccountAliasCode may be optional, indicates how expenses are grouped for the purpose of G/L (General Ledger) account determination, and may be based on datatype GDT: GeneralLedgerAccountAliasCode. ExpenseReportExpenseCategoryCode may be optional, is an expense category of an expense item received from an expense report, and may be based on datatype GDT: ExpenseReportExpenseCategoryCode. ExpenseReportReceiptID may be optional, is a unique identifier of a receipt received from an expense report, and may be based on datatype GDT: ExpenseReportReceiptID. BaseMeasureUnitName may be optional, is a name of a unit that is based on a receipt received from an expense report, and may be based on datatype GDT: MEDIUM_Name, with a qualifier of MeasureUnit. DeductionIndicator indicates whether there is a deduction on an expense item received from an expense report, and may be based on datatype GDT: Indicator, with a qualifier of Deduction. TotalQuantity may be optional, is a recorded quantity of an expense incurred for a project task, and may be based on datatype GDT: Quantity, with a qualifier of Total. TotalQuantityTypeCode may be optional, is a coded representation of a type of a total quantity, and may be based on datatype GDT: QuantityTypeCode, with a qualifier of Total. ExpenseRelevanceIndicator indicates whether or not an expense is to be used in subsequent processes such as invoicing, cost to complete analysis, FIN reporting, and so on, and may be based on datatype GDT: Indicator, with a qualifier of Relevance. TotalAmount may be optional, is a recorded amount of an expense incurred for a project task, and may be based on datatype GDT: Amount, with a qualifier of Total. ExpenseIncurrencePeriod is a date and time period during which an expense was incurred on a project task, and may be based on datatype GDT: UPPEROPEN_LOCALNORMALISED_DateTimePeriod, with a qualifier of ExpenseIncurrence. CheckedIndicatorindicates whether a project expense view item has been checked for invoicing, and may be based on datatype GDT: Indicator, with a qualifier of Checked. SetDate may be optional, is a date on which an item is checked for invoicing, and may be based on datatype GDT: Date, with a qualifier of Set. Note may be optional, is a text field in which a detailed description of an item can be entered, and may be based on datatype GDT: LANGUAGEINDEPENDENT_MEDIUM_Note. SystemAdministrativeData includes administrative data that provides information about creation and change dates as well as a system user who performed actions, and may be based on datatype GDT: SystemAdministrativeData. CancellationStatusCode is a coded representation of a cancellation status of a project expense view item, and may be based on datatype GDT: CancellationStatusCode. ExpenseDocumentItemLastNotificationDateTime may be optional, is a point in time when a message including notification of a creation or change of a project expense item is received, and may be based on datatype GDT: LOCALNORMALISED_DateTime, with a qualifier of Notification. CancelledItemUUID may be optional, is a universally unique identifier of a canceled project expense view item, and may be based on datatype GDT: UUID. A cancellation item corresponds to a project expense view item that has been canceled. ProductKey may be optional, is a key of a product in a business document, and may be based on datatype KDT: ProductKey. ProductTypeCode is a coded representation of a product type such as a material or service, and may be based on datatype GDT: ProductTypeCode. ProductidentifierTypeCode is a coded representation of a product identifier type, and may be based on datatype GDT: ProductidentifierTypeCode. ProductID is an identifier for a product, and may be based on datatype GDT: ProductID. ProductCategoryUUID may be optional, is a universally unique identifier of a category of product used for a project task on which an expense was incurred, and may be based on datatype GDT: UUID. CompanyResponsibleUUID may be optional, is a universally unique identifier of a company responsible for expenses present in an expense item, and may be based on datatype GDT: UUID. ServiceProviderCompanyUUID may be optional, is a universally unique identifier of a company that provided a service which caused an expense included in an expense item, and may be based on datatype GDT: UUID. BillableIndicator indicates whether an expense included in an expense item is billable, and may be based on datatype GDT: Indicator, with a qualifier of Billable.

The following composition relationships to subordinate nodes exist: Item Party with a cardinality of 1:C, Item Attachment Folder with a cardinality of 1:C, and Item Text Collection with a cardinality of 1:C. A Project inbound aggregation relationship may exist from the business object Project/node Project, with a cardinality of 1:CN, which is a project on which an expense was incurred. A Project Task inbound aggregation relationship may exist from the business object Project/node Task, with a cardinality of 1:CN, which is a project task on which an expense occurred. A CompanyResponsible inbound association relationship may exist from the business object Company/node Company Cross DU, with a cardinality of 1:CN, which is a company responsible for an expense included in an expense document item. A ServiceProviderCompany inbound association relationship may exist from the business object Company/node Company Cross DU, with a cardinality of 1:CN, which is a company that provided a service which caused an expense included in an expense item. A Employee Time Calendar Period Item inbound association relationship may exist from the business object Employee Time Calendar/node Period Item Cross DU, with a cardinality of C:C, which specifies a time recording done on a project task from an employee time calendar period item. A Expense Report Settlement Result Posting Transaction Expense Item inbound association relationship may exist from the business object Expense Report/node Settlement Result Posting Transaction Expense Item Cross DU, with a cardinality of C:C, which specifies a recording of an expense from a settlement result posting transaction expense item of an expense report with reference to a project task. A Goods and Activity Confirmation Inventory Change Item inbound association relationship may exist from the business object Goods and Activity Confirmation/node Inventory Change Item Cross DU, with a cardinality of C:C, which specifies a recording of an expense against a project task owing to a quantity and/or attribute change of a material in a storage location. A Goods and Service Acknowledgement Item inbound association relationship may exist from the business object Goods and Service Acknowledgement/node Item Cross DU, with a cardinality of C:C, which specifies a recording of an expense from a goods and service acknowledgement item with reference to a project task. A Creation Identity inbound association relationship may exist from the business object Identity/node Identity, with a cardinality of 1:CN, which is an identity of a user who created an item. A Last Change Identity inbound association relationship may exist from the business object Identity/node Identity, with a cardinality of 1:CN, which is an identity of a user who last changed an item. A Material inbound association relationship may exist from the business object Material/node Material, with a cardinality of C:C, which specifies a material that was consumed for a project task. A Product Category inbound association relationship may exist from the business object Product Category Hierarchy/node Product Category Cross DU, with a cardinality of C:C, which specifies the characteristics of a product responsible for an expense recorded against a project task. A Purchase Order Item inbound association relationship may exist from the business object Purchase Order/node Item Cross DU, with a cardinality of C:C, which specifies a purchase order item to which a supplier invoice or goods and service acknowledgement recording belongs. A Service Product inbound association relationship may exist from the business object Service Product/node Service Product Cross DU, with a cardinality of C:C, which specifies a service product that is rendered for a project task. A Supplier Invoice Item inbound association relationship may exist from the business object Supplier Invoice/node Item Cross DU, with a cardinality of C:C, which specifies the recording of an expense from a supplier invoice item with reference to a project task.

The following specialization associations for navigation may exist to node item Party: Employee Responsible Item Party, with a target cardinality of C, which is an association to an item party that occurs in the specialization Responsible Employee Party; Seller Item Party, with a target cardinality of C, which is an association to an item party that occurs in the specialization Seller Party; Service Performer Item Party, with a target cardinality of C, which is an association to an item party that occurs in the specialization Service Performer Party; Expense Incurring Item Party, with a target cardinality of C, which is an association to an item party that is responsible for an expense included in the project expense view item; Customer Project Expense List Expense Document Item, with a target cardinality of C, which is an association to the business object Customer Project Expense List/node Expense Document Item and an association to an expense document item in a customer project expense list; CompanyResponsibleCurrentData, with a target cardinality of C, which is an association to the business object Company/node CurrentDefaultAddressAndMostRecentName and an association to the company responsible for an expense included in an expense document item; ServiceProviderCompanyCurrentData, with a target cardinality of C, which is an association to the business object Company/node CurrentDefaultAddressAndMostRecentName and an association to a company that performed a service which caused an expense included in an expense document item.

In some implementations, either a ProductUUID, an expense description, a ProductCategoryHierarchyProductCategoryIDKey, or a ExpenseReportExpenseCategoryCode with GeneralLedgerAccountAliasCode are provided. In some implementations, TotalQuantityTypeCode and TotalQuantityUnitCode are filled if TotalQuantity is filled. In some implementations, TotalAmountCurrencyCode is filled if TotalAmount is filled. In some implementations, at least one of TotalQuantity with type code and unit code or TotalAmount with currency code information is filled. In some implementations, ExpenseDocumentItemReference information is not filled if MigratedDataAdaptationTypeCode on the root node is filled. In some implementations, EmployeeTimeCalendarPeriodItemID is filled if an item is created based on a recording from goods and service acknowledgement. In some implementations, GoodsandServiceAcknowledgementItemReference is filled if an item is created based on a recording from supplier invoice. In some implementations, PurchaseOrderItemReference is filled if an item is created based on a recording from goods and service acknowledgement. In some implementations, Set Date is filled if the Checked Indicator is set to true.

A Query By Elements query may be used to query Item elements. The query elements are defined by the data type ProjectExpenseViewItemElementsQueryElements. These elements include: ProjectTaskID, ProjectID, ExpenseDocumentItemReferenceFormattedID, ExpenseDocumentItemReferenceObjectTypeCode, ExpenseDocumentItemReferenceObjectNodeTypeCode, SearchText, ExpenseIncurrencePeriod, EmployeeTimeCalendarPeriodItemID, SetDate, ExpenseRelevanceIndicator, CancellationStatusCode, CheckedIndicator, SystemAdministrativeData, CreationDateTime, CreationIdentityUUID, CreationIdentityID, CreationIdentityBusinessPartnerInternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, LastChangeIdentityEmployeeID, ExpenseDocumentItemReferenceObj ectID, and ExpenseDocumentItemReferenceUUID. ProjectTaskID may be optional, and may be based on datatype GDT: ProjectElementID. ProjectID may be optional, and may be based on datatype GDT: ProjectID. ExpenseDocumentItemReferenceFormattedID may be optional, and may be based on datatype GDT: ObjectNodeFormattedID. ExpenseDocumentItemReferenceObjectTypeCode may be optional, and may be based on datatypeGDT: ObjectTypeCode. ExpenseDocumentItemReferenceObjectNodeTypeCode may be optional, and may be based on datatype GDT: ObjectNodeTypeCode. SearchText may be optional, and may be based on datatype GDT: SearchText. SearchText may include free text including one or several search terms to search for a project expense view. For every query that includes the SearchText as a query parameter an application-specific subset of the other query parameters may be defined. The search terms may be assigned to the subset of query parameters in such a way that every search term is used exactly once in an assignment. Several search terms may be assigned to the same query parameter. For each of these assignments the query result is calculated. The total result is the union of the results calculated per assignment. ExpenseIncurrencePeriod may be optional, and may be based on datatype GDT: UPPEROPEN_LOCALNORMALISED_DateTimePeriod, with a qualifier of ExpenseIncurrence. EmployeeTimeCalendarPeriodItemID may be optional, and may be based on datatype GDT: BusinessTransactionDocumentID. SetDate may be optional, and may be based on datatype GDT: Date, with a qualifier of Set. ExpenseRelevanceIndicator may be optional, and may be based on datatype GDT: Indicator, with a qualifier of Relevance. CancellationStatusCode may be optional, and may be based on datatype GDT: CancellationStatusCode. CheckedIndicator may be optional, and may be based on datatype GDT: Indicator, with a qualifier of Checked. SystemAdministrativeData may be optional, and may be based on datatype QueryIDT: QueryElementSystemAdministrativeData. CreationDateTime may be optional, is a point in time date and time stamp of a creation, and may be based on datatype GDT: GLOBAL_DateTime. CreationIdentityUUID may be optional, is a globally unique identifier for an identity who performed a creation, and may be based on datatype GDT: UUID. CreationIdentityID may be optional, is an identifier for an identity who performed a creation, and may be based on datatype GDT: IdentityID. CreationIdentityBusinessPartnerInternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made last changes, and may be based on datatype GDT: UUID. LastChangeIdentityID may be optional, is an identifier for an identity who made last changes, and may be based on datatype GDT: IdentityID. LastChangeIdentityBusinessPartnerInternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID. ExpenseDocumentItemReferenceObjectID may be optional, and may be based on datatype GDT: ObjectID. ExpenseDocumentItemReferenceUUID may be optional, and may be based on datatype GDT: UUID.

Item Party is a natural or legal person, organization, organizational unit or group that is involved in a project expense view item in a party role. A party role specifies which rights and obligations a party has regarding a project expense view item and associated processes. An item party can be a business partner or organizational center in the specializations Employee, Seller or Service Performer. An item party can occur in the following disjoint and complete specializations: EmployeeResponsibleParty, which is a party employee that is responsible for contribution to or that has contributed to the creation of goods or services for a company; Seller Party, which is party seller that sells materials or services; and Service Performer Party, which is a party that provides services.

The elements located directly at the node Item Party are defined by the data type ProjectExpenseViewItemPartyElements. These elements include: PartyUUID, PartyKey, PartyTypeCode, PartyID, PartyRoleCode, and PartyRoleCategoryCode. PartyUUID is a universally unique identifier of a business partner or organizational center involved in an expense incurred for a project task, and may be based on datatype GDT: UUID. PartyKey may be optional, is a key of item party in a business document or master data object, and may be based on datatype KDT: PartyKey. PartyTypeCode is a coded representation of a type of party, and may be based on datatype GDT: BusinessObjectTypeCode. PartyID is an identifier for a party, and may be based on datatype GDT: PartyID. PartyRoleCode may be optional, is Party role of an item party in a business document, and may be based on datatype GDT: PartyRoleCode. PartyRoleCategoryCode may be optional, is Party role category of an item party in a business document, and may be based on datatype GDT: PartyRoleCategoryCode.

A Party inbound association relationship may exist from the business object Party/node Party Cross DU, with a cardinality of C:C, which specifies a referenced party in master data. In some implementations, party information may not exist for a project expense view created corresponding to a recording from goods and activity confirmation. An Item Attachment Folder dependent object inclusion node is a collection of documents that are assigned to an item of a project expense view. An Item Text Collection dependent object inclusion node is a set of multilingual textual descriptions, including formatting information, for an item of a project expense view. An Attachment Folder dependent object inclusion node is a collection of documents that are assigned to a project expense view. The Text Collection dependent object inclusion node is a set of multilingual textual descriptions, including formatting information, for a project expense view.

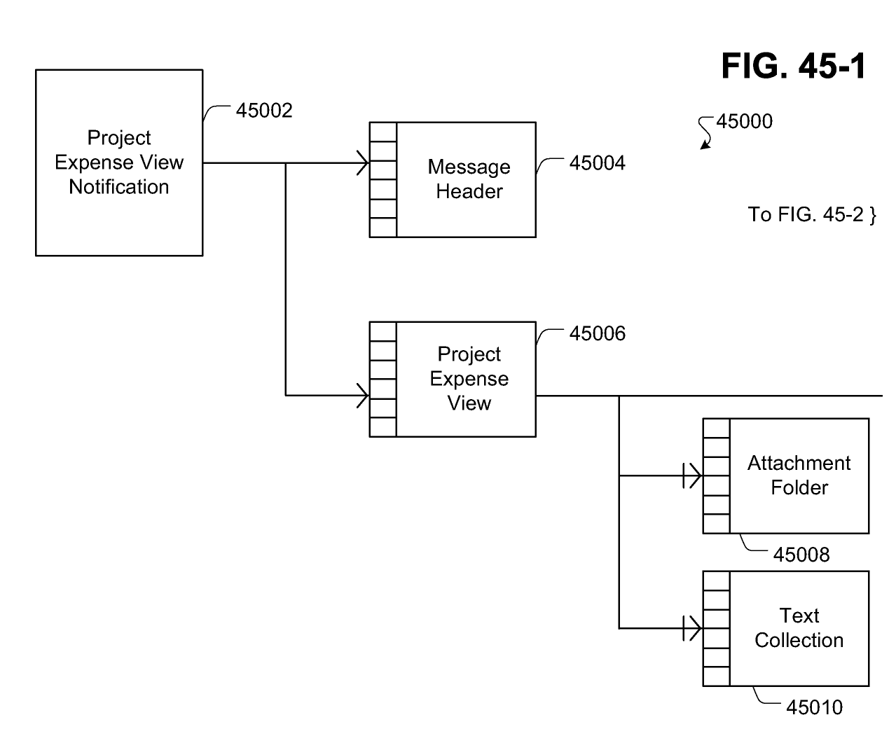

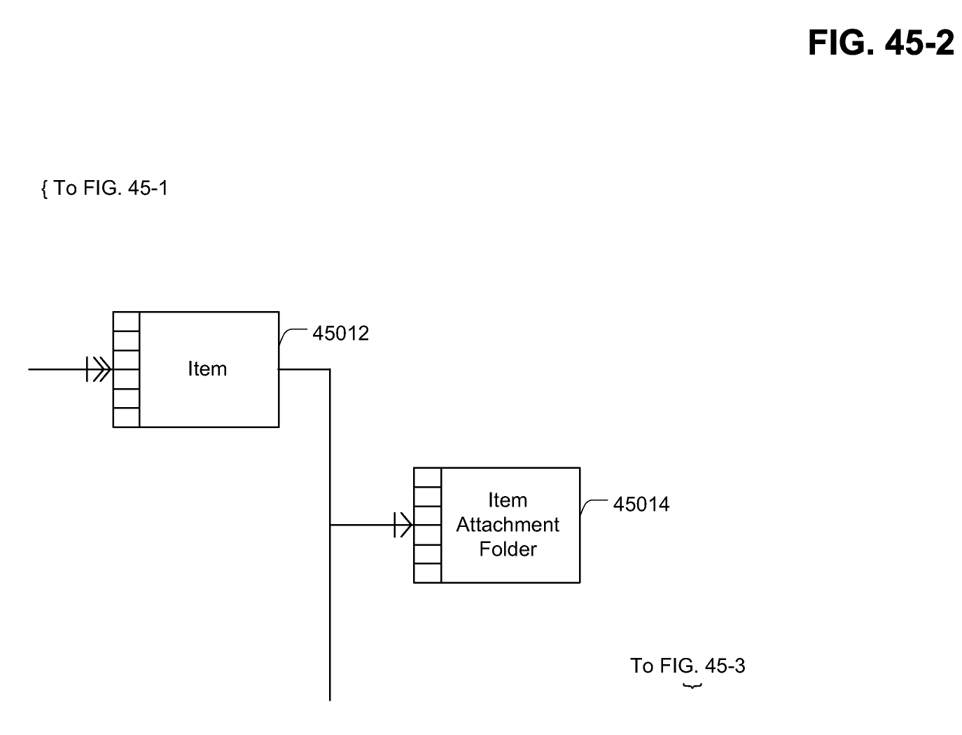

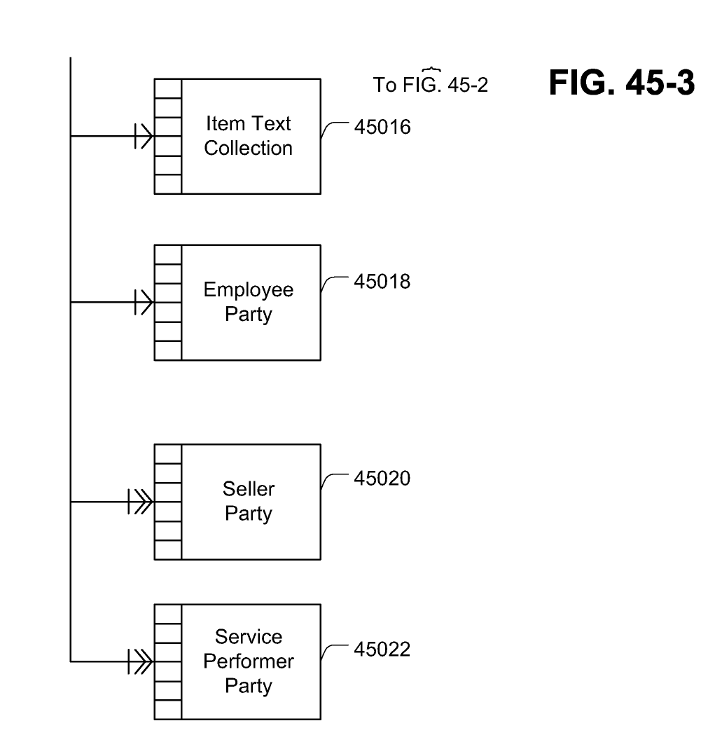

FIGS. 45-1 through 45-3 depict an example Project Expense View Notification Message Data Type 45000, which comprises elements 45002-45022, hierarchically related as shown. For example, the Project Expense View Notification 45002 includes a Message Header 45004.

The message type Project Expense View Notification is derived from the business object Project Expense View as leading object together with its operation signature. Project Expense View Notification is a notification that includes information about expense incurred for a project. The structure of this message type is determined by the message data type ProjectExpenseViewMessage.

This message data type ProjectExpenseViewMessage includes an object ProjectExpenseView which is included in the business document, business information that is relevant for sending a business document in a message, a MessageHeader package, and a ProjectExpenseView package. This message data type, therefore, provides the structure for a Project Expense View Notification message types and the operations that are based on it.

The MessageHeader package is a grouping of business information that is relevant for sending a business document in a message, and includes the node MessageHeader. MessageHeader is a grouping of business information from the perspective of a sending application. MessageHeader may include information to identify a business document in a message, information about a sender, and may optionally include information about a recipient. The MessageHeader may include SenderParty and RecipientParty. MessageHeader may be based on datatype GDT:BusinessDocumentMessageHeader, and the following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime.

SenderParty is a partner responsible for sending a business document at business application level. SenderParty may be based on datatype GDT:BusinessDocumentMessageHeaderParty. RecipientParty is a partner responsible for receiving a business document at business application level. RecipientParty may be based on datatype GDT:BusinessDocumentMessageHeaderParty.

The ProjectExpenseView package is a grouping of ProjectExpenseView with its packages. ProjectExpenseView may include Attachment Folder, Text Collection, and Item, and the entity ProjectExpenseView. ProjectExpenseView is a notification that includes information about expense incurred for a project.

ProjectExpenseView may include the following Attributes: reconciliationPeriodCounterValue, actionCode, CompleteTransmissionIndicator, and ItemListCompleteTransmissionIndicator. reconciliationPeriodCounterValue is the Number of a current reconciliation period. reconciliationPeriodCounterValue may be optional and may be based on datatype GDT:CounterValue with a qualifier of ReconciliationPeriod. actionCode is coded instruction to a recipient of a message that states how the recipient is to process a transferred element. actionCode may be based on datatype GDT:ActionCode. CompleteTransmissionIndicator is an indicator that defines whether all elements are transferred. CompleteTransmissionIndicator may be based on datatype CDT:Indicator with a qualifier of CompleteTransmission. ItemListCompleteTransmissionIndicator is an indicator that defines whether items are transferred. ItemListCompleteTransmissionIndicator may be based on datatype CDT:Indicator with a qualifier of CompleteTransmission.

ProjectExpenseView may include the following non-node elements: ExpenseDocumentIncludingBusinessObjectReference, ExpenseDocumentReference, ExpenseDocumentTransactionUUID, and CancelledIndicator. ExpenseDocumentIncludingBusinessObjectReference may be optional and may be based on datatype GDT:ObjectNodeReference. ExpenseDocumentReference may be based on datatype GDT:ObjectNodeReference. ExpenseDocumentTransactionUUID may be optional and may be based on datatype GDT:UUID. CancelledIndicator may be based on datatype CDT:Indicator with a qualifier of Cancelled. ProjectExpenseView may include the following node elements: Attachment Folder, with a cardinality of 1:C; Text Collection, with a cardinality of 1:C; and Item, with a cardinality of 1:CN. For each expense document, there may be a Project Expense View. A ProjectExpenseViewNotification may contain data for a Project Expense View. ExpenseDocumentIncludingBusinessObjectReference, ExpenseDocumentReference, and ExpenseDocumentTransactionUUID is information for Financial Accounting and may be filled in the same way as it was filled for the AccountingNotification in the sending process component. The Attachment Folder package and Text Collection package may contain texts and attachments that were assigned to the root node of expense items.

ProjectExpenseViewAttachment Folder package may include an Attachment Folder entity. Attachment Folder is typed by AttachmentFolder. ProjectExpenseViewText Collection package may include a Text Collection entity. Text Collection is typed by TextCollection. ProjectExpenseViewItem package may include an Item entity.

Item may include the following Attributes: actionCode and ItemPartyListCompleteTransmissionIndicator. actionCode is coded instruction to a recipient of a message that states how the recipient is to process a transferred element. actionCode may be based on datatype GDT:ActionCode. ItemPartyListCompleteTransmissionIndicator is an indicator that defines whether item parties are transferred. ItemPartyListCompleteTransmissionIndicator may be based on datatype CDT:Indicator with a qualifier of CompleteTransmission.

Item may include the following non-node elements: ExpenseDocumentItemReference, ProjectReference, ExpenseIncurrencePeriod, TotalQuantity, TotalQuantityTypeCode, TotalAmount, PurchaseOrderItemReference, GoodsAndServiceAcknowledgementItemReference, EmployeeTimeCalendarPeriodItemID, GeneralLedgerAccountAliasCode, MeasureUnitName, DeductionIndicator, ExpenseReportExpenseCategoryCode, BusinessTransactionDocumentProduct, ExpenseReportReceiptID, ProductCategoryInternalID, ProductCategoryHierarchyID, ExpenseDescription, and CancelledIndicator. ExpenseDocumentItemReference may be based on datatype GDT:Obj ectNodeReference. ProjectReference may be based on datatype GDT:ProjectReference. ExpenseIncurrencePeriod may be based on datatype GDT:UPPEROPEN_LOCALNORMALISED_DateTimePeriod. TotalQuantity may be optional and may be based on datatype CDT:Quantity. TotalQuantityTypeCode may be optional and may be based on datatype GDT:QuantityTypeCode. TotalAmount may be optional and may be based on datatype CDT:Amount. PurchaseOrderItemReference may be optional and may be based on datatype GDT:BusinessTransactionDocumentReference. GoodsAndServiceAcknowledgementItemReference may be optional and may be based on datatype GDT:BusinessTransactionDocumentReference. EmployeeTimeCalendarPeriodItemID may be optional and may be based on datatype GDT:BusinessTransactionDocumentID. GeneralLedgerAccountAliasCode may be optional and may be based on datatype GDT:GeneralLedgerAccountAliasCode. MeasureUnitName may be optional and may be based on datatype CDT:MEDIUM_Name. DeductionIndicator may be optional and may be based on datatype CDT:Indicator with a qualifier of Deduction. ExpenseReportExpenseCategoryCode may be optional and may be based on datatype GDT:ExpenseReportExpenseCategoryCode. BusinessTransactionDocumentProduct may be optional and may be based on datatype GDT:BusinessTransactionDocumentProduct. ExpenseReportReceiptID may be optional and may be based on datatype GDT:ExpenseReportReceiptID. ProductCategoryInternalID may be optional and may be based on datatype GDT:ProductCategoryInternalID. ProductCategoryHierarchyID may be optional and may be based on datatype GDT:ProductCategoryHierarchyID. ExpenseDescription may be optional and may be based on datatype GDT:MEDIUM_Description. CancelledIndicator may be based on datatype CDT:Indicator with a qualifier of Cancelled.

Item may include the following node elements: Item Attachment Folder, with a cardinality of 1:C; ItemTextCollection, with a cardinality of 1:C; EmployeeParty, with a cardinality of 1:C; SellerParty, with a cardinality of 1:C; and ServicePerformerParty, with a cardinality of 1:C.

In some implementations, either quantity or amount or both must be filled. In some implementations, QuantityTypeCode must be filled if Quantity is filled. In some implementations, ProjectReference: ProjectID and ProjectTaskID are required. In some implementations, Deduction indicator, MeasureUnitName, ExpenseCategory and GeneralLedgerAccountAliasCode are for messages from Expense and Reimbursement Management (ERM). In some implementations, UUID and formatted ID are required, and formatted ID must be filled with the ID of the object. In some implementations, for messages from Inventory Processing, BusinessTransactionDocumentProduct is required. In some implementations, for other senders, at least one of GeneralLedgerAccountAliasCode or ExpenseDescription or ProductCategory or Product must be provided. For example, PurchaseOrderItemReference may be filled by Goods and Service Acknowledgement and Supplier Invoicing in order to identify SIVs and GSAs that belong together. GoodsAndServiceAcknowledgementItemReference may be filled by Supplier Invoicing to identify GSAs that a SIV refers to. For ExpenseIncurrencePeriod, for example, if a single date or date and time is available, this may be converted into the DateTimePeriod (e.g., by using a method). If no time is available, for example, the time may be set to 00:00:00. When an item is cancelled, for example, all information may be sent again as in an original message, and an indicator may be set.

ProjectExpenseViewItemItem Attachment Folder package may include an Item Attachment Folder entity. Item Attachment Folder is typed by AttachmentFolder. ProjectExpenseViewItemTextCollection package may include an ItemTextCollection entity. ItemTextCollection is typed by TextCollection. ProjectExpenseViewItemParty package may include the entities EmployeeParty, SellerParty, and ServicePerformerParty. EmployeeParty is typed by BusinessTransactionDocumentParty. SellerParty is typed by BusinessTransactionDocumentParty. ServicePerformerParty is typed by BusinessTransactionDocumentParty.

Data Types Used (GDTs) may include ActionCode, AttachmentFolder, BusinessDocumentMessageID, BusinessScope, BusinessSystemID, BusinessTransactionDocumentID, BusinessTransactionDocumentParty, BusinessTransactionDocumentReference, CounterValue, ExpenseReportExpenseCategoryCode, ExpenseReportReceiptID, GLOBAL_DateTime, GeneralLedgerAccountAliasCode, MEDIUM_Description, ObjectNodeReference, ProductCategoryHierarchyID, ProductCategoryInternalID, ProjectReference, QuantityTypeCode, TextCollection, UPPEROPEN_LOCALNORMALISED_DateTimePeriod, and UUID.

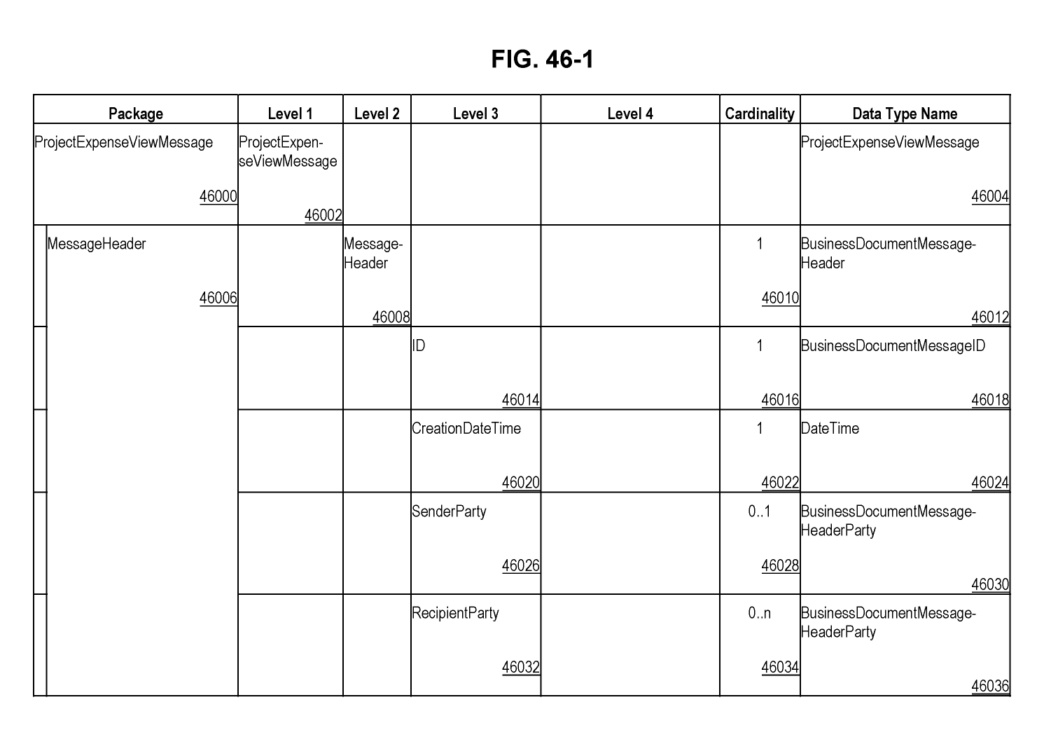

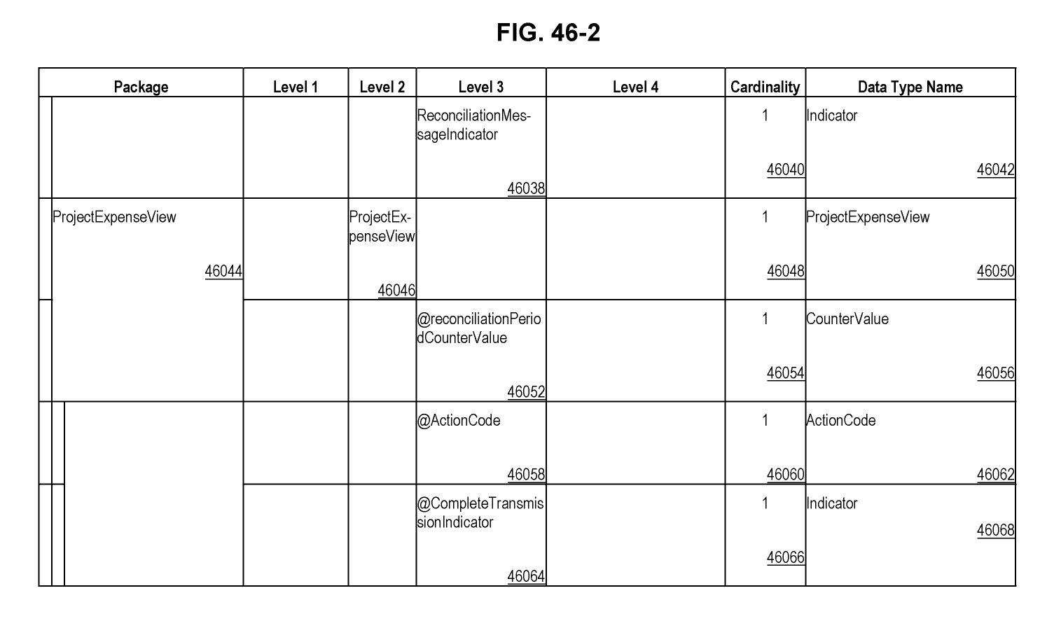

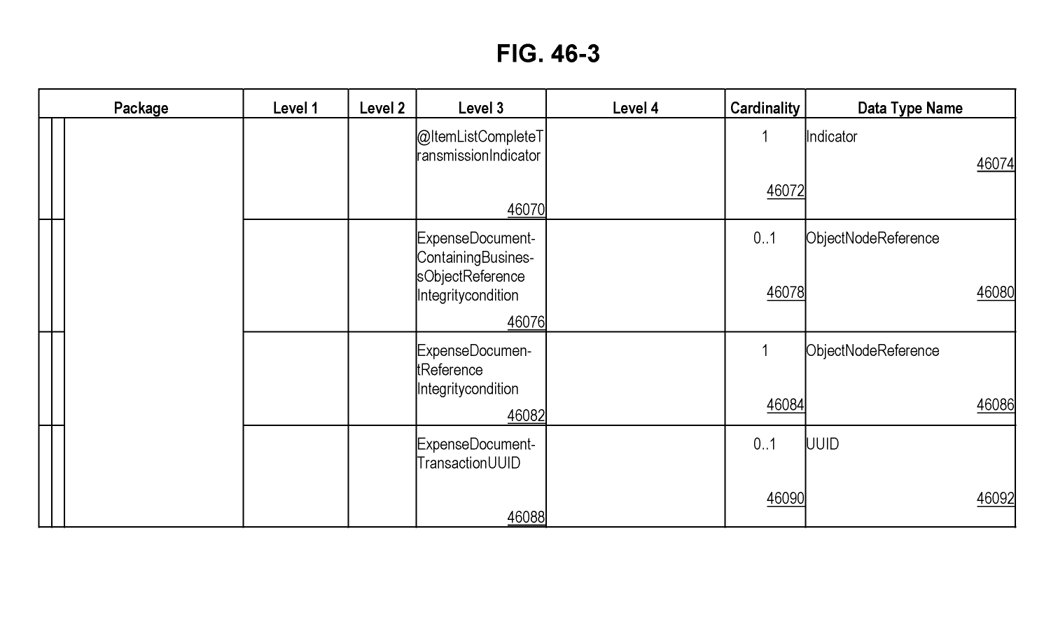

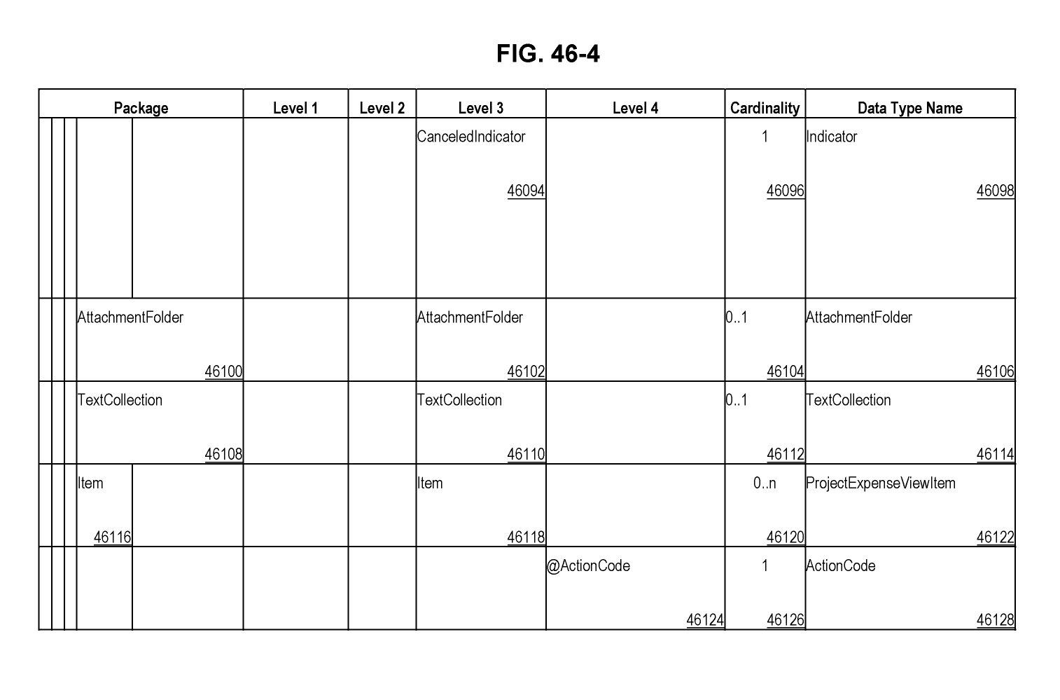

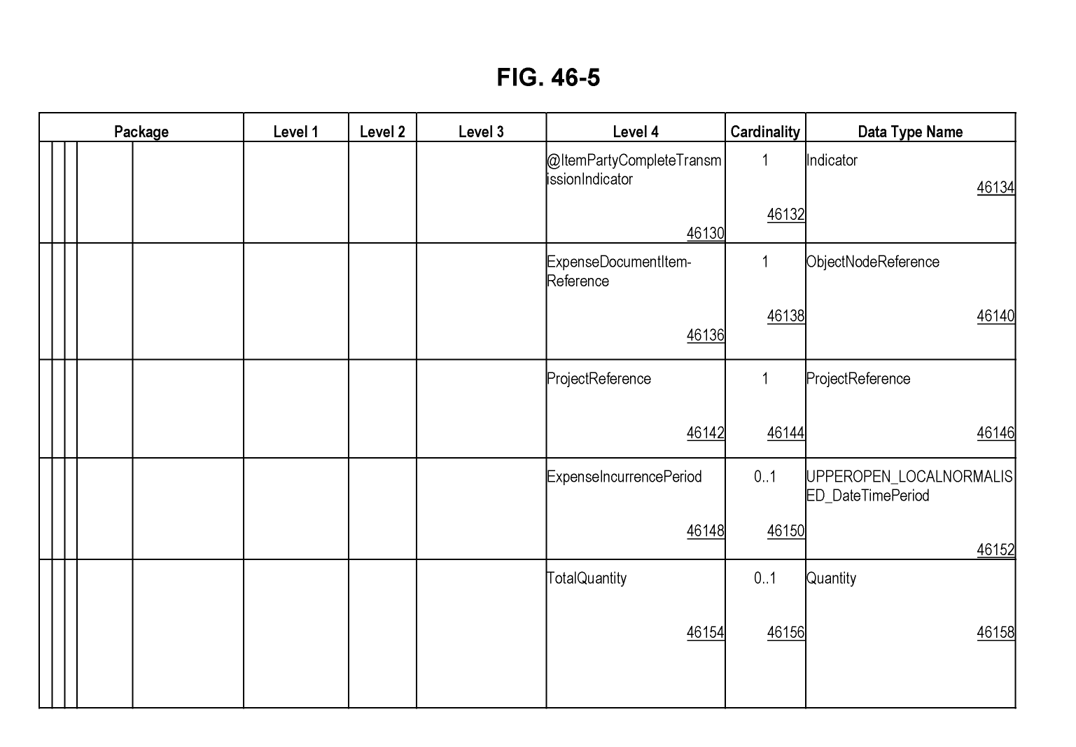

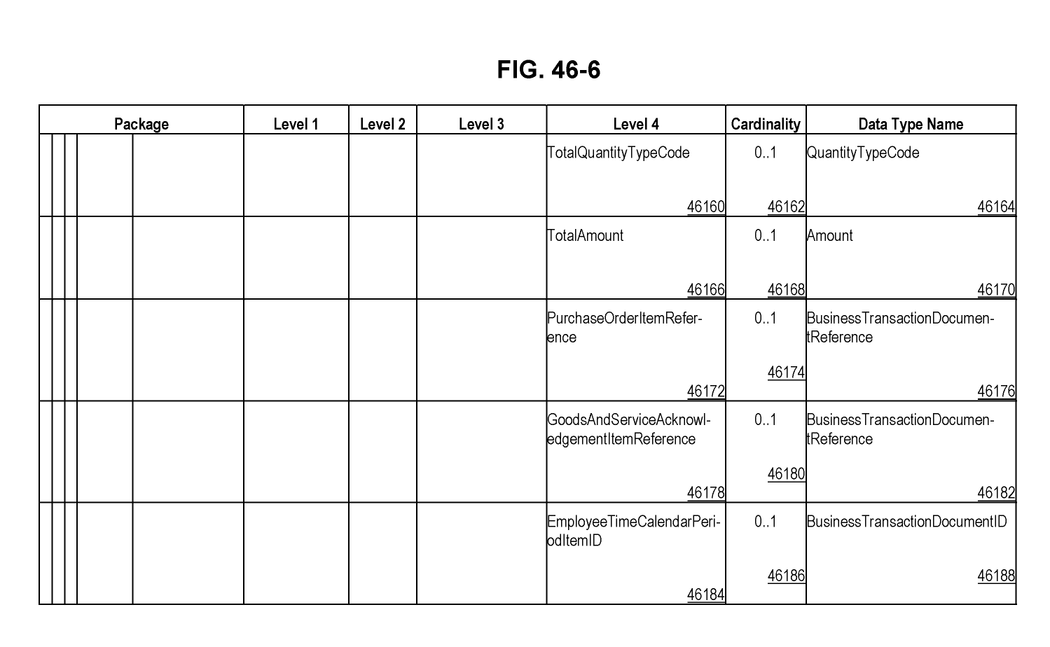

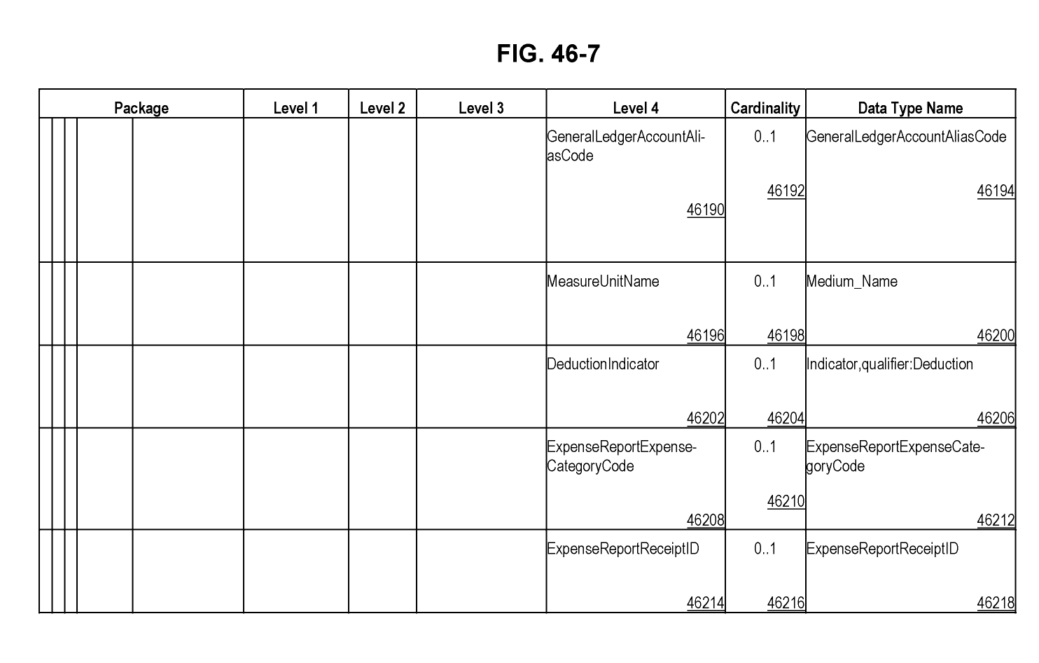

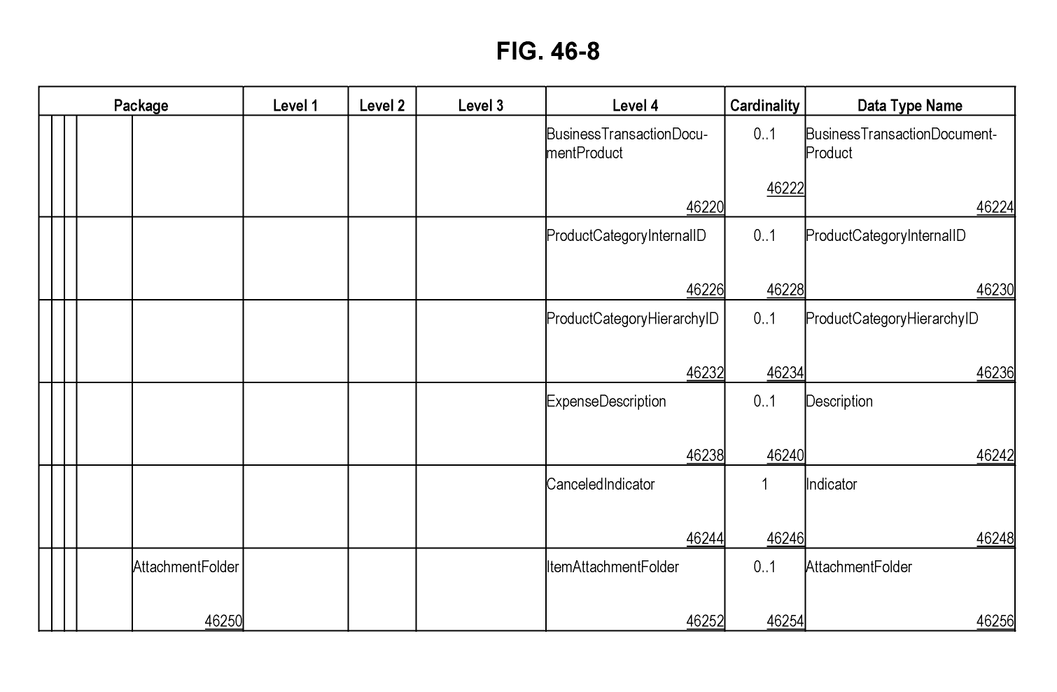

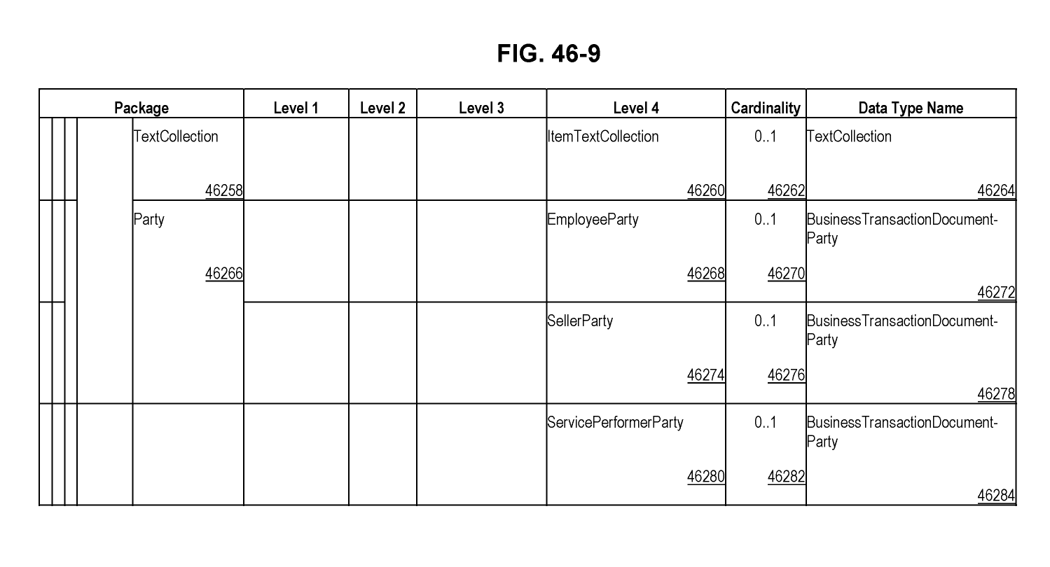

FIGS. 46-1 through 46-9 show an example configuration of an Element Structure that includes a ProjectExpenseViewMessage 46000 package. Specifically, these figures depict the arrangement and hierarchy of various components such as one or more levels of packages, entities, and datatypes, shown here as 46000 through 46284. As described above, packages may be used to represent hierarchy levels. Entities are discrete business elements that are used during a business transaction. Data types are used to type object entities and interfaces with a structure. For example, the ProjectExpenseViewMessage 46000 includes, among other things, a ProjectExpenseViewMessage 46002. Accordingly, heterogeneous applications may communicate using this consistent message configured as such.

A number of implementations have been described. Nevertheless, it will be understood that various modifications may be made without departing from the spirit and scope of the disclosure. Accordingly, other implementations are within the scope of the following claims.

What is claimed is:

1. A tangible computer readable medium including program code for providing a message-based interface for exchanging sales and invoice information between a sales order processing system and other systems, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting a confirmation to the sales order processing system that a customer project invoicing agreement related to a sales order has been created or updated that includes a first message package derived from the common business object model and hierarchically organized in memory as:
a customer project invoicing agreement maintain confirmation request message entity; and
a customer project invoicing agreement package comprising a customer project invoicing agreement entity and an item package comprising an item entity, where the customer project invoicing agreement entity includes an item list complete transmission indicator, an action code, a base customer transaction document identifier (ID), a base customer transaction document universally unique ID and a customer project invoicing agreement reference, and where the item entity includes a base customer transaction document item ID, a fulfillment processing status code, an invoice processing status code and a customer project invoicing agreement item reference;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

2. The computer readable medium of claim 1, wherein the customer project invoicing agreement entity further comprises at least one of the following: a reconciliation period counter value.

3. A distributed system operating in a landscape of computer systems providing message-based services defined in a service registry, the system comprising:
a graphical user interface comprising computer readable instructions, embedded on tangible media, for requesting a confirmation to a sales order processing system that a customer project invoicing agreement related to a sales order has been created or updated using a request;
a first memory storing a user interface controller for processing the request and involving a message including a message package derived from a common business object model, where the common business object model includes business objects having relationships that enable derivation of message-based service interfaces and message packages, the message package hierarchically organized as:
a customer project invoicing agreement maintain confirmation request message entity; and
a customer project invoicing agreement package comprising a customer project invoicing agreement entity and an item package comprising an item entity, where the customer project invoicing agreement entity includes an item list complete transmission indicator, an action code, a base customer transaction document identifier (ID), a base customer transaction document universally unique ID and a customer project invoicing agreement reference, and where the item entity includes a base customer transaction document item ID, a fulfillment processing status code, an invoice processing status code and a customer project invoicing agreement item reference; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

4. The distributed system of claim 3, wherein the first memory is remote from the graphical user interface.

5. The distributed system of claim 3, wherein the first memory is remote from the second memory.

6. A tangible computer readable medium including program code for providing a message-based interface for exchanging information about an engineering change case, including a collection of documents, references, and decisions for the purpose of i) identifying a potential solution to problems that initiate an engineering change, ii) researching, designing, and validating engineering change alternatives, iii) reviewing and deciding on an implementation of the change, and iv) instructing the participants in the change and defining their responsibilities, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for retrieving information about an engineering change case that includes a first message package derived from the common business object model and hierarchically organized in memory as:
an engineering change case request message entity; and
an engineering change case package comprising an engineering change case entity, a business folder entity, and a business process variant type entity, where the engineering change case entity includes a universally unique identifier (UUID), an identifier (ID), an engineering change type code, a responsible employee UUID, a responsible employee ID, a due date time, a partial system administrative data, and a status;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

7. The computer readable medium of claim 6, wherein the engineering change case entity further comprises at least one of the following: a name, an engineering change reason code, an engineering change risk level code, a project UUID, and a project ID.

8. The computer readable medium of claim 6, wherein the engineering change case package comprises at least one of the following: a text collection entity, a stage entity, an engineering change order reference entity, a product requirement specification reference entity, a product design reference entity, a material reference entity, a production bill of material reference entity, a production model reference entity, a master data change folder entity, and a master data change record entity.

9. A distributed system operating in a landscape of computer systems providing message-based services defined in a service registry, the system comprising:
a graphical user interface comprising computer readable instructions, embedded on tangible media, for retrieving information about an engineering change case using a request;
a first memory storing a user interface controller for processing the request and involving a message including a message package derived from a common business object model, where the common business object model includes business objects having relationships that enable derivation of message-based service interfaces and message packages, the message package hierarchically organized as:
an engineering change case request message entity; and
an engineering change case package comprising an engineering change case entity, a business folder entity, and a business process variant type entity, where the engineering change case entity includes a universally unique identifier (UUID), an identifier (ID), an engineering change type code, a responsible employee UUID, a responsible employee ID, a due date time, a partial system administrative data, and a status; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

10. The distributed system of claim 9, wherein the first memory is remote from the graphical user interface.

11. The distributed system of claim 9, wherein the first memory is remote from the second memory.

12. A tangible computer readable medium including program code for providing a message-based interface for exchanging design-related information that describes a product as designed by engineering, including design-related documents and a list of components, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for confirming the replication of the design-related information that includes a first message package derived from the common business object model and hierarchically organized in memory as:
a product design replication confirmation request message entity; and
a product design package comprising a product design entity, where the product design entity includes an action code, an identifier (ID), an engineering design business system name, an engineering design business system ID, an engineering design ID, and an engineering design internal ID;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

13. The computer readable medium of claim 12, wherein the product design package further comprises at least one of the following: a version package and a log package.

14. A distributed system operating in a landscape of computer systems providing message-based services defined in a service registry, the system comprising:
a graphical user interface comprising computer readable instructions, embedded on tangible media, for confirming the replication of design-related information that describes a product as designed by engineering, including design-related documents and a list of components, using a request;
a first memory storing a user interface controller for processing the request and involving a message including a message package derived from a common business object model, where the common business object model includes business objects having relationships that enable derivation of message-based service interfaces and message packages, the message package hierarchically organized as:
a product design replication confirmation request message entity; and
a product design package comprising a product design entity, where the product design entity includes an action code, an identifier (ID), an engineering design business system name, an engineering design business system ID, an engineering design ID, and an engineering design internal ID; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

15. The distributed system of claim 14, wherein the first memory is remote from the graphical user interface.

16. The distributed system of claim 14, wherein the first memory is remote from the second memory.

17. A tangible computer readable medium including program code for providing a message-based interface for exchanging information about a hierarchy of product design versions that describe, in detail, a product as designed by engineering, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting information about a hierarchy of product design versions that describe, in detail, a product as designed by engineering that includes a first message package derived from the common business object model and hierarchically organized in memory as:
a product design version hierarchy request message entity; and
a product design version hierarchy package comprising a product design version hierarchy entity and a component entity, where the product design version hierarchy entity includes a universally unique identifier (UUID), a product design version UUID, a product design version key, a product design ID, a product design version ID, and an inactive version included indicator;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

18. The computer readable medium of claim 17, wherein the product design version hierarchy entity further comprises at least one of the following: a product design version base, a quantity, a product design version base quantity type code, a quantity, an explosion date, and a maximum hierarchy level ordinal number value.

19. A distributed system operating in a landscape of computer systems providing message-based services defined in a service registry, the system comprising:
a graphical user interface comprising computer readable instructions, embedded on tangible media, for requesting information about a hierarchy of product design versions that describe, in detail, a product as designed by engineering, using a request;
a first memory storing a user interface controller for processing the request and involving a message including a message package derived from a common business object model, where the common business object model includes business objects having relationships that enable derivation of message-based service interfaces and message packages, the message package hierarchically organized as:
a product design version hierarchy request message entity; and
a product design version hierarchy package comprising a product design version hierarchy entity and a component entity, where the product design version hierarchy entity includes a universally unique identifier (UUID), a product design version UUID, a product design version key, a product design ID, a product design version ID, and an inactive version included indicator; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

20. The distributed system of claim 19, wherein the first memory is remote from the graphical user interface.

21. The distributed system of claim 19, wherein the first memory is remote from the second memory.

22. A tangible computer readable medium including program code for providing a message-based interface for exchanging grouping-related information that is used for grouping business information related to sending a business document in a message, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a notification of a grouping of business information that is relevant for sending the business document in the message that includes a first message package derived from the common business object model and hierarchically organized in memory as:
a project expense view notification request message entity; and
a project expense view package comprising a project expense view entity, where the project expense view entity includes a reconciliation period counter value, an action code, a complete transmission indicator, an item list complete transmission indicator, an expense document reference, and a canceled indicator;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

23. The computer readable medium of claim 22, wherein the project expense view entity further comprises at least one of the following: an expense document containing business object reference and an expense document transaction UUID.

24. The computer readable medium of claim 22, wherein the project expense view package comprises at least one of the following: an attachment folder package, a text collection package, and an item package.

25. A distributed system operating in a landscape of computer systems providing message-based services defined in a service registry, the system comprising:
a graphical user interface comprising computer readable instructions, embedded on tangible media, for providing a notification of a grouping of business information that is relevant for sending a business document in a message using a request;
a first memory storing a user interface controller for processing the request and involving a message including a message package derived from a common business object model, where the common business object model includes business objects having relationships that enable derivation of message-based service interfaces and message packages, the message package hierarchically organized as:
a project expense view notification request message entity; and
a project expense view package comprising a project expense view entity, where the project expense view entity includes a reconciliation period counter value, an action code, a complete transmission indicator, an item list complete transmission indicator, an expense document reference, and a canceled indicator; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

26. The distributed system of claim 25, wherein the first memory is remote from the graphical user interface.

27. The distributed system of claim 25, wherein the first memory is remote from the second memory.
